(19) United States
(12) Patent Application Publication
(10) Pub. No.: US 2018/0075798 A1
(43) Pub. Date: Mar. 15, 2018

(54) External Compensation for Display on Mobile Device

(71) Applicant: Apple Inc., Cupertino, CA (US)

(72) Inventors: Hyunwoo Nho, Stanford, CA (US); Hung Sheng Lin, San Jose, CA (US); Jie Won Ryu, Sunnyvale, CA (US); Junhua Tan, Santa Clara, CA (US); Sun-Il Chang, San Jose, CA (US); Shengkui Gao, San Jose, CA (US); Rui Zhang, Santa Clara, CA (US); Injae Hwang, Tokyo (JP); Kingsuk Brahma, San Francisco, CA (US); Jesse Aaron Richmond, San Francisco, CA (US); Shiping Shen, Cupertino, CA (US); Hyunsoo Kim, Cupertino, CA (US); Sebastian Knitter, San Francisco, CA (US); Lu Zhang, Cupertino, CA (US); Nicolas P. Bonnier, Campbell, CA (US); Chih-Wei Yeh, Campbell, CA (US); Chaohao Wang, Sunnyvale, CA (US); Paolo Sacchetto, Cupertino, CA (US); Chin-Wei Lin, Cupertino, CA (US); Mohammad B Vahid Far, San Jose, CA (US); Shinya Ono, Cupertino, CA (US); Yafei Bi, Palo Alto, CA (US); Majid Gharghi, Cupertino, CA (US); Kavinaath Murugan, Cupertino, CA (US); Yun Wang, Cupertino, CA (US); Derek K. Shaeffer, Redwood City, CA (US); Baris Cagdaser, Sunnyvale, CA (US); Tobias Jung, München (DE); Marc Albrecht, San Francisco, CA (US); Myung-Je Cho, Cupertino, CA (US)

(21) Appl. No.: 15/661,995

(22) Filed: Jul. 27, 2017

Related U.S. Application Data
(60) Provisional application No. 62/394,595, filed on Sep. 14, 2016.
(60) Provisional application No. 62/483,237, filed on Apr. 7, 2017.
(60) Provisional application No. 62/396,659, filed on Sep. 19, 2016.
(60) Provisional application No. 62/397,845, filed on Sep. 21, 2016.
(60) Provisional application No. 62/398,902, filed on Sep. 23, 2016.
(60) Provisional application No. 62/483,264, filed on Apr. 7, 2017.
(60) Provisional application No. 62/511,812, filed on May 26, 2017.
(60) Provisional application No. 62/396,538, filed on Sep. 19, 2016.
(60) Provisional application No. 62/399,371, filed on Sep. 24, 2016.
(60) Provisional application No. 62/483,235, filed on Apr. 7, 2017.
(60) Provisional application No. 62/396,547, filed on Sep. 19, 2016.
(60) Provisional application No. 62/511,818, filed on May 26, 2017.

(51) Int. Cl. G09G 3/32

(52) U.S. Cl. CPC G09G 3/32; G09G 2320/0233; G09G 2320/041; G09G 2320/029; G09G 2320/045; G09G 2320/0626

(57) ABSTRACT

A mobile electronic device includes a display having a pixel and processing circuitry separate from but communicatively coupled to the display. The processing circuitry prepares image data to send to the pixel and adjusts the image data to compensate for operational variations of the display based on feedback received from the display that describes a present operational behavior of the pixel. The mobile electronic device also includes additional electronic components that affect the present operational behavior of the pixel depending on present operational behavior of the additional electronic components.

### CROSS-REFERENCE TO RELATED APPLICATIONS

This application claims priority to and benefit from U.S. Provisional Application No. 62/394,595, filed Sep. 14, 2016, entitled “Systems and Methods for In-Frame Sensing and Adaptive Sensing Control”; U.S. Provisional Application No. 62/483,237, filed Apr. 7, 2017, entitled “Sensing Considering Image”; U.S. Provisional Application No. 62/396,659, filed Sep. 19, 2016, entitled “Low-Visibility Display Sensing;” U.S. Provisional Application No. 62/397,845, filed Sep. 21, 2016, entitled “Noise Mitigation for Display Panel Sensing;” U.S. Provisional Application No. 62/398,902, filed Sep. 23, 2016, entitled “Edge Column Differential Sensing Systems and Methods;” U.S. Provisional Application No. 62/483,264, filed Apr. 7, 2017, entitled “Device And Method For Panel Conditioning;” U.S. Provisional Application No. 62/511,812, filed May 26, 2017, entitled “Common-Mode Noise Compensation;” U.S. Provisional Application No. 62/396,538, filed Sep. 19, 2016, entitled “Dual-Loop Display Sensing For Compensation;” U.S. Provisional Application No. 62/399,371, filed Sep. 24, 2016, entitled “Display Adjustment;” U.S. Provisional Application No. 62/483,235, filed Apr. 7, 2017, entitled “Correction Schemes For Display Panel Sensing;” U.S. Provisional Application No. 62/396,547, filed Sep. 19, 2016, entitled “Power Cycle Display Sensing”; and U.S. Provisional Application No. 62/511,818, filed on May 26, 2017, entitled “Predictive Temperature Compensation”; the contents of which are incorporated by reference in their entirety for all purposes.

### BACKGROUND

The present disclosure relates generally to electronic displays and, more particularly, to devices and methods for achieving improvements in sensing attributes of a light emitting diode (LED) electronic display or attributes affecting an LED electronic display.

This section is intended to introduce the reader to various aspects of art that may be related to various aspects of the present disclosure, which are described and/or claimed below. This discussion is believed to be helpful in providing the reader with background information to facilitate a better understanding of the various aspects of the present disclosure. Accordingly, it should be understood that these statements are to be read in this light, and not as admissions of prior art.

Flat panel displays, such as active matrix organic light emitting diode (AMOLED) displays, micro-LED (μLED) displays, and the like, are commonly used in a wide variety of electronic devices, including such consumer electronics as televisions, computers, and handheld devices (e.g., cellular telephones, audio and video players, gaming systems, and so forth). Such display panels typically provide a flat display in a relatively thin package that is suitable for use in a variety of electronic goods. In addition, such devices may use less power than comparable display technologies, making them suitable for use in battery-powered devices or in other contexts where it is desirable to minimize power usage.

LED displays typically include picture elements (e.g. pixels) arranged in a matrix to display an image that may be viewed by a user. Individual pixels of an LED display may generate light as a voltage is applied to each pixel. The voltage applied to a pixel of an LED display may be regulated by, for example, thin film transistors (TFTs). For example, a circuit switching TFT may be used to regulate current flowing into a storage capacitor, and a driver TFT may be used to regulate the voltage being provided to the LED of an individual pixel. Finally, the growing reliance on electronic devices having LED displays has generated interest in improvement of the operation of the displays.

### SUMMARY

A summary of certain embodiments disclosed herein is set forth below. It should be understood that these aspects are presented merely to provide the reader with a brief summary of these certain embodiments and that these aspects are not intended to limit the scope of this disclosure. Indeed, this disclosure may encompass a variety of aspects that may not be set forth below.

The present disclosure relate to devices and methods for increased determination of the performance of certain electronic display devices including, for example, light emitting diode (LED) displays, such as organic light emitting diode (OLED) displays, active matrix organic light emitting diode (AMOLED) displays, or micro LED (μLED) displays. Under certain conditions, non-uniformity of a display induced by process non-uniformity temperature gradients, or other factors across the display should be compensated for to increase performance of a display (e.g., reduce visible anomalies). The non-uniformity of pixels in a display may vary between devices of the same type (e.g., two similar phones, tablets, wearable devices, or the like), it can vary over time and usage (e.g., due to aging and/or degradation of the pixels or other components of the display), and/or it can vary with respect to temperatures, as well as in response to additional factors.

To improve display panel uniformity, compensation techniques related to adaptive correction of the display may be employed. For example, as pixel response (e.g., luminance and/or color) can vary due to component processing, temperature, usage, aging, and the like, in one embodiment, to compensate for non-uniform pixel response, a property of the pixel (e.g., a current or a voltage) may be measured (e.g., sensed via a sensing operation) and compared to a target value, for example, stored in a lookup table or the like, to generate a correction value to be applied to correct pixel illuminations to match a desired gray level. In this manner, modified data values may be transmitted to the display to generate compensated image data (e.g., image data that accurately reflects the intended image to be displayed by adjusting for non-uniform pixel responses).

Various refinements of the features noted above may be made in relation to various aspects of the present disclosure. Further features may also be incorporated in these various aspects as well. These refinements and additional features may exist individually or in any combination. For instance, various features discussed below in relation to one or more of the illustrated embodiments may be incorporated into any of the above-described aspects of the present disclosure alone or in any combination. The brief summary presented above is intended only to familiarize the reader with certain aspects and contexts of embodiments of the present disclosure without limitation to the claimed subject matter.

### BRIEF DESCRIPTION OF THE DRAWINGS

Various aspects of this disclosure may be better understood upon reading the following detailed description and upon reference to the drawings in which:

FIG. 1 is a schematic block diagram of an electronic device that performs display sensing and compensation, in accordance with an embodiment;

FIG. 2 is a perspective view of a notebook computer representing an embodiment of the electronic device of FIG. 1;

FIG. 3 is a front view of a hand-held device representing another embodiment of the electronic device of FIG. 1;

FIG. 4 is a front view of another hand-held device representing another embodiment of the electronic device of FIG. 1;

FIG. 5 is a front view of a desktop computer representing another embodiment of the electronic device of FIG. 1;

FIG. 6 is a front view and side view of a wearable electronic device representing another embodiment of the electronic device of FIG. 1;

FIG. 7 is a block diagram of a system for display sensing and compensation, according to an embodiment of the present disclosure;

FIG. 8 is a flowchart illustrating a method for display sensing and compensation using the system of FIG. 7, according to an embodiment of the present disclosure;

FIG. 9 is block diagram of a portion of the electronic device of FIG. 1 used to display image frames, in accordance with an embodiment;

FIG. 10 is a block diagram of a sensing controller, in accordance with an embodiment of the present disclosure;

FIG. 11 is a diagram of a display panel refreshing display of one or more image frames, in accordance with an embodiment of the present disclosure;

FIG. 12 is a flow diagram of a process for determining a pattern of illuminated sense pixels, in accordance with an embodiment of the present disclosure;

FIG. 13 is a diagram of example patterns of sense pixels, in accordance with an embodiment of the present disclosure;

FIG. 14 is a flow diagram of a process for sensing operational parameters using sense pixels in a refresh pixel group while an image frame is displayed, in accordance with an embodiment of the present disclosure;

FIG. 15 is a timing diagram describing operation of display pixels based on the process of FIG. 14, in accordance with an embodiment of the present disclosure;

FIG. 16 is a flow diagram of another process for operational parameters using the sense pixels in the refresh pixels while an image frame is displayed, in accordance with an embodiment of the present disclosure;

FIG. 17 is a timing diagram describing operation of display pixels based on the process of FIG. 16, in accordance with an embodiment of the present disclosure;

FIG. 18 is a timing diagram describing operation of display pixels utilizing multiple refresh pixel groups based on the process of FIG. 16, in accordance with an embodiment of the present disclosure;

FIG. 19 is a flow diagram of another process for sensing operational parameters using the sense pixels in the refresh pixels while an image frame is displayed, in accordance with an embodiment of the present disclosure;

FIG. 20 is a timing diagram describing operation of display pixels based on the process of FIG. 19, in accordance with an embodiment of the present disclosure;

FIG. 21 is a timing diagram describing operation of display pixels utilizing multiple refresh pixel groups based on the process of FIG. 19, in accordance with an embodiment of the present disclosure;

FIG. 22 is a graph of image frames that include multiple intra frame pausing sensing periods, in accordance with an embodiment of the present disclosure;

FIG. 23 is a block diagram of an electronic display of FIG. 1 that performs display panel sensing, in accordance with an embodiment;

FIG. 24 is a block diagram of a pixel of the electronic display of FIG. 23, in accordance with an embodiment;

FIG. 25 is a graphical example of updating a correction map of the electronic display of FIG. 23, in accordance with an embodiment;

FIG. 26 is a second graphical example of updating a correction map of the electronic display of FIG. 23, in accordance with an embodiment;

FIG. 27 is a third graphical example of updating a correction map of the electronic display of FIG. 23, in accordance with an embodiment;

FIG. 28 is a diagram illustrating a portion of the electronic display of FIG. 23, in accordance with an embodiment;

FIG. 29 is a schematic view of a display system that includes an active area and driving circuitry for display and sensing modes, in accordance with an embodiment;

FIG. 30 is a schematic view of a pixel circuitry of the active area of FIG. 29, in accordance with an embodiment;

FIG. 31 is a diagram of display artifact resulting from a scan of a line with a dark display, in accordance with an embodiment;

FIG. 32 is a flow diagram of a process for scanning a display to sense information about the display, in accordance with an embodiment;

FIG. 33 is a graph of visibility of various colors of pixels during a sense based on ambient light levels, in accordance with an embodiment;

FIG. 34 is a graph of visibility of various colors of pixels during a sense based on luminance of the display, in accordance with an embodiment;

FIG. 35 is a diagram of display of scanning scheme for sensing during relatively high ambient light levels and/or relatively high UI luminance levels, in accordance with an embodiment;

FIG. 36 is a diagram of display of scanning scheme for sensing during relatively low ambient light levels and/or relatively low UI luminance levels, in accordance with an embodiment;

FIG. 37 is a diagram of display having a scanning scheme for a screen that includes both relatively high UI luminance levels and relatively low UI luminance levels, in accordance with an embodiment;

FIG. 38 is a flow diagram for a process for scanning a display based on video content luminosity, in accordance with an embodiment;

FIG. 39 is a flow diagram for a process for scanning a display based on ambient light levels, in accordance with an embodiment;

FIG. 40 is a flow diagram for a process for scanning a display for sensing based on a parameter using two thresholds, in accordance with an embodiment; and

FIG. 41 is a flow diagram for a process for controlling scanning of a display for sensing based at least in part on eye locations, in accordance with an embodiment.

FIG. 42 is a block diagram of an electronic display that performs display panel sensing, in accordance with an embodiment;

FIG. 43 is a thermal diagram indicating temperature variations due to heat sources on the electronic display, in accordance with an embodiment;

FIG. 44 is a block diagram of a process for compensating image data to account for changes in temperature on the electronic display, in accordance with an embodiment;

FIG. 45 is a flowchart of a method for determining to perform predictive temperature correction based at least in part on a display frame rate on the electronic display, in accordance with an embodiment;

FIG. 46 is a block diagram of circuitry to compensate image data for thermal variations of the electronic display using display sense feedback, in accordance with an embodiment;

FIG. 47 is a flowchart of a method for compensating the image data for the temperature variations of the electronic display, in accordance with an embodiment;

FIG. 48 is a block diagram of a system to perform predictive temperature correction, in accordance with an embodiment;

FIG. 49 is a flowchart of a method to perform the predictive temperature adjustment, in accordance with an embodiment;

FIG. 50 is a flowchart of a method for controlling an electronic display due at least in part to a predicted temperature change due to a change in image data content, in accordance with an embodiment;

FIG. 51 is a diagram showing blocks of image data to be displayed on the electronic display for analysis of thermal changes due changes in the image data, in accordance with an embodiment;

FIG. 52 is a timing diagram showing a change in content between two frames and an estimated change in temperature that occurs as a result, in accordance with an embodiment;

FIG. 53 is a block diagram of a system for performing content-dependent temperature correction, in accordance with an embodiment;

FIG. 54 is a table to estimate a change in temperature over time based on a change in brightness between content of two image frames, in accordance with an embodiment;

FIG. 55 is a timing diagram of predicted changes in temperature on an electronic display due to changes in content to be displayed on the electronic display, in accordance with an embodiment;

FIG. 56 is a timing diagram that illustrates accumulating a predicted amount of temperature change over time to trigger a new frame to prevent the appearance of a visional artifact due to the predicted temperature change, in accordance with an embodiment;

FIG. 57 is a block diagram of an electronic display that performs display panel sensing, in accordance with an embodiment;

FIG. 58 is a block diagram of single-ended sensing used in combination with a digital filter, in accordance with an embodiment;

FIG. 59 is a flowchart of a method performing single-ended sensing, in accordance with an embodiment;

FIG. 60 is a plot illustrating a relationship between signal and noise over time using single-ended sensing, in accordance with an embodiment;

FIG. 61 is a block diagram of differential sensing, in accordance with an embodiment;

FIG. 62 is a flowchart of a method for performing differential sensing, in accordance with an embodiment;

FIG. 63 is a plot of the relationship between signal and noise using differential sensing, in accordance with an embodiment;

FIG. 64 is a block diagram of differential sensing of non-adjacent columns of pixels, in accordance with an embodiment;

FIG. 65 is a block diagram of another example of differential sensing of other non-adjacent columns of pixels, in accordance with an embodiment;

FIG. 66 is a diagram showing capacitances on data lines used as sense lines of the electronic display when the data lines are equally aligned with another conductive line of the electronic display, in accordance with an embodiment;

FIG. 67 shows differences in capacitance on the data lines used as sense lines when the other conductive line is misaligned between the data lines, in accordance with an embodiment;

FIG. 68 is a circuit diagram illustrating the effect of different sense line capacitances on the detection of common-mode noise, in accordance with an embodiment;

FIG. 69 is a circuit diagram employing difference-differential sensing to remove differential common-mode noise from a differential signal, in accordance with an embodiment;

FIG. 70 is a block diagram of difference-differential sensing in the digital domain, in accordance with an embodiment;

FIG. 71 is a flowchart of a method for performing difference-differential sensing, in accordance with an embodiment;

FIG. 72 is a block diagram of difference-differential sensing in the analog domain, in accordance with an embodiment;

FIG. 73 is a block diagram of difference-differential sensing in the analog domain using multiple test differential sense amplifiers per reference differential sense amplifier, in accordance with an embodiment;

FIG. 74 is a block diagram of difference-differential sensing using multiple reference differential sense amplifiers to generate a differential common noise mode signal, in accordance with an embodiment;

FIG. 75 is a timing diagram for correlated double sampling, in accordance with an embodiment;

FIG. 76 is a comparison of plots of signals obtained during the correlated double sampling of FIG. 75, in accordance with an embodiment;

FIG. 77 is a flowchart of a method for performing correlated double sampling, in accordance with an embodiment;

FIG. 78 is a timing diagram of a first example of correlated double sampling that obtains one test sample and one reference sample, in accordance with an embodiment;

FIG. 79 is a timing diagram of a second example of correlated double sampling that obtains multiple test samples and one reference sample, in accordance with an embodiment;

FIG. 80 is a timing diagram of a third example of correlated double sampling that obtains non-sequential samples, in accordance with an embodiment;

FIG. 81 is an example of correlated double sampling occurring over two different display frames, in accordance with an embodiment;

FIG. 82 is a timing diagram showing a combined performance of correlated double sampling at different frames and difference-differential sampling across the same frame, to further reduce or mitigate common-mode noise during display sensing, in accordance with an embodiment;

FIG. 83 is a circuit diagram in which a capacitance difference between two sense lines is mitigated by adding capacitance to one of the sense lines, in accordance with an embodiment;

FIG. 84 is a circuit diagram in which the difference in capacitance on two sense lines is mitigated by adjusting a capacitance of an integration capacitor on a sense amplifier, in accordance with an embodiment;

FIG. 85 is a block diagram of an electronic display that performs display panel sensing, in accordance with an embodiment;

FIG. 86 is a block diagram of single-ended sensing used in combination with a digital filter, in accordance with an embodiment;

FIG. 87 is a flowchart of a method performing single-ended sensing, in accordance with an embodiment;

FIG. 88 is a plot illustrating a relationship between signal and noise over time using single-ended sensing, in accordance with an embodiment;

FIG. 89 is a block diagram of differential sensing, in accordance with an embodiment;

FIG. 90 is a flowchart of a method for performing differential sensing, in accordance with an embodiment;

FIG. 91 is a plot of the relationship between signal and noise using differential sensing, in accordance with an embodiment;

FIG. 92 is a block diagram of differential sensing of non-adjacent columns of pixels, in accordance with an embodiment;

FIG. 93 is a block diagram of another example of differential sensing of other non-adjacent columns of pixels, in accordance with an embodiment;

FIG. 94 is a diagram showing capacitances on data lines used as sense lines of the electronic display when the data lines are equally aligned with another conductive line of the electronic display, in accordance with an embodiment;

FIG. 95 shows differences in capacitance on the data lines used as sense lines when the other conductive line is misaligned between the data lines, in accordance with an embodiment;

FIG. 96 is a block diagram of differential sensing of an odd number of electrically similar columns by including a dummy column, in accordance with an embodiment;

FIG. 97 is a block diagram of differential sensing of an odd number of electrically similar columns using a dedicated sensing channel for edge columns, in accordance with an embodiment;

FIG. 98 is a block diagram of differential sensing of electrically similar columns with swapped sensing connections, in accordance with an embodiment;

FIG. 99 is a block diagram of differential sensing of an odd number of electrically similar columns using load matching, in accordance with an embodiment;

FIG. 100 is a block diagram of differential sensing of an odd number of electrically similar columns using dancing channels, in accordance with an embodiment;

FIG. 101 is a flowchart of a method for differential sensing using the dancing channels of FIG. 100, in accordance with an embodiment;

FIG. 102 is a block diagram of a channel layout that includes dancing channels, in accordance with an embodiment;

FIG. 103 is a circuit diagram for dancing channels for voltage sensing, in accordance with an embodiment;

FIG. 104 is a circuit diagram of dancing channels for current sensing, in accordance with an embodiment;

FIG. 105 is a circuit diagram of full display dancing channels, in accordance with an embodiment;

FIG. 106 is another of example of dancing channels at an edge of a display with an odd number of electrically similar columns, in accordance with an embodiment;

FIG. 107 is a block diagram of dancing channels that can differentially sense columns between two groups of electrically similar columns;

FIG. 108 is block diagram of an light emitting diode (LED) electronic display, in accordance with an embodiment;

FIG. 109 is a block diagram of light emission control of the LED electronic display of FIG. 108, in accordance with an embodiment;

FIG. 110 a second block diagram of light emission control of the LED electronic display of FIG. 108, in accordance with an embodiment;

FIG. 111 illustrates a timing diagram inclusive of a control signal provided to the display panel of FIG. 108, in accordance with an embodiment;

FIG. 112 illustrates a second timing diagram inclusive of a control signal provided to the display panel of FIG. 108, in accordance with an embodiment;

FIG. 113 illustrates a third timing diagram illustrating a control signal provided to the display panel of FIG. 108, in accordance with an embodiment;

FIG. 114 illustrates a fourth timing diagram inclusive of a control signal provided to the display panel of FIG. 108, in accordance with an embodiment;

FIG. 115 illustrates the a block diagram of the display of FIG. 108, in accordance with an embodiment;

FIG. 116 illustrates a second block diagram of the display of FIG. 108, in accordance with an embodiment;

FIG. 117 illustrates a fifth timing diagram inclusive of a control signal provided to the display panel of FIG. 108, in accordance with an embodiment;

FIG. 118 illustrates a third block diagram of the display of FIG. 108, in accordance with an embodiment;

FIG. 119 illustrates a block diagram view of a single-channel current sensing scheme, in accordance with an embodiment;

FIG. 120 illustrates a flow diagram of a process for sensing a current using two channels, in accordance with an embodiment;

FIG. 121 illustrates a block diagram view of a dual-channel current sensing scheme used in the process of FIG. 120, in accordance with an embodiment;

FIG. 122 illustrates a flow diagram of a process 150 for sensing a current using two channels each having differential inputs, in accordance with an embodiment;

FIG. 123 illustrates a block diagram view of a dual-channel current sensing scheme with differential input channels employing the process of FIG. 122, in accordance with an embodiment;

FIG. 124 illustrates a flow diagram of a process for calibrating the noise compensation circuitry to determine a scaling factor used in the process of FIG. 120 or 122, in accordance with an embodiment;

FIG. 125 is a block diagram view of calibration scheme used in the process of FIG. 12, in accordance with an embodiment;

FIG. 126 is a schematic view of a display system that includes an active area and a driving circuitry for display and sensing modes, in accordance with an embodiment;

FIG. 127 is a schematic view of a pixel circuitry of the active area of FIG. 126, in accordance with an embodiment;

FIG. 128 is a block diagram of a dual-loop compensation scheme with two independent loops that run at different times, in accordance with an embodiment;

FIG. 129 is a block diagram of a dual-loop compensation scheme with an aging loop and a temperature loop, in accordance with an embodiment;

FIG. 130 is a flow diagram of a dual-loop compensation scheme with a slow loop and a fast loop, in accordance with an embodiment;

FIG. 131 is a graph of fast loop and slow loop interaction with relation to temporal frequency and spatial frequencies, in accordance with an embodiment;

FIG. 132 is a schematic view of a screen of a display using a coarsened fast loop to have various regions with a display area spanning multiple regions, in accordance with an embodiment;

FIG. 133A illustrates a screen of a display illustrating an artifact resulting from only compensating using the fast loop, in accordance with an embodiment;

FIG. 133B illustrates a screen of a display illustrating a screen resulting from compensating using the fast loop and the slow loop, in accordance with an embodiment;

FIG. 134 illustrates a flow diagram of a process for compensating for temperature and aging variations using a fast loop and a slow loop, in accordance with an embodiment;

FIG. 135 illustrates a flow diagram of a process for compensating using a fast loop using spatially averages of scan data, in accordance with an embodiment

FIG. 136 illustrates a flow diagram of a process for compensating using a fast loop using sensed data sampling of less than all of the pixels of a display, in accordance with an embodiment;

FIG. 137 is a block diagram of an electronic display that performs display panel sensing, in accordance with an embodiment;

FIG. 138 is a thermal diagram indicating temperature variations due to heat sources on the electronic display, in accordance with an embodiment;

FIG. 139 is a block diagram of a process for compensating image data to account for changes sensed conditions affecting a pixel of the display of FIG. 137, in accordance with an embodiment;

FIG. 140 is a representation of converting the data values of a correction map of FIG. 139, in accordance with an embodiment;

FIG. 141 is a graphical example of updating of the correction map of FIG. 139, in accordance with an embodiment;

FIG. 142 is a diagram illustrating updating of voltage levels supplied to pixels of the display of FIG. 137, in accordance with an embodiment;

FIG. 143 is a graph illustrating a first embodiment of compensating for non-uniform pixel response of the display of FIG. 137, in accordance with an embodiment;

FIG. 144 is a graph illustrating a second embodiment of compensating for non-uniform pixel response of the display of FIG. 137, in accordance with an embodiment;

FIG. 145 is a graph illustrating a third embodiment of compensating for non-uniform pixel response of the display of FIG. 137;

FIG. 146 is a schematic diagram of a display panel correction system that may be used with the electronic device of FIG. 1, in accordance with an embodiment;

FIG. 147 is a schematic diagram of errors sources that may affect a display panel correction system such as the one of FIG. 146;

FIG. 148 is a chart illustrating sensing errors that may affect a display panel correction system such as the one of FIG. 146;

FIGS. 149A and 149B illustrate hysteresis errors that may affect a display panel correction system such as the one of FIG. 146;

FIG. 150 is an illustration of thermal errors that may affect a display panel correction system such as the one of FIG. 146;

FIG. 151 is a schematic diagram of a system to increase tolerance to hysteresis-induced sensing errors, and that may be used in the display panel correction system such as the one of FIG. 146, in accordance with an embodiment;

FIG. 152 is an illustration of the effect of the system of FIG. 151 in the sensing errors, in accordance with an embodiment;

FIG. 153 is an illustration of the increased tolerance to hysteresis-induced sensing errors that may be obtained by the system of FIG. 151, in accordance with an embodiment;

FIG. 154 is a schematic diagram of a system to increase tolerance to hysteresis-induced sensing errors, and that may be used in the display panel correction system such as the one of FIG. 146, in accordance with an embodiment;

FIGS. 155A and 155B are charts that illustrate the signal response to spatial filters and the feedback loop illustrated in FIG. 15, in accordance with an embodiment;

FIG. 156 illustrates multiple filter types that may be used to increase tolerance to hysteresis-induced sensing errors of FIGS. 151 and 153, in accordance with an embodiment;

FIG. 157 is a schematic diagram of a system to decrease luminance fluctuations using feedforward sensing and partial corrections to a correction map and that may be used in a display panel correction system such as the one of FIG. 146, in accordance with an embodiment;

FIG. 158 is another schematic diagram of a system to decrease luminance fluctuations using feedforward sensing and partial corrections to a correction map and that may be used in a display panel correction system such as the one of FIG. 146, in accordance with an embodiment;

FIG. 159 is another schematic diagram of a system to decrease luminance fluctuations using feedforward sensing and partial corrections to a correction map and that may be used in a display panel correction system such as the one of FIG. 146, in accordance with an embodiment;

FIG. 160 is a series of charts illustrating the effect of partial correction in decreasing luminance fluctuations observed using any of the systems of FIGS. 157-159, in accordance with an embodiment;

FIG. 161 is a series of charts illustrating the effect of feedforward sensing in decreasing luminance fluctuations observed using any of the systems of FIGS. 157-159, in accordance with an embodiment;

FIGS. 162A-D are charts that illustrate the effect of feedforward sensing and partial correction in decreasing luminance fluctuations observed using any of the systems of FIGS. 157-159, in accordance with an embodiment;

FIG. 163 is a schematic view of a display system that includes an active area and driving circuitry for display and sensing modes, in accordance with an embodiment;

FIG. 164 is a schematic view of pixel circuitry of the active area of FIG. 163, in accordance with an embodiment;

FIG. 165 is a graph of a thermal profile by location of the active area of FIG. 163 at boot up that may cause a display image artifact, in accordance with an embodiment;

FIG. 166 is a diagram of a screen that may be displayed when the thermal profile of FIG. 165 exists at start up of a portion of the electronic device, in accordance with an embodiment;

FIG. 167 is a flow diagram of a process for sensing during boot up, in accordance with an embodiment;

FIG. 168 is a timing diagram of the boot-up sensing of FIG. 167, in accordance with an embodiment;

FIG. 169 illustrates a block diagram view a circuit diagram of the display of FIG. 1, in accordance with an embodiment;

FIG. 170 illustrates a block diagram of a sensing period during a progressive scan of a display, in accordance with an embodiment;

FIG. 171 illustrates a block diagram view of a simplified pixel that controls emission of an OLED, in accordance with an embodiment;

FIG. 172A illustrates a graph of a relationship between an OLED current and VHILO in various temperatures for a red pixel, in accordance with an embodiment;

FIG. 172B illustrates a graph of a relationship between an OLED current and VHILO in various temperatures for a green pixel, in accordance with an embodiment;

FIG. 172C illustrates a graph of a relationship between an OLED current and VHILO in various temperatures for a blue pixel, in accordance with an embodiment;

FIG. 173A illustrates a block diagram view a graph showing a relationship between gray level and VHILO shift for a red pixel, in accordance with an embodiment;

FIG. 173B illustrates a block diagram view a graph showing a relationship between gray level and VHILO shift for a green pixel, in accordance with an embodiment;

FIG. 173C illustrates a block diagram view a graph showing a relationship between gray level and VHILO shift for a blue pixel, in accordance with an embodiment;

FIG. 174 illustrates a schematic diagram of pixel control circuitry for an OLED, in accordance with an embodiment;

FIG. 175 is timing diagram of ideal operation of the pixel control circuitry of FIG. 174, in accordance with an embodiment;

FIG. 176 is timing diagram of non-ideal operation of the pixel control circuitry of FIG. 174, in accordance with an embodiment;

FIG. 177 is a flow chart illustrating a process for compensating for VHILO fluctuations due to temperature, in accordance with an embodiment;

FIG. 178 is a block diagram of a system used to perform the process of FIG. 177, in accordance with an embodiment;

FIG. 179 is a schematic diagram of the pixel control circuitry of FIG. 174 in an emission phase, in accordance with an embodiment;

FIG. 180 is a schematic diagram of the pixel control circuitry of FIG. 174 in a data write phase, in accordance with an embodiment;

FIG. 181 is a schematic diagram of the pixel control circuitry of FIG. 174 in an sense injection voltage phase, in accordance with an embodiment; and

FIG. 182 is a schematic diagram of the pixel control circuitry of FIG. 174 in a sense phase, in accordance with an embodiment.

### DETAILED DESCRIPTION OF SPECIFIC EMBODIMENTS

One or more specific embodiments will be described below. In an effort to provide a concise description of these embodiments, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present disclosure, the articles “a,” “an,” and “the” are intended to mean that there are one or more of the elements. The terms “comprising,” “including,” and “having” are intended to be inclusive and mean that there may be additional elements other than the listed elements. Additionally, it should be understood that references to “one embodiment” or “an embodiment” of the present disclosure are not intended to be interpreted as excluding the existence of additional embodiments that also incorporate the recited features. Furthermore, the phrase A “based on” B is intended to mean that A is at least partially based on B. Moreover, the term “or” is intended to be inclusive (e.g., logical OR) and not exclusive (e.g., logical XOR). In other words, the phrase A “or” B is intended to mean A, B, or both A and B.

Electronic displays are ubiquitous in modern electronic devices. As electronic displays gain ever-higher resolutions and dynamic range capabilities, image quality has increasingly grown in value. In general, electronic displays contain numerous picture elements, or “pixels,” that are programmed with image data. Each pixel emits a particular amount of light based on the image data. By programming different pixels with different image data, graphical content including images, videos, and text can be displayed.

Display panel sensing allows for operational properties of pixels of an electronic display to be identified to improve the performance of the electronic display. For example, variations in temperature and pixel aging (among other things) across the electronic display cause pixels in different locations on the display to behave differently. Indeed, the same image data programmed on different pixels of the display could appear to be different due to the variations in temperature and pixel aging. Without appropriate compensation, these variations could produce undesirable visual artifacts. However, compensation of these variations may hinge on proper sensing of differences in the images displayed on the pixels of the display. Accordingly, the techniques and systems described below may be utilized to enhance the compensation of operational variations across the display through improvements to the generation of reference images to be sensed to determine the operational variations.

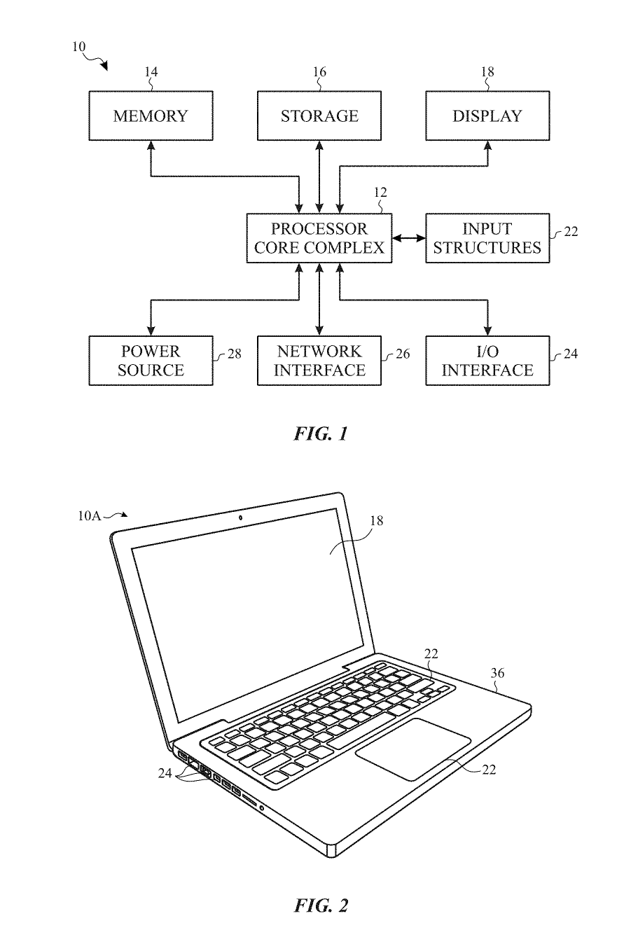

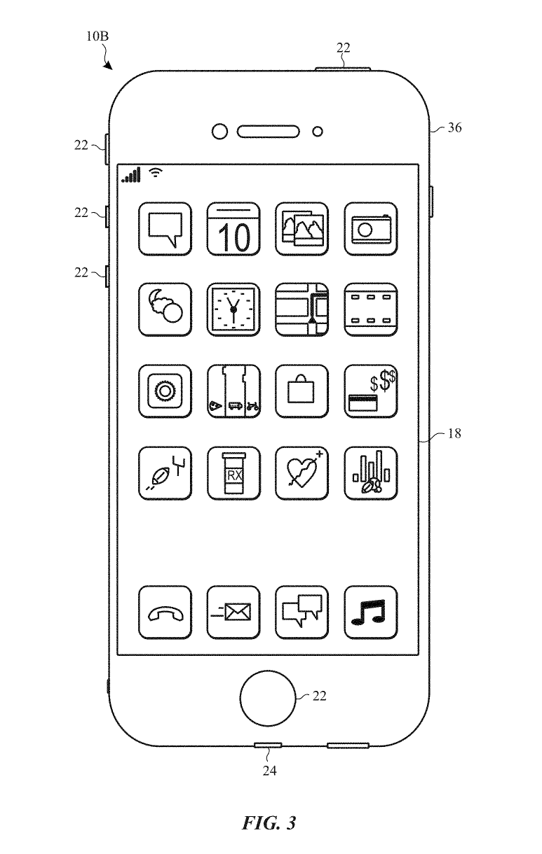

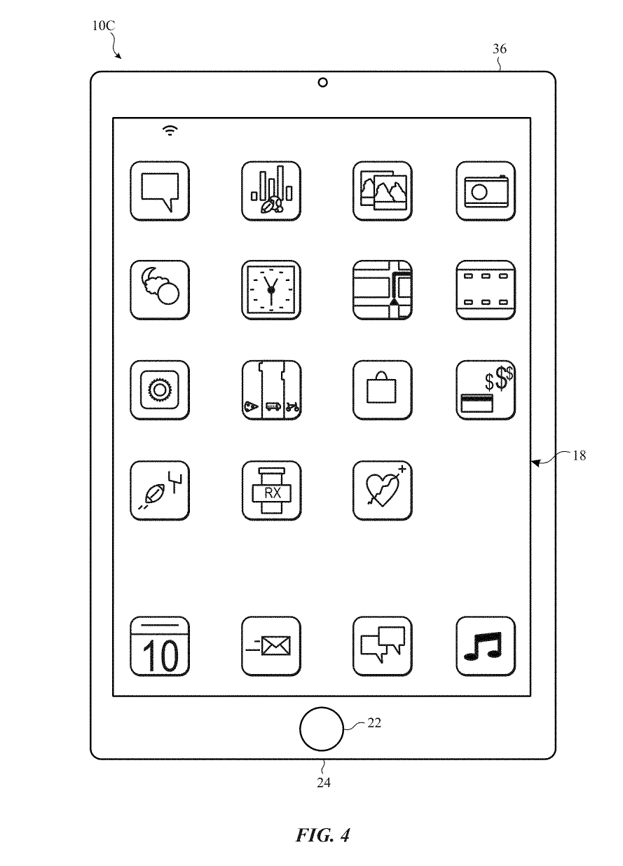

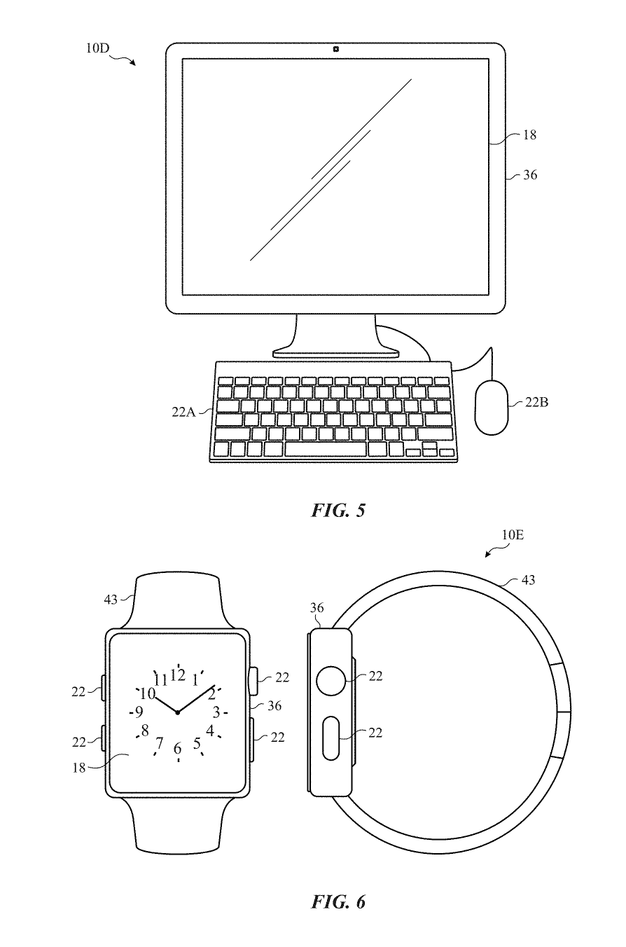

With this in mind, a block diagram of an electronic device 10 is shown in FIG. 1. As will be described in more detail below, the electronic device 10 may represent any suitable electronic device, such as a computer, a mobile phone, a portable media device, a tablet, a television, a virtual-reality headset, a vehicle dashboard, or the like. The electronic device 10 may represent, for example, a notebook computer 10A as depicted in FIG. 2, a handheld device 10B as depicted in FIG. 3, a handheld device 10C as depicted in FIG. 4, a desktop computer 10D as depicted in FIG. 5, a wearable electronic device 10E as depicted in FIG. 6, or a similar device.

The electronic device 10 shown in FIG. 1 may include, for example, a processor core complex 12, a local memory 14, a main memory storage device 16, an electronic display 18, input structures 22, an input/output (I/O) interface 24, network interfaces 26, and a power source 28. The various functional blocks shown in FIG. 1 may include hardware elements (including circuitry), software elements (including machine-executable instructions stored on a tangible, non-transitory medium, such as the local memory 14 or the main memory storage device 16) or a combination of both hardware and software elements. It should be noted that FIG. 1 is merely one example of a particular implementation and is intended to illustrate the types of components that may be present in electronic device 10. Indeed, the various depicted components may be combined into fewer components or separated into additional components. For example, the local memory 14 and the main memory storage device 16 may be included in a single component.

The processor core complex 12 may carry out a variety of operations of the electronic device 10, such as causing the electronic display 18 to perform display panel sensing and using the feedback to adjust image data for display on the electronic display 18. The processor core complex 12 may include any suitable data processing circuitry to perform these operations, such as one or more microprocessors, one or more application specific processors (ASICs), or one or more programmable logic devices (PLDs). In some cases, the processor core complex 12 may execute programs or instructions (e.g., an operating system or application program) stored on a suitable article of manufacture, such as the local memory 14 and/or the main memory storage device 16. In addition to instructions for the processor core complex 12, the local memory 14 and/or the main memory storage device 16 may also store data to be processed by the processor core complex 12. By way of example, the local memory 14 may include random access memory (RAM) and the main memory storage device 16 may include read only memory (ROM), rewritable non-volatile memory such as flash memory, hard drives, optical discs, or the like.

The electronic display 18 may display image frames, such as a graphical user interface (GUI) for an operating system or an application interface, still images, or video content. The processor core complex 12 may supply at least some of the image frames. The electronic display 18 may be a self-emissive display, such as an organic light emitting diodes (OLED) display, a micro-LED display, a micro-OLED type display, or a liquid crystal display (LCD) illuminated by a backlight. In some embodiments, the electronic display 18 may include a touch screen, which may allow users to interact with a user interface of the electronic device 10. The electronic display 18 may employ display panel sensing to identify operational variations of the electronic display 18. This may allow the processor core complex 12 to adjust image data that is sent to the electronic display 18 to compensate for these variations, thereby improving the quality of the image frames appearing on the electronic display 18.

The input structures 22 of the electronic device 10 may enable a user to interact with the electronic device 10 (e.g., pressing a button to increase or decrease a volume level). The I/O interface 24 may enable electronic device 10 to interface with various other electronic devices, as may the network interface 26. The network interface 26 may include, for example, interfaces for a personal area network (PAN), such as a Bluetooth network, for a local area network (LAN) or wireless local area network (WLAN), such as an 802.11x Wi-Fi network, and/or for a wide area network (WAN), such as a cellular network. The network interface 26 may also include interfaces for, for example, broadband fixed wireless access networks (WiMAX), mobile broadband Wireless networks (mobile WiMAX), asynchronous digital subscriber lines (e.g., ADSL, VDSL), digital video broadcasting-terrestrial (DVB-T) and its extension DVB Handheld (DVB-H), ultra wideband (UWB), alternating current (AC) power lines, and so forth. The power source 28 may include any suitable source of power, such as a rechargeable lithium polymer (Li-poly) battery and/or an alternating current (AC) power converter.

In certain embodiments, the electronic device 10 may take the form of a computer, a portable electronic device, a wearable electronic device, or other type of electronic device. Such computers may include computers that are generally portable (such as laptop, notebook, and tablet computers) as well as computers that are generally used in one place (such as conventional desktop computers, workstations and/or servers). In certain embodiments, the electronic device 10 in the form of a computer may be a model of a MacBook®, MacBook® Pro, MacBook Air®, iMac®, Mac® mini, or Mac Pro® available from Apple Inc. By way of example, the electronic device 10, taking the form of a notebook computer 10A, is illustrated in FIG. 2 in accordance with one embodiment of the present disclosure. The depicted computer 10A may include a housing or enclosure 36, an electronic display 18, input structures 22, and ports of an I/O interface 24. In one embodiment, the input structures 22 (such as a keyboard and/or touchpad) may be used to interact with the computer 10A, such as to start, control, or operate a GUI or applications running on computer 10A. For example, a keyboard and/or touchpad may allow a user to navigate a user interface or application interface displayed on the electronic display 18.

FIG. 3 depicts a front view of a handheld device 10B, which represents one embodiment of the electronic device 10. The handheld device 10B may represent, for example, a portable phone, a media player, a personal data organizer, a handheld game platform, or any combination of such devices. By way of example, the handheld device 10B may be a model of an iPod® or iPhone® available from Apple Inc. of Cupertino, Calif. The handheld device 10B may include an enclosure 36 to protect interior components from physical damage and to shield them from electromagnetic interference. The enclosure 36 may surround the electronic display 18. The I/O interfaces 24 may open through the enclosure 36 and may include, for example, an I/O port for a hard wired connection for charging and/or content manipulation using a standard connector and protocol, such as the Lightning connector provided by Apple Inc., a universal service bus (USB), or other similar connector and protocol.

User input structures 22, in combination with the electronic display 18, may allow a user to control the handheld device 10B. For example, the input structures 22 may activate or deactivate the handheld device 10B, navigate user interface to a home screen, a user-configurable application screen, and/or activate a voice-recognition feature of the handheld device 10B. Other input structures 22 may provide volume control, or may toggle between vibrate and ring modes. The input structures 22 may also include a microphone may obtain a user's voice for various voice-related features, and a speaker may enable audio playback and/or certain phone capabilities. The input structures 22 may also include a headphone input may provide a connection to external speakers and/or headphones.

FIG. 4 depicts a front view of another handheld device 10C, which represents another embodiment of the electronic device 10. The handheld device 10C may represent, for example, a tablet computer or portable computing device. By way of example, the handheld device 10C may be a tablet-sized embodiment of the electronic device 10, which may be, for example, a model of an iPad® available from Apple Inc. of Cupertino, Calif.

Turning to FIG. 5, a computer 10D may represent another embodiment of the electronic device 10 of FIG. 1. The computer 10D may be any computer, such as a desktop computer, a server, or a notebook computer, but may also be a standalone media player or video gaming machine. By way of example, the computer 10D may be an iMac®, a MacBook®, or other similar device by Apple Inc. It should be noted that the computer 10D may also represent a personal computer (PC) by another manufacturer. A similar enclosure 36 may be provided to protect and enclose internal components of the computer 10D such as the electronic display 18. In certain embodiments, a user of the computer 10D may interact with the computer 10D using various peripheral input devices, such as input structures 22A or 22B (e.g., keyboard and mouse), which may connect to the computer 10D.

Similarly, FIG. 6 depicts a wearable electronic device 10E representing another embodiment of the electronic device 10 of FIG. 1 that may be configured to operate using the techniques described herein. By way of example, the wearable electronic device 10E, which may include a wristband 43, may be an Apple Watch® by Apple, Inc. However, in other embodiments, the wearable electronic device 10E may include any wearable electronic device such as, for example, a wearable exercise monitoring device (e.g., pedometer, accelerometer, heart rate monitor), or other device by another manufacturer. The electronic display 18 of the wearable electronic device 10E may include a touch screen display 18 (e.g., LCD, OLED display, active-matrix organic light emitting diode (AMOLED) display, and so forth), as well as input structures 22, which may allow users to interact with a user interface of the wearable electronic device 10E.

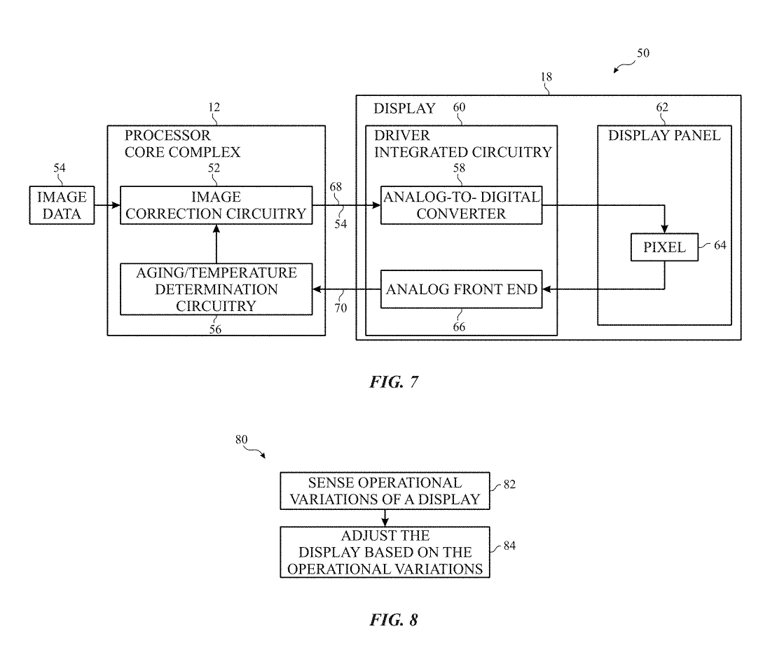

FIG. 7 is a block diagram of a system 50 for display sensing and compensation, according to an embodiment of the present disclosure. The system 50 includes the processor core complex 12, which includes image correction circuitry 52. The image correction circuitry 52 may receive image data 54, and compensate for non-uniformity of the display 18 based on and induced by process non-uniformity temperature gradients, aging of the display 18, and/or other factors across the display 18 to increase performance of the display 18 (e.g., by reducing visible anomalies). The non-uniformity of pixels in the display 18 may vary between devices of the same type (e.g., two similar phones, tablets, wearable devices, or the like), over time and usage (e.g., due to aging and/or degradation of the pixels or other components of the display 18), and/or with respect to temperatures, as well as in response to additional factors.

As illustrated, the system 50 includes aging/temperature determination circuitry 56 that may determine or facilitate determining the non-uniformity of the pixels in the display 18 due to, for example, aging and/or degradation of the pixels or other components of the display 18. The aging/temperature determination circuitry 56 that may also determine or facilitate determining the non-uniformity of the pixels in the display 18 due to, for example, temperature.

The image correction circuitry 52 may send the image data 54 (for which the non-uniformity of the pixels in the display 18 have or have not been compensated for by the image correction circuitry 52) to analog-to-digital converter 58 of a driver integrated circuit 60 of the display 18. The analog-to-digital conversion converter 58 may digitize then image data 54 when it is in an analog format. The driver integrated circuit 60 may send signals across gate lines to cause a row of pixels of a display panel 62, including pixel 64, to become activated and programmable, at which point the driver integrated circuit 68 may transmit the image data 54 across data lines to program the pixels, including the pixel 64, to display a particular gray level (e.g., individual pixel brightness). By supplying different pixels of different colors with the image data 54 to display different gray levels, full-color images may be programmed into the pixels. The driver integrated circuit 60 may also include a sensing analog front end (AFE) 66 to perform analog sensing of the response of the pixels to data input (e.g., the image data 54) to the pixels.

The processor core complex 12 may also send sense control signals 68 to cause the display 18 to perform display panel sensing. In response, the display 18 may send display sense feedback 70 that represents digital information relating to the operational variations of the display 18. The display sense feedback 70 may be input to the aging/temperature determination circuitry 56, and take any suitable form. Output of the aging/temperature determination circuitry 56 may take any suitable form and be converted by the image correction circuitry 52 into a compensation value that, when applied to the image data 54, appropriately compensates for non-uniformity of the display 18. This may result in greater fidelity of the image data 54, reducing or eliminating visual artifacts that would otherwise occur due to the operational variations of the display 18. In some embodiments, the processor core complex 12 may be part of the driver integrated circuit 60, and as such, be part of the display 18.

FIG. 8 is a flowchart illustrating a method 80 for display sensing and compensation using the system 50 of FIG. 7, according to an embodiment of the present disclosure. The method 80 may be performed by any suitable device that may sense operational variations of the display 18 and compensate for the operational variations, such as the display 18 and/or the processor core complex 12.

The display 18 senses (process block 82) operational variations of the display 18 itself. In particular, the processor core complex 12 may send one or more instructions (e.g., sense control signals 68) to the display 18. The instructions may cause the display 18 to perform display panel sensing. The operational variations may include any suitable variations that induce non-uniformity in the display 19, such as process non-uniformity temperature gradients, aging of the display 18, and the like.

The processor core complex 12 then adjusts (process block 84) the display 18 based on the operational variations. For example, the processor core complex 12 may receive display sense feedback 70 that represents digital information relating to the operational variations from the display 18 in response to receiving the sense control signals 68. The display sense feedback 70 may be input to the aging/temperature determination circuitry 56, and take any suitable form. Output of the aging/temperature determination circuitry 56 may take any suitable form and be converted by the image correction circuitry 52 into a compensation value. For example, processor core complex 12 may apply the compensation value to the image data 54, which may then be sent to the display 18. In this manner, the processor core complex 12 may perform the method 80 to increase performance of the display 18 (e.g., by reducing visible anomalies).

### Sensing Operational Variations of the Display

### A. When to Perform Sensing

### 1. In-Frame Sensing

To accurately display an image frame, an electronic display may control light emission (e.g., actual luminance) from its display pixels, based on for example, environmental operational parameters (e.g., ambient temperature, humidity, brightness, and the like) and/or display-related operational parameters (e.g., light emission, current signal magnitude which may affect light emission, and the like).

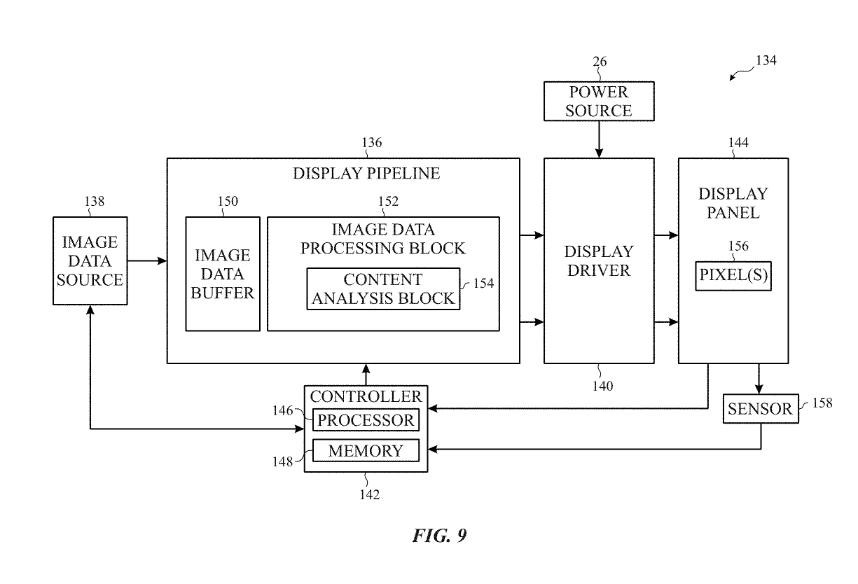

To help illustrate, a portion 134 of the electronic device 10 including a display pipeline 136 is shown in FIG. 9. In some embodiments, the display pipeline 136 may be implemented by circuitry in the electronic device 10, circuitry in the electronic display 18, or a combination thereof. For example, the display pipeline 136 may be included in the processor core complex 12, a timing controller (TCON) in the electronic display 18, or any combination thereof.

As depicted, the portion 134 of the electronic device 10 also includes the power source 28, an image data source 138, a display driver 140, a controller 142, and a display panel 144. In some embodiments, the controller 142 may control operation of the display pipeline 136, the image data source 138, and/or the display driver 140. To control operation, the controller 142 may include a controller processor 146 and controller memory 148. In some embodiments, the controller processor 146 may execute instructions stored in the controller memory 148. Thus, in some embodiments, the controller processor 146 may be included in the processor core complex 12, a timing controller in the electronic display 18, a separate processing module, or any combination thereof. Additionally, in some embodiments, the controller memory 148 may be included in the local memory 14, the main memory storage device 16, a separate tangible, non-transitory, computer readable medium, or any combination thereof.

In the depicted embodiment, the display pipeline 136 is communicatively coupled to the image data source 138. In this manner, the display pipeline 136 may receive image data from the image data source 138. As described above, in some embodiments, the image data source 138 may be included in the processor core complex 12, or a combination thereof. In other words, the image data source 138 may provide image data to be displayed by the display panel 144.

Additionally, in the depicted embodiment, the display pipeline 136 includes an image data buffer 150 to store image data, for example, received from the image data source 138. In some embodiments, the image data buffer 150 may store image data to be processed by and/or already processed by the display pipeline 136. For example, the image data buffer 150 may store image data corresponding with multiple image frames (e.g., a previous image frame, a current image frame, and/or a subsequent image frame). Additionally, the image data buffer may store image data corresponding with multiple portions (e.g., a previous row, a current row, and/or a subsequent row) of an image frame.

To process the image data, the display pipeline 136 may include one or more image data processing blocks 152. For example, in the depicted embodiment, the image data processing blocks 152 include a content analysis block 154. Additionally, in some embodiments, the image data processing block 152 may include an ambient adaptive pixel (AAP) block, a dynamic pixel backlight (DPB) block, a white point correction (WPC) block, a sub-pixel layout compensation (SPLC) block, a burn-in compensation (BIC) block, a panel response correction (PRC) block, a dithering block, a sub-pixel uniformity compensation (SPUC) block, a content frame dependent duration (CDFD) block, an ambient light sensing (ALS) block, or any combination thereof.

To display an image frame, the content analysis block 154 may process the corresponding image data to determine content of the image frame. For example, the content analysis block 154 may process the image data to determine target luminance (e.g., greyscale level) of display pixels 156 for displaying the image frame. Additionally, the content analysis block 154 may determine control signals, which instruct the display driver 140 to generate and supply analog electrical signals to the display panel 144. To generate the analog electrical signals, the display driver 140 may receive electrical power from the power source 28, for example, via one or more power supply rails. In particular, the display driver 140 may control supply of electrical power from the one or more power supply rails to display pixels 156 in the display panel 144.

In some embodiments, the content analysis block 154 may determine pixel control signals that each indicates a target pixel current to be supplied to a display pixel 156 in the display panel 144 of the electronic display 18. Based at least in part on the pixel control signals, the display driver 140 may illuminate display pixels 156 by generating and supplying analog electrical signals (e.g., voltage or current) to control light emission from the display pixels 156. In some embodiments, the content analysis block 154 may determine the pixel control signals based at least in part on target luminance of corresponding display pixels 156.

Additionally, in some embodiments, one or more sensors 158 may be used to sense (e.g., determine) information related to display performance of the electronic device 10 and/or the electronic display 18, such as display-related operational parameters and/or environmental operational parameters. For example, the display-related operational parameters may include actual light emission from a display pixel 156 and/or current flowing through the display pixel 156. Additionally, the environmental operational parameters may include ambient temperature, humidity, and/or ambient light.

In some embodiments, the controller 142 may determine the operational parameters based at least in part on sensor data received from the sensors 158. Thus, as depicted, the sensors 158 are communicatively coupled to the controller 142. In some embodiments, the controller 142 may include a sensing controller that controls performance of sensing operations and/or determines results (e.g., operational parameters and/or environmental parameters) of the sensing operations.

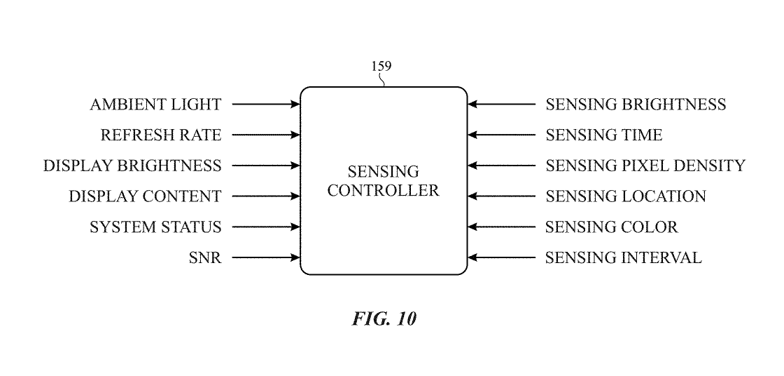

To help illustrate, one embodiment of a sensing controller 159 that may be included in the controller 142 is shown in FIG. 10. In some embodiments, the sensing controller 159 may receive sensor data from the one or more sensors 158 and/or operational parameter data of the electronic display 18, for example, from the controller 142. In the depicted embodiment, the sensing controller 159 receives data indicating ambient light, refresh rate, display brightness, display content, system status, and/or signal to noise ratio (SNR).

Additionally, in some embodiments, the sensing controller 159 may process the received data to determine control commands instructing the display pipeline 136 to perform control actions and/or determine control commands instructing the electronic display to perform control actions. In the depicted embodiment, the sensing controller 159 outputs control commands indicating sensing brightness, sensing time (e.g., duration), sense pixel density, sensing location, sensing color, and sensing interval. It should be understood that the described input data and output control commands are merely intended to be illustrative and not limiting.

As described above, the electronic device 12 may refresh an image or an image frame at a refresh rate, such as 60 Hz, 120 Hz, and/or 240 Hz. To refresh an image frame, the display driver 140 may refresh (e.g., update) image data written to the display pixels 156 on the display panel 144. For example, to refresh a display pixel 156, the electronic display 18 may toggle the display pixel 156 from a light emitting mode to a non-light emitting mode and write image data to the display pixel 156 such that display pixel 156 emits light based on the image data when toggled back to the light emitting mode. Additionally, in some embodiments, display pixels 156 may be refreshed with image data corresponding to an image frame in one or more contiguous refresh pixel groups.

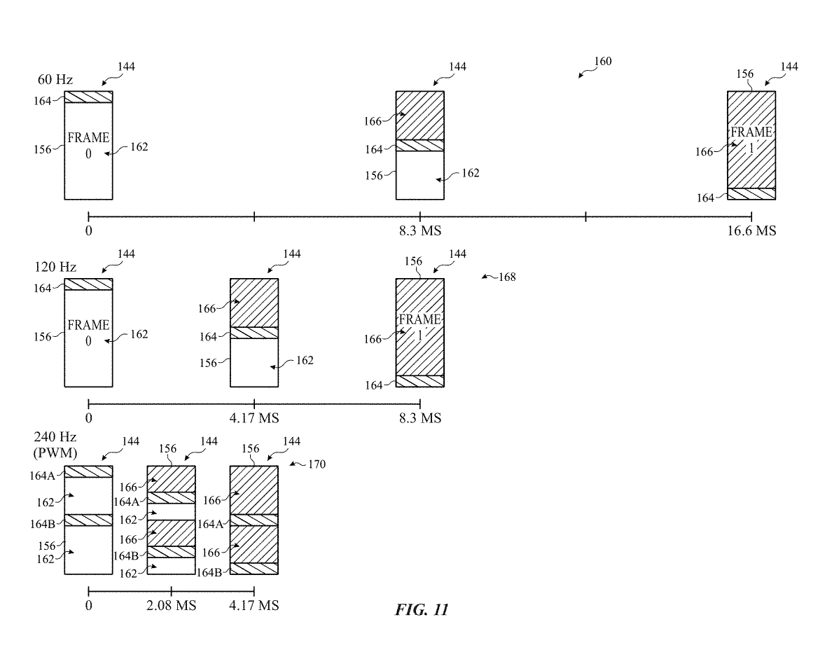

To help illustrate, timing diagrams of a display panel 144 using different refresh rates to display an image frame are shown in FIG. 11. In particular, a first timing diagram 160 describes the display panel 144 operating using a 60 Hz refresh rate, a second timing diagram 168 describes the display panel 144 operating using a 120 Hz refresh rate, and a third timing diagram 170 describes the display panel 144 operating using a 240 Hz pulse-width modulated (PWM) refresh rate. Generally, the display panel 144 includes multiple display pixel rows. To refresh the display pixels 156, the one or more refresh pixel groups 164 may be propagated down the display panel 144. In some embodiments, display pixels 156 in a refresh pixel group 164 may be toggled to a non-light emitting mode. Thus, with regard to the depicted embodiment, a refresh pixel groups 164 is depicted as a solid black stripe.

With regard to the first timing diagram 160, a new image frame is displayed by the display panel 144 approximately once every 16.6 milliseconds when using the 60 Hz refresh rate. In particular, at 0 ms, the refresh pixel group 164 is positioned at the top of the display panel 144 and the display pixels 156 below the refresh pixel group 164 illuminate based on image data corresponding with a previous image frame 162. At approximately 8.3 ms, the refresh pixel group 164 has rolled down to approximately halfway between the top and the bottom of the display panel 144. Thus, the display pixels 156 above the refresh pixel group 164 may illuminate based on image data corresponding to a next image frame 166 while the display pixels 156 below the refresh pixel group 164 illuminate based on image data corresponding with the previous image frame 162. At approximately 16.6 ms, the refresh pixel group 164 has rolled down to the bottom of the display panel 144 and, thus, each of the display pixels 156 above the refresh pixel group 164 may illuminate based on image data corresponding to the next image frame 166.

With regard to the second timing diagram 168, a new frame is displayed by the display panel 144 approximately once every 8.3 milliseconds when using the 120 Hz refresh rate. In particular, at 0 ms, the refresh pixel group 164 is positioned at the top of the display panel 144 and the display pixels 156 below the refresh pixel group 164 illuminate based on image data corresponding with a previous image frame 162. At approximately 4.17 ms, the refresh pixel group 164 has rolled down to approximately halfway between the top and the bottom of the display panel 144. Thus, the display pixels 156 above the refresh pixel group 164 may illuminate based on image data corresponding to a next image frame 166 while the display pixels 156 below the refresh pixel group 164 illuminate based on image data corresponding with the previous image frame 162. At approximately 8.3 ms, the refresh pixel group 164 has rolled down to the bottom of the display panel 144 and, thus, each of the display pixels 156 above the refresh pixel group 164 may illuminate based on image data corresponding to the next image frame 166.

With regard to the third timing diagram 170, a new frame is displayed by the display panel 144 approximately once every 4.17 milliseconds when using the 240 Hz PWM refresh rate by using multiple noncontiguous refresh pixel groups—namely a first refresh pixel group 164A and a second refresh pixel group 164B. In particular, at 0 ms, the first refresh pixel group 164A is positioned at the top of the display panel 144 and a second refresh pixel group 164B is positioned approximately halfway between the top and the bottom of the display panel 144. Thus, the display pixels 156 between the first refresh pixel group 164A and the second refresh pixel group 164B may illuminate based on image data corresponding to a previous image frame 162, and the display pixels 156 between the first refresh pixel group 164A and the second refresh pixel group 164B may illuminate based on image data corresponding to the previous image frame 162.

At approximately 2.08 ms, the first refresh pixel group 164A has rolled down to approximately one quarter of the way between the top and the bottom of the display panel 144 and the second refresh pixel group 164B has rolled down to approximately three quarters of the way between the top and the bottom of the display panel 144. Thus, the display pixels 156 above the first pixel refresh group 164 illuminate based on image data corresponding to a next image frame 166 and the display pixels 156 between the position of the second refresh pixel group 164B at 0 ms and the second refresh pixel group 164B illuminate based on image data corresponding to the next image frame 166. At approximately 4.17 ms, the first refresh pixel group 164A has rolled approximately halfway down between the top and the bottom of the display panel 144 and the second refresh pixel group 164B has rolled to the bottom of the display panel 144. Thus, the display pixel 156 above the first refresh pixel group 164A and the display pixels between the first refresh pixel group 164A and the second refresh pixel group 164B may illuminate based on image data corresponding to the next image frame 166.

As described above, refresh pixel groups 164 (including 164A and 164B) may be used to sense information related to display performance of the display panel 144, such as environmental operational parameters and/or display-related operational parameters. That is, the sensing controller 159 may instruct the display panel 144 to illuminate one or more display pixels 156 (e.g., sense pixels) in a refresh pixel group 164 to facilitate sensing the relevant information. In some embodiments, a sensing operation may be performed at any suitable frequency, such as once per image frame, once every 2 image frames, once every 5 image frames, once every 10 image frames, between image frames, and the like. Additionally, in some embodiments, a sensing operation may be performed for any suitable duration of time, such as between 20 μs and 500 μs (e.g., 50 μs, 75 μs, 100 μs, 125 μs, 150 μs, and the like).

As discussed above, a sensing operation may be performed by using one or more sensors 158 to determine sensor data indicative of operational parameters. Additionally, the controller 142 may process the sensor data to determine the operational parameters. Based at least in part on the operational parameters, the controller 142 may instruct the display pipeline 136 and/or the display driver 140 to adjust image data written to the display pixels 156, for example, to compensate for expected affects the operational parameters may have on perceived luminance.

Additionally, as described above, sense pixels may be illuminated during a sensing operation. Thus, when perceivable, illuminated sense pixels may result in undesired front of screen (FOS) artifacts. To reduce the likelihood of producing front of screen artifacts, characteristics of the sense pixels may be adjusted based on various factors expected to affect perceivability, such as content of an image frame and/or ambient light conditions.

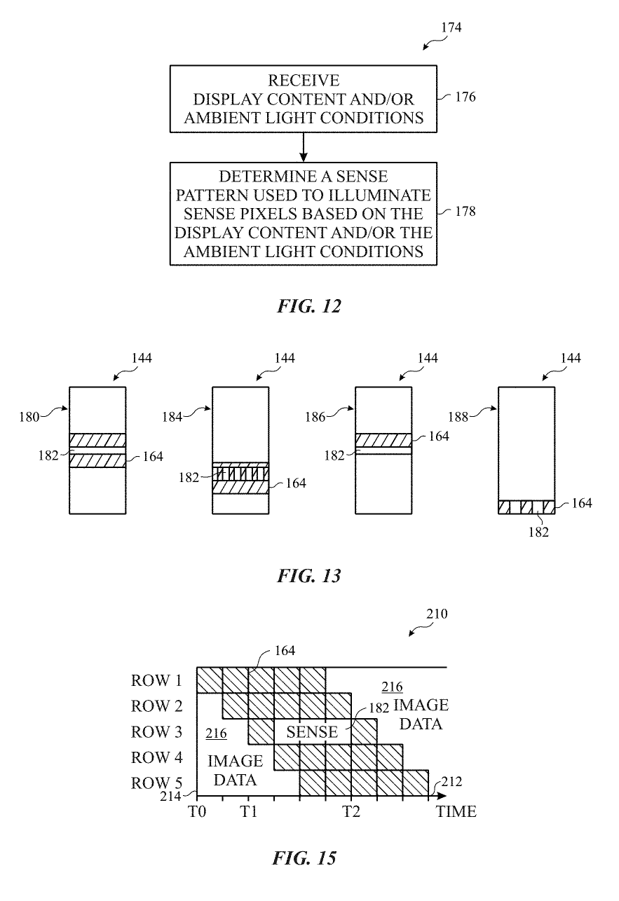

To help illustrate, one embodiment of a process 174 for adjusting a characteristics—namely a pattern—of the sense pixels is described in FIG. 12. Generally, the process 174 includes receiving display content and/or ambient light conditions (process block 276) and determining a sense pattern used to illuminate the sense pixels based on the display content and/or the ambient light conditions (process block 278). In some embodiments, the process 174 may be implemented by executing instructions stored in a tangible, non-transitory, computer-readable medium, such as the controller memory 148, using a processor, such as the controller processor 146.

Accordingly, in some embodiments, the controller 142 may receive display content and/or ambient light conditions (process block 276). For example, the controller 142 may receive content of an image frame from the content analysis block 154. In some embodiments, the display content may include information related to color, variety of patterns, amount of contrast, change of image data corresponding to an image frame compared to image data corresponding to a previous frame, and/or the like. Additionally, the controller 142 may receive ambient light conditions from one or more sensors 158 (e.g., an ambient light sensor). In some embodiments, the ambient light conditions may include information related to the brightness/darkness of the ambient light.

Based at least in part on the display content and/or ambient light conditions, the controller 142 may determine a sense pattern used to illuminate the sense pixels (process block 278). In this manner, the controller 142 may determine the sense pattern to reduce likelihood of illuminating the sense pixels cause a perceivable visual artifact. For example, when the content to be displayed includes solid, darker blocks, less variety of colors or patterns, and the like, the controller 142 may determine that a brighter, more solid pattern of sense pixels should not be used. On the other hand, when the content being displayed includes a large variety of different patterns and colors that change frequently from frame to frame, the controller 142 may determine that a brighter, more solid pattern of sense pixels may be used. Similarly, when there is little ambient light, the controller 142 may determine that a brighter, more solid pattern of sense pixels should not be used. On the other hand, when there is greater ambient light, the controller 142 may determine that a brighter, more solid pattern of sense pixels may be used.

To help illustrate, examples of sense patterns that may be used to sense information related to display performance of the display panel 144 are depicted in FIG. 13. In particular, FIG. 13 describes a first sense pattern 180, a second sense pattern 184, a third sense pattern 186, and a fourth sense pattern 188 displayed using sense pixels 182 in a refresh pixel group 164. As depicted, the sense patterns have varying characteristics, such as density, color, location, configuration, and/or dimension.

For example, with regard to the first sense pattern 180, one or more contiguous sense pixel rows in the refresh pixel group 164 are illuminated. Similarly, one or more contiguous sense pixel rows in the refresh pixel group 164 are illuminated in the third sense pattern 186. However, compared to the first sense pattern 180, the sense pixels 182 in the third sense pattern 186 may be a different color, a location on the display panel 144, and/or include fewer rows.

To reduce perceivability, noncontiguous sense pixels 182 may be illuminated, as shown in the second sense pattern 184. Similarly, noncontiguous sense pixels 182 are illuminated in the fourth sense pattern 188. However, compared to the second sense pattern 184, the sense pixels 182 in the fourth sense pattern 188 may be a different color, a location on the display panel 144, and/or include fewer rows. In this manner, the characteristics (e.g., density, color, location, configuration, and/or dimension) of sense patterns may be dynamically adjusted based at least in part on content of an image frame and/or ambient light to reduce perceivability of illuminated sense pixels 182. It should be understood that the sensing patterns described are merely intended to be illustrative and not limiting. In other words, in other embodiments, other sense pattern with varying characteristics may be implements, for example, based on operational parameter to be sensed.

One embodiment of a process 190 for sensing operational parameters using sense pixels 182 in a refresh pixel group 164 is described in FIG. 14. Generally, the process 190 includes determining a sense pattern used to illuminate sense pixels 182 during a sensing operation (process block 192), instructing the display driver 140 to determine sense pixels 182 to be illuminated and/or sense data to be written to the sense pixels 182 to perform the sensing operation (process block 194), determining when each display pixel row of the display panel 144 is to be refreshed (process block 196), determining whether a row includes sense pixels 182 (decision block 198), instructing the display driver 140 to write sense data to the sense pixels 182 based at least in part on the sense pattern when the row includes sense pixels 182 (process block 200), performing a sensing operation (process block 202), instructing the display driver 140 to write image data corresponding to an image frame to be displayed to each of the display pixels 156 in the row when the row does not include sense pixels 182 and/or after the sensing operation is performed (process block 204), determining whether the row is the last pixel row on the display panel 144 (decision block 206), and instructing the display pipeline 136 and/or the display driver 140 to adjust image data corresponding to subsequent image frames written to the display pixels 156 based at least in part on the sensing operation (e.g., determined operational parameters) (process block 208). While the process 190 is described using steps in a specific sequence, it should be understood that the present disclosure contemplates that the describe steps may be performed in different sequences than the sequence illustrated, and certain described steps may be skipped or not performed altogether. In some embodiments, the process 190 may be implemented by executing instructions stored in a tangible, non-transitory, computer-readable medium, such as the controller memory 148, using a processor, such as the controller processor 146.

Accordingly, in some embodiments, the controller 142 may determine a sense pattern used to illuminate sense pixels 182 during a sensing operation (process block 192). As described above, the controller 142 may determine a sense pattern based at least in part on content of an image frame to be displayed and/or ambient light conditions to facilitate reducing likelihood of the sensing operation causing perceivable visual artifacts. Additionally, in some embodiments, the sense patterns with varying characteristics may be predetermined and stored, for example, in the controller memory 148. Thus, in such embodiments, controller 142 may determine the sense pattern by selecting and retrieving a sense pattern. In other embodiments, the controller 142 may determine the sense pattern by dynamically adjusting a default sensing pattern.

Based at least in part on the sense pattern, the controller 142 may instruct the display driver 140 to determine sense pixels 182 to be illuminated and/or sense data to be written to the sense pixels 182 to perform the sensing operation (process block 194). In some embodiments, the sensing pattern may indicate characteristics of sense pixels 182 to be illuminated during the sensing operation. As such, the controller 142 may analyze the sensing pattern to determine characteristics such as, density, color, location, configuration, and/or dimension of the sense pixels 182 to be illuminated.

Additionally, the controller 142 may determine when each display pixel row of the display panel 144 is to be refreshed (process block 196). As described above, display pixels 156 may be refreshed (e.g., updated) with image data corresponding with an image frame by propagating a refresh pixel group 164. Thus, when a row is to be refreshed, the controller 142 may determine whether the row includes sense pixels 182 (decision block 198).

When the row includes sense pixels 182, the controller 142 may instruct the display driver 140 to write sense data to the sense pixels 182 based at least in part on the sense pattern. (process block 200). The controller 142 may then perform a sensing operation (process block 202). In some embodiments, to perform the sensing operation, the controller 142 may instruct the display driver 140 to write sensing image data to the sense pixels 182. Additionally, the controller 142 may instruct the display panel 144 to illuminate the sense pixels 182 based on the sensing image data, thereby enabling one or more sensors 158 to determine (e.g., measure) sensor data resulting from illumination of the sense pixels 182.

In this manner, the controller 142 may receive and analyze sensor data received from one or more sensors 158 indicative of environmental operational parameters and/or display-related operational parameters. As described above, in some embodiments, the environmental operational parameters may include ambient temperature, humidity, brightness, and the like. Additionally, in some embodiments, the display-related operational parameters may include an amount of light emission from at least one display pixel 156 of the display panel 144, an amount of current at the at least one display pixel 156, and the like.

When the row does not include sense pixels 182 and/or after the sensing operation is performed, the controller 142 may instruct the display driver 140 to write image data corresponding to an image frame to be displayed to each of the display pixels 156 in the row (process block 204). In this manner, the display pixels 156 may display the image frame when toggled back into the light emitting mode.

Additionally, the controller 142 may determine whether the row is the last display pixel row on the display panel 144 (decision block 206). When not the last row, the controller 142 may continue propagating the refresh pixel group 164 successively through rows of the display panel 144 (process block 196). In this manner, the display pixels 156 may be refreshed (e.g., update) to display the image frame.

On the other hand, when the last row is reached, the controller 142 may instruct the display pipeline 136 and/or the display driver 140 to adjust image data corresponding to subsequent image frames written to the display pixels 156 based at least in part on the sensing operation (e.g., determined operational parameters) (process block 208). In some embodiments, the controller 142 may instruct the display pipeline 136 and/or the display driver 140 to adjust image data to compensate for determined changes in the operational parameters. For example, the display pipeline 136 may adjust image data written to a display pixel 156 based on determined temperature, which may affect perceived luminance of the display pixel. In this manner, the sensing operation may be performed to facilitate improving perceived image quality of displayed image frames.

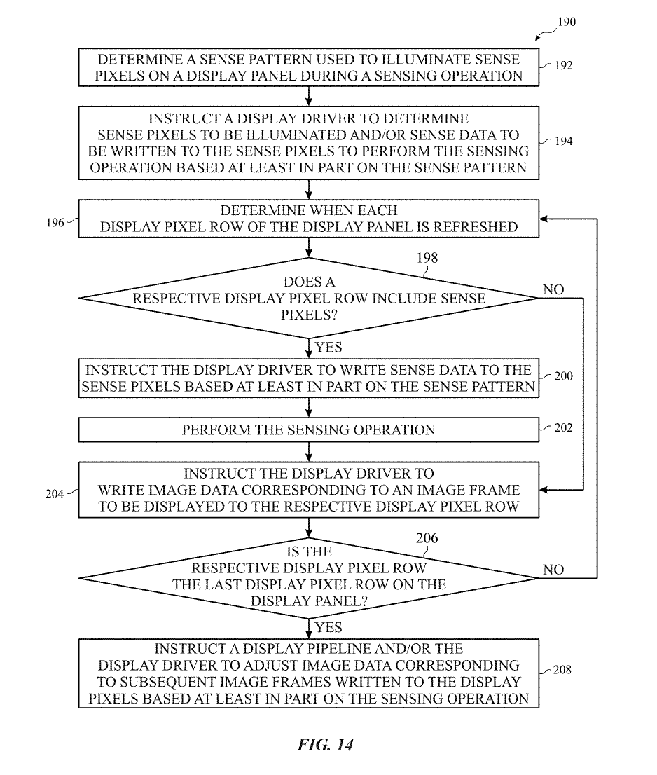

To help illustrate, timing diagram 210, shown in FIG. 15, describes operation of display pixel rows on a display panel 144 when performing the process 190. In particular, the timing diagram 210 represents time on the x-axis 212 and the display pixel rows on the y-axis 214. To simplify explanation, the timing diagram 210 is described with regard to five display pixel rows—namely pixel row 1, pixel row 2, pixel row 3, pixel row 4, and pixel row 5. However, it should be understood that the display panel 144 may include any number of display pixel rows. For example, in some embodiments, the display panel 144 may include 148 display pixel rows.

With regard to the depicted embodiment, at time to, pixel row 1 is included in the refresh pixel group 164 and, thus, in a non-light emitting mode. On the other hand, pixel rows 2-5 are illuminated based on image data 216 corresponding to a previous image frame. For the purpose of illustration, the controller 142 may determine a sense pattern that includes sense pixels 182 in pixel row 3. Additionally, the controller 142 may determine that pixel row 3 is to be refreshed at t₁.

Thus, when pixel row 3 is to be refreshed at t₁, the controller 142 may determine that pixel row 3 includes sense pixels 182. As such, the controller 142 may instruct the display driver 140 to write sensing image data to the sense pixels 182 in pixel row 3 and perform a sensing operation based at least in part on illumination of the sense pixels 182 to facilitate determining operational parameters. After the sensing operation is completed (e.g., at time t₂), the controller 142 may instruct the display driver 140 to write image data 216 corresponding with a next image frame to the display pixels 156 in pixel row 3.

Additionally, the controller 142 may determine whether pixel row 3 is the last row in the display panel 144. Since additional pixel rows remain, the controller 142 may instruct the display driver 140 to successively write image data corresponding to the next image frame to the remaining pixel rows. Upon reaching the last pixel row (e.g., pixel row 5), the controller 142 may instruct the display pipeline 136 and/or the display driver 140 to adjust image data written to the display pixels 156 for displaying subsequent image frames based at least in part on the determined operational parameters. For example, when the determined operational parameters indicate that current output from a sense pixel 182 is less than expected, the controller 142 may instruct the display pipeline 136 and/or the display driver 140 to increase current supplied to the display pixels 156 for displaying subsequent image frames. On the other hand, when the determined operational parameters indicate that the current output from the sense pixel is greater than expected, the controller 142 may instruct the display pipeline 136 and/or the display driver 140 to decrease current supplied to the display pixels 156 for displaying subsequent image frames.

It should be noted that the process 190 of FIG. 14 may be used with electronic displays 12 implementing any suitable refresh rate, such as a 60 Hz refresh rate, a 120 Hz refresh rate, and/or a 240 Hz PWM refresh rate. As described above, to increase refresh rate, an electronic display 18 may utilize multiple refresh pixel groups. However, multiple refresh pixel groups may increase timing complexity of the sensing operations, thereby affecting size, power consumption, component count, and/or other implementation associated costs. Thus, to reduce implementation-associated cost, sensing techniques may be adapted when used with multiple noncontiguous refresh pixel groups 164.

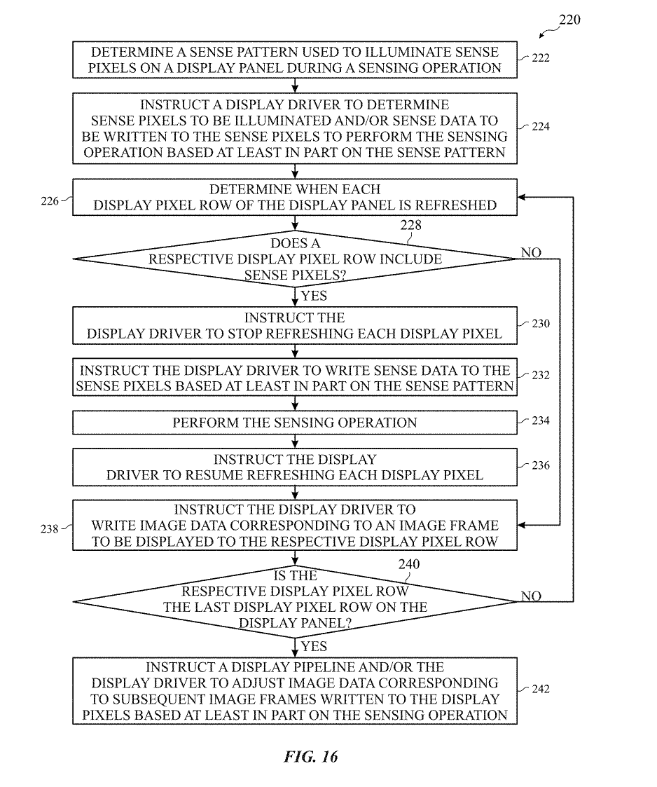

To help illustrate, a process 220 for sensing (e.g., determining) operational parameters when using multiple noncontiguous refresh pixel groups 164 is described in FIG. 16. Generally, the process 220 includes determining a sense pattern used to illuminate sense pixels 182 during a sensing operation (process block 222), instructing the display driver 140 to determine sense pixels 182 to be illuminated and/or sense data to be written to the sense pixels 182 to perform the sensing operation (process block 224), determining when each display pixel row of the display panel 144 is to be refreshed (process block 226), determining whether a row includes sense pixels 182 (decision block 228), instructing the display driver 140 to stop refreshing each display pixel 156 when the row includes sense pixels 182 (process block 230), instructing the display driver 140 to write sense data to the sense pixels 182 based at least in part on the sense pattern when the row includes sense pixels 182 (process block 232), performing a sensing operation (process block 234), instructing the display driver 140 to resume refreshing each display pixel 156 (process block 236), instructing the display driver 140 to write image data corresponding to an image frame to be displayed to each of the display pixels 156 in the row when the row does not include sense pixels 182 and/or after the sensing operation is performed (process block 238), determining whether the row is the last display pixel row on the display panel 144 (decision block 240), and instructing the display pipeline 136 and/or the display driver 140 to adjust image data corresponding to subsequent image frames written to the display pixels 156 based at least in part on the sensing operation (e.g., determined operational parameters) (process block 208). While the process 220 is described using steps in a specific sequence, it should be understood that the present disclosure contemplates that the describe steps may be performed in different sequences than the sequence illustrated, and certain described steps may be skipped or not performed altogether. In some embodiments, the process 220 may be implemented by executing instructions stored in a tangible, non-transitory, computer-readable medium, such as the controller memory 148, using a processor, such as the controller processor 146.

Accordingly, in some embodiments, the controller 142 may determine a sense pattern used to illuminate sense pixels 182 during a sensing operation (process block 222), as described in process block 192 of the process 190. Based at least in part on the sense pattern, the controller 142 may instruct the display driver 140 to determine sense pixels 182 to be illuminated and/or sense data to be written to the sense pixels 182 to perform a sensing operation (process block 224), as described in process block 194 of the process 190. Additionally, the controller 142 may determine when each display pixel row of the display panel 144 is to be refreshed (process block 226), as described in process block 196 of the process 190. When a row is to be refreshed, the controller 142 may determine whether the row includes sense pixels 182 (decision block 228), as described in decision block 198 of the process 190.

When the row includes sense pixels 182, the controller 142 may instruct the display driver 140 to stop refreshing each display pixel 156, such that the display pixel 156 is not refreshed until the display pixel 156 is instructed to resume refreshing (process block 230). That is, if a display pixel 156 of the display panel 144 is emitting light, or more specifically displaying image data 216, the controller 142 instructs the display pixel 156 to continue emitting light, and continue displaying the image data 216. If the display pixel 156 is not emitting light (e.g., is a refresh pixel 64), the controller 142 instructs the display pixel 156 to continue not emitting light. In some embodiments, the controller 142 may instruct the display pipeline 136 and/or the display driver 140 to instruct the display pixels 156 to stop refreshing until instructed to.

The controller 142 may then instruct the display driver 140 to write sense data to the sense pixels 182 based at least in part on the sense pattern (process block 232), as described in process block 200 of the process 190. The controller 142 may perform the sensing operation (process block 234), as described in process block 202 of the process 190.

The controller 142 may then instruct the display driver 140 to resume refreshing each display pixel 156 (process block 236). The display pixels 156 may then follow the next instruction from the display pipeline 136 and/or the display driver 140.

When the row does not include sense pixels 182 and/or after the sensing operation is performed, the controller 142 may instruct the display driver 140 to write image data corresponding to an image frame to be displayed to each of the display pixels 156 in the row (process block 238), as described in process block 204 of the process 190. Additionally, the controller 142 may determine whether the row is the last display pixel row on the display panel 144 (decision block 240), as described in decision block 206 of the process 190. When not the last row, the controller 142 may continue propagating the refresh pixel group 164 successively through rows of the display panel 144 (process block 226). In this manner, the display pixels 156 may be refreshed (e.g., update) to display the image frame.

On the other hand, when the last row is reached, the controller 142 may instruct the display pipeline 136 and/or the display driver 140 to adjust image data corresponding to subsequent image frames written to the display pixels 156 based at least in part on the sensing operation (e.g., determined operational parameters) (process block 242), as described in process block 208 of the process 190.

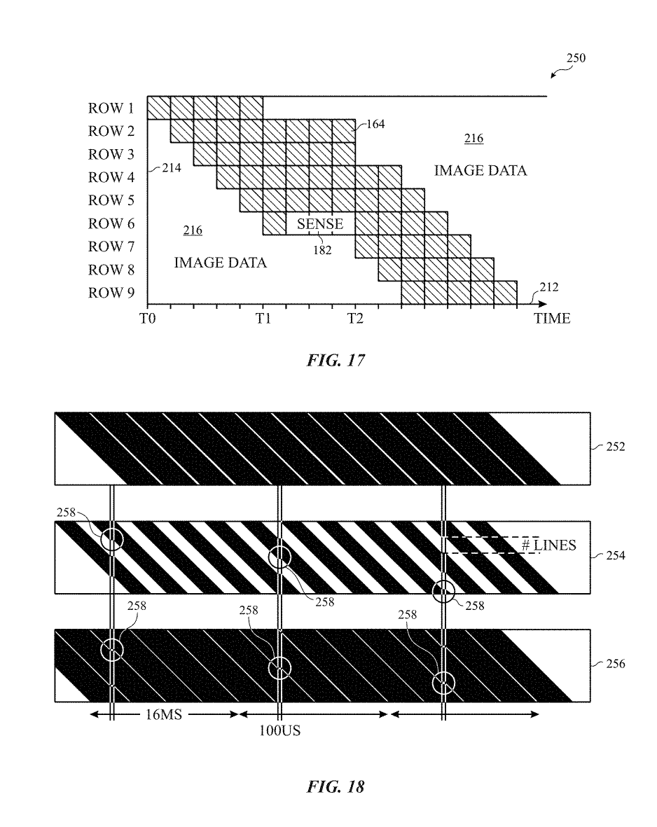

To help illustrate, timing diagram 250, shown in FIG. 17, describes operation of display pixel rows on a display panel 144 when performing the process 220. In particular, the timing diagram 250 represents time on the x-axis 212 and the display pixel rows on the y-axis 214. To simplify explanation, the timing diagram 210 is described with regard to nine display pixel rows—namely pixel row 1, pixel row 2, pixel row 3, pixel row 4, pixel row 5, pixel row 6, pixel row 7, pixel row 8, and pixel row 9. However, it should be understood that the display panel 144 may include any number of display pixel rows. For example, in some embodiments, the display panel 144 may include 148 display pixel rows.

With regard to the depicted embodiment, at time to, pixel row 1 is included in the refresh pixel group 164 and, thus, in a non-light emitting mode. On the other hand, pixel rows 2-9 are illuminated based on image data 216 corresponding to a previous image frame. For the purpose of illustration, the controller 142 may determine a sense pattern that includes sense pixels 182 in pixel row 6. Additionally, the controller 142 may determine that pixel row 6 is to be refreshed at t₁.

Thus, when pixel row 6 is to be refreshed at t₁, the controller 142 may determine that pixel row 6 includes sense pixels 182. As such, the controller 142 may instruct the display driver 140 to stop refreshing each display pixel 156 of the display panel 144, such that the display pixel 156 is not refreshed until the display pixel 156 is instructed to resume refreshing. That is, if a display pixel 156 of the display panel 144 is emitting light, or more specifically displaying image data 216, the controller 142 instructs the display pixel 156 to continue emitting light, and continue displaying the image data 216. If the display pixel 156 is not emitting light (e.g., is a refresh pixel 64), the controller 142 instructs the display pixel 156 to continue not emitting light.

Additionally, the controller 142 may instruct the display driver 140 to write sensing image data to the sense pixels 182 in pixel row 6 and perform a sensing operation based at least in part on illumination of the sense pixels 182 to facilitate determining operational parameters. After the sensing operation is completed (e.g., at time t₂), the controller 142 may instruct the display driver 140 to resume refreshing each display pixel 156. The display pixels 156 may then follow the next instruction from the display pipeline 136 and/or the display driver 140. The controller 142 may then instruct the display driver 140 to write image data 216 corresponding with a next image frame to the display pixels 156 in pixel row 6.

The controller 142 may then determine whether pixel row 6 is the last row in the display panel 144. Since additional pixel rows remain, the controller 142 may instruct the display driver 140 to successively write image data corresponding to the next image frame to the remaining pixel rows. Upon reaching the last pixel row (e.g., pixel row 9), the controller 142 may instruct the display pipeline 136 and/or the display driver 140 to adjust image data written to the display pixels 156 for displaying subsequent image frames based at least in part on the determined operational parameters. For example, when the determined operational parameters indicate that current output from a sense pixel 182 is less than expected, the controller 142 may instruct the display pipeline 136 and/or the display driver 140 to increase current supplied to the display pixels 156 for displaying subsequent image frames. On the other hand, when the determined operational parameters indicate that the current output from the sense pixel is greater than expected, the controller 142 may instruct the display pipeline 136 and/or the display driver 140 to decrease current supplied to the display pixels 156 for displaying subsequent image frames.

It should be noted that the process 220 of FIG. 16 may be used with electronic displays 12 implementing any suitable refresh rate, such as a 60 Hz refresh rate, a 120 Hz refresh rate, and/or a 240 Hz PWM refresh rate. As described above, to increase refresh rate, an electronic display 18 may utilize multiple refresh pixel groups. However, multiple refresh pixel groups may increase timing complexity of the sensing operations, thereby affecting size, power consumption, component count, and/or other implementation associated costs. Thus, to reduce implementation-associated cost, sensing techniques may be adapted when used with multiple noncontiguous refresh pixel groups 164.

To help illustrate, FIG. 18 includes three graphs 252, 254, 256 illustrating timing during operation of display pixels 156 utilizing multiple refresh pixel groups based on the process 220 of FIG. 16, in accordance with an embodiment of the present disclosure. The first graph 252 illustrates operation of display pixels 156 utilizing multiple refresh pixel groups without a sensing operation, the second graph 254 illustrates operation of display pixels 156 utilizing multiple refresh pixel groups during a sensing operation with a greater number of sense pixel rows, and the third graph 256 illustrates operation of display pixels 156 utilizing multiple refresh pixel groups during a sensing operation with a fewer number of sense pixel rows. As illustrated, each display pixel 156 is instructed to stop refreshing (as shown by 258) when a respective display pixel row includes the sense pixels 182. After the sensing operation is completed, each display pixel 156 is instructed to resume refreshing.

The process 220 enables the controller 142 to sense environmental operational parameters and/or display-related operational parameters using sense pixels 182 in a refresh pixel group 164 displayed by the display panel 144. Because the sensing time does not fit into a duration of a refresh operation that does not include sense pixels 182, such that the duration of the refresh operation is unaltered, the circuitry used to implement the process 220 may be simpler, use fewer components, and be more appropriate for applications where saving space in the display panel 144 is a priority. It should be noted, however, that because the majority of display pixels 156 of the display panel 144 are emitting light (e.g., displaying the image data 216) rather than not emitting light, performing the process 220 may increase average luminance during sensing. In particular, stopping the display pixels 156 of the display panel 144 from refreshing during the sensing time may freeze a majority of display pixels 156 that are emitting light, which may increase perceivability of the sensing. As such, perceivability, via a change in average luminance of the display panel 144, may vary with the number of display pixels 156 emitting light and/or displaying image data 216.

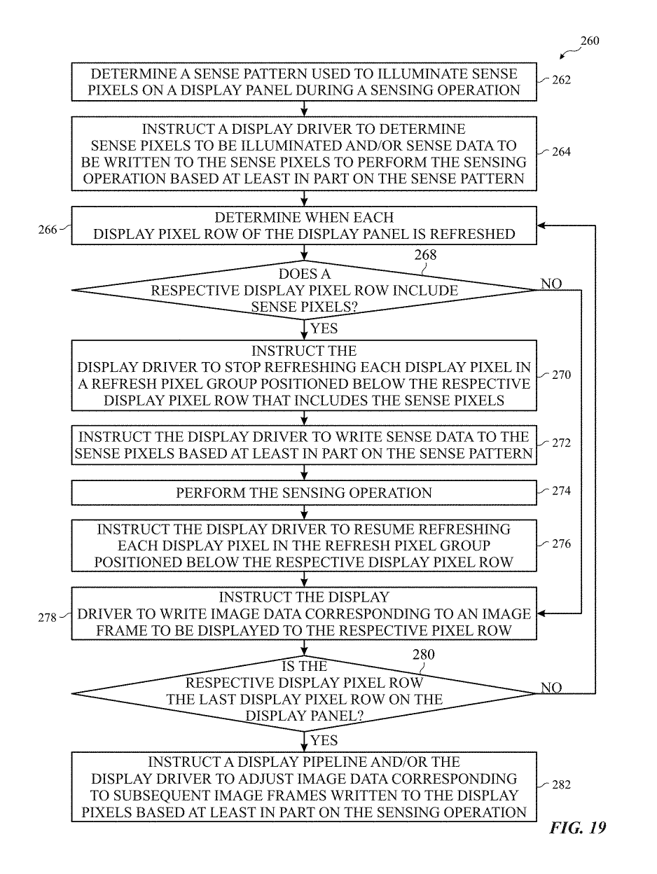

FIG. 19 is a flow diagram of a process 260 for sensing environmental and/or operational information using the sense pixels 182 in the refresh pixel group 164 of a frame displayed by the display panel 144, in accordance with an embodiment of the present disclosure. Generally, the process 260 includes determining a sense pattern used to illuminate sense pixels 182 during a sensing operation (process block 262), instructing the display driver 140 to determine sense pixels 182 to be illuminated and/or sense data to be written to the sense pixels 182 to perform the sensing operation (process block 264), determining when each display pixel row of the display panel 144 is to be refreshed (process block 266), determining whether a respective display pixel row includes sense pixels 182 (decision block 268), instructing the display driver 140 to stop refreshing each display pixel 156 in a refresh pixel group 164 positioned below the respective display pixel row that includes the sense pixels 182 when the row includes sense pixels 182 (process block 270), instructing the display driver 140 to write sense data to the sense pixels 182 based at least in part on the sense pattern when the row includes sense pixels 182 (process block 272), performing a sensing operation (process block 274), instructing the display driver 140 to resume refreshing each display pixel 156 in the refresh pixel group (process block 276), instructing the display driver 140 to write image data corresponding to an image frame to be displayed to each of the display pixels 156 in the row when the row does not include sense pixels 182 and/or after the sensing operation is performed (process block 278), determining whether the row is the last display pixel row on the display panel 144 (decision block 280), and instructing the display pipeline 136 and/or the display driver 140 to adjust image data corresponding to subsequent image frames written to the display pixels 156 based at least in part on the sensing operation (e.g., determined operational parameters) (process block 282). While the process 260 is described using steps in a specific sequence, it should be understood that the present disclosure contemplates that the describe steps may be performed in different sequences than the sequence illustrated, and certain described steps may be skipped or not performed altogether. In some embodiments, the process 260 may be implemented by executing instructions stored in a tangible, non-transitory, computer-readable medium, such as the controller memory 148, using a processor, such as the controller processor 146.

Accordingly, in some embodiments, the controller 142 may determine a sense pattern used to illuminate sense pixels 182 during a sensing operation (process block 262), as described in process block 192 of the process 190. Based at least in part on the sense pattern, the controller 142 may instruct the display driver 140 to determine sense pixels 182 to be illuminated and/or sense data to be written to the sense pixels 182 to perform a sensing operation (process block 264), as described in process block 194 of the process 190. Additionally, the controller 142 may determine when each display pixel row of the display panel 144 is to be refreshed (process block 266), as described in process block 196 of the process 190. When a row is to be refreshed, the controller 142 may determine whether the row includes sense pixels 182 (decision block 268), as described in decision block 198 of the process 190.

When the row includes sense pixels 182, the controller 142 may instruct the display driver 140 to stop refreshing each display pixel 156 in a refresh pixel group 164 positioned below the row that includes the sense pixels 182, such that the display pixel 156 in the refresh pixel group 164 positioned below the row is not refreshed until the display pixel 156 is instructed to resume refreshing (process block 270). That is, if a display pixel 156 of the display panel 144 in the refresh pixel group 164 positioned below the row is emitting light, or more specifically displaying image data 216, the controller 142 instructs the display pixel 156 to continue emitting light, and continue displaying the image data 216. If the display pixel 156 in the refresh pixel group 164 positioned below the row is not emitting light (e.g., is a refresh pixel 64), the controller 142 instructs the display pixel 156 to continue not emitting light. In some embodiments, the controller 142 may instruct the display pipeline 136 and/or the display driver 140 to instruct the display pixels 156 to stop refreshing until instructed to.

The controller 142 may then instruct the display driver 140 to write sense data to the sense pixels 182 based at least in part on the sense pattern (process block 272), as described in process block 200 of the process 190. The controller 142 may perform the sensing operation (process block 274), as described in process block 202 of the process 190.

The controller 142 may then instruct the display driver 140 to resume refreshing each display pixel 156 in the refresh pixel group 164 positioned below the row that includes the sense pixels 182 in the refresh pixel group (process block 276). The display pixels 156 in the refresh pixel group 164 positioned below the row may then follow the next instruction from the display pipeline 136 and/or the display driver 140.

When the row does not include sense pixels 182 and/or after the sensing operation is performed, the controller 142 may instruct the display driver 140 to write image data corresponding to an image frame to be displayed to each of the display pixels 156 in the row (process block 278), as described in process block 204 of the process 190. Additionally, the controller 142 may determine whether the row is the last display pixel row on the display panel 144 (decision block 280), as described in decision block 206 of the process 190. When not the last row, the controller 142 may continue propagating the refresh pixel group 164 successively through rows of the display panel 144 (process block 266). In this manner, the display pixels 156 may be refreshed (e.g., update) to display the image frame.

On the other hand, when the last row is reached, the controller 142 may instruct the display pipeline 136 and/or the display driver 140 to adjust image data corresponding to subsequent image frames written to the display pixels 156 based at least in part on the sensing operation (e.g., determined operational parameters) (process block 282), as described in process block 208 of the process 190.

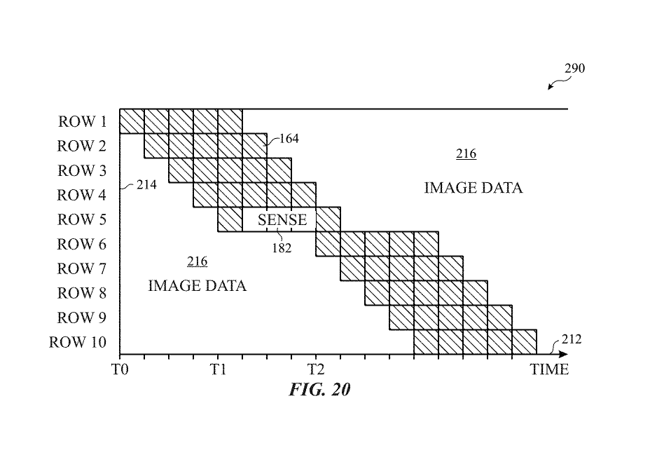

To help illustrate, timing diagram 290, shown in FIG. 20, describes operation of display pixel rows on a display panel 144 when performing the process 260. In particular, the timing diagram 290 represents time on the x-axis 212 and the display pixel rows on the y-axis 214. To simplify explanation, the timing diagram 210 is described with regard to ten display pixel rows—namely pixel row 1, pixel row 2, pixel row 3, pixel row 4, pixel row 5, pixel row 6, pixel row 7, pixel row 8, pixel row 9, and pixel row 10. However, it should be understood that the display panel 144 may include any number of display pixel rows. For example, in some embodiments, the display panel 144 may include 148 display pixel rows.

With regard to the depicted embodiment, at time to, pixel row 1 is included in the refresh pixel group 164 and, thus, in a non-light emitting mode. On the other hand, pixel rows 2-10 are illuminated based on image data 216 corresponding to a previous image frame. For the purpose of illustration, the controller 142 may determine a sense pattern that includes sense pixels 182 in pixel row 5. Additionally, the controller 142 may determine that pixel row 5 is to be refreshed at t₁.

Thus, when pixel row 5 is to be refreshed at t₁, the controller 142 may determine that pixel row 5 includes sense pixels 182. As such, the controller 142 may instruct the display driver 140 to stop refreshing each display pixel 156 in the refresh pixel group 164 positioned below pixel row 5, such that the display pixel 156 in the refresh pixel group 164 positioned below pixel row 5 is not refreshed until the display pixel 156 is instructed to resume refreshing. That is, if a display pixel 156 in the refresh pixel group 164 positioned below pixel row 5 is emitting light, or more specifically displaying image data 216, the controller 142 instructs the display pixel 156 to continue emitting light, and continue displaying the image data 216. If the display pixel 156 in the refresh pixel group 164 positioned below pixel row 5 is not emitting light (e.g., is a refresh pixel 64), the controller 142 instructs the display pixel 156 to continue not emitting light.

Additionally, the controller 142 may instruct the display driver 140 to write sensing image data to the sense pixels 182 in pixel row 5 and perform a sensing operation based at least in part on illumination of the sense pixels 182 to facilitate determining operational parameters. After the sensing operation is completed (e.g., at time t₂), the controller 142 may instruct the display driver 140 to resume refreshing each display pixel 156 in the refresh pixel group 164 positioned below pixel row 5. The display pixels 156 in the refresh pixel group 164 positioned below pixel row 5 may then follow the next instruction from the display pipeline 136 and/or the display driver 140. The controller 142 may then instruct the display driver 140 to write image data 216 corresponding with a next image frame to the display pixels 156 in pixel row 5.

The controller 142 may then determine whether pixel row 5 is the last row in the display panel 144. Since additional pixel rows remain, the controller 142 may instruct the display driver 140 to successively write image data corresponding to the next image frame to the remaining pixel rows. Upon reaching the last pixel row (e.g., pixel row 10), the controller 142 may instruct the display pipeline 136 and/or the display driver 140 to adjust image data written to the display pixels 156 for displaying subsequent image frames based at least in part on the determined operational parameters. For example, when the determined operational parameters indicate that current output from a sense pixel 182 is less than expected, the controller 142 may instruct the display pipeline 136 and/or the display driver 140 to increase current supplied to the display pixels 156 for displaying subsequent image frames. On the other hand, when the determined operational parameters indicate that the current output from the sense pixel is greater than expected, the controller 142 may instruct the display pipeline 136 and/or the display driver 140 to decrease current supplied to the display pixels 156 for displaying subsequent image frames.

It should be noted that the process 260 of FIG. 19 may be used with electronic displays 12 implementing any suitable refresh rate, such as a 60 Hz refresh rate, a 120 Hz refresh rate, and/or a 240 Hz PWM refresh rate. As described above, to increase refresh rate, an electronic display 18 may utilize multiple refresh pixel groups. However, multiple refresh pixel groups may increase timing complexity of the sensing operations, thereby affecting size, power consumption, component count, and/or other implementation associated costs. Thus, to reduce implementation-associated cost, sensing techniques may be adapted when used with multiple noncontiguous refresh pixel groups 164.

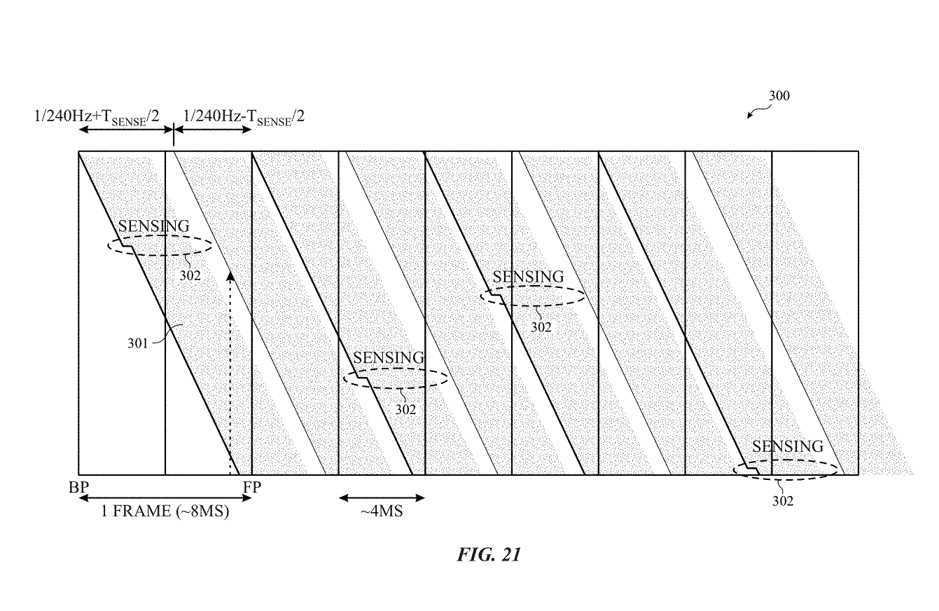

To help illustrate, FIG. 21 is a graph 300 illustrating timing during operation of display pixels 156 utilizing multiple refresh pixel groups based on the process 260 of FIG. 19, in accordance with an embodiment of the present disclosure. As illustrated, when a respective display pixel row of an image frame 301 includes the sense pixels 182, each display pixel 156 in a respective refresh pixel group 164 positioned below the respective display pixel row is instructed to stop refreshing (e.g., during an intra frame pausing sensing period 302). After the sensing operation is completed, each display pixel 156 in the respective refresh pixel group 164 positioned below the respective display pixel row in the refresh pixel group is instructed to resume refreshing. Because it may be desirable to avoid multiple contiguous refresh pixel groups 164 to avoid perceivability of sensing operations, a subsequent refresh pixel group may be phase-shifted forward in time (e.g., by half of a sensing period). In this manner, a refresh pixel group may avoid abutting a subsequent refresh pixel group.

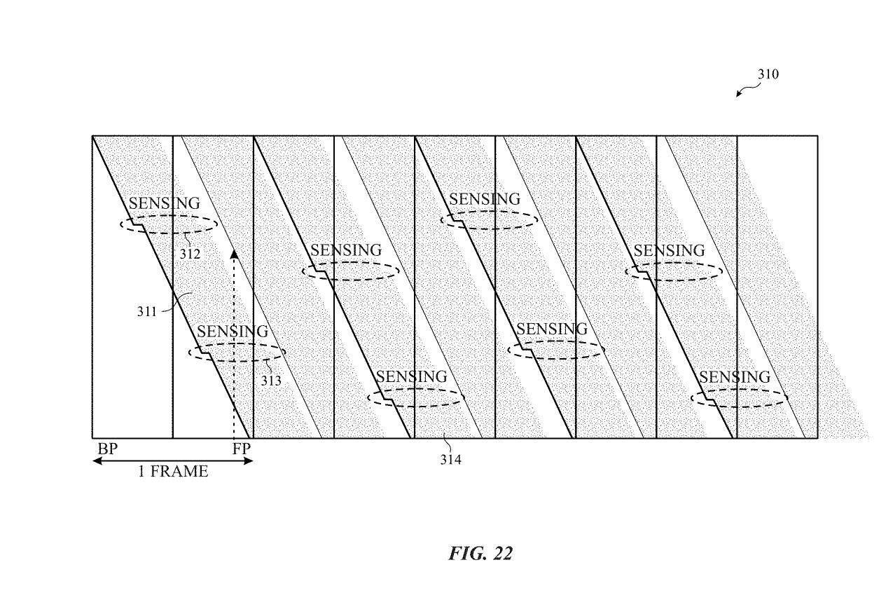

The graph 300 of FIG. 21 illustrates a single intra frame pausing sensing period 302 for the image frame 301. In some embodiments, the image frame 301 may include multiple intra frame pausing sensing periods. To help illustrate, FIG. 22 is a graph 310 of image frames 311 that include multiple intra frame pausing sensing periods 312, 313, in accordance with an embodiment of the present disclosure. As illustrated, when a respective display pixel row of the image frame 311 includes a first set of sense pixels 182, each display pixel 156 in a respective refresh pixel group 164 positioned below the respective display pixel row is instructed to stop refreshing (e.g., during a first intra frame pausing sensing period 312). After the sensing operation is completed, each display pixel 156 in the respective refresh pixel group 164 positioned below the respective display pixel row in the refresh pixel group is instructed to resume refreshing. Moreover, when a subsequent respective display pixel row of the image frame 311 includes a second set of sense pixels 182, each display pixel 156 in a respective refresh pixel group 164 positioned below the subsequent respective display pixel row is instructed to stop refreshing (e.g., during a second intra frame pausing sensing period 313). Again, because it may be desirable to avoid multiple contiguous refresh pixel groups 164 to avoid perceivability of sensing operations, a subsequent refresh pixel group may be phase-shifted forward in time (e.g., by half of a sensing period). In this manner, a refresh pixel group may avoid abutting a subsequent refresh pixel group. Additionally, intervals between multiple intra frame pausing sensing periods (e.g., the first and second intra frame pausing sensing periods 312, 313) in a single image frame 311 may be fixed or variable. Moreover, each intra frame pausing sensing period (e.g., 312, 313) in the single image frame may have same or different durations. While two intra frame pausing sensing periods (e.g., 312, 313) are shown in image frames (e.g., 311, 314) of the graph 310 of FIG. 22, it should be understood that any suitable number of intra frame pausing sensing periods in an image frame is contemplated. Moreover, the number of intra frame pausing sensing periods, the interval between the intra frame pausing sensing periods, and the duration of the intra frame pausing sensing periods, may be fixed or variable from image frame (e.g., 311) to image frame (e.g., 314).

The process 260 enables the controller 142 to sense environmental operational parameters and/or display-related operational parameters using sense pixels 182 in a refresh pixel group 164 displayed by the display panel 144. Because the sensing time does not fit into a duration of a refresh operation that does not include sense pixels 182, such that the duration of the refresh operation is unaltered, the circuitry used to implement the process 260 may be simpler, use fewer components, and be more appropriate for embodiments where saving space is a priority. Additionally, because only the display pixels 156 in a refresh pixel group 164 positioned below the respective display pixel row that includes the one or more sense pixels 182 are paused, while the display pixels 156 positioned above the respective display pixel row that includes the one or more sense pixels 182 continue to operate normally, all display pixels 156 of the display panel 144 are not “paused,” and as such, performing the process 260 may maintain average luminance during sensing.

As a result, during sensing, the instantaneous luminance of the display panel 144 may vary due to the display pixels 156 in a refresh pixel group 164 positioned below the respective display pixel row that includes the one or more sense pixels 182 not refreshing. As such, perceivability, via a change in instantaneous luminance of the display panel 144, may vary with the number of display pixels 156 in the refresh pixel group 164 positioned below the pixel row that includes the one or more sense pixels 182 that are emitting light and/or displaying image data 216.

Accordingly, the technical effects of the present disclosure include sensing environmental and/or operational information within a refresh pixel group of a frame displayed by an electronic display. In this manner, perceivability of the sensing may be reduced. In some embodiments, a total time that a first display pixel row includes a continuous block of refresh pixels is the same as a total time used for a second display pixel row to illuminate a continuous block of refresh pixels and sense pixels. In some embodiments, during sensing, each pixel of the display panel is instructed to stop refreshing. As such, a total time that a first display pixel row includes a continuous block of refresh pixels, wherein the first display pixel row is not instructed to stop refreshing at a time when the first display pixel row includes a refresh pixel, is less than a total time that a second display pixel row includes a continuous block of the refresh pixels and the sense pixels. Additionally, in some embodiments, during sensing, each pixel of the display panel in a refresh pixel group positioned below a respective display pixel row that includes the sense pixels is instructed to stop refreshing. As such, a total time that a first display pixel row includes a continuous block of refresh pixels is the same as a total time used for a second display pixel row to illuminate a continuous block of refresh pixels and sense pixels.

### 2. Sensing Considering Image

Display panel sensing allows for operational properties of pixels of an electronic display to be identified to improve the performance of the electronic display. For example, variations in temperature and pixel aging (among other things) across the electronic display cause pixels in different locations on the display to behave differently. Indeed, the same image data programmed on different pixels of the display could appear to be different due to the variations in temperature and pixel aging. Without appropriate compensation, these variations could produce undesirable visual artifacts. However, compensation of these variations may hinge on proper sensing of differences in the images displayed on the pixels of the display. Accordingly, the techniques and systems described below may be utilized to enhance the compensation of operational variations across the display through improvements to the generation of reference images to be sensed to determine the operational variations.

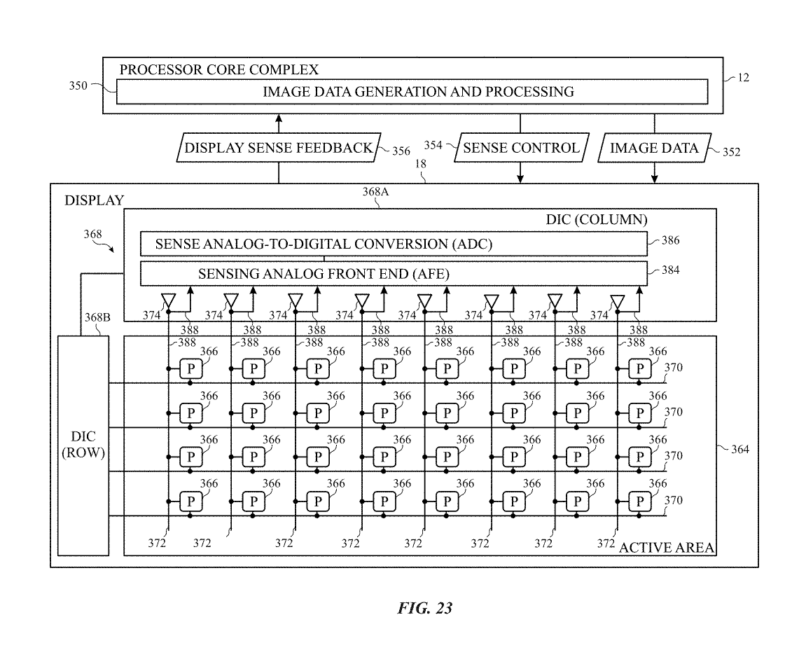

As shown in FIG. 23, in the various embodiments of the electronic device 10, the processor core complex 12 may perform image data generation and processing circuitry 350 to generate image data 352 for display by the electronic display 18. The image data generation and processing circuitry 350 of the processor core complex 12 is meant to represent the various circuitry and processing that may be employed by the core processor 12 to generate the image data 352 and control the electronic display 18. As illustrated, the image data generation and processing circuitry 350 may externally coupled to the electronic display 18. However, in other embodiments, the image data generation and processing circuitry 350 may be part of the display 12. In some embodiments, the image data generation and processing circuitry 350 may represent a graphics processing unit, a display pipeline, or the like and to facilitate control of operation of the electronic display 18. The image data generation and processing circuitry 350 may include a processor and memory such that the processor of the image data generation and processing circuitry 350 may execute instructions and/or process data stored in memory of the image data generation and processing circuitry 350 to control operation in the electronic display 12.

As previously discussed, since it may be desirable to compensate for image data 352, for example, based on manufacturing and/or operational variations of the electronic display 18, the processor core complex 12 may provide sense control signals 354 to cause the electronic display 18 to perform display panel sensing to generate display sense feedback 356. The display sense feedback 356 represents digital information relating to the operational variations of the electronic display 18. The display sense feedback 356 may take any suitable form, and may be converted by the image data generation and processing circuitry 350 into a compensation value that, when applied to the image data 352, appropriately compensates the image data 352 for the conditions of the electronic display 18. This results in greater fidelity of the image data 352, reducing or eliminating visual artifacts that would otherwise occur due to the operational variations of the electronic display 18.

The electronic display 18 includes an active area 364 with an array of pixels 366. The pixels 366 are schematically shown distributed substantially equally apart and of the same size, but in an actual implementation, pixels of different colors may have different spatial relationships to one another and may have different sizes. In one example, the pixels 366 may take a red-green-blue (RGB) format with red, green, and blue pixels, and in another example, the pixels 366 may take a red-green-blue-green (RGBG) format in a diamond pattern. The pixels 366 are controlled by a driver integrated circuit 368, which may be a single module or may be made up of separate modules, such as a column driver integrated circuit 368A and a row driver integrated circuit 368B. The driver integrated circuit 368 (e.g., 368B) may send signals across gate lines 370 to cause a row of pixels 366 to become activated and programmable, at which point the driver integrated circuit 368 (e.g., 368A) may transmit image data signals across data lines 372 to program the pixels 366 to display a particular gray level (e.g., individual pixel brightness). By supplying different pixels 366 of different colors with image data to display different gray levels, full-color images may be programmed into the pixels 366. The image data may be driven to an active row of pixel 366 via source drivers 374, which are also sometimes referred to as column drivers.

As described above, display 18 may display image frames through control of its luminance of its pixels 366 based at least in part on received image data. When a pixel 366 is activated (e.g., via a gate activation signal across a gate line 370 activating a row of pixels 366), luminance of a display pixel 366 may be adjusted by image data received via a data line 372 coupled to the pixel 366. Thus, as depicted, each pixel 366 may be located at an intersection of a gate line 370 (e.g., a scan line) and a data line 372 (e.g., a source line). Based on received image data, the display pixel 366 may adjust its luminance using electrical power supplied from a power source 28, for example, via power a supply lines coupled to the pixel 366.

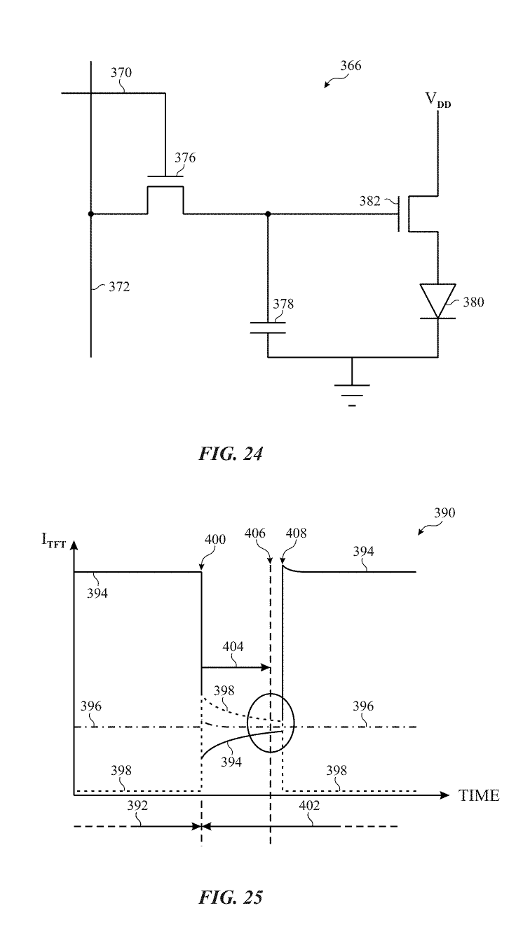

As illustrated in FIG. 24, each pixel 366 may include a circuit switching thin-film transistor (TFT) 376, a storage capacitor 378, an LED 380, and a driver TFT 382 (whereby each of the storage capacitor 378 and the LED 380 may be coupled to a common voltage, Vcom or ground). However, variations may be utilized in place of illustrated pixel 366 of FIG. 24. To facilitate adjusting luminance, the driver TFT 382 and the circuit switching TFT 376 may each serve as a switching device that is controllably turned on and off by voltage applied to its respective gate. In the depicted embodiment, the gate of the circuit switching TFT 376 is electrically coupled to a gate line 370. Accordingly, when a gate activation signal received from its gate line 370 is above its threshold voltage, the circuit switching TFT 376 may turn on, thereby activating the pixel 366 and charging the storage capacitor 378 with image data received at its data line 372.

Additionally, in the depicted embodiment, the gate of the driver TFT 382 is electrically coupled to the storage capacitor 378. As such, voltage of the storage capacitor 378 may control operation of the driver TFT 382. More specifically, in some embodiments, the driver TFT 382 may be operated in an active region to control magnitude of supply current flowing through the LED 380 (e.g., from a power supply or the like providing Vdd). In other words, as gate voltage (e.g., storage capacitor 378 voltage) increases above its threshold voltage, the driver TFT 382 may increase the amount of its channel available to conduct electrical power, thereby increasing supply current flowing to the LED 380. On the other hand, as the gate voltage decreases while still being above its threshold voltage, the driver TFT 382 may decrease amount of its channel available to conduct electrical power, thereby decreasing supply current flowing to the LED 380. In this manner, the luminance of the pixel 366 may be controlled and, when similar techniques are applied across the display 18 (e.g., to the pixels 366 of the display 18), an image may be displayed.

As mentioned above, the pixels 366 may be arranged in any suitable layout with the pixels 366 having various colors and/or shapes. For example, the pixels 366 may appear in alternating red, green, and blue in some embodiments, but also may take other arrangements. The other arrangements may include, for example, a red-green-blue-white (RGBW) layout or a diamond pattern layout in which one column of pixels alternates between red and blue and an adjacent column of pixels are green. Regardless of the particular arrangement and layout of the pixels 366, each pixel 366 may be sensitive to changes on the active area 364 of the electronic display 18, such as variations and temperature of the active area 364, as well as the overall age of the pixel 366. Indeed, when each pixel 366 is a light emitting diode (LED), it may gradually emit less light over time. This effect is referred to as aging, and takes place over a slower time period than the effect of temperature on the pixel 366 of the electronic display 18.

Returning to FIG. 23, display panel sensing may be used to obtain the display sense feedback 356, which may enable the processor core complex 12 to generate compensated image data 352 to negate the effects of temperature, aging, and other variations of the active area 364. The driver integrated circuit 368 (e.g., 368A) may include a sensing analog front end (AFE) 384 to perform analog sensing of the response of pixels 366 to test data (e.g., test image data) or user data (e.g., user image data). It should be understood that further references to test data or test image data in the present disclosure include user data and/or user image data. The analog signal may be digitized by sensing analog-to-digital conversion circuitry (ADC) 386.

For example, to perform display panel sensing, the electronic display 18 may program one of the pixels 366 with test data (e.g., having a particular reference voltage or reference current). The sensing analog front end 384 then senses (e.g., measures, receives, etc.) at least one value (e.g., voltage, current, etc.) along sense line 388 of connected to the pixel 366 that is being tested. Here, the data lines 372 are shown to act as extensions of the sense lines 388 of the electronic display 18. In other embodiments, however, the display active area 364 may include other dedicated sense lines 388 or other lines of the display 18 may be used as sense lines 388 instead of the data lines 372. In some embodiments, other pixels 366 that have not been programmed with test data may be also sensed at the same time a pixel 366 that has been programmed with test data is sensed. Indeed, by sensing a reference signal on a sense line 388 when a pixel 366 on that sense line 388 has not been programmed with test data, a common-mode noise reference value may be obtained. This reference signal can be removed from the signal from the test pixel 366 that has been programmed with test data to reduce or eliminate common mode noise.

The analog signal may be digitized by the sensing analog-to-digital conversion circuitry 386. The sensing analog front end 384 and the sensing analog-to-digital conversion circuitry 386 may operate, in effect, as a single unit. The driver integrated circuit 368 (e.g., 368A) may also perform additional digital operations to generate the display feedback 356, such as digital filtering, adding, or subtracting, to generate the display feedback 356, or such processing may be performed by the processor core complex 12.

In some embodiments, a correction map (e.g., stored as a look-up table or the like) that may include correction values that correspond to or represent offsets or other values applied to generated compensated image data 352 being transmitted to the pixels 366 to correct, for example, for temperature differences at the display 18 or other characteristics affecting the uniformity of the display 18. This correction map may be part of the image data generation and processing circuit (e.g., stored in memory therein) or it may be stored in, for example, memory 14 or storage 16. Through the use of the correction map (i.e., the correction information stored therein), effects of the variation and non-uniformity in the display 18 may be corrected using the image data generation and processing circuitry 350 of the processor core complex 12. The correction map, in some embodiments, correspond to the entire active area 364 of the display 18 or a sub-segment of the active area 364. For example, to reduce the size of the memory required to store the correction map (or the data therein), the correction map may include correction values that correspond to only to predetermined groups or regions of the active area 364, whereby one or more correction values may be applied to the group of pixels 366. Additionally, in some embodiments, the correction map be a reduced resolution correction map that enables low power and fast response operations such that, for example, the image data generation and processing circuitry 350 may reduce the resolution of the correction values prior to their storage in memory so that less memory may be required, responses may be accelerated, and the like. Additionally, adjustment of the resolution of the correction map may be dynamic and/or resolution of the correction map may be locally adjusted (e.g., adjusted at particular locations corresponding to one or more regions or groups of pixels 366).

The correction map (or a portion thereof, for example, data corresponding to a particular region or group of pixels 366), may be read from the memory of the image data generation and processing circuitry 350. The correction map (e.g., one or more correction values) may then (optionally) be scaled, whereby the scaling corresponds to (e.g., offsets or is the inverse of) a resolution reduction that was applied to the correction map. In some embodiments, whether this scaling is performed (and the level of scaling) may be based on one or more input signals received as display settings and/or system information by the image data generation and processing circuitry 350.

Conversion of the correction map may be undertaken via interpolation (e.g., Gaussian, linear, cubic, or the like), extrapolation (e.g., linear, polynomial, or the like), or other conversion techniques being applied to the data of the correction map. This may allow for accounting of, for example, boundary conditions of the correction map and may yield compensation driving data that may be applied to raw display content (e.g., image data) so as to generate compensated image data 352 that is transmitted to the pixels 366.

In some embodiments, the correction map may be updated, for example, based on input values generated from the display sense feedback 356 by the image data generation and processing circuitry 350. This updating of the correction map may be performed globally (e.g., affecting the entirety of the correction map) and/or locally (e.g., affecting less than the entirety of the correction map). The update may be based on real time measurements of the active area 364 of the electronic display 18, transmitted as display sense feedback 356. Additionally and/or alternatively, a variable update rate of correction can be chosen, e.g., by the image data generation and processing system 350, based on conditions affecting the display 18 (e.g., display 18 usage, power level of the device, environmental conditions, or the like).

FIG. 25 illustrates a graphical example of a technique for updating of the correction map. As shown in graph 390, during frame 392 (e.g., represented by n−1), a current 394 passing through the driver TFT 382 may correspond to a brightness level (e.g., a gray level) above a threshold current value 396 (e.g., current 394 may correspond to a gray level or desired gray level for a pixel 366 above a reference gray level value that corresponds to threshold current value 396). For example, the current 394 may represent the current applied through the driver TFT 382 and transmitted to the LED 380 to generate a relatively bright portion of an image during frame 392. Also illustrated in graph 390 is a current 398 passing through the driver TFT 382, which illustrates an example of a different current than current 394 previously discussed, where only one of current 394 or current 398 is applied during frame 392. The current 398 may correspond to a brightness level (e.g., a gray level) below a threshold current value 396 (e.g., current 398 may correspond to a gray level or desired gray level for a pixel 366 below a reference gray level value that corresponds to threshold current value 396). Current 398 may represent the current applied through the driver TFT 382 and transmitted to the LED 380 to generate a relatively dark portion of an image during frame 392.

As illustrated at time 400, the first frame 392 is completed and a second frame 402 (which may be referred to as frame n and may, for example, correspond to a frame refresh) begins. However, in other embodiments, frame 402 may begin at time 408 (discussed below) and, accordingly, the time between frame 392 and 402 may be considered a sensing frame (e.g., separate from frame 402 instead of part of frame 402). At time 400, a display panel sensing operation may begin whereby, for example, the processor core complex 12 (or a portion thereof, such as image data generation and processing circuitry 350) may provide sense control signals 354 to cause the electronic display 18 to perform display panel sensing to generate display sense feedback 356. These sense control signals 354 may be used to program one of the pixels 366 with test data (e.g., having a particular reference voltage or reference current). For the purposes of discussion, test currents will be sensed as part of the display panel sensing operation, however, it is understood that the display panel sensing operation may instead operate to sense voltage levels from one of more components of the pixels 366, current levels from one or more components of the pixels 366, brightness of the LED 380, or any combination thereof based on test data supplied to the pixels 366.

As illustrated, when the test data is applied to a pixel 366, hysteresis (e.g., a lag between a present input and a past input affecting operation) of, for example, the driver TFT 382 of the pixel 366 or one or more transient conditions affecting the pixel 366 or one or more component therein can cause a transient state wherein the current to be sensed has not reached a steady state (e.g., such that measurements of the currents at this time would affect their reliability). For example, at time 400 as the pixel is programed with test data, when the pixel 366 previously had a driver TFT current 394 corresponding to a relatively high gray level, this current 394 swings below the threshold current value 396 corresponding to the test data gray level value. The driver TFT current 394 may continue to move towards a steady state. In some embodiments, the amount of time that the current 394 of the driver TFT 382 has to settle (e.g., the relaxation time) is illustrated as time period 404 which represents the time between time 400 and time 406 corresponding to a sensing of the current (e.g., the driver TFT 382 current). Time period 404 may be, for example, less than approximately 10 microseconds (μs), 20 μs, 30 μs, 40 μs, 50 μs, 75 μs, 100 μs, 200 μs, 300 μs, 400 μs, 500 μs, or a similar value. At time 408, the pixel 366 may be programmed again with a data value, returning the current 394 to its original level (assuming the data signal has not changed between frame 392 and frame 402).

Likewise, at time 400 as the pixel is programed with test data, when the pixel 366 previously had a driver TFT current 398 corresponding to a relatively low gray level, this current 398 swings above the threshold current value 396 corresponding to the test data gray level value. The driver TFT current 394 may continue to move towards a steady state. In some embodiments, the amount of time that the current 398 of the driver TFT 382 has to settle (e.g., the relaxation time) is illustrated as time period 404. At time 408, the pixel 366 may be programmed again with a data value, returning the current 398 to its original level (assuming the data signal has not changed between frame 392 and frame 402).

As illustrated, the a technique for updating of the correction map illustrated in graph 390 in conjunction with a display panel sensing operation includes a double sided error (e.g., current 394 swinging below the threshold current value 396 corresponding to the test data gray level value and current 398 swinging above the threshold current value 396 corresponding to the test data gray level value) during time period 404. However, techniques may be applied to reduce the double sided error present in FIG. 25.

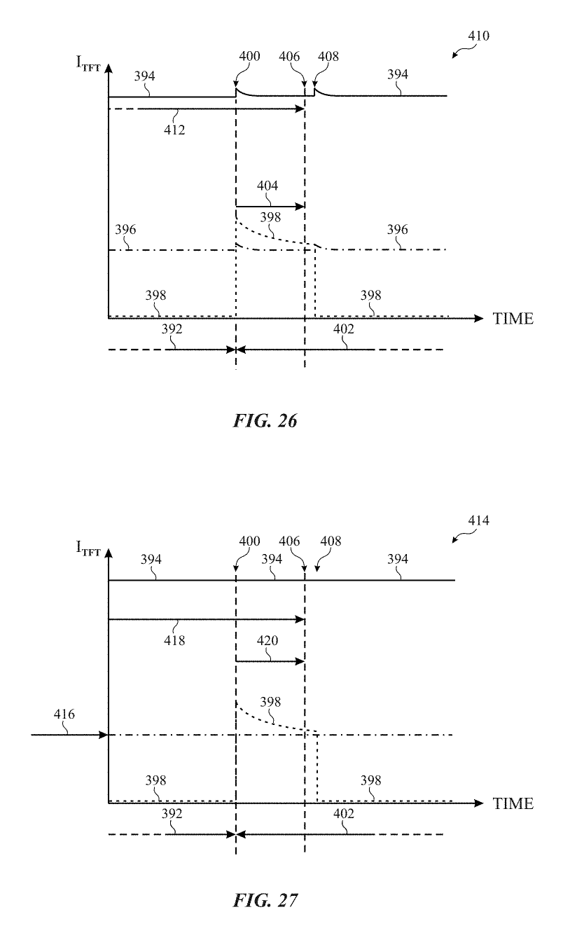

For example, FIG. 26 illustrates a graphical representation (e.g., graph 410) of a technique for updating of the correction map having only a single sided error present. As shown in graph 410, during frame 392, a current 394 passing through the driver TFT 382 may correspond to a brightness level (e.g., a gray level) above a threshold current value 396 (e.g., current 394 may correspond to a gray level or desired gray level for a pixel 366 above a reference gray level value that corresponds to threshold current value 396). For example, the current 394 may represent the current applied through the driver TFT 382 and transmitted to the LED 380 to generate a relatively bright portion of an image during frame 392. Also illustrated in graph 390 is a current 398 passing through the driver TFT 382, which illustrates an example of a different current than current 394 previously discussed, where only one of current 394 or current 398 is applied during frame 392. The current 398 may correspond to a brightness level (e.g., a gray level) below a threshold current value 396 (e.g., current 398 may correspond to a gray level or desired gray level for a pixel 366 below a reference gray level value that corresponds to threshold current value 396). Current 398 may represent the current applied through the driver TFT 382 and transmitted to the LED 380 to generate a relatively dark portion of an image during frame 392.

As illustrated at time 400, the first frame 392 is completed and a second frame 402 (which, for example, may correspond to a frame refresh) begins. At time 400, a display panel sensing operation may begin whereby, for example, the processor core complex 12 (or a portion thereof, such as image data generation and processing circuitry 350) may provide sense control signals 354 to cause the electronic display 18 to perform display panel sensing to generate display sense feedback 356. These sense control signals 354 may be used to program one of the pixels 366 with test data (e.g., having a particular reference voltage or reference current). For the purposes of discussion, test currents will be sensed as part of the display panel sensing operation, however, it is understood that the display panel sensing operation may instead operate to sense voltage levels from one of more components of the pixels 366, current levels from one or more components of the pixels 366, brightness of the LED 380, or any combination thereof based on test data supplied to the pixels 366.

As illustrated, the processor core complex 12 (or a portion thereof, such as image data generation and processing circuitry 350) may dynamically provide sense control signals 354 to cause the electronic display 18 to perform display panel sensing to generate display sense feedback 356. For example, the processor core complex 12 (or a portion thereof, such as image data generation and processing circuitry 350) may determine whether, in frame 392, the current 394 corresponds to a gray level or desired gray level for a pixel 366 above (or at or above) a reference gray level value that corresponds to threshold current value 396. Alternatively, the processor core complex 12 (or a portion thereof, such as image data generation and processing circuitry 350) may determine whether, in frame 392, the gray level or desired gray level for a pixel 366 is above (or at or above) a reference gray level value that corresponds to threshold current value 396. If the current 394 in frame 392 corresponds to a gray level or desired gray level for a pixel 366 above (or at or above) a reference gray level value corresponding to threshold current value 396, or if the gray level or desired gray level for a pixel 366 in frame 392 is above (or at or above) a reference gray level value corresponding to threshold current value 396, the processor core complex 12 (or a portion thereof, such as image data generation and processing circuitry 350) may produce and provide sense control signals 354 (e.g., test data) corresponding to the gray level or desired gray level of the pixel in frame 392 such that the current level to be sensed at time 406 is equivalent to the current level of the TFT driver 382 during frame 392. This allows for a time period 412 that the current 394 of the driver TFT 382 has to settle (e.g., the relaxation time) which represents the time between the start of frame 392 and time 406 corresponding to a sensing of the current (e.g., the driver TFT 382 current). Time period 412 may be, for example, less than approximately 20 milliseconds (ms), 15 ms, 10 ms, 9 ms, 8 ms, 7, ms, 6 ms, 5 ms, or a similar value.

As additionally illustrated in FIG. 26, at time 400 (as the pixel is programed with test data), when the pixel 366 previously had a driver TFT current 398 corresponding to a relatively low gray level, this current 398 swings above the threshold current value 396 corresponding to the test data gray level value. The driver TFT current 394 may continue to move towards a steady state. In some embodiments, the amount of time that the current 398 of the driver TFT has to settle (e.g., the relaxation time) is illustrated as time period 404. At time 408, the pixel 366 may be programmed again with a data value, returning the current 398 to its original level (assuming the data signal has not changed between frame 392 and frame 402). However, as illustrated in FIG. 26 and described above, through dynamic selection of test data sent to the pixel 366 (e.g., differential sensing using separate test data based on the operation of a pixel 366 in a frame 392), double sided errors illustrated in FIG. 25 may be reduced to single sided errors in FIG. 26, thus allowing for more accurate readings (sensed data) to be retrieved as display sense feedback 356, which allows for increased accuracy in the correction values calculated, stored (e.g., in a correction map), and/or applied as compensated image data 352. The single sided errors of FIG. 26 may be illustrative of, for example, hysteresis caused by a change of the gate-source voltage of the driver TFT 382 when sensing programming of a pixel 366 at time 400 alters the gray level corresponding to current 398 to a gray level corresponding to the threshold current value 396, whereby the hysteresis may be proportional to a change in the gate-source voltage of the driver TFT 382.

In some embodiments, further reduction of sensing errors (e.g., errors due to the sensed current not being able to reach or not being able to nearly reach a steady state) may also be reduced for example, through selection of test data having a gray level corresponding to a threshold current value differing from threshold current value 396. FIG. 27 illustrates a second graphical representation (e.g., graph 414) of a technique for updating of the correction map having only a single sided error present. As shown in graph 410, during frame 392, a current 394 passing through the driver TFT 382 may correspond to a brightness level (e.g., a gray level) above a threshold current value 416 (e.g., current 394 may correspond to a gray level or desired gray level for a pixel 366 above a reference gray level value that corresponds to threshold current value 416).

Current value 416 may be, for example, initially set at a predetermined level based upon, for example, an initial configuration of the device 10 (e.g., at the factory and/or during initial device 10 or display 18 testing) or may be dynamically performed and set (e.g., at predetermined intervals or in response to a condition, such as startup of the device). The current value 416 may be selected to correspond to the lowest gray level or desired gray level for a pixel 366 having a predetermined or desired reliability, a predetermined or desired signal to noise ratio (SNR), or the like. Alternatively, the current value 416 may be selected to correspond to a gray level within 2%, 5%, 10%, or another value the lowest gray level or desired gray level for a pixel 366 having a predetermined or desired reliability, a predetermined or desired SNR, or the like. For example, selection of a current value 416 corresponding to a gray level 0 may introduce too much noise into any sensed current value. However, each device 10 may have a gray level (e.g., gray level 10, 15, 20, 20, 30, or another level) at which a predetermined or desired reliability, a predetermined or desired SNR, or the like may be achieved and this gray value (or a gray value within a percentage value above the minimum gray level if, for example, a buffer regarding the reliability, SNR, or the like is desirable) may be selected for test data, which corresponds to threshold current value 416. In some embodiments, the test data, which corresponds to threshold current value 416, can also be altered based on results from the sensing operation (e.g., altered in a manner similar to the alteration of the compensated image data 352).

Thus, as illustrated in FIG. 27, the current 394 may represent the current applied through the driver TFT 382 and transmitted to the LED 380 to generate a relatively bright portion of an image during frame 392. Also illustrated in graph 414 is a current 398 passing through the driver TFT 382, which illustrates an example of a different current than current 394 previously discussed, where only one of current 394 or current 398 is applied during frame 392. The current 398 may correspond to a brightness level (e.g., a gray level) below the threshold current value 416 (e.g., current 398 may correspond to a gray level or desired gray level for a pixel 366 below a reference gray level value that corresponds to threshold current value 416). Current 398 may represent the current applied through the driver TFT 382 and transmitted to the LED 380 to generate a relatively dark portion of an image during frame 392.

As illustrated at time 400, the first frame 392 is completed and a second frame 402 (which, for example, may correspond to a frame refresh) begins. At time 400, a display panel sensing operation may begin whereby, for example, the processor core complex 12 (or a portion thereof, such as image data generation and processing circuitry 350) may provide sense control signals 354 to cause the electronic display 18 to perform display panel sensing to generate display sense feedback 356. These sense control signals 354 may be used to program one of the pixels 366 with test data (e.g., having a particular reference voltage or reference current). For the purposes of discussion, test currents will be sensed as part of the display panel sensing operation, however, it is understood that the display panel sensing operation may instead operate to sense voltage levels from one of more components of the pixels 366, current levels from one or more components of the pixels 366, brightness of the LED 380, or any combination thereof based on test data supplied to the pixels 366.

As illustrated, the processor core complex 12 (or a portion thereof, such as image data generation and processing circuitry 350) may dynamically provide sense control signals 354 to cause the electronic display 18 to perform display panel sensing to generate display sense feedback 356. For example, the processor core complex 12 (or a portion thereof, such as image data generation and processing circuitry 350) may determine whether, in frame 392, the current 394 corresponds to a gray level or desired gray level for a pixel 366 above (or at or above) a reference gray level value that corresponds to threshold current value 416. Alternatively, the processor core complex 12 (or a portion thereof, such as image data generation and processing circuitry 350) may determine whether, in frame 392, the gray level or desired gray level for a pixel 366 is above (or at or above) a reference gray level value that corresponds to threshold current value 416. If the current 394 in frame 392 corresponds to a gray level or desired gray level for a pixel 366 above (or at or above) a reference gray level value corresponding to threshold current value 416, or if the gray level or desired gray level for a pixel 366 in frame 392 is above (or at or above) a reference gray level value corresponding to threshold current value 416, the processor core complex 12 (or a portion thereof, such as image data generation and processing circuitry 350) may produce and provide sense control signals 354 (e.g., test data) corresponding to the gray level or desired gray level of the pixel in frame 392 such that the current level to be sensed at time 406 is equivalent to the current level of the TFT driver 382 during frame 392. This allows for a time period 418 (e.g., less than time period 412) that the current 394 of the driver TFT 382 has to settle (e.g., the relaxation time) which represents the time between the start of frame 392 and time 406 corresponding to a sensing of the current (e.g., the driver TFT 382 current). Time period 418 may be, for example, less than approximately 20 ms, 15 ms, 10 ms, 9 ms, 8 ms, 7, ms, 6 ms, 5 ms, or a similar value.

As additionally illustrated in FIG. 27, at time 400 (as the pixel is programed with test data), when the pixel 366 previously had a driver TFT current 398 corresponding to a relatively low gray level, this current 398 swings above the threshold current value 416 corresponding to the test data gray level value. The driver TFT current 394 may continue to move towards a steady state. In some embodiments, the amount of time that the current 398 of the driver TFT has to settle (e.g., the relaxation time) is illustrated as time period 420 (e.g., less than time period 404). At time 408, the pixel 366 may be programmed again with a data value, returning the current 398 to its original level (assuming the data signal has not changed between frame 392 and frame 402). However, as illustrated in FIG. 27 and described above, through dynamic selection of test data sent to the pixel 366 (e.g., selection of a set or dynamic test data value corresponding to a desired gray value that generates threshold reference current 416), the single sided error of FIG. 27 may be reduced in size, thus allowing for more accurate readings (sensed data) to be retrieved as display sense feedback 356, which allows for increased accuracy in the correction values calculated, stored (e.g., in a correction map), and/or applied as compensated image data 352.

Additionally and/or alternatively, sensing errors from hysteresis effects may appear as high frequency artifacts. Accordingly, suppression of a high frequency component of a sensing error may be obtained by having the sensing data run through a low pass filter, which may decrease the amount of visible artifacts. The low pass filter may be a two-dimensional spatial filter, such as a Gaussian filter, a triangle filter, a box filter, or any other two-dimensional spatial filter. The filtered data may then be used by the image data generation and processing circuitry 350 to determine correction factors and/or a correction map. Likewise, by grouping pixels 366 and filtering sensed data of the grouped pixels 366, sensing errors may further be reduced.

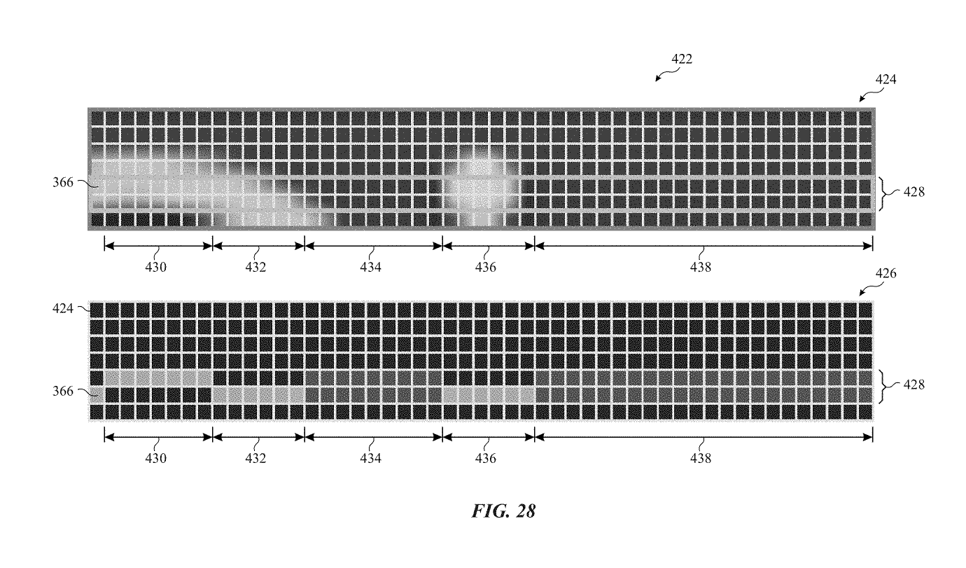

FIG. 28 illustrates another technique for updating of the correction map, for example, using groupings of pixels 366 and utilizing the grouped pixels to make determinations relative to a gray level of test data corresponding to one of either threshold reference current 396 or threshold reference current 416. For example, FIG. 28 illustrates a schematic diagram 422 of a portion 424 of display 18 as well as a representation 426 of test data applied to the portion 424. As illustrated in portion 424, a group 428 of pixels 366 may include two rows of adjacent pixels 366 across all columns of the display 18. Schematic diagram 422 may illustrate an image being displayed at frame 392 having various brightness levels (e.g., gray levels) for each of regions 430, 432, 434, 436, and 438 (collectively regions 430-438).

In some embodiments, instead of performing a display panel sensing operation (e.g., performing display panel sensing) on each pixel 366 of the display 18, the display panel sensing can be performed on subsets of the group 428 of pixels 366 (e.g., a pixel 366 in an upper row and a lower row of a common column of the group 428). It should be noted that each of the group 428 size and/or dimensions and/or the subsets of the group 428 chosen can be dynamically and/or statically selected and the present example is provided for reference and is not intended to be exclusive of other group 428 sizes and/or dimensions and/or alterations to the subsets of the group 428 (e.g., the number of pixels 366 in the subset of the group 428.

In one embodiment, a current passing through the driver TFT 382 of a pixel 366 at location x,y in a given subset of the group 428 of pixels 366 in frame 392 may correspond to a brightness level (e.g., a gray level) represented by G_{x,y}. Likewise, a current passing through the driver TFT 382 of a pixel 366 at location x,y−1 in the subset of the group 428 of pixels 366 (e.g., a location in the same column but a row below the pixel 366 of the subset of the group 428 corresponding to the brightness level represented by G_{x,y}) in frame 392 may correspond to a brightness level (e.g., a gray level) represented by G_{x,y-1}. Instead of the processor core complex 12 (or a portion thereof, such as image data generation and processing circuitry 350) dynamically providing sense control signals 354 to cause the electronic display 18 to perform display panel sensing to generate display sense feedback 356 for each pixel 366 based on a grey level threshold comparison (as detailed above in conjunction with FIGS. 25-27), the processor core complex 12 (or a portion thereof, such as image data generation and processing circuitry 350) may dynamically provide sense control signals 354 (e.g., a single or common test data value) to both pixels 366 of the subsets of the group 428 of pixels 366 based on a subset threshold comparison.

An embodiment of a threshold comparison is described below. If the processor core complex 12 (or a portion thereof, such as image data generation and processing circuitry 350) determines that G_{x,y}<G_{threshold} and G_{x,y-1}<G_{threshold}, whereby G_{threshold} is equal to a reference gray level value that corresponds to threshold current value 416 (or the threshold current value 106), then G_{test(x,y)}=G_{threshold} and G_{test(x,y-1)}=G_{threshold}, whereby G_{test(x,y)} is the test data gray level value (e.g., a reference gray level value that corresponds to threshold current value 416 or the threshold current value 396, depending on the operation of the processor core complex 12 or a portion thereof, such as image data generation and processing circuitry 350) at time 400. Thus, if each of the gray levels of the pixels 366 of a subset of the group of pixels 366 corresponds to a current level (e.g., current 398) below the threshold current value (e.g., threshold current value 416 or the threshold current value 396), the test data gray level that corresponds to threshold current value 416 or the threshold current value 396 is used in the sensing operation. These determinations are illustrated, for example, in regions 434 and 438 of FIG. 28.

Likewise, if the processor core complex 12 (or a portion thereof, such as image data generation and processing circuitry 350) determines that either G_{x,y}≧G_{threshold} and/or G_{x,y-1}≧G_{threshold}, then the processor core complex 12 (or a portion thereof, such as image data generation and processing circuitry 350) may choose one of G_{x,y} or G_{x,y-1} to be applied as G_{test(x,y)} at time 400, such that G_{test(x,y)}=G_{x,y} and G_{test(x,y-1)}=G_{x,y} or G_{test(x,y)}=G_{x,y-1} and G_{test(x,y-1)}=G_{x,y-1}. Alternatively, if the processor core complex 12 (or a portion thereof, such as image data generation and processing circuitry 350) determines that either G_{x,y}≧G_{threshold} and/or G_{x,y-1}≧G_{threshold}, then the processor core complex 12 (or a portion thereof, such as image data generation and processing circuitry 350) may choose one of G_{x,y} or G_{x,y-1} to be applied at time 400 to one of the pixels 366 of the subset of the group 428 of pixels 366 and choose a lowest gray level value G₀ to be applied to the other one of the pixels 366 of the subset of the group 428 of pixels 366, such that G_{test(x,y)}=G_{x,y} and G_{test(x,y-1)}=G₀ or G_{test(x,y)}=G₀ and G_{test(x,y-1)}=G₀. For example, it may be advantageous to apply separate test data values (one of which is the lowest available gray level or another gray level below G_{threshold}) so that when the sensed values of the subset of the group 428 of pixels 366 are taken together and applied as correction values, the correction values can be averaged to a desired correction level when taken across the subset of the group 428 of pixels 366 (e.g., to generate a correction map average for the subset of the group 428 of pixels 366) to be applied as corrected feedback 356, which allows for increased accuracy in the correction values calculated, stored (e.g., in a correction map), and/or applied as compensated image data 352.

In some embodiments, a weighting operation may be performed and applied by the processor core complex 12 or a portion thereof, such as image data generation and processing circuitry 350, to select which of G_{x,y} and G_{x,y-1} is supplied with test data G₀. For example, test data gray level selection may be based on the weighting of each gray level of the pixels 366 of the subset of the group 428 of pixels 366 in frame 392, by weighting determined based on characteristics of the individual pixels 366 of the subset of the group 428 of pixels 366 (e.g., I-V characteristics, current degradation level of the pixels 366 of the subset, etc.), by weighting determined by the SNR of the respective sensing lines 388, and/or a combination or one or more of these determinations. For example, if the processor core complex 12 or a portion thereof, such as image data generation and processing circuitry 350, determines that, for example, W_{x,y}≧W_{x,y-1}, whereby W_{x,y} is the weight value of the pixel 366 at location x,y and W_{x,y-1} is the weight value of the pixel 366 at location x,y−1 (e.g., a weighting factor determined and given to each pixel 366), then G_{test(x,y)}=G_{x,y} and G_{test(x,y-1)}=G₀. These determinations are illustrated, for example, in regions 432 and 436 of FIG. 28. Likewise, if the processor core complex 12 or a portion thereof, such as image data generation and processing circuitry 350, determines that, for example, W_{x,y-1}>W_{x,y-1}, then G_{test(x,y)}=G₀ and G_{test(x,y-1)}=G₀. These determinations are illustrated, for example, in regions 430 of FIG. 28.

It may be appreciated that alternate weighing processes or selection of test data processes may additionally and/or alternatively be chosen. Additionally, in at least one embodiment, sensing circuitry (e.g., one or more sensors) may be present in, for example, AFE 384 to perform analog sensing of the response of more than one pixel 366 at a time (e.g., to sense each of the pixels 366 of a subset of the group 428 of pixels 366 in parallel) when, for example, the techniques described above in conjunction with FIG. 28 are performed. Similarly, alteration to the column driver integrated circuit 368A and/or the row driver integrated circuit 368B may be performed (either via hardware or via the sense control signals 354 sent thereto) to allow for the column driver integrated circuit 368A and the row driver integrated circuit 368B to simultaneously drive each of the pixels 366 of a subset of the group 428 of pixels 366 in parallel.

### B. The Operational Variations

### 1. Low Visibility Display Sensing

A sensing scan of an active area of pixels may result in artifacts detected via emissive pixels that emit light during a sensing mode scan. Such artifacts may be more apparent during certain conditions, such as low ambient light and dim user interface (UI) content. Furthermore, when sensing during a scan, some pixels (e.g., green and blue pixels) may display a more apparent artifact than other pixels (e.g., red pixels). Thus, in conditions where artifacts are likely to be more apparent (e.g., low ambient light, dim UI, eye contact) pixels that are more likely to display a more apparent artifact are treated differently than pixels that are less likely to display an apparent artifact. For instance, the pixels that are less likely to display an apparent artifact may be sensed more strongly (e.g., higher sensing current) and/or may include sensing of more pixels per line during a scan. In some situations where artifacts are likely to be more visible, certain pixel colors that are more likely to display visible artifacts may not be sensed at all. Also, a scanning scheme may vary within a single screen based on UI content varying throughout the screen. Furthermore, accounting for potential visibility of artifacts may be ignored when no eyes are detected, are beyond a threshold distance from a screen, and/or are not directed at the screen since even apparent artifacts are unlikely to be seen if a user is too far from the screen or is not looking at the screen.

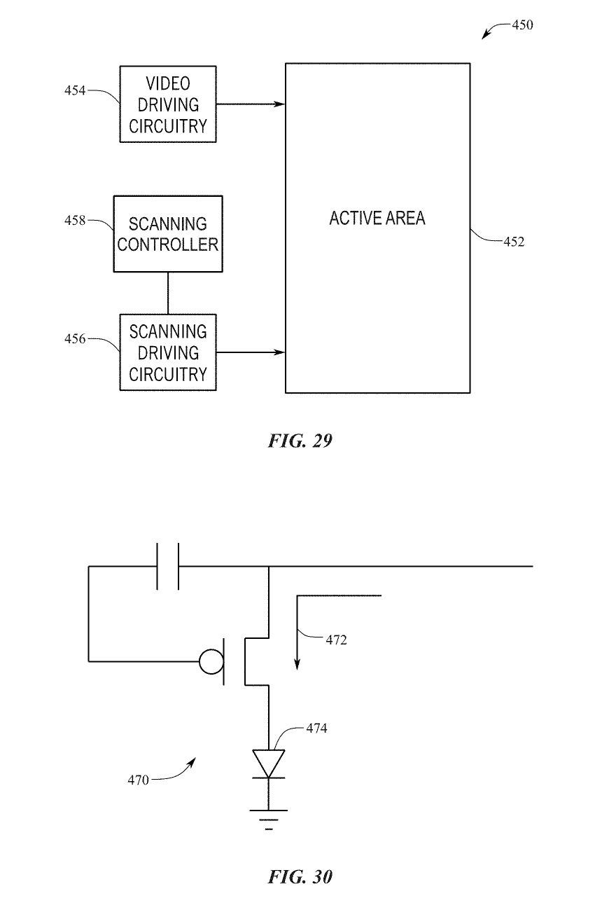

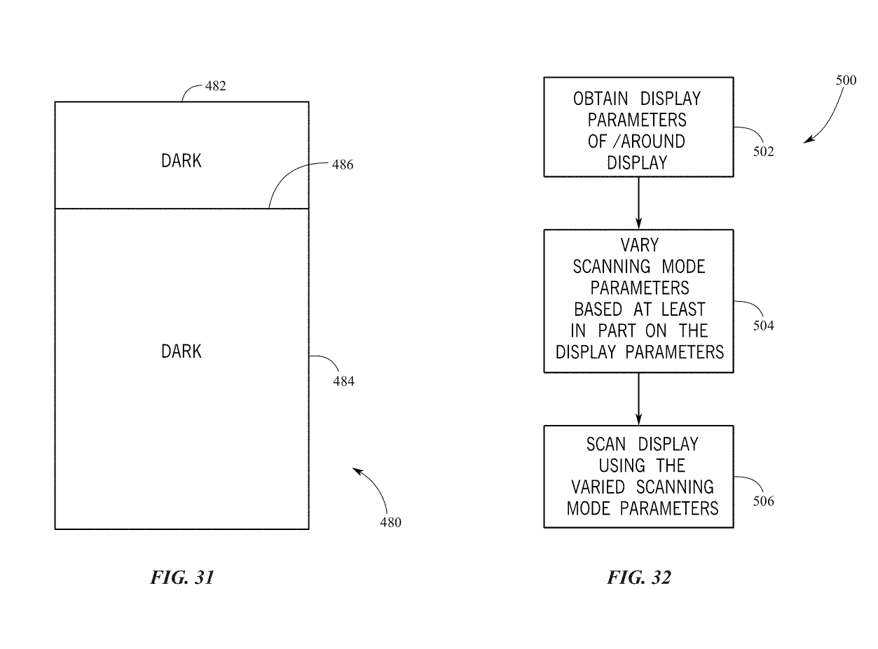

With the foregoing in mind, FIG. 29 illustrates a display system 450 that may be included in the display 18 be used to display and scan an active area 452 of the display 18. The display system 450 includes video driving circuitry 454 that drives circuitry in the active area 452 to display images. The display system 450 also includes scanning driving circuitry 456 that drives circuitry in the active area 452. In some embodiments, at least some of the components of the video driving circuitry 454 may be common to the scanning driving circuitry 456. Furthermore, some circuitry of the active area may be used both for displaying images and scanning. For example, pixel circuitry 470 of FIG. 30 may be driven, alternatingly, by the video driving circuitry 454 and the scanning driving circuitry 456. When a pixel current 472 is submitted to a light emitting diode (LED) 474 from the video driving circuitry 454 and the scanning driving circuitry 456, the LED 474 turns on. However, emission of the LED 474 during a scanning phase may result in artifacts. For example, FIG. 31 illustrates a screen 480 that is supposed to be dark during a scanning phase. However, during the scanning phase, the screen 480 may be divided into an upper dark section 482 and a lower dark section 484 by a line artifact 486 that is due to scanning pixels in a line during the scanning phase causing activation of pixels in the line. The visibility of the line artifact may vary based on various parameters for the scanning the display 18.

To reduce visibility of scans during the scanning mode, scanning controller 458 of FIG. 29 may control scanning mode parameters used to drive the scanning mode via the scanning driving circuitry 456. The scanning controller 458 may be embodied using software, hardware, or a combination thereof. For example, the scanning controller 458 may at least be partially embodied as the processors 12 using instructions stored in memory 14. FIG. 32 illustrates a process 500 that may be employed by the scanning controller 458. The scanning controller 458 obtains display parameters of or around the display 12/electronic device 10 (block 502). For example, the display parameters may include image data including pixel luminance (total luminance or by location), ambient light, image colors, temperature map of the screen 480, power remaining in the power source 28, and/or other parameters. Based at least in part on these parameters, the scanning controller 458 varies scanning mode parameters of the scanning mode (block 504). For example, the scanning controller 458 may vary the scanning frequency, scanning mode whether pixels of different colors are scanned simultaneously in a single pixel and/or in the same line, scanning location and corresponding scanning mode of pixels by location, and/or other parameters of scanning. Using the varied scanning mode parameters, the scanning controller 458 scans the active area 452 of the display 12 (block 506).

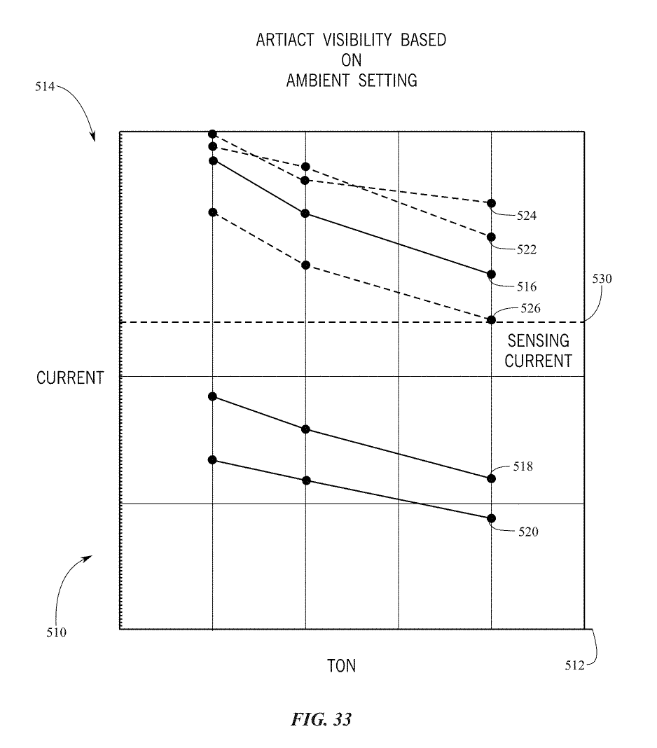

As an illustration of a change in visibility of a scanning mode, FIG. 33 illustrates maximum current that is substantially undetectable of a scanning mode relative to a color, an ambient light level, and a period of time that each LED emits. FIG. 33 includes a graph 510 that includes a horizontal axis 512 corresponding to a period of emission and a vertical axis 514 corresponding to a current level to control luminance of the respective LED. Furthermore, the graph 510 illustrates a difference in visibility due to changes in ambient light level.

Lines 516, 518, and 520 respectively correspond to detectable level of emission of red, blue, and green LEDs at a first level (e.g., 0 lux) of luminance of ambient light. Lines 522, 524, and 526 respectively correspond to visible emission of red, blue, and green LEDs at a second and higher level (e.g., 20 lux) of luminance of ambient light. As illustrated, red light is visible at a relatively similar current at both light levels. However, blue and green light visible at substantially lower current at the lower ambient light level. Furthermore, a sensing current 530 may be substantially above a maximum current at which the blue and green lights are visible at the lower level. Thus, red sensing may be on for temperature sensing and red pixel aging sensing regardless of ambient light level without risking detectability. However, blue and green light may be detectable at low ambient light if tested. Thus, the scanning controller 458 may disable blue and green sensing unless ambient light levels is above an ambient light threshold. Additionally or alternatively, a sensing strength (e.g., current, pixel density, duration, etc.) may be set based at least in part on ambient light.

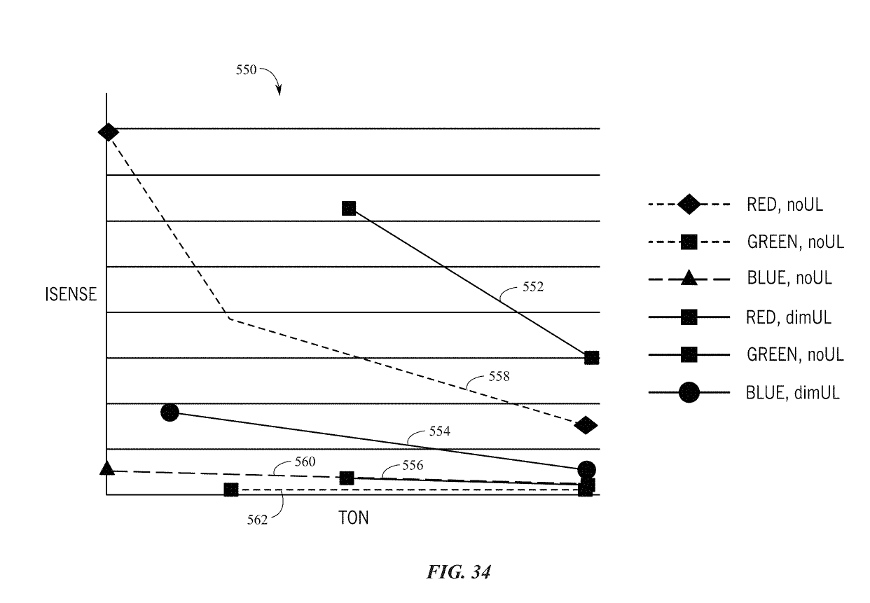

FIG. 34 illustrates a graph 550 reflecting permissibility of a sensing current before risking detectability of a scan/sense relative to a brightness level of the screen of the active area 452. Lines 552, 554, and 556 respectively correspond to an edge of a detectable level of emission of red, blue, and green LEDs at a first level of luminance (e.g., no user interface or dark screen) of the screen of the active area 452. Lines 558, 560, and 562 respectively correspond to an edge of a visible emission of red, blue, and green LEDs at a second and higher level of luminance (e.g., low luminance user interface) of the screen of the active area 452. As illustrated, red light is only visible at a relatively high current at both luminance levels. However, blue light and green light are both visible at substantially lower current at the both luminance levels. Based on the foregoing, red sensing may be on for temperature sensing, touch sensing, and red pixel aging sensing regardless of UI level without risking detectability. However, blue and green light may be detectable at dim UI levels, if tested. Thus, the scanning controller 458 may disable blue and green sensing unless UI luminance levels are above a UI light threshold or operate blue or green sensing with lower sensing levels or by skipping more pixels in a line during a sense/scan.

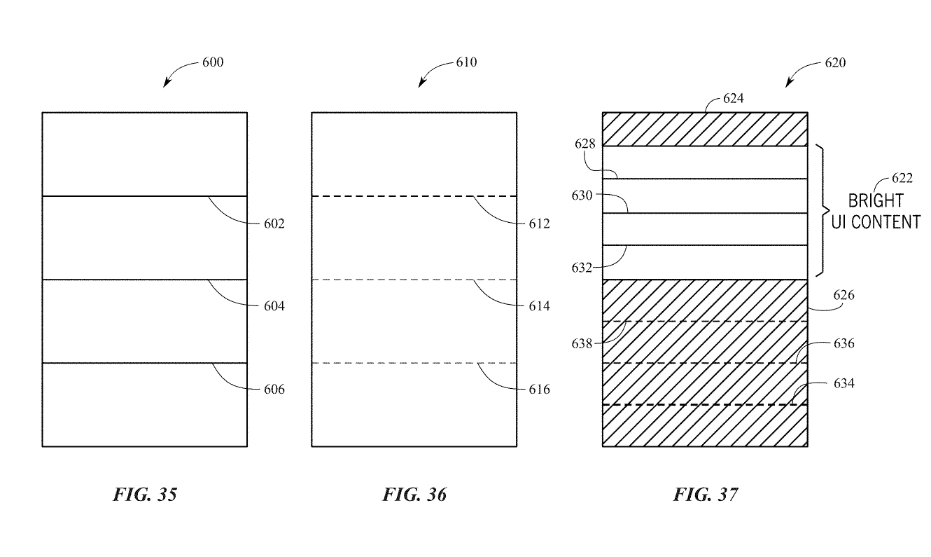

FIGS. 35-37 illustrate potential scanning schemes relative to parameters of the electronic device 10 and/or around the electronic device 10. The parameters may include ambient light levels, brightness of a user interface (UI), or other parameters. For example, the electronic device 10 may employ a first scanning scheme 600 where all pixels in a line (e.g., lines 602, 604, and 606) may be scanned in each scanning phase. This scheme may be deployed when relatively high ambient light is located around the electronic device 10 and/or when the display has bright luminance (e.g., bright UI). Furthermore, when using the scanning scheme 600, the electronic device 10 may employ a relatively high sensing level (e.g., higher sensing current) of each of the lines rather than a relatively low sensing level that may be used with low ambient light and/or low brightness UIs.

Moreover, in some embodiments, the lines 602, 604, and 606 may correspond to different color pixels being scanned. For example, the line 602 may correspond to a scan of red pixels, the line 604 may correspond to a scan of green pixels, and the line 606 may correspond to a scan of blue pixels. Furthermore, these different colors may be scanned using a similar scanning level or may deploy a scanning level that is based at least in part on visibility of the scan based on scanned color of pixel. For example, the line 602 may be scanned at a relatively high level with the line 604 scanned at a level near the same level. However, the line 606 may be scanned at a relatively lower level (e.g., lower sensing current) during the scan. Alternatively, in the high ambient light and/or bright UI conditions, all scans may be driven using a common level regardless of color being used to sense.

FIG. 36 illustrates a scanning scheme 610 that may be deployed when conditions differ from those used to display the scheme 600. For example, the scheme 610 may be used when ambient light levels and/or UI brightness levels are low. The scheme 600 includes varying how many pixels in a line are scanned in each pass. For instance, the lines 612, 614, and 616 may skip at least one pixel in the line when scanning a line for sensing. In some embodiments, an amount of pixels skipped in a scanning may depend on the color being used to scan the line, a sensing level of the scan, the ambient light level, UI brightness, and/or other factors. Additionally or alternatively, a sensing level may be adjusted inversely with the number of pixels skipped in the line.

The number of pixels skipped in a line may not be consistent between at least some of the scanned lines 612, 614, and 616. For example, more pixels may be skipped for colors (e.g., blue and green) that are more susceptible to being visible during a scan during low ambient light scans and/or dim UI scans. Additionally or alternatively, a sensing level may be inconsistent between at least some of the scanned lines 612, 614, and 616. For example, the line 612 may be scanned at a higher level (e.g., greater sensing current) than the lines 614 and 616 as reflected by the varying thickness of the lines in FIG. 36. In this example, the line 612 corresponds to a color (e.g., red) that is less susceptible to visibility during a scan than the colors (e.g., blue and green) of the lines 614 and 616. In some embodiments, the electronic device 10 may skip all pixels for more visible colors (e.g., blue and/or green) effectively reducing sensing level to zero (e.g., sensing current of 0 amps) for such colors.

As previously discussed, scanning of a screen may be varied as a function of UI brightness. However, this variation may also occur spatially throughout the UI. In other words, the scan may vary through various regions of content within a single screen. FIG. 37 illustrates a screen 620 that includes a brighter UI content region 622 surrounded by darker UI content regions 624 and 626. Scans of pixels in the brighter UI content region 622 may reflect the scheme 600 in FIG. 35. Specifically, the lines 628, 630, and 632 may correspond to the lines 602, 604, and 606, respectively.

In the darker UI regions 624 and 626, scanning may be treated differently. For example, lines 634, 636, and 638 may be treated similar to the lines 612, 614, and 616 of FIG. 36, respectively. Moreover, colors corresponding to more visible colors (e.g., blue and green) may be omitted entirely from scans of pixels in the darker UI regions 624 and 626.

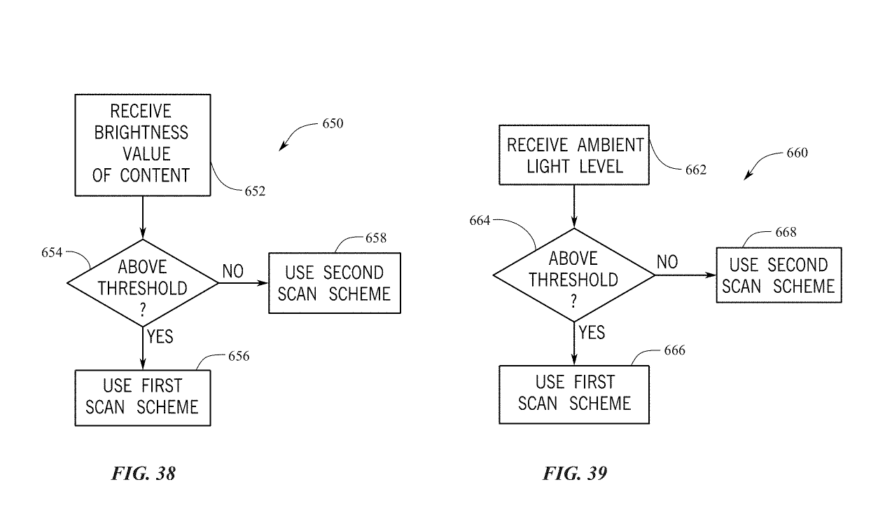

FIG. 38 illustrates a process 650 for selecting a scanning scheme for a display 18 of an electronic device 10 based at least in part on luminance of UI content. One or more processors 12 of the electronic device 10 receives a brightness value of content to be displayed on the display 18 (block 652). In some embodiments, the processors 12 may derive the brightness from video content by deriving luminance values from the video content. The processors 12 determine if the brightness value is above a threshold value (block 654). If the threshold is above a threshold value, the processors 12 uses a first scanning scheme to scan pixels of the display (block 656). The first scanning scheme may include scanning all colors at a same level or scanning at least a portion of colors at a reduced level. If the threshold is below the threshold value, the processors 12 uses a second scanning scheme to scan pixels of the display (block 658). If the first scanning scheme includes scanning all colors at a same level, the second scanning scheme includes using a first scanning level and/or frequency for a first color (e.g., red) and using a lower scanning level and/or lower scanning frequency for at least one other color (e.g., green and/or blue). If the first scanning scheme includes scanning at least a portion of colors at a reduced level, the second scanning scheme includes foregoing scanning of the portion of colors.

FIG. 39 illustrates a process 660 for selecting a scanning scheme for a display 18 of an electronic device 10 based at least in part on ambient light levels. A processors 12 of the electronic device 10 receives an ambient light level (block 662). In some embodiments, the processors 12 may receive the ambient light level from an ambient light sensor of the electronic device 10. The processors 12 determine if the ambient light level value is above a threshold value (block 664). If the threshold is above a threshold value, the processors 12 uses a first scanning scheme to scan pixels of the display (block 666). The first scanning scheme may include scanning all colors at a same level or scanning at least a portion of colors at a reduced level. If the threshold is below the threshold value, the processors 12 uses a second scanning scheme to scan pixels of the display (block 668). If the first scanning scheme includes scanning all colors at a same level, the second scanning scheme includes using a first scanning level and/or frequency for a first color (e.g., red) and using a lower scanning level and/or lower scanning frequency for at least one other color (e.g., green and/or blue). If the first scanning scheme includes scanning at least a portion of colors at a reduced level, the second scanning scheme includes foregoing scanning of the portion of colors. Furthermore, the scan scheme may vary by region within a display, as previously discussed regarding FIG. 37.

The processes 650 and 660 may be used in series to each other, such that the scanning scheme derived from a first process (e.g., process 650 or 660) may be then further modified by a second process (e.g., process 660 or 650). In some embodiments, some of the scanning schemes may be common to each process. For example, the processes may include a full scan scheme using all colors at same level and frequency, a reduced level or frequency for some colors, and a scheme omitting scans of at least one color. Furthermore, in some embodiments, one process may be applied to select whether to reduce a number of pixels scanned in a row while a different process may be applied to select levels at which pixels are to be scanned.

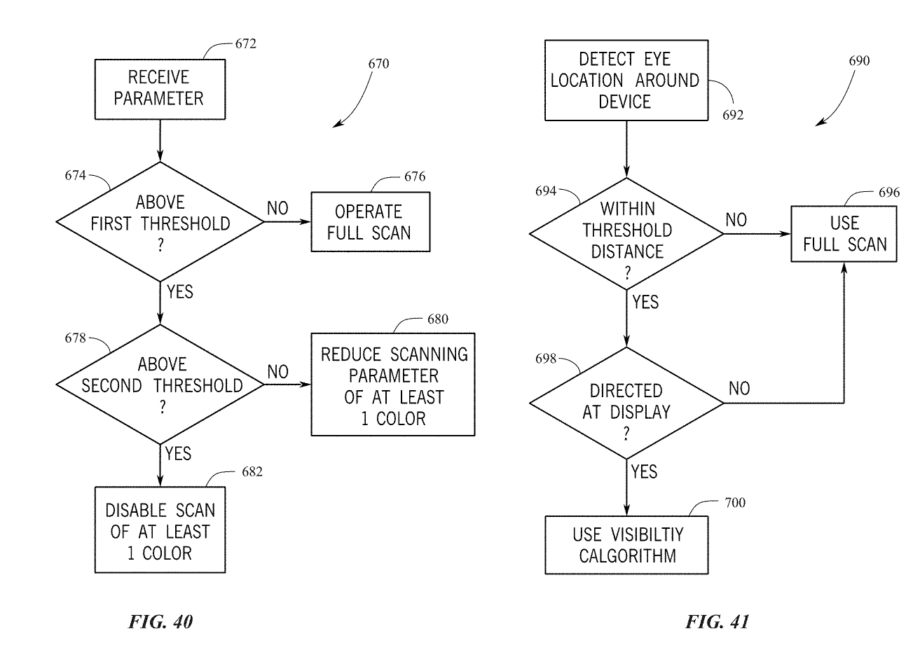

Furthermore, each process previously discussed may include more than a single threshold. FIG. 40 illustrates a process 670 that includes multiple thresholds. The processors 12 receive a parameter, such as ambient light levels, UI brightness, eye locations, and/or other factors around the electronic device 10 (block 672). The processors 12 determine whether the parameter is above a first threshold (block 674). If the parameter is above the first threshold, a full scan mode is used (block 676). A full scan may include using pixels of all colors at a common level. If the parameter is not above the first threshold, the processors 12 determine whether the parameter is above a second threshold (block 678). If the parameter is above the second threshold, the processors 12 cause a scan of the display using a reduced scanning parameter of at least one color for at least corresponding portion of the display (block 680). For example, the scanning scheme for a reduced scanning parameter may include a decreased frequency and/or sensing level from the frequency and/or sensing level used for the full scan. If the parameter is above the third threshold, the processors 12 disable scanning of the at least one color for the relative portions of the screen (block 682).

Visibility of a scan may be dependent upon ambient light levels and/or UI content when eyes are viewing the display. However, if no eyes are viewing the display 18, a scan may not be visible regardless of levels, frequency, or colors used to scan. Thus, the processors 12 may use eye detection to determine whether visibility reduction should be deployed. Eye tracking may be implemented using the camera of the electronic device and software running on the processors. Additionally or alternatively, any suitable eye tracking techniques and/or systems may be used to implement such eye tracking, such as eye tracking solutions provided by iMotions, Inc. of Boston, Mass. FIG. 41 illustrates a process 690 for determining whether to reduce visibility of a scan for a display 18. The processors 12 determine eye location around a device (block 692). For example, the location may be indicative of a distance from the display 18 and/or an orientation (e.g., direction of gaze) of the eyes. The processors 12 may determine such eye locations using a camera of the electronic device 10. The processors 12 determine whether the location is within a threshold distance of the display 18 (block 694). If the eye location is outside a threshold distance, the processors 12 use a full scan to scan the display 18 (block 696). Furthermore, if no eyes are detected, the location may be assumed to be greater than the threshold distance. If the eye location is within the threshold distance, the processors 12 determine whether a direction of gaze of the eyes is directed at the display 18 (block 698). If the direction is oriented toward the display, the processors 12 may scan the display 18 using a visibility algorithm (block 700). The visibility algorithm may pertain to or include the processes 650 and/or 660.

2. Display Panel Adjustment from Temperature Prediction

Display panel sensing involves programming certain pixels with test data and measuring a response by the pixels to the test data. The response by a pixel to test data may indicate how that pixel will perform when programmed with actual image data. In this disclosure, pixels that are currently being tested using the test data are referred to as “test pixels” and the response by the test pixels to the test data is referred to as a “test signal.” The test signal is sensed from a “sense line” of the electronic display. In some cases, the sense line may serve a dual purpose on the display panel. For example, data lines of the display that are used to program pixels of the display with image data may also serve as sense lines during display panel sensing.

Under certain conditions, display panel sensing may be too slow to identify operational variations due to thermal variations on an electronic display. For instance, when a refresh rate of the electronic display is set to a low refresh rate to save power, it is possible that portions of the electronic display could change temperature faster than could be detected through display panel sensing. To avoid visual artifacts that could occur due to these temperature changes, a predicted temperature effect may be used to adjust the operation of the electronic display.

In one example, an electronic device may store a prediction lookup table associated with independent heat-producing components of the electronic device that may create temperature variations on the electronic display. These heat-producing components could include, for example, a camera and its associated image signal processing (ISP) circuitry, wireless communication circuitry, data processing circuitry, and the like. Since these heat-producing components may operate independently, there may be a different heat source prediction lookup table for each one. In some cases, an abbreviated form of display panel sensing may be performed in which a reduced number of areas of the display panel are sensed. The reduced number of areas may correspond to portions of the display panel that are most likely to be affected by each heat source. In this way, a maximum temperature effect that may be indicated by the heat source predication lookup tables may be compared to actual sensed conditions on the electronic display and scaled accordingly. The individual effects of the predictions of the individual heat source lookup tables may be additively combined into a correction lookup table to correct for image display artifacts due to heat from the various independent heat sources.

In addition, the image content itself that is displayed on a display could cause a local change in temperature when content of an image frame changes. For example, when a dark part of an image being displayed on the electronic display suddenly becomes very bright, that part of the electronic display may rapidly increase in temperature. Likewise, when a bright part of an image being displayed on the electronic display suddenly becomes very dark, that part of the electronic display may rapidly decrease in temperature. If these changes in temperature occur faster than would be identified by display panel sensing, display panel sensing alone may not adequately identify and correct for the change in temperature due to the change in image content.

Accordingly, this disclosure also discusses taking corrective action based on temperature changes due to changes in display panel content. For instance, blocks of the image frames to be displayed on the electronic display may be analyzed for changes in content from frame to frame. Based on the change in content, a rate of change in temperature over time may be predicted. The predicted rate of the temperature change over time may be used to estimate when the change in temperature is likely to be substantial enough to produce a visual artifact on the electronic display. Thus, to avoid displaying a visual artifact, the electronic display may be refreshed sooner that it would have otherwise been refreshed to allow the display panel to display new image data that has been adjusted to compensate for the new display temperature.

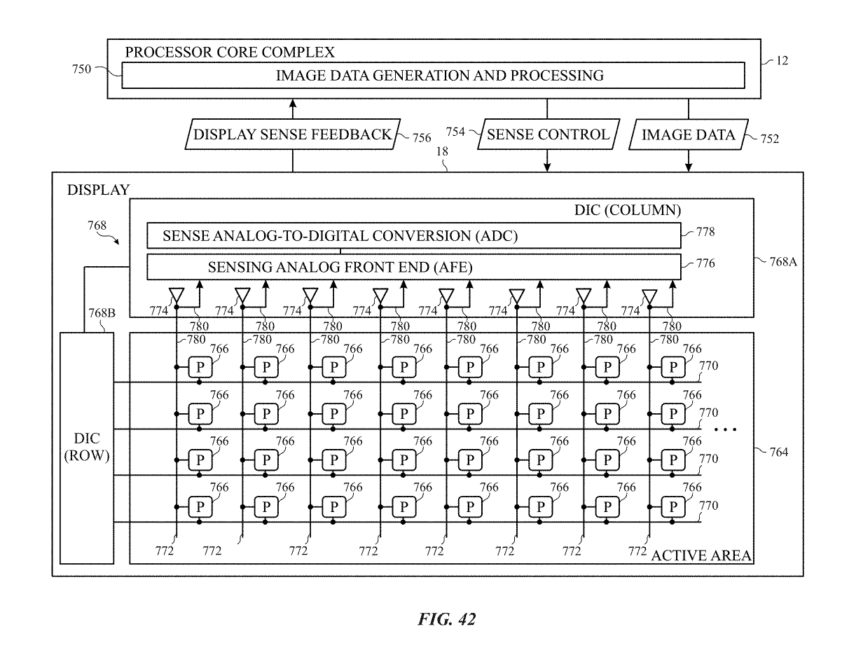

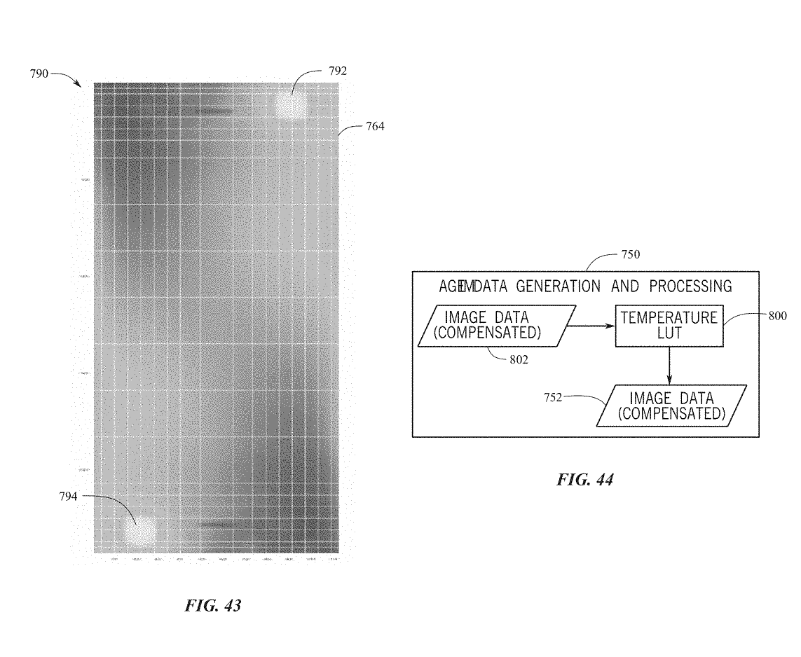

As shown in FIG. 42, in the various embodiments of the electronic device 10, the processor core complex 12 may perform image data generation and processing 750 to generate image data 752 for display by the electronic display 18. The image data generation and processing 750 of the processor core complex 12 is meant to represent the various circuitry and processing that may be employed by the core processor 12 to generate the image data 752 and control the electronic display 18. Since this may include compensating the image data 752 based on operational variations of the electronic display 18, the processor core complex 12 may provide sense control signals 754 to cause the electronic display 18 to perform display panel sensing to generate display sense feedback 756. The display sense feedback 756 represents digital information relating to the operational variations of the electronic display 18. The display sense feedback 756 may take any suitable form, and may be converted by the image data generation and processing 750 into a compensation value that, when applied to the image data 752, appropriately compensates the image data 752 for the conditions of the electronic display 18. This results in greater fidelity of the image data 752, reducing or eliminating visual artifacts that would otherwise occur due to the operational variations of the electronic display 18.

The electronic display 18 includes an active area or display panel 764 with an array of pixels 766. The pixels 766 are schematically shown distributed substantially equally apart and of the same size, but in an actual implementation, pixels of different colors may have different spatial relationships to one another and may have different sizes. In one example, the pixels 766 may take a red-green-blue (RGB) format with red, green, and blue pixels, and in another example, the pixels 766 may take a red-green-blue-green (RGBG) format in a diamond pattern. The pixels 766 are controlled by a driver integrated circuit 768, which may be a single module or may be made up of separate modules, such as a column driver integrated circuit 768A and a row driver integrated circuit 768B. The driver integrated circuit 768 (e.g., 768B) may send signals across gate lines 770 to cause a row of pixels 766 to become activated and programmable, at which point the driver integrated circuit 768 (e.g., 768A) may transmit image data signals across data lines 772 to program the pixels 766 to display a particular gray level (e.g., individual pixel brightness). By supplying different pixels 766 of different colors with image data to display different gray levels, full-color images may be programmed into the pixels 766. The image data may be driven to an active row of pixel 766 via source drivers 774, which are also sometimes referred to as column drivers.

As mentioned above, the pixels 766 may be arranged in any suitable layout with the pixels 766 having various colors and/or shapes. For example, the pixels 766 may appear in alternating red, green, and blue in some embodiments, but also may take other arrangements. The other arrangements may include, for example, a red-green-blue-white (RGBW) layout or a diamond pattern layout in which one column of pixels alternates between red and blue and an adjacent column of pixels are green. Regardless of the particular arrangement and layout of the pixels 766, each pixel 766 may be sensitive to changes on the active area 764 of the electronic display 18, such as variations and temperature of the active area 764, as well as the overall age of the pixel 766. Indeed, when each pixel 766 is a light emitting diode (LED), it may gradually emit less light over time. This effect is referred to as aging, and takes place over a slower time period than the effect of temperature on the pixel 766 of the electronic display 18.

Display panel sensing may be used to obtain the display sense feedback 756, which may enable the processor core complex 12 to generate compensated image data 752 to negate the effects of temperature, aging, and other variations of the active area 764. The driver integrated circuit 768 (e.g., 768A) may include a sensing analog front end (AFE) 776 to perform analog sensing of the response of pixels 766 to test data. The analog signal may be digitized by sensing analog-to-digital conversion circuitry (ADC) 778.

For example, to perform display panel sensing, the electronic display 18 may program one of the pixels 766 with test data. The sensing analog front end 776 then senses a sense line 780 of connected to the pixel 766 that is being tested. Here, the data lines 772 are shown to act as the sense lines 780 of the electronic display 18. In other embodiments, however, the display active area 764 may include other dedicated sense lines 780 or other lines of the display may be used as sense lines 780 instead of the data lines 772. Other pixels 766 that have not been programmed with test data may be sensed at the same time a pixel that has been programmed with test data. Indeed, by sensing a reference signal on a sense line 780 when a pixel on that sense line 780 has not been programmed with test data, a common-mode noise reference value may be obtained. This reference signal can be removed from the signal from the test pixel that has been programmed with test data to reduce or eliminate common mode noise.

The analog signal may be digitized by the sensing analog-to-digital conversion circuitry 778. The sensing analog front end 776 and the sensing analog-to-digital conversion circuitry 778 may operate, in effect, as a single unit. The driver integrated circuit 768 (e.g., 768A) may also perform additional digital operations to generate the display feedback 756, such as digital filtering, adding, or subtracting, to generate the display feedback 756, or such processing may be performed by the processor core complex 12.

A variety of sources can produce heat that could cause a visual artifact to appear on the electronic display 18 if the image data 752 is not compensated for the thermal variations on the electronic display 18. For example, as shown in a thermal diagram 790 of FIG. 43, the active area 764 of the electronic display 18 may be influenced by a number of different nearby heat sources. For example, the thermal map 790 for FIG. 43 illustrates the effect of two heat sources that create high local distributions of heat 792 and 794 on the active area 764. These heat sources 792 and 794 may be any heat-producing electronic component, such as the processor core complex 12, camera circuitry, or the like, that generate heat in a predictable pattern on the electronic display 18.

As shown in FIG. 44, the effects of the heat variation caused by the heat sources 792 and 794 may be corrected using the image data generation and processing system 750 of the processor core complex 12. For example, uncompensated image data 802 may be indexed to a temperature lookup table 800, which contains a correction factor to apply to each pixel 766 of the electronic display 18 that would prevent visual artifacts due to thermal variations on the active area 764 of the electronic display 18. Thus, the temperature lookup table (LUT) 800 may operate as a correction LUT (e.g., a two-dimensional lookup table) is used to obtain compensated image data 752. Although not shown in particular in FIG. 44, it should be appreciated that the temperature lookup table (LUT) 800 may represent a table of coefficient values to apply to the uncompensated image data 802. The compensated image data 752 may be obtained when the coefficient values from the temperature lookup table (LUT) 800 are applied to the uncompensated image data 802.

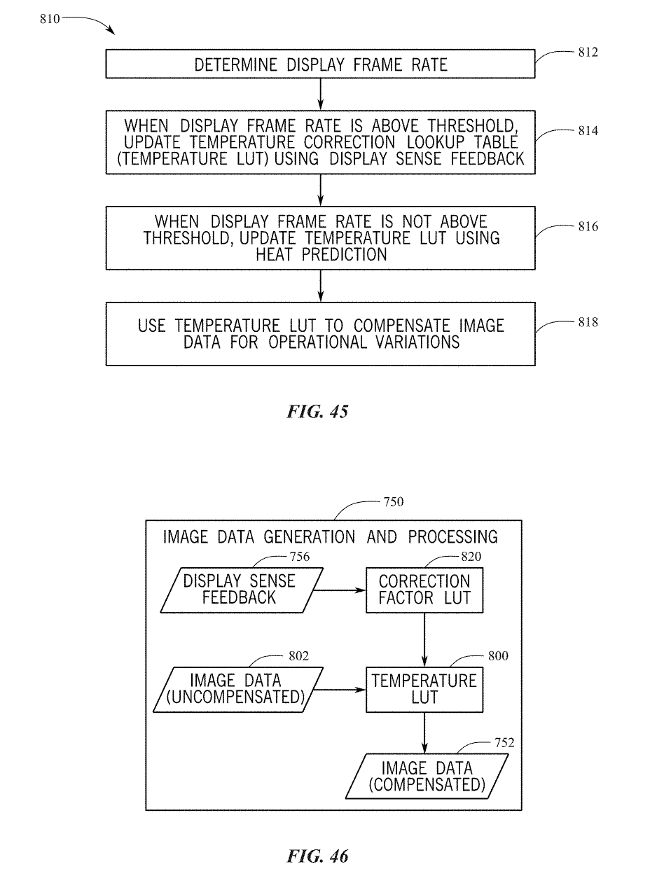

Because the amount of heating on the active area 764 of the electronic display 18 may change faster than could be updated using display panel sensing to update the temperature lookup table (LUT) 800, in some embodiments, predictive compensation may be performed based on the current frame rate of the electronic display 18. However, it should be understood that, in other embodiments, predictive compensation may be performed at all times or when activated by the processor core complex 12. An example of determining to perform predictive compensation based on the current frame rate of the electronic display 18 is shown by a flowchart 810 of FIG. 45. In the flowchart 810, the processor core complex 12 may determine the current display frame rate on the electronic display 18 (block 812). When the display frame rate is above some threshold frame rate indicating that the temperature lookup table (LUT) 800 could be updated quickly enough using display panel sensing alone, the processor core complex 12 may update the temperature correction lookup table (LUT) 800 using the display sense feedback (block 814). When the display frame rate is not above the threshold, the processor core complex 12 may update the temperature lookup table (LUT) 800 at least in part using heat predication on the electronic display due to heat sources (e.g., heat sources 792 and 794) or changes in content (block 816). In either case, the processor core complex 12 may use the temperature lookup table (LUT) 800 to obtain compensated image data 752 to account for operational variations of the electronic display 18 caused by heat variations across the electronic display 18.

FIG. 46 illustrates a system for updating the temperature lookup table (LUT) 800 based on display sense feedback 756 or in the image data generation processing system 750 of the processor core complex 12. In the example of FIG. 46, display sense feedback 756 from the electronic display 18 may be provided to a correction factor lookup table 820 that may transform the values of the display based feedback 756 into corresponding values representing a correction factor that, when applied to the uncompensated image data 802, would result in the compensated image data 32. The display sense feedback 756 may represent display panel sensing from various locations in the active area 764 of the electronic display. When the refresh rate is high enough, the display sense feedback is able to cover enough of the spatial locations on the active area 764 of the electronic display 18 to enable the temperature lookup table (LUT) 800 to be accurate.

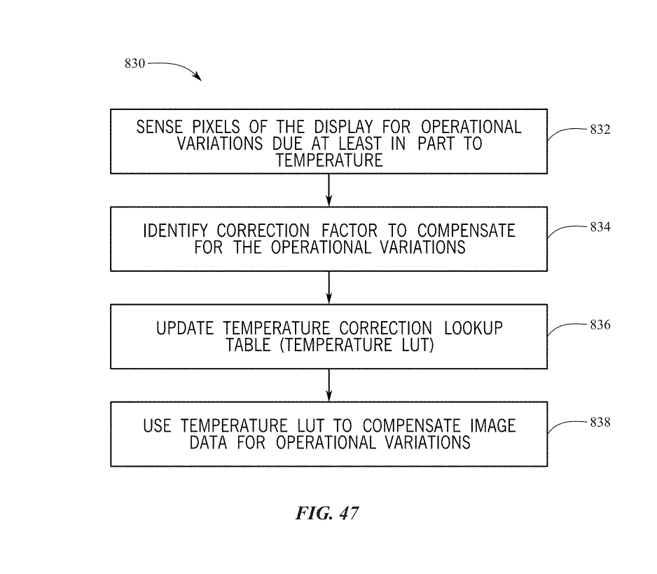

Indeed, as shown in a flowchart 830 of FIG. 47, the electronic display may sense pixels 766 of the active area 764 of the display to obtain indications of operational variations due at least in part to temperature (block 832), which is shown in FIG. 46 as the display sense feedback 756. The display sense feedback 756 may be converted to an appropriate correction factor that would compensate for the operational variations (block 834). These correction factors may be used to update the temperature lookup table (LUT) 800 (block 836). Thereafter, the temperature lookup table (LUT) 800 may be used to compensate the uncompensated image data 802 to obtain the compensated image data 752 (block 838).

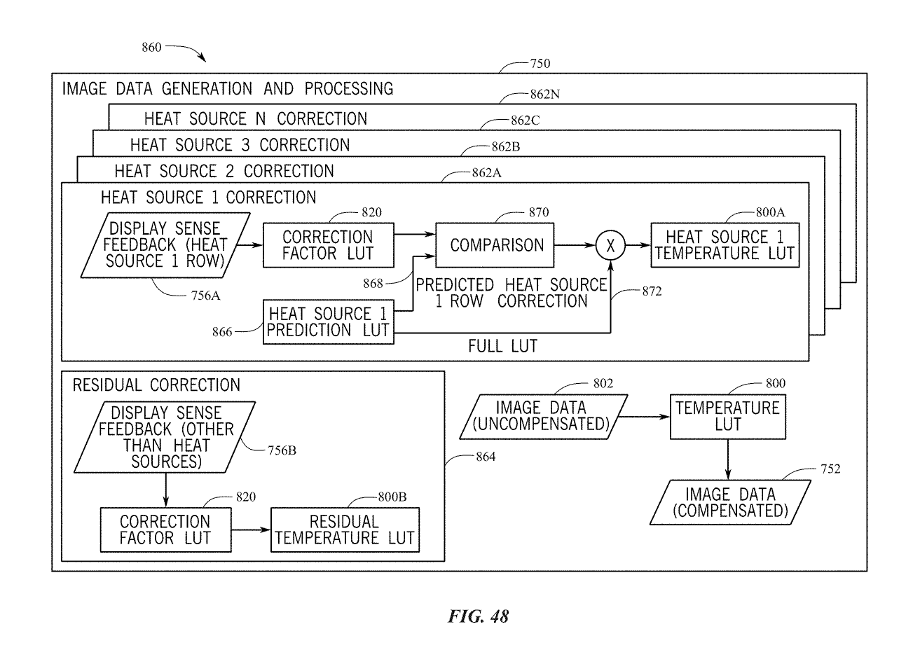

A predictive heat correction system 860 is shown in a block diagram of FIG. 48. The predictive heat correction system 860 may be carried out using any suitable circuitry and/or processing components. In one example, the predictive heat correction system 860 is carried out within image data and image data generation and processing system 750 of the processor core complex 12. The predictive heating correction system 860 may include heat source correction loops 862 for any suitable number of independent heat sources that may be present near the electronic display 18. Here, there are N heat sources that are being corrected for, so there are N heat source correction loops 862: a first heat source correction loop 862A, second heat source correction loop 862B, third heat source correction loop 862C, and Nth heat source correction loop 862N. Each of the heat source correction loops 862 may be used to update the temperature lookup table (LUT) 800 to correct for thermal or aging variations on the active area 764 on the electronic display 18. There may be some amount of residual correction from parts of the active area 764 other than where the heat sources are located that may be adjusted through a residual correction loop 864.

Each heat source correction loop 862 may have an operation that is similar to the first heat source correction loop 862A, but which relates to a different heat source. That is, each heat source loop 862 can be used to correct for visual artifacts that can be used to update the temperature lookup table (LUT) 800 to correct for artifacts due to that particular heat source (but not other heat sources). Thus, referring particularly to the first heat source correction loop 862A, a first heat source prediction lookup table (LUT) 866 may be used to update the temperature lookup table (LUT) 800 for a particular reference value of the amount of heat being emitted by the first heat source (e.g., heat source 792). Yet because the amount of heat emitted by the first heat source to account for the variations in the amount of heat that could be emitted by the first heat source (e.g., heat source 792), the first heat source prediction lookup table (LUT) 866 can be scaled up or down depending how closely the first heat source prediction lookup table (LUT) 866 matches current conditions on the active area 764.

The first heat source correction loop 862A may receive a reduced form of display sense feedback 756A at least from pixels that are located on the active area 764 where the first heat source will most prominently affect the active area 764. The display sense feedback 756A may be an average, for example of multiple pixels 766 that have been sensed on the active area 764. In the particular example shown in FIG. 48, the display sense feedback 756A is an average of a row of pixels 766 that is most greatly affected by the first heat source. The display sense feedback 756A may be converted to a correction factor by the correction factor LUT 820. Meanwhile, a first heat source prediction lookup table 866 may provide a predicted first heat source correction value 868 from the same row as the display sense feedback 756A, which may be compared to the display sense feedback 756A in comparison logic 870. The first heat source prediction LUT 866 may contain a table of correction factors that would enable the uncompensated image data 802 to be converted to compensated image data 752 when the heat from the first heat source (e.g., heat source 792) is at a particular level. In one example, the first heat source prediction LUT 866 may contain a table of correction factors 872 for a maximum amount of heat or maximum temperature due to the first heat source.

Since the amount of correction that may be used to correct from the first heat source may scale with this amount of heat, the values of the first heat source prediction LUT 866 may be scaled based on the comparison of the values from the display sense feedback 756A and the predicted first heat source correction value 868 from the same row as the display sense feedback 756A. This comparison may identify a relationship between the predicted heat source row correction values (predicted first heat source correction value 868) and the measured first heat source row correction values (display sense feedback 756A) to obtain a scaling factor “a”. The entire set of values of the first heat source prediction lookup table 866 may be scaled by the scaling factor “a” and applied to a first heat source temperature lookup table (LUT) 800A. Each of the other heat source correction loops 862B, 862C, . . . 862N may similarly populate a respective heat source temperature lookup tables (not shown) similar to the first heat source temperature lookup table (LUT) 800A, which may be added together into the overall temperature lookup table (LUT) 800 that is used to compensate the image data 802 to obtain the compensated image data 752.

Additional corrections may be made using the residual correction loop 864. The residual correction loop 864 may receive other display sense feedback 756B that may be from a location on the active area 764 of the electronic display 18 other than one that is most greatly affected by one of the heat sources 1, 2, 3, . . . N. The display sense feedback 756B may be converted to appropriate correction factor(s) using the correction factor LUT 820 and these correction factors may be used to populate a temperature lookup table (LUT) 800B, which may also be added to the overall temperature lookup table (LUT) 800.

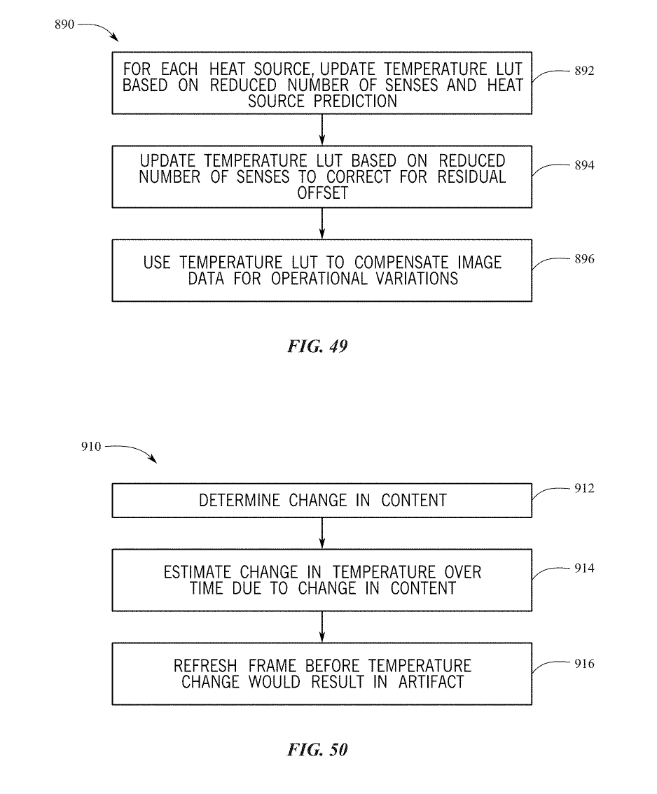

To summarize, as shown by a flowchart 890 of FIG. 49, the temperature lookup table (LUT) 800 may be updated to account for each heat source based on a reduced number of display panel senses and the heat source prediction associated with that heat source (block 892). A residual offset may also be used to update the temperature lookup table (LUT) 800 using a number of senses obtained from a part of the active area 764 of the electronic display 18 that is not most greatly affected by any of the heat sources (block 894). The updated temperature lookup table (LUT) 800 may be used to compensate image data 802 to obtain compensated image data 752 that is compensated for operational variations that is due to the heat sources affecting the electronic display 18 (block 896).

### C. Performing the Sensing Operation

### 1. Current-Based Sensing

Display panel sensing involves programming certain pixels with test data and measuring a response by the pixels to the test data. The response by a pixel to test data may indicate how that pixel will perform when programmed with actual image data. In this disclosure, pixels that are currently being tested using the test data are referred to as “test pixels” and the response by the test pixels to the test data is referred to as a “test signal.” The test signal is sensed from a “sense line” of the electronic display and may be a voltage or a current, or both a voltage and a current. In some cases, the sense line may serve a dual purpose on the display panel. For example, data lines of the display that are used to program pixels of the display with image data may also serve as sense lines during display panel sensing.

To sense the test signal, it may be compared to some reference value. Although the reference value could be static—referred to as “single-ended” testing using a static reference value may cause too much noise to remain in the test signal. Indeed, the test signal often contains both the signal of interest, which may be referred to as the “pixel operational parameter” or “electrical property” that is being sensed, as well as noise due to any number of electromagnetic interference sources near the sense line. This disclosure provides a number of systems and methods for mitigating the effects of noise on the sense line that contaminate the test signal. These include, for example, differential sensing (DS), difference-differential sensing (DDS), correlated double sampling (CDS), and programmable capacitor matching. These various display panel sensing systems and methods may be used individually or in combination with one another.

Differential sensing (DS) involves performing display panel sensing not in comparison to a static reference, as is done in single-ended sensing, but instead in comparison to a dynamic reference. For example, to sense an operational parameter of a test pixel of an electronic display, the test pixel may be programmed with test data. The response by the test pixel to the test data may be sensed on a sense line (e.g., a data line) that is coupled to the test pixel. The sense line of the test pixel may be sensed in comparison to a sense line coupled to a reference pixel that was not programmed with the test data. The signal sensed from the reference pixel does not include any particular operational parameters relating to the reference pixel in particular, but rather contains common-noise that may be occurring on the sense lines of both the test pixel and the reference pixel. In other words, since the test pixel and the reference signal are both subject to the same system-level noise—such as electromagnetic interference from nearby components or external interference—differentially sensing the test pixel in comparison to the reference pixel results in at least some of the common-mode noise subtracted away from the signal of the test pixel.

Difference-differential sensing (DDS) involves differentially sensing two differentially sensed signals to mitigate the effects of remaining differential common-mode noise. Thus, a differential test signal may be obtained by differentially sensing a test pixel that has been programmed with test data and a reference pixel that has not been programmed with test data, and a differential reference signal may be obtained by differentially sensing two other reference pixels that have not been programmed with the test data. The differential test signal may be differentially compared to the differential reference signal, which further removes differential common-mode noise.

Correlated double sampling (CDS) involves performing display panel sensing at least two different times and digitally comparing the signals to remove temporal noise. At one time, a test sample may be obtained by performing display panel sensing on a test pixel that has been programmed with test data. At another time, a reference sample may be obtained by performing display panel sensing on the same test pixel but without programming the test pixel with test data. Any suitable display panel sensing technique may be performed, such as differential sensing or difference-differential sensing, or even single-ended sensing. There may be temporal noise that is common to both of the samples. As such, the reference sample may be subtracted out of the test sample to remove temporal noise.

Programmable integration capacitance may further reduce the impact of display panel noise. In particular, different sense lines that are connected to a particular sense amplifier may have different capacitances. These capacitances may be relatively large. To cause the sense amplifier to sensing signals on these sense lines as if the sense line capacitances were equal, the integration capacitors may be programmed to have the same ratio as the ratio of capacitances on the sense lines. This may account for noise due to sense line capacitance mismatch.

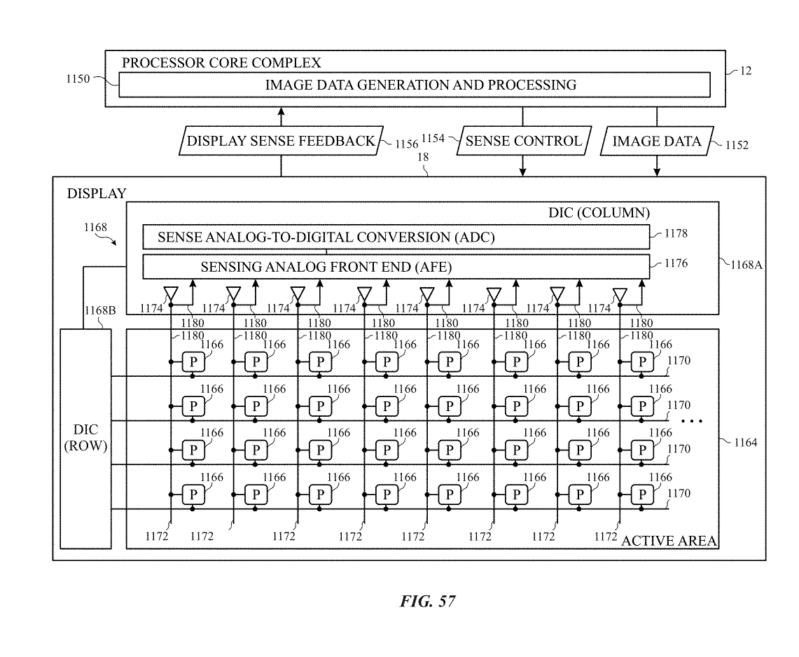

As shown in FIG. 57, in the various embodiments of the electronic device 10, the processor core complex 12 may perform image data generation and processing 1150 to generate image data 1152 for display by the electronic display 18. The image data generation and processing 1150 of the processor core complex 12 is meant to represent the various circuitry and processing that may be employed by the core processor 12 to generate the image data 1152 and control the electronic display 18. Since this may include compensating the image data 1152 based on operational variations of the electronic display 18, the processor core complex 12 may provide sense control signals 1154 to cause the electronic display 18 to perform display panel sensing to generate display sense feedback 1156. The display sense feedback 1156 represents digital information relating to the operational variations of the electronic display 18. The display sense feedback 1156 may take any suitable form, and may be converted by the image data generation and processing 1150 into a compensation value that, when applied to the image data 1152, appropriately compensates the image data 1152 for the conditions of the electronic display 18. This results in greater fidelity of the image data 1152, reducing or eliminating visual artifacts that would otherwise occur due to the operational variations of the electronic display 18.

The electronic display 18 includes an active area 1164 with an array of pixels 1166. The pixels 1166 are schematically shown distributed substantially equally apart and of the same size, but in an actual implementation, pixels of different colors may have different spatial relationships to one another and may have different sizes. In one example, the pixels 1166 may take a red-green-blue (RGB) format with red, green, and blue pixels, and in another example, the pixels 1166 may take a red-green-blue-green (RGBG) format in a diamond pattern. The pixels 1166 are controlled by a driver integrated circuit 1168, which may be a single module or may be made up of separate modules, such as a column driver integrated circuit 1168A and a row driver integrated circuit 1168B. The driver integrated circuit 1168 may send signals across gate lines 1170 to cause a row of pixels 1166 to become activated and programmable, at which point the driver integrated circuit 1168 (e.g., 1168A) may transmit image data signals across data lines 1172 to program the pixels 1166 to display a particular gray level. By supplying different pixels 1166 of different colors with image data to display different gray levels or different brightness, full-color images may be programmed into the pixels 1166. The image data may be driven to an active row of pixel 1166 via source drivers 1174, which are also sometimes referred to as column drivers.

As mentioned above, the pixels 1166 may be arranged in any suitable layout with the pixels 1166 having various colors and/or shapes. For example, the pixels 1166 may appear in alternating red, green, and blue in some embodiments, but also may take other arrangements. The other arrangements may include, for example, a red-green-blue-white (RGBW) layout or a diamond pattern layout in which one column of pixels alternates between red and blue and an adjacent column of pixels are green. Regardless of the particular arrangement and layout of the pixels 1166, each pixel 1166 may be sensitive to changes on the active area 1164 of the electronic display 18, such as variations and temperature of the active area 1164, as well as the overall age of the pixel 1166. Indeed, when each pixel 1166 is a light emitting diode (LED), it may gradually emit less light over time. This effect is referred to as aging, and takes place over a slower time period than the effect of temperature on the pixel 1166 of the electronic display 18.

Display panel sensing may be used to obtain the display sense feedback 1156, which may enable the processor core complex 12 to generate compensated image data 1152 to negate the effects of temperature, aging, and other variations of the active area 1164. The driver integrated circuit 1168 (e.g., 1168A) may include a sensing analog front end (AFE) 1176 to perform analog sensing of the response of pixels 1166 to test data. The analog signal may be digitized by sensing analog-to-digital conversion circuitry (ADC) 1178.

For example, to perform display panel sensing, the electronic display 18 may program one of the pixels 1166 with test data. The sensing analog front end 1176 then senses a sense line 1180 of connected to the pixel 1166 that is being tested. Here, the data lines 1172 are shown to act as the sense lines 1180 of the electronic display 18. In other embodiments, however, the display active area 1164 may include other dedicated sense lines 1180 or other lines of the display may be used as sense lines 1180 instead of the data lines 1172. Other pixels 1166 that have not been programmed with test data may be sensed at the same time a pixel that has been programmed with test data. Indeed, as will be discussed below, by sensing a reference signal on a sense line 1180 when a pixel on that sense line 1180 has not been programmed with test data, a common-mode noise reference value may be obtained. This reference signal can be removed from the signal from the test pixel that has been programmed with test data to reduce or eliminate common mode noise.

The analog signal may be digitized by the sensing analog-to-digital conversion circuitry 1178. The sensing analog front end 1176 and the sensing analog-to-digital conversion circuitry 1178 may operate, in effect, as a single unit. The driver integrated circuit 1168 (e.g., 1168A) may also perform additional digital operations to generate the display feedback 1156, such as digital filtering, adding, or subtracting, to generate the display feedback 1156, or such processing may be performed by the processor core complex 12.

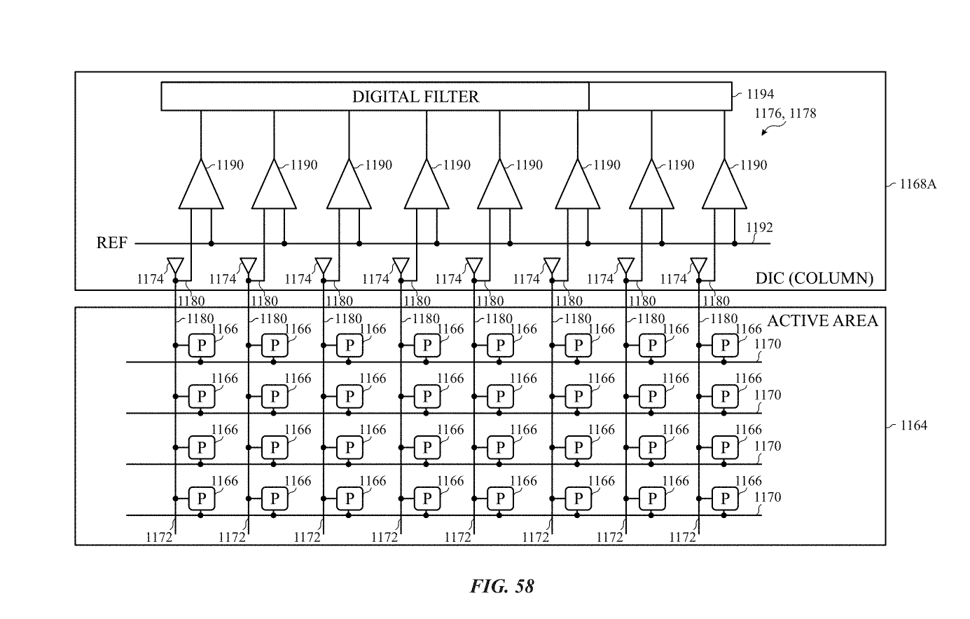

FIG. 58 illustrates a single-ended approach to display panel sensing. Namely, the sensing analog front end 1176 and the sensing analog-to-digital conversion circuitry 1178 may be represented schematically by sense amplifiers 1190 that differentially sense a signal from the sense lines 1180 (here, the data lines 1172) in comparison to a static reference signal 1192 and output a digital value. It should be appreciated that, in FIG. 58 as well as other figures of this disclosure, the sense amplifiers 1190 are intended to represent both analog amplification circuitry and/or the sense analog to digital conversion (ADC) circuitry 1178. Whether the sense amplifiers 1190 represent analog or digital circuitry, or both, may be understood through the context of other circuitry in each figure. A digital filter 1194 may be used to digitally process the resulting digital signals obtained by the sense amplifiers 1190.

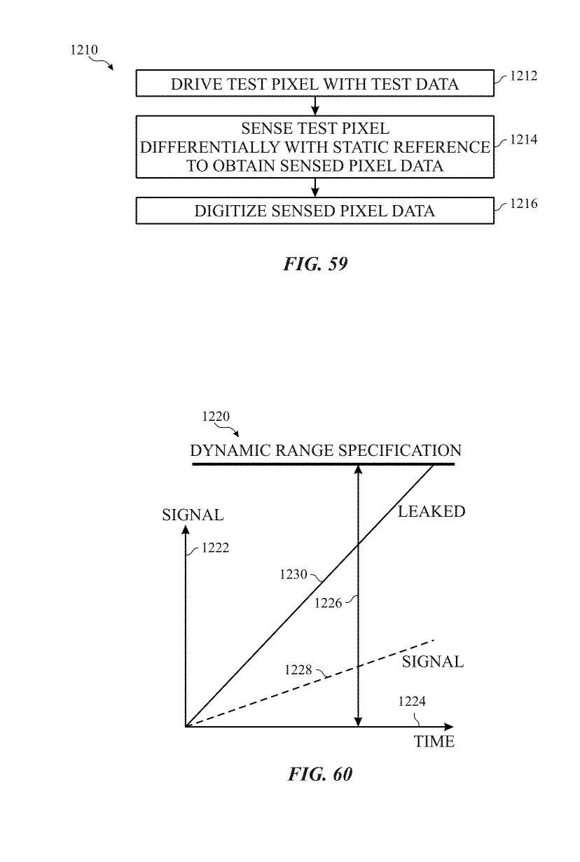

The single-ended display panel sensing shown in FIG. 58 may generally follow a process 1210 shown in FIG. 59. Namely, a pixel 1166 may be driven with test data (referred to as a “test pixel”) (block 1212). Any suitable pixel 1166 may be selected to be driven with the test data. In one example, all of the pixels 1166 of a particular row are activated and driven with test pixel data. After the test pixel has been driven with the test data, the differential amplifiers 1190 may sense the test pixels differentially in comparison to the static reference signal 1192 to obtain sensed test signal data (block 1214). The sensed test pixel data may be digitized (block 1216) to be filtered by the digital filter 1194 or for analysis by the processor core complex 12.

Although the single-ended approach of FIG. 58 may operate to efficiently obtain sensed test pixel data, the sense lines 1180 of the active area 1164 (e.g., the data lines 1172) may be susceptible to noise from the other components of the electronic device 10 or other electrical signals in the vicinity of the electronic device 10, such as radio signals, electromagnetic interference from data processing, and so forth. This may increase an amount of noise in the sensed signal, which may make it difficult to amplify the sensed signal within a specified dynamic range. An example is shown by a plot 1220 of FIG. 60. The plot 1220 compares the detected signal of the sensed pixel data (ordinate 1222) over the sensing time (abscissa 1224). Here, a specified dynamic range 1226 is dominated not by a desired test pixel signal 1228, but rather by leakage noise 1230. To cancel out some of the leakage noise 1230, and therefore improve the signal-to-noise ratio, an approach other than, or in addition to, a single-ended sensing approach may be used.

i. Differential Sensing (DS)

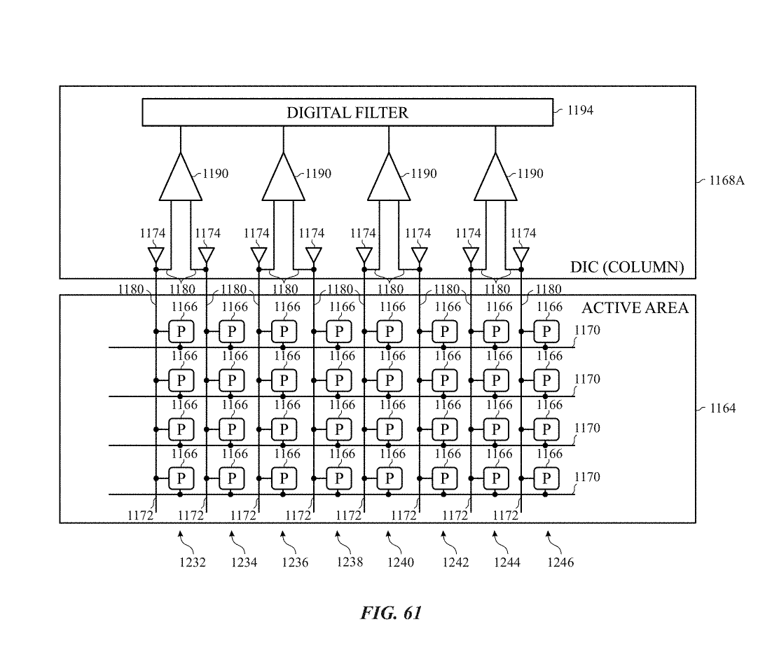

Differential sensing involves sensing a test pixel that has been driven with test data in comparison to a reference pixel that has not been applied with test data. By doing so, common-mode noise that is present on the sense lines 1180 of both the test pixel and the reference pixel may be excluded. FIGS. 61-65 describe a few differential sensing approaches that may be used by the electronic display 18. In FIG. 61, the electronic display 18 includes sense amplifiers 1190 that are connected to differentially sense two sense lines 1180. In the example shown in FIG. 61, columns 1232 and 1234 can be differentially sensed in relation to one another, columns 1236 and 1238 can be differentially sensed in relation to one another, columns 1240 and 1242 can be differentially sensed in relation to one another, and columns 1244 and 1246 can be differentially sensed in relation to one another.

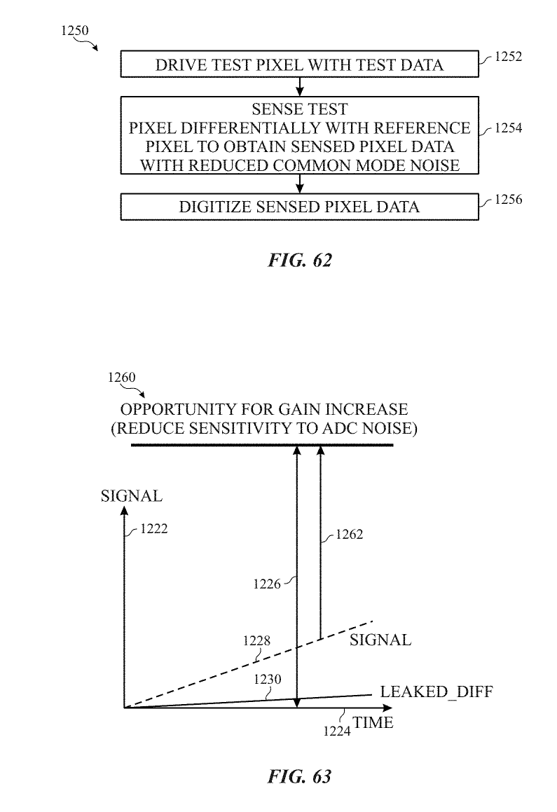

As shown by a process 1250 of FIG. 62, differential sensing may involve driving a test pixel 1166 with test data (block 1252). The test pixel 1166 may be sensed differentially in relation to a reference pixel or reference sense line 1180 that was not driven with test data (block 1254). For example, a test pixel 1166 may be the first pixel 1166 in the first column 1232, and the reference pixel 1166 may be the first pixel 1166 of the second column 1234. By sensing the test pixel 1166 in this way, the sense amplifier 1190 may obtain test pixel 1166 data with reduced common-mode noise. The sensed test pixel 1166 data may be digitized (block 1256) for further filtering or processing.

As a result, the signal-to-noise ratio of the sensed test pixel 1166 data may be substantially better using the differential sensing approach than using a single-ended approach. Indeed, this is shown in a plot 1260 of FIG. 63, which compares a test signal value (ordinate 1222) in comparison to a sensing time (abscissa 1224). In the plot 1260, even with the same dynamic range specification 1226 as shown in the plot 1220 of FIG. 60, the desired test pixel signal 1228 may be much higher than the leakage noise 1230. This is because the common-mode noise that is common to the sense lines 1180 of both the test pixel 1166 and the reference pixel 1166 may be subtracted when the differential amplifier 1190 compares the test signal to the reference signal. This also provides an opportunity to increase the gain of the signal 1228 by providing additional headroom 1262 between the desired test pixel signal 1228 and the dynamic range specification 1226.

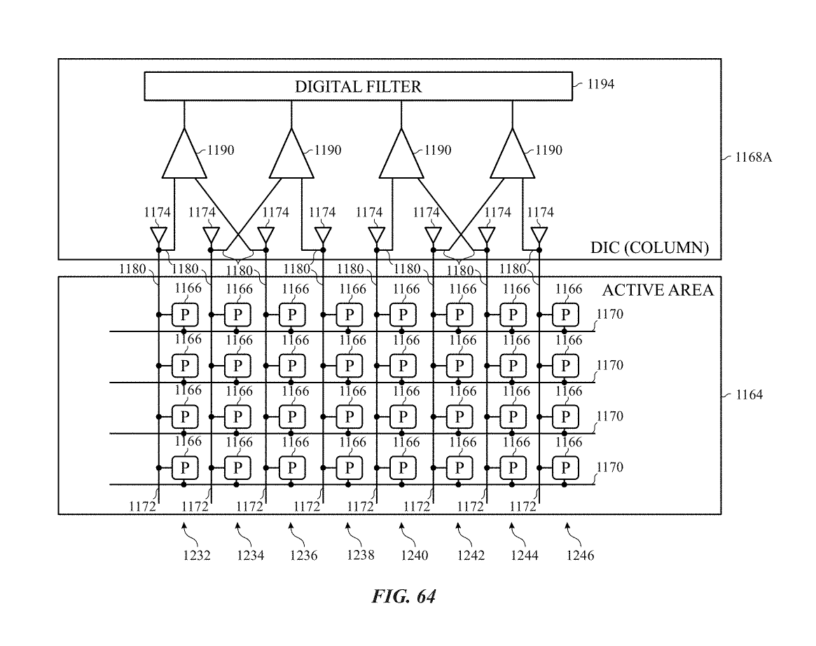

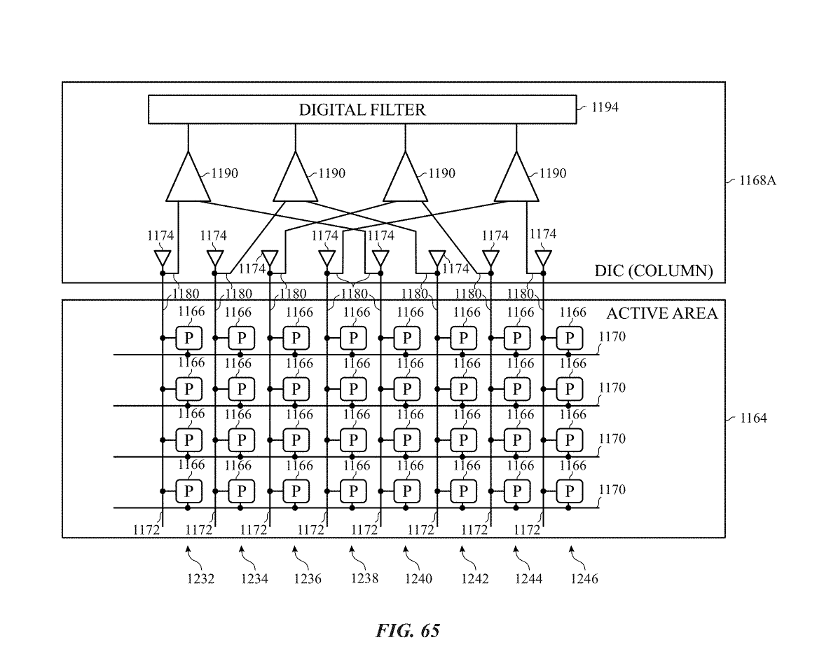

Differential sensing may take place by comparing a test pixel 1166 from one column with a reference pixel 1166 from any other suitable column. For example, as shown in FIG. 64, the sense amplifiers 1190 may differentially sense pixels 1166 in relation to columns with similar electrical characteristics. In this example, even columns have electrical characteristics more similar to other even columns, and odd columns have electrical characteristics more similar to other odd columns. Here, for instance, the column 1232 may be differentially sensed with column 1236, the column 1240 may be differentially sensed with column 1244, the column 1234 may be differentially sensed with column 1238, and column 1242 may be differentially sensed with column 1246. This approach may improve the signal quality when the electrical characteristics of the sense lines 1180 of even columns are more similar to those of sense lines 1180 of other even columns, and the electrical characteristics of the sense lines 1180 of odd columns are more similar to those of sense lines 1180 of other odd columns. This may be the case for an RGBG configuration, in which even columns have red or blue pixels and odd columns have green pixels and, as a result, the electrical characteristics of the even columns may differ somewhat from the electrical characteristics of the odd columns. In other examples, the sense amplifiers 1190 may differentially sense test pixels 1166 in comparison to reference pixels 1166 from every third column or, as shown in FIG. 65, every fourth column. It should be appreciated that the configuration of FIG. 65 may be particularly useful when every fourth column is more electrically similar to one another than to other columns.

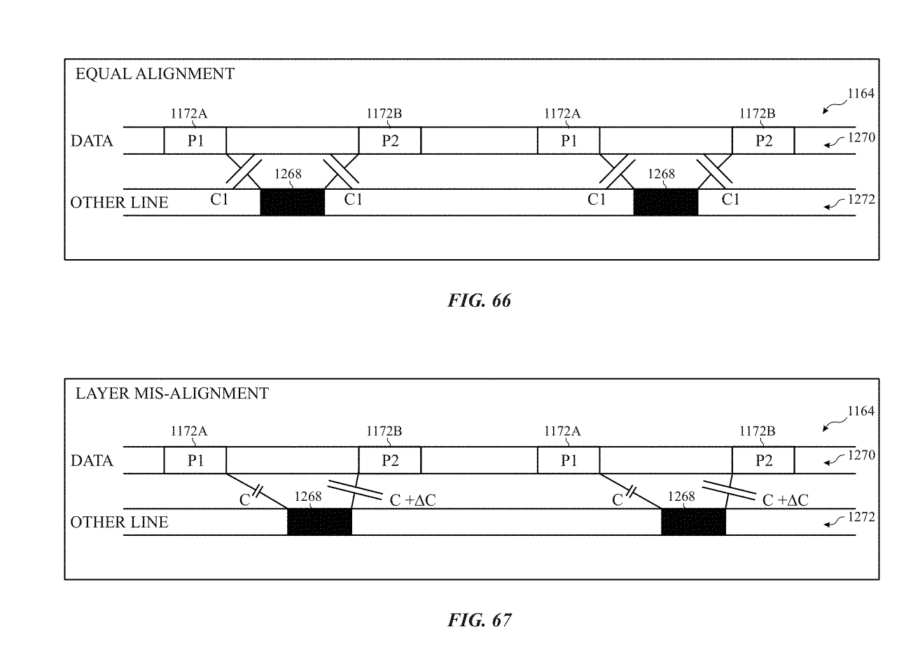

One reason different electrical characteristics could occur on the sense lines 1180 of different columns of pixels 1166 is illustrated by FIGS. 66 and 67. As shown in FIG. 66, when the sense lines 1180 are represented by the data lines 1172, a first data line 1172A and a second data line 1172B (which may be associated with different colors of pixels or different pixel arrangements) may share the same capacitance Ci with another conductive line 1268 in the active area 1164 of the electronic display 18 because the other line 1268 is aligned equally between the data lines 1172A and 1172B. The other line 1268 may be any other conductive line, such as a power supply line like a high or low voltage rail for electroluminance of the pixels 1166 (e.g., VDDEL or VSSEL). Here, the data lines 1172A and 1172B appear in one layer 1270, while the conductive line 1268 appears in a different layer 1272. Being in two separate layers 1270 and 1272, the data lines 1172A and 1172B may be fabricated at a different step in the manufacturing process from the conductive line 1268. Thus, it is possible for the layers to be misaligned when the electronic display 18 is fabricated.

Such layer misalignment is shown in FIG. 67. In the example of FIG. 67, the conductive line 1268 is shown to be farther from the first data line 1172A and closer to the second data line 1172B. This produces an unequal capacitance between the first data line 1172A and the conductive line 1268 compared to the second data line 1172B and the conductive line 1268. These are shown as a capacitance C on the data line 1172A and a capacitance C+AC on the data line 1172B.

ii. Difference-Differential Sensing (DDS)

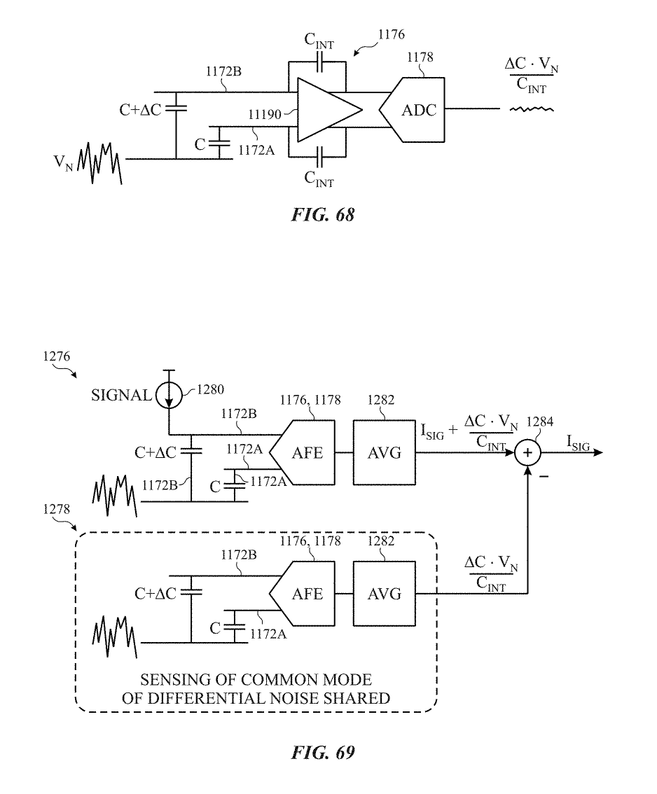

The different capacitances on the data lines 1172A and 1172B may mean that even differential sensing may not fully remove all common-mode noise appearing on two different data lines 1172 that are operating as sense lines 1180, as shown in FIG. 68. Indeed, a voltage noise signal Vₙ may appear on the conductive line 1268, which may represent ground noise on the active area 1164 of the electronic display 18. Although this noise would ideally be cancelled out by the sense amplifier 1190 through differential sensing before the signal is digitized via the sensing analog-to-digital conversion circuitry 1178, the unequal capacitance between the data lines 1172A and 1172B may result in differential common-mode noise. The differential common-mode noise may have a value equal to the following relationship:

$$\frac{Δ C \cdot Vn}{CINT} ¶$$

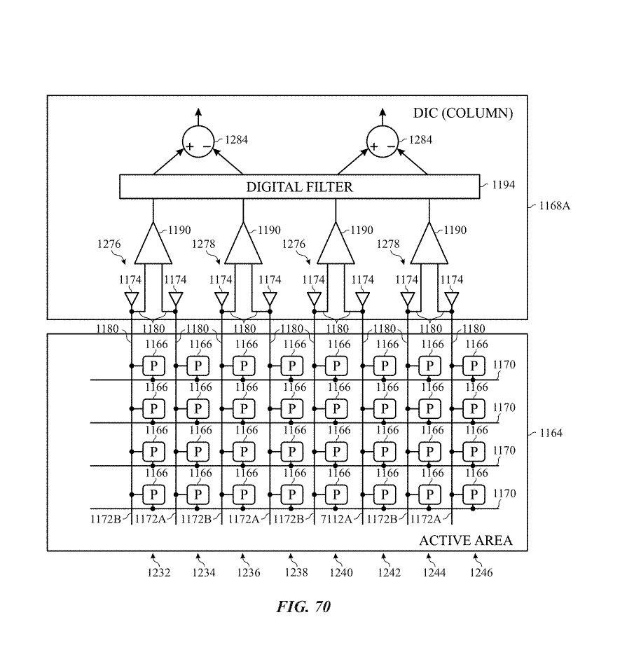

Difference-differential sensing may mitigate the effect of differential common-mode noise that remains after differential sensing due to differences in capacitance on different data lines 1172 when those data lines 1172 are used as sense lines 1180 for display panel sensing. FIG. 69 schematically represents a manner of performing difference-differential sensing in the digital domain by sampling a test differential pair 1276 and a reference differential pair 1278. As shown in FIG. 69, a test signal 1280 representing a sensed signal from a test pixel 1166 on the data line 1172B may be sensed differentially with a reference pixel 1166 on the data line 1172A with the test differential pair 1276. The test signal 1280 may be sensed using the sensing analog front end 1176 and sensing analog-to-digital conversion circuitry 1178. Sensing the test differential pair 1276 may filter out most of the common-mode noise, but differential common-mode noise may remain. Thus, the reference differential pair 1278 may be sensed to obtain a reference signal without programming any test data on the second differential pair 1278. To remove certain high-frequency noise, the signals from the first differential pair 1276 and the second differential pair 1278 may be averaged using temporal digital averaging 1282 to low-pass filter the signals. The digital signal from the reference differential pair 1278, acting as a reference signal, may be subtracted from the signal from the test differential pair 1276 in subtraction logic 1284. Doing so may remove the differential common-mode noise and improve the signal quality. An example block diagram of digital difference-differential sensing appears in FIG. 70, which represents an example of circuitry that may be used to carry out the difference-differential sensing shown in FIG. 69 in a digital manner.

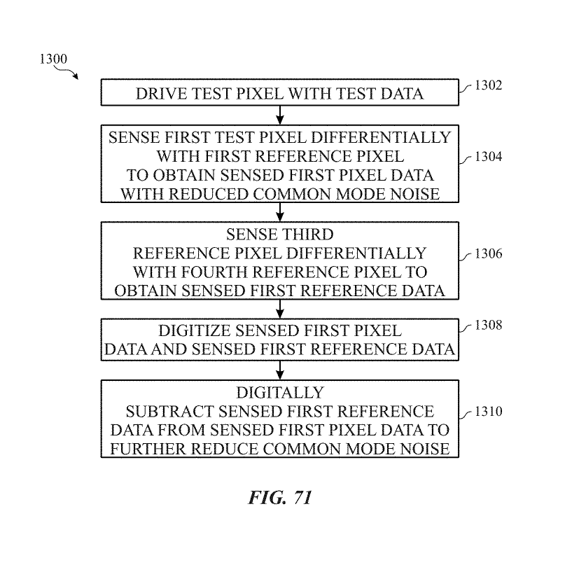

A process 1300 shown in FIG. 71 describes a method for difference-differential sensing in the digital domain. Namely, a first test pixel 1166 on a first data line 1172 (e.g., 1172A) may be programmed with test data (block 1302). The first test pixel 1166 may be sensed differentially with a first reference pixel on a different data line 1172 (e.g., data line 1172B) of a test differential pair 1276 to obtain sensed first pixel data that includes reduced common-mode noise, but which still may include some differential common-mode noise (block 1304). A signal representing substantially only the differential common-mode noise may be obtained by sensing a third reference pixel 1166 on a third data line 1172 (e.g., a second data line 1172B) differentially with a fourth reference pixel 1166 on a fourth data line (e.g., a second data line 1172A) in a reference differential pair 1278 to obtain sensed first reference data (block 1306). The sensed first pixel data of block 1304 and the sensed first reference data of block 1306 may be digitized (block 1308) and the first reference data of block 1306 may be digitally subtracted from the sensed first pixel data of block 1304. This may remove the differential common-mode noise from the sensed first pixel data (block 1310), thereby improving the signal quality.

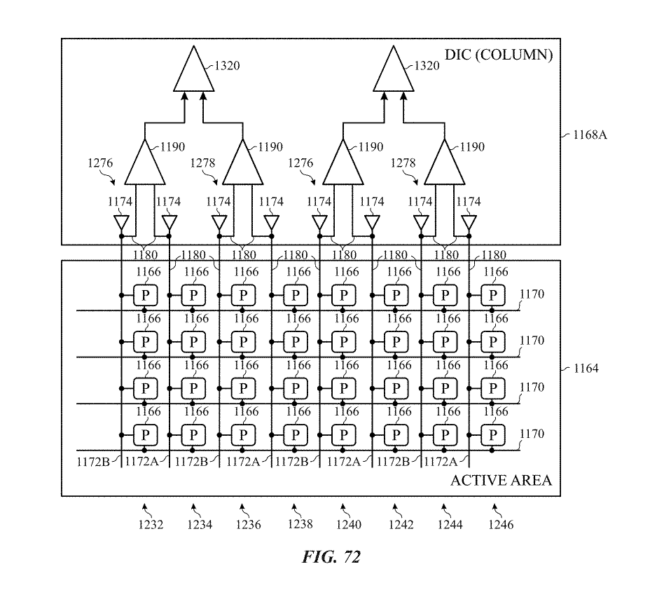

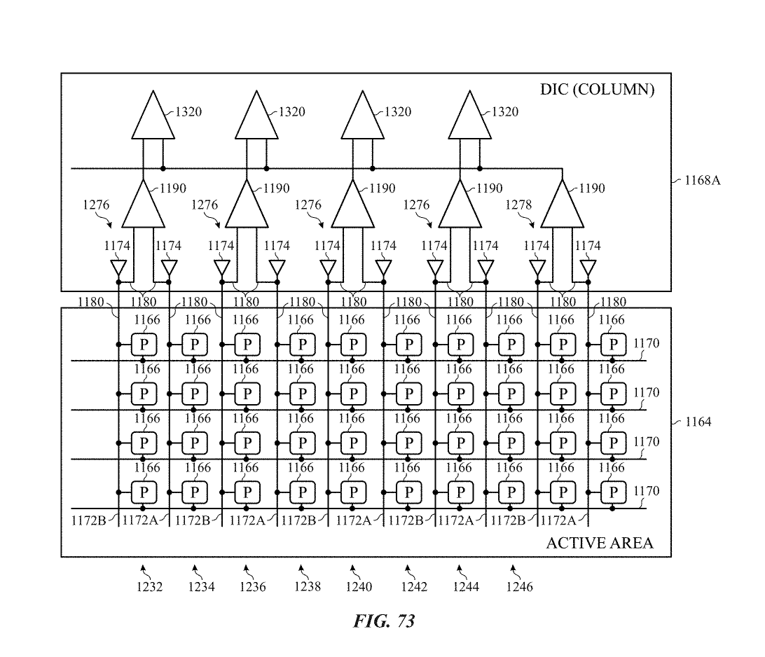

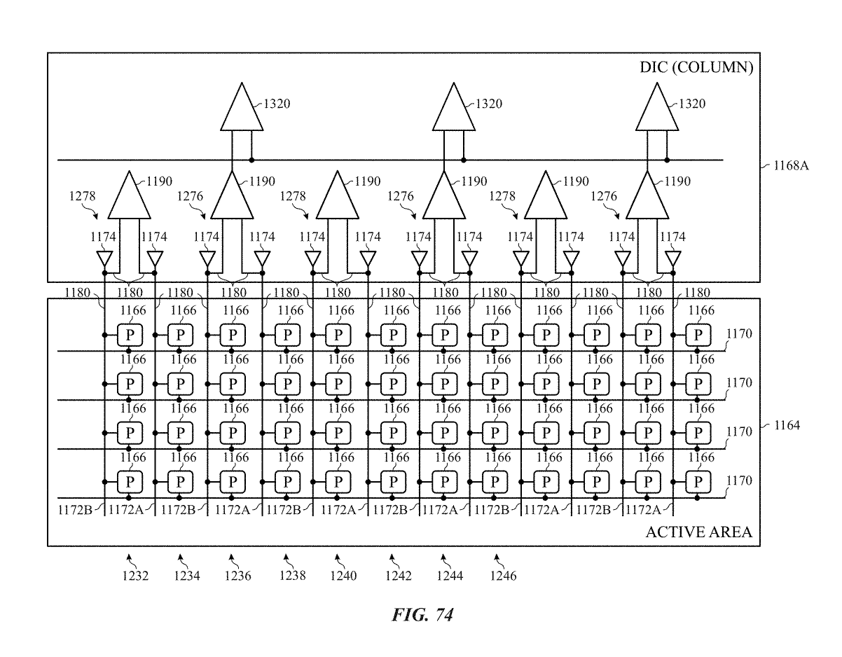

Difference-differential sensing may also take place in the analog domain. For example, as shown in FIG. 72, analog versions of the differentially sensed test pixel signal and the differential reference signal may be differentially compared in a second-stage sense amplifier 1320. A common reference differential pair 1278 may be used for difference-differential sensing of several test differential pairs 1276, as shown in FIG. 73. Any suitable number of test differential pairs 1276 may be differentially sensed in comparison to the reference differential pair 1278. Moreover, the reference differential pair 1278 may vary at different times, meaning that the location of the reference differential pair 1278 may vary from image frame to image frame. Moreover, as shown in FIG. 74, multiple reference differential pairs 1278 may be connected together to provide an analog averaging of the differential reference signals from the reference differential pairs 1278. This may also improve a signal quality of the difference-differential sensing on the test differential pairs 1276.

iii. Correlated Double Sampling (CDS)

Correlated double sampling involves sensing the same pixel 1166 for different samples at different, at least one of the samples involving programming the pixel 1166 with test data and sensing a test signal and at least another of the samples involving not programming the pixel 1166 with test data and sensing a reference signal. The reference signal may be understood to contain temporal noise that can be removed from the test signal. Thus, by subtracting the reference signal from the test signal, temporal noise may be removed. Indeed, in some cases, there may be noise due to the sensing process itself. Thus, correlated double sampling may be used to cancel out such temporal sensing noise.

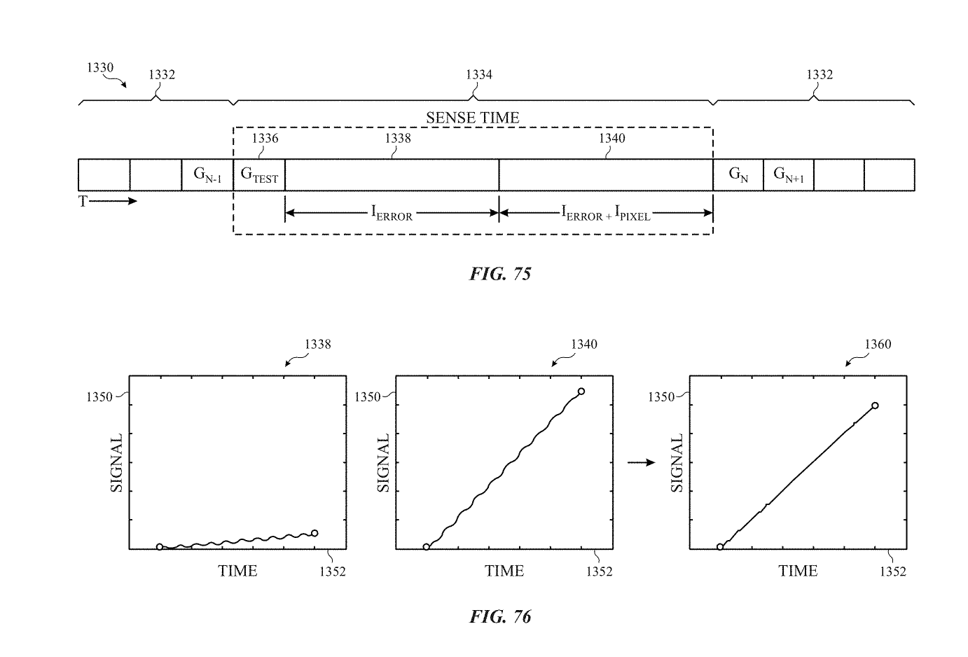

FIG. 75 provides a timing diagram 1330 representing a manner of performing correlated double sampling. The timing diagram 1330 includes display operations 1332 and sensing operations 1334. The sensing operations 1334 may fall between times where image data is being programmed into the pixels 1166 of the electronic display 18. In the example of FIG. 75, the sensing operations 1334 include an initial header 1336, a reference sample 1338, and a test sample 1340. The initial header 1336 provides an instruction to the electronic display 18 to perform display panel sensing. The reference sample 1338 represents time during which a reference signal is obtained for a pixel (i.e., the test pixel 1166 is not supplied test data) and includes substantially only sensing noise (I_{ERROR}). The test sample 1340 represents time when the test signal is obtained that includes both a test signal of interest (I_{PIXEL}) and sensing noise (I_{ERROR}). The reference signal obtained during the reference sample 1338 and the test signal obtained during the test sample 1340 may be obtained using any suitable technique (e.g., single-ended sensing, differential sensing, or difference-differential sensing).

FIG. 76 illustrates three plots: a first plot showing a reference signal obtained during the reference sample 1338, a second plot showing a test signal obtained during the test sample 1340, and a third plot showing a resulting signal that is obtained when the reference signal is removed from the test signal. Each of the plots shown in FIG. 76 compares a sensed signal strength (ordinate 1350) in relation to sensing time (abscissa 1352). As can be seen, even when no test data is programmed into a test pixel 1166, the reference signal obtained during the reference sample 1338 is non-zero and represents temporal noise (I_{ERROR}), as shown in the first plot. This temporal noise component also appears in the test signal obtained during the test sample 1340, as shown in the second plot (I_{PIXEL}+I_{ERROR}). The third plot, labeled numeral 1360, represents a resulting signal obtained by subtracting the temporal noise of the reference signal (I_{ERROR}) obtained during the reference sample 1338 from the test signal (I_{PIXEL}+I_{ERROR}) obtained during the test sample 1340. By removing the reference signal (I_{ERROR}) from the test signal (I_{PIXEL}+I_{ERROR}), the resulting signal is substantially only the signal of interest (I_{PIXEL}).

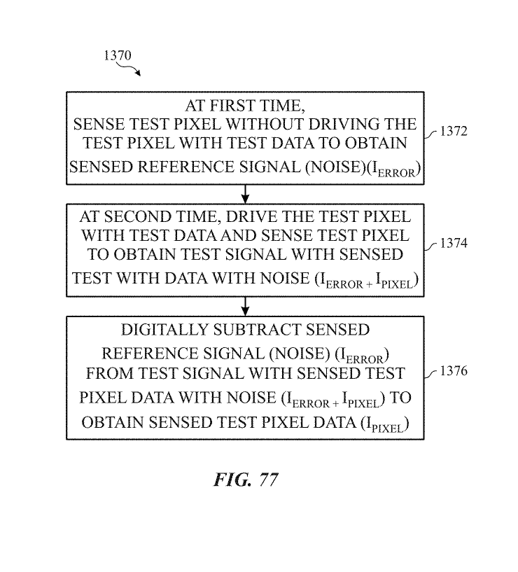

One manner of performing correlated double sampling is described by a flowchart 1370 of FIG. 77. At a first time, a test pixel 1166 may be sensed without first programming the test pixel with test data, thereby causing the sensed signal to represent temporal noise (I_{ERROR}) (block 1372). At a second time different from the first time, the test pixel 1166 may be programmed with test data and the test pixel 1166 may be sensed using any suitable display panel sensing techniques to obtain a test signal that includes sensed text pixel data as well as the noise (I_{PIXEL}+I_{ERROR}) (block 1374). The reference signal (I_{ERROR}) may be subtracted from the test signal (I_{PIXEL}+I_{ERROR}) to obtain sensed text pixel data with reduced noise (I_{PIXEL}) (block 1376).

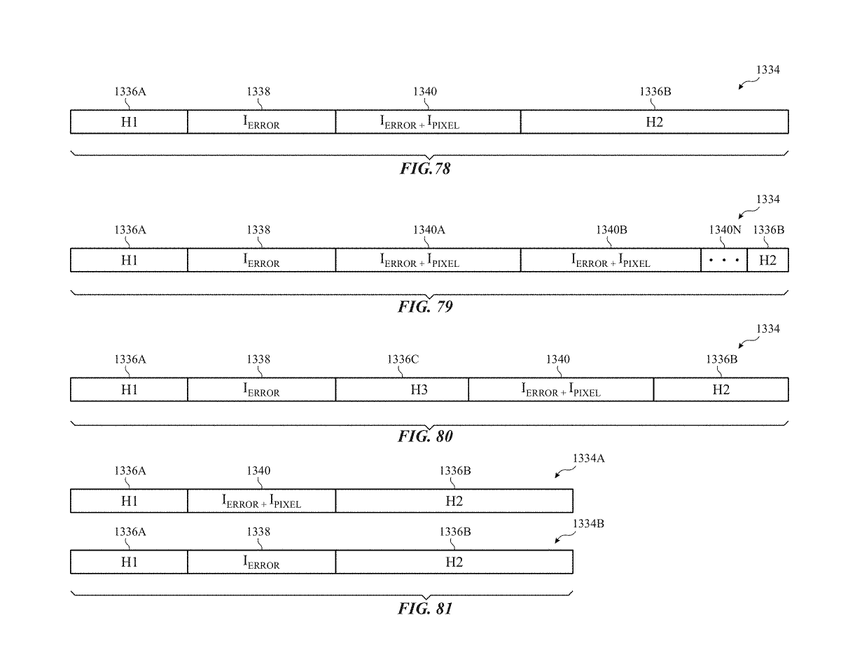

It should be appreciated that correlated double sampling may be performed in a variety of manners, such as those shown by way of example in FIGS. 78-82. For instance, as shown in FIG. 78, another timing diagram for correlated double sampling may include headers 1336A and 1336B that indicate a start and end of a sensing period, in which a reference sample 1338 and a test sample 1340 occur. In the example correlated double sampling timing diagram 1334 of FIG. 79, there is one reference sample 1338, but multiple test frames 1340A, 1340B, . . . , 1340N. In other examples, multiple references frames 1338 may take place to be averaged and a single test sample 1340 or multiple test frames 1340 may take place.

A reference sample 1338 and a test sample 1340 may not necessarily occur sequentially. Indeed, as shown in FIG. 80, a reference sample 1338 may occur between two headers 1336A and 1336C, while the test sample 1340 may occur between two headers 1336C and 1336B. Additionally or alternatively, the reference signal 1338 and the test signal 1340 used in correlated double sampling may be obtained in different frames, as shown by FIG. 81. In FIG. 81, a first sensing period 1334A occurs during a first frame that includes a reference sample 1338 between two headers 1336A and 1336B. A second sensing period 1334B occurs during a second frame, which may or may not sequentially follow the first frame or may be separated by multiple other frames. The second sensing period 1334B in FIG. 81 includes a test sample 1340 between two headers 1336A and 1336B.

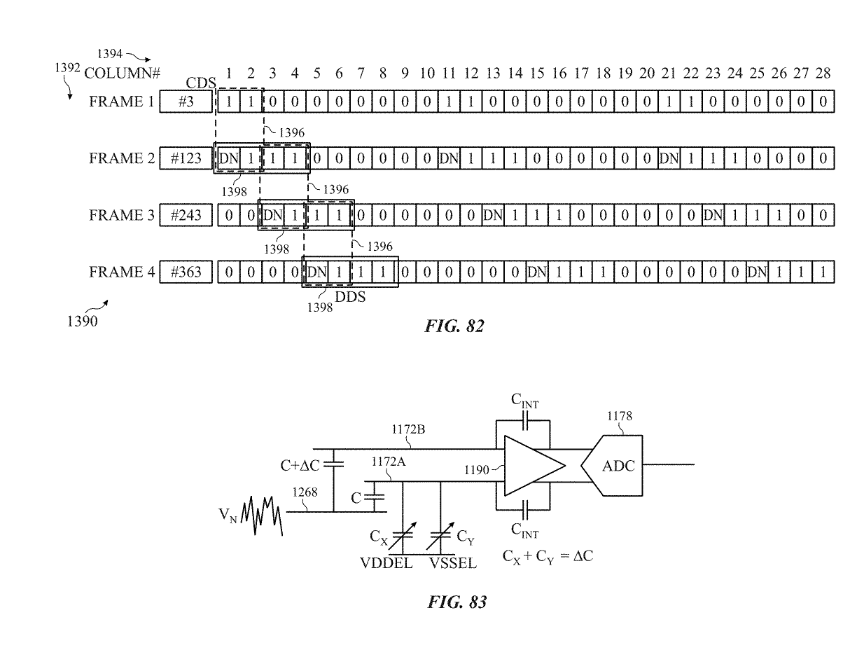

Correlated double sampling may lend itself well for use in combination with differential sensing or difference-differential sensing, as shown in FIG. 82. A timing diagram 1390 of FIG. 82 compares activities that occur in different image frames 1392 at various columns 1394 of the active area 1164 of the electronic display 18. In the timing diagram 1390, a “1” represents a column that is sensed without test data, “DN” represents a column with a pixel 1166 that is supplied with test data, and “0” represents a column that is not sensed during that frame or is sensed but not used in the particular correlated double sampling or difference-differential sensing that is illustrated in FIG. 82. As shown in the timing diagram 1390, reference signals obtained during one frame may be used in correlated double sampling (blocks 1396) and may be used with difference-differential sensing (blocks 1398). For example, during a first frame (“FRAME 1”), a reference signal may be obtained by differentially sensing two reference pixels 1166 in columns 1 and 2 that have not been programmed with test data. During a second frame (“FRAME 2”), a test pixel 1166 of column 1 may be programmed with test data and differentially sensed in comparison to a reference pixel 1166 in column 2 to obtain a differential test signal and a second differential reference signal may be obtained by differentially sensing two reference pixels 1166 in columns 3 and 4. The differential test signal may be used in correlated double sampling of block 1396 with the reference signal obtained in frame 1, and may also be used in difference-differential sampling with the second differential reference signal from columns 3 and 4.

iv. Capacitance Balancing

Capacitance balancing represents another way of improving the signal quality used in differential sensing by equalizing the effect of a capacitance difference (AC) between two sense lines 1180 (e.g., data lines 1172A and 1172B). In an example shown in FIG. 83, there is a difference between a first capacitance between the data lines 1172B and the conductive line 1268 and a second capacitance between the data line 1172A and the conductive line 1268. Since this difference in capacitance could lead to the sense amplifier 1190 detecting differential common-mode noise as a component of common-mode noise V_{N} that is not canceled-out, additional capacitance equal to the difference in capacitance (ΔC) may be added between the conductive lines 1268 and some of the data lines 1172 (e.g., the data lines 1172A) via additional capacitor structures (e.g., Cₓ and C_{y}).

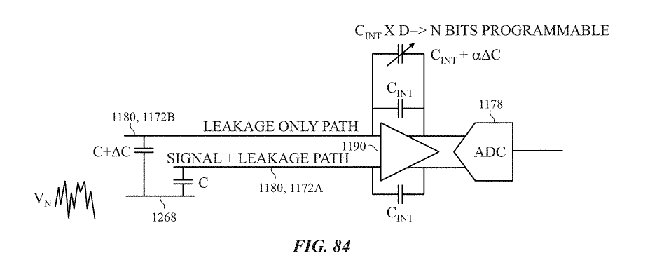

Placing additional capacitor structures between the conductive lines 1268 and some of the data lines 1172 (e.g., the data lines 1172A), however, may involve relatively large capacitors that take up a substantial amount of space. Thus, additionally or alternatively, a much smaller programmable capacitor may be programmed to a value that is proportional to the difference in capacitance (ΔC) between the two data lines 1172A and 1172B (shown in FIG. 84 as a ΔC). This may be added to the integration capacitance C_{INT} used by the sense amplifier 1190. The capacitance αΔC may be selected such that the ratio of capacitances between the data lines 1172A and 1172B (C to (C+ΔC)) may be substantially the same as the ratio of the capacitances around the sense amplifier 1190 (C_{INT} to (C_{INT}+αΔC)). This may offset the effects of the capacitance mismatch on the two data lines 1172A and 1172B. The programmable capacitance may be provided instead of or in addition to another integration capacitor C_{INT}, and may be programmed based on testing of the electronic display 18 during manufacture of the electronic display 18 or of the electronic device 10. The programmable capacitance may have any suitable precision (e.g., 1, 2, 3, 4, 5 bits) that can reduce noise when programmed with an appropriate proportional capacitance.

v. Combinations of Approaches

While many of the techniques discussed above have been discussed generally as independent noise-reduction techniques, it should be appreciated that these may be used separately or in combination with one another. Indeed, the specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

vi. Edge Column Differential Sensing

Display panel sensing involves programming certain pixels with test data and measuring a response by the pixels to the test data. The response by a pixel to test data may indicate how that pixel will perform when programmed with actual image data. In this disclosure, pixels that are currently being tested using the test data are referred to as “test pixels” and the response by the test pixels to the test data is referred to as a “test signal.” The test signal is sensed from a “sense line” of the electronic display and may be a voltage or a current, or both a voltage and a current. In some cases, the sense line may serve a dual purpose on the display panel. For example, data lines of the display that are used to program pixels of the display with image data may also serve as sense lines during display panel sensing.

To sense the test signal, it may be compared to some reference value. Although the reference value could be static—referred to as “single-ended” testing using a static reference value may cause too much noise to remain in the test signal. Indeed, the test signal often contains both the signal of interest, which may be referred to as the “pixel operational parameter” or “electrical property” that is being sensed, as well as noise due to any number of electromagnetic interference sources near the sense line. Differential sensing (DS) may be used to cancel out common mode noise of the display panel during sensing.

Differential sensing involves performing display panel sensing not in comparison to a static reference, as is done in single-ended sensing, but instead in comparison to a dynamic reference. For example, to sense an operational parameter of a test pixel of an electronic display, the test pixel may be programmed with test data. The response by the test pixel to the test data may be sensed on a sense line (e.g., a data line) that is coupled to the test pixel. The sense line of the test pixel may be sensed in comparison to a sense line coupled to a reference pixel that was not programmed with the test data. The signal sensed from the reference pixel does not include any particular operational parameters relating to the reference pixel in particular, but rather contains common-noise that may be occurring on the sense lines of both the test pixel and the reference pixel. In other words, since the test pixel and the reference signal are both subject to the same system-level noise—such as electromagnetic interference from nearby components or external interference—differentially sensing the test pixel in comparison to the reference pixel results in at least some of the common-mode noise being subtracted away from the signal of the test pixel. The resulting differential sensing may be used in combination with other techniques, such as difference-differential sensing, correlated double sampling, and the like.

It may be beneficial to perform differential sensing using two lines with similar electrical characteristics. For example, every other sense line may have electrical characteristics that are more similar than adjacent sense lines. An electronic display panel with an odd number of electrically similar sense lines may not perform differential sensing with every other sense line without having one remaining sense line that is left out. Accordingly, this disclosure provides systems and methods to enable differential sensing of sense lines in a display panel even when the display panel contains odd numbers of electrically similar sense lines. In one example, some or all of the sense lines may be routed to sense amplifiers be differentially sensed with different sense lines at different points in time. These may be considered to be “dancing channels” that are not fixed in place, but rather may dance from sense amplifier to sense amplifier in a way that mitigates odd pairings.

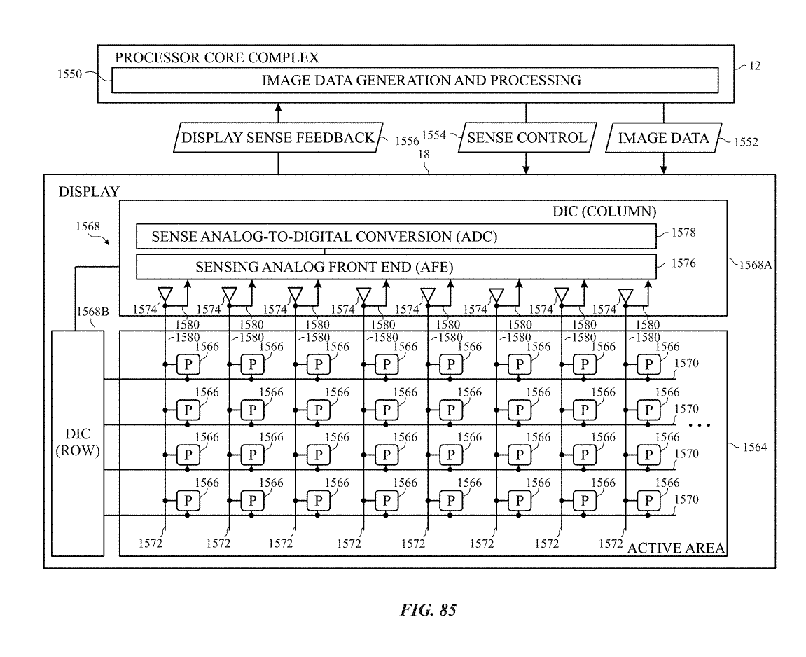

As shown in FIG. 85, in the various embodiments of the electronic device 10, the processor core complex 12 may perform image data generation and processing 1550 to generate image data 1552 for display by the electronic display 18. The image data generation and processing 1550 of the processor core complex 12 is meant to represent the various circuitry and processing that may be employed by the core processor 12 to generate the image data 1552 and control the electronic display 18. Since this may include compensating the image data 1552 based on operational variations of the electronic display 18, the processor core complex 12 may provide sense control signals 1554 to cause the electronic display 18 to perform display panel sensing to generate display sense feedback 1556. The display sense feedback 1556 represents digital information relating to the operational variations of the electronic display 18. The display sense feedback 1556 may take any suitable form, and may be converted by the image data generation and processing 1550 into a compensation value that, when applied to the image data 1552, appropriately compensates the image data 1552 for the conditions of the electronic display 18. This results in greater fidelity of the image data 1552, reducing or eliminating visual artifacts that would otherwise occur due to the operational variations of the electronic display 18.

The electronic display 18 includes an active area 1564 with an array of pixels 1566. The pixels 1566 are schematically shown distributed substantially equally apart and of the same size, but in an actual implementation, pixels of different colors may have different spatial relationships to one another and may have different sizes. In one example, the pixels 1566 may take a red-green-blue (RGB) format with red, green, and blue pixels, and in another example, the pixels 1566 may take a red-green-blue-green (RGBG) format in a diamond pattern. The pixels 1566 are controlled by a driver integrated circuit 1568, which may be a single module or may be made up of separate modules, such as a column driver integrated circuit 1568A and a row driver integrated circuit 1568B. The driver integrated circuit 1568 may send signals across gate lines 1570 to cause a row of pixels 1566 to become activated and programmable, at which point the driver integrated circuit 1568 (e.g., 1568A) may transmit image data signals across data lines 1572 to program the pixels 1566 to display a particular gray level. By supplying different pixels 1566 of different colors with image data to display different gray levels or different brightness, full-color images may be programmed into the pixels 1566. The image data may be driven to an active row of pixel 1566 via source drivers 1574, which are also sometimes referred to as column drivers.

As mentioned above, the pixels 1566 may be arranged in any suitable layout with the pixels 1566 having various colors and/or shapes. For example, the pixels 1566 may appear in alternating red, green, and blue in some embodiments, but also may take other arrangements. The other arrangements may include, for example, a red-green-blue-white (RGBW) layout or a diamond pattern layout in which one column of pixels alternates between red and blue and an adjacent column of pixels are green. Regardless of the particular arrangement and layout of the pixels 1566, each pixel 1566 may be sensitive to changes on the active area 1564 of the electronic display 18, such as variations and temperature of the active area 1564, as well as the overall age of the pixel 1566. Indeed, when each pixel 1566 is a light emitting diode (LED), it may gradually emit less light over time. This effect is referred to as aging, and takes place over a slower time period than the effect of temperature on the pixel 1566 of the electronic display 18.

Display panel sensing may be used to obtain the display sense feedback 1556, which may enable the processor core complex 12 to generate compensated image data 1552 to negate the effects of temperature, aging, and other variations of the active area 1564. The driver integrated circuit 1568 (e.g., 1568A) may include a sensing analog front end (AFE) 1576 to perform analog sensing of the response of pixels 1566 to test data. The analog signal may be digitized by sensing analog-to-digital conversion circuitry (ADC) 1578.

For example, to perform display panel sensing, the electronic display 18 may program one of the pixels 1566 with test data. The sensing analog front end 1576 then senses a sense line 1580 of connected to the pixel 1566 that is being tested. Here, the data lines 1572 are shown to act as the sense lines 1580 of the electronic display 18. In other embodiments, however, the display active area 1564 may include other dedicated sense lines 1580 or other lines of the display may be used as sense lines 1580 instead of the data lines 1572. Other pixels 1566 that have not been programmed with test data may be sensed at the same time a pixel that has been programmed with test data. Indeed, as will be discussed below, by sensing a reference signal on a sense line 1580 when a pixel on that sense line 1580 has not been programmed with test data, a common-mode noise reference value may be obtained. This reference signal can be removed from the signal from the test pixel that has been programmed with test data to reduce or eliminate common mode noise.

The analog signal may be digitized by the sensing analog-to-digital conversion circuitry 1578. The sensing analog front end 1576 and the sensing analog-to-digital conversion circuitry 1578 may operate, in effect, as a single unit. The driver integrated circuit 1568 (e.g., 1568A) may also perform additional digital operations to generate the display feedback 1556, such as digital filtering, adding, or subtracting, to generate the display feedback 1556, or such processing may be performed by the processor core complex 12.

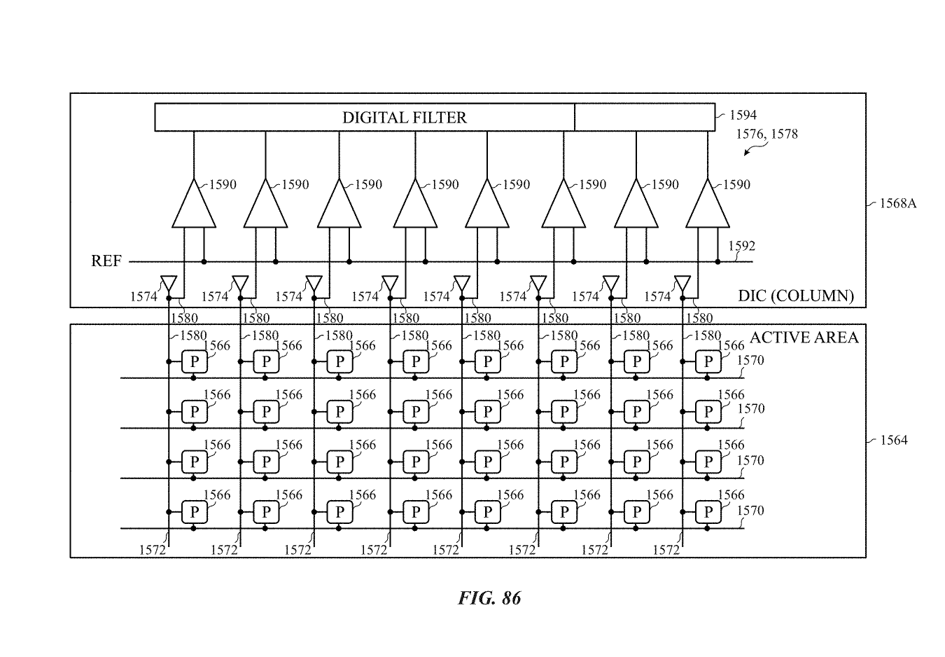

FIG. 86 illustrates a single-ended approach to display panel sensing. Namely, the sensing analog front end 1576 and the sensing analog-to-digital conversion circuitry 1578 may be represented schematically by sense amplifiers 1590 that differentially sense a signal from the sense lines 1580 (here, the data lines 1572) in comparison to a static reference signal 1592 and output a digital value. It should be appreciated that, in FIG. 86 as well as other figures of this disclosure, the sense amplifiers 1590 are intended to represent both analog amplification circuitry and/or the sense analog to digital conversion (ADC) circuitry 1578. Whether the sense amplifiers 1590 represent analog or digital circuitry, or both, may be understood through the context of other circuitry in each figure. A digital filter 1594 may be used to digitally process the resulting digital signals obtained by the sense amplifiers 1590.

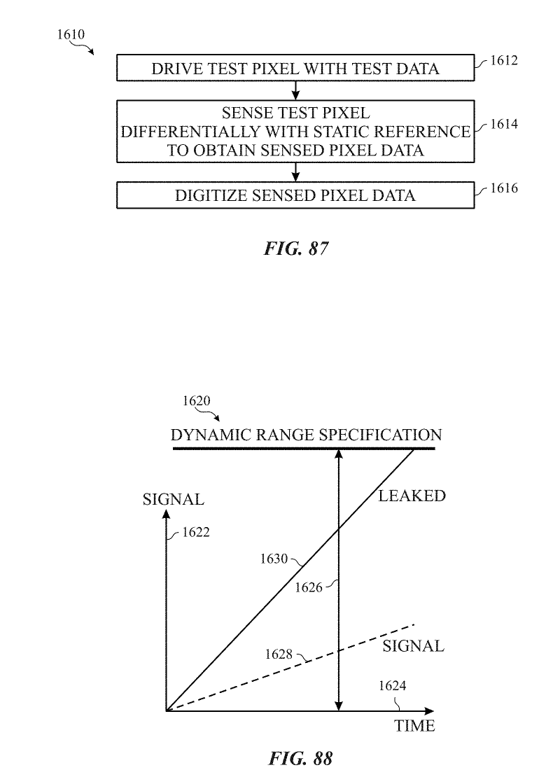

The single-ended display panel sensing shown in FIG. 86 may generally follow a process 1610 shown in FIG. 87. Namely, a pixel 1566 may be driven with test data (referred to as a “test pixel”) (block 1612). Any suitable pixel 1566 may be selected to be driven with the test data. In one example, all of the pixels 1566 of a particular row are activated and driven with test pixel data. After the test pixel has been driven with the test data, the differential amplifiers 1590 may sense the test pixels differentially in comparison to the static reference signal 1592 to obtain sensed test signal data (block 1614). The sensed test pixel data may be digitized (block 1616) to be filtered by the digital filter 1594 or for analysis by the processor core complex 12.

Although the single-ended approach of FIG. 86 may operate to efficiently obtain sensed test pixel data, the sense lines 1580 of the active area 1564 (e.g., the data lines 1572) may be susceptible to noise from the other components of the electronic device 10 or other electrical signals in the vicinity of the electronic device 10, such as radio signals, electromagnetic interference from data processing, and so forth. This may increase an amount of noise in the sensed signal, which may make it difficult to amplify the sensed signal within a specified dynamic range. An example is shown by a plot 1620 of FIG. 88. The plot 1620 compares the detected signal of the sensed pixel data (ordinate 1622) over the sensing time (abscissa 1624). Here, a specified dynamic range 1626 is dominated not by a desired test pixel signal 1628, but rather by leakage noise 1630. To cancel out some of the leakage noise 1630, and therefore improve the signal-to-noise ratio, an approach other than, or in addition to, a single-ended sensing approach may be used. For example, the electronic display 18 may perform differential sensing to cancel out certain common mode noise.

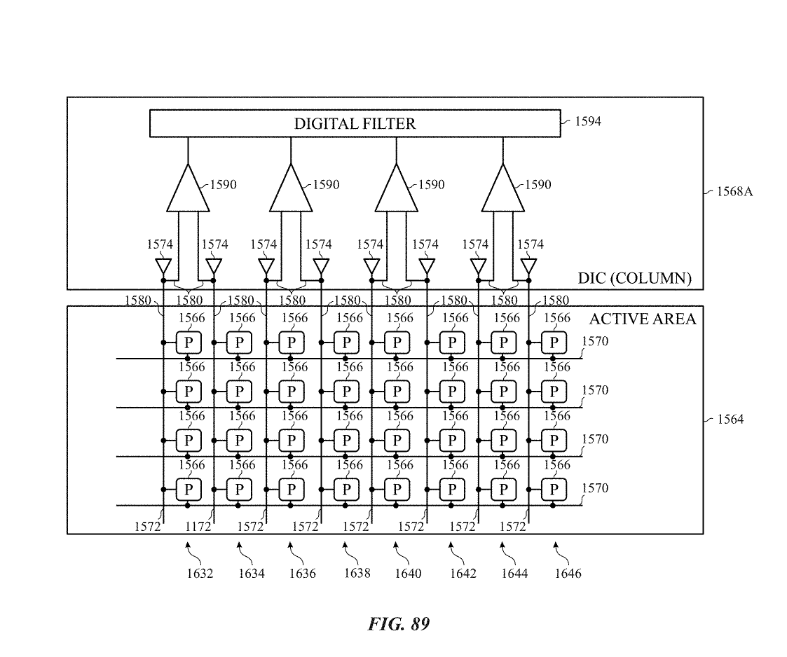

Differential sensing involves sensing a test pixel that has been driven with test data in comparison to a reference pixel that has not been applied with test data. By doing so, common-mode noise that is present on the sense lines 1580 of both the test pixel and the reference pixel may be excluded. FIGS. 89-93 describe a few differential sensing approaches that may be used by the electronic display 18. In FIG. 89, the electronic display 18 includes sense amplifiers 1590 that are connected to differentially sense two sense lines 1580. In the example shown in FIG. 89, columns 1632 and 1634 can be differentially sensed in relation to one another, columns 1636 and 1638 can be differentially sensed in relation to one another, columns 1640 and 1642 can be differentially sensed in relation to one another, and columns 1644 and 1646 can be differentially sensed in relation to one another.

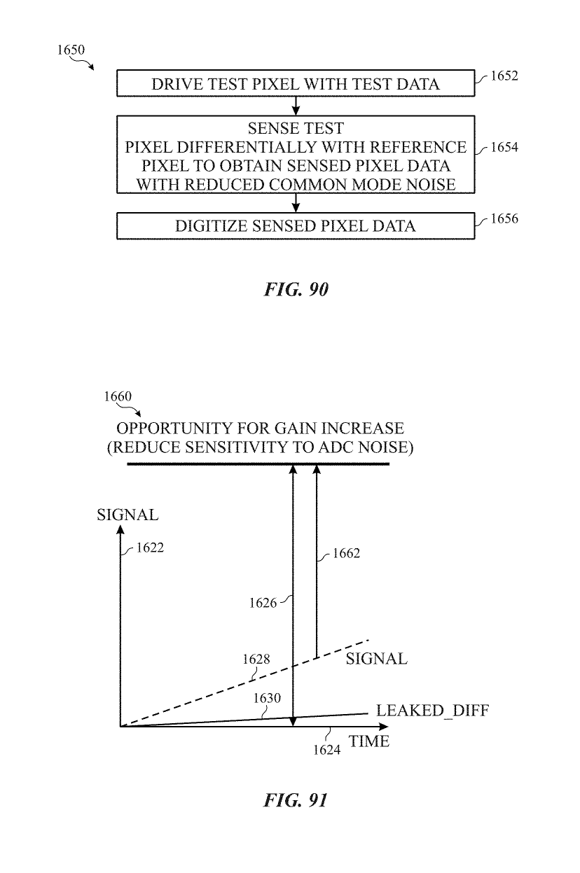

As shown by a process 1650 of FIG. 90, differential sensing may involve driving a test pixel 1566 with test data (block 1652). The test pixel 1566 may be sensed differentially in relation to a reference pixel or reference sense line 1580 that was not driven with test data (block 1654). For example, a test pixel 1566 may be the first pixel 1566 in the first column 1632, and the reference pixel 1566 may be the first pixel 1566 of the second column 1634. By sensing the test pixel 1566 in this way, the sense amplifier 1590 may obtain test pixel 1566 data with reduced common-mode noise. The sensed test pixel 1566 data may be digitized (block 1656) for further filtering or processing.

As a result, the signal-to-noise ratio of the sensed test pixel 1566 data may be substantially better using the differential sensing approach than using a single-ended approach. Indeed, this is shown in a plot 1660 of FIG. 91, which compares a test signal value (ordinate 1622) in comparison to a sensing time (abscissa 1624). In the plot 1660, even with the same dynamic range specification 1626 as shown in the plot 1620 of FIG. 88, the desired test pixel signal 1628 may be much higher than the leakage noise 1630. This is because the common-mode noise that is common to the sense lines 1580 of both the test pixel 1566 and the reference pixel 1566 may be subtracted when the differential amplifier 1590 compares the test signal to the reference signal. This also provides an opportunity to increase the gain of the signal 1628 by providing additional headroom 1662 between the desired test pixel signal 1628 and the dynamic range specification 1626.

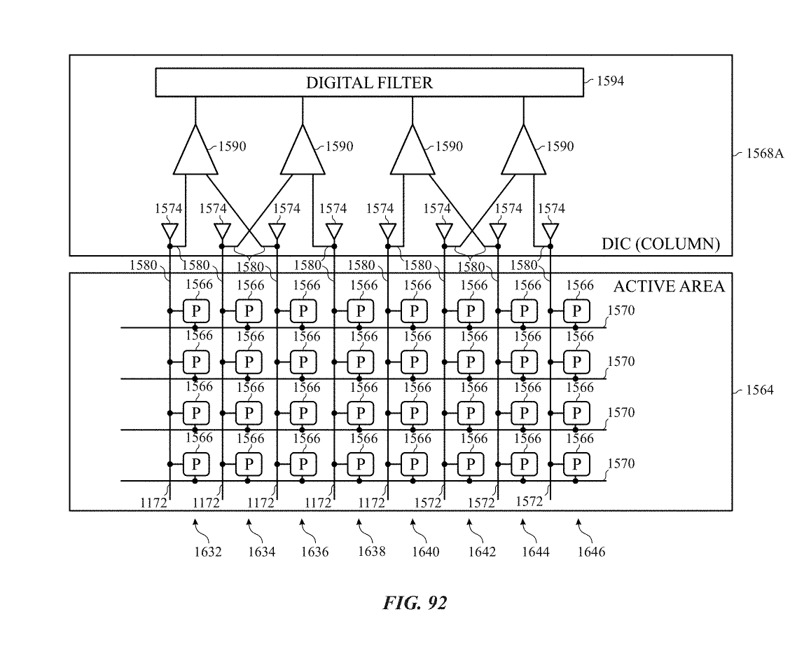

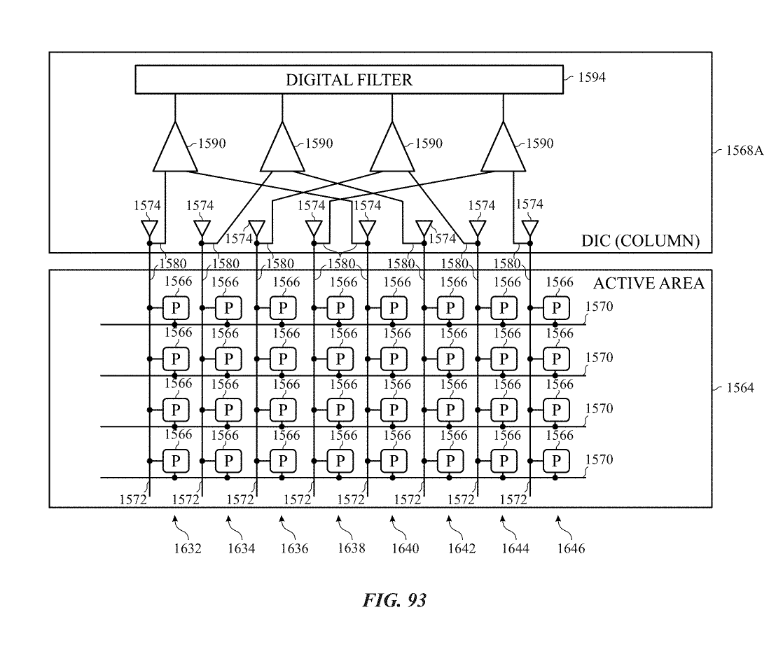

Differential sensing may take place by comparing a test pixel 1566 from one column with a reference pixel 1566 from any other suitable column. For example, as shown in FIG. 92, the sense amplifiers 1590 may differentially sense pixels 1566 in relation to columns with similar electrical characteristics. In this example, even columns have electrical characteristics more similar to other even columns, and odd columns have electrical characteristics more similar to other odd columns. Here, for instance, the column 1632 may be differentially sensed with column 1636, the column 1640 may be differentially sensed with column 1644, the column 1634 may be differentially sensed with column 1638, and column 1642 may be differentially sensed with column 1646. This approach may improve the signal quality when the electrical characteristics of the sense lines 1580 of even columns are more similar to those of sense lines 1580 of other even columns, and the electrical characteristics of the sense lines 1580 of odd columns are more similar to those of sense lines 1580 of other odd columns. This may be the case for an RGBG configuration, in which even columns have red or blue pixels and odd columns have green pixels and, as a result, the electrical characteristics of the even columns may differ somewhat from the electrical characteristics of the odd columns. In other examples, the sense amplifiers 1590 may differentially sense test pixels 1566 in comparison to reference pixels 1566 from every third column or, as shown in FIG. 93, every fourth column. It should be appreciated that the configuration of FIG. 93 may be particularly useful when every fourth column is more electrically similar to one another than to other columns.

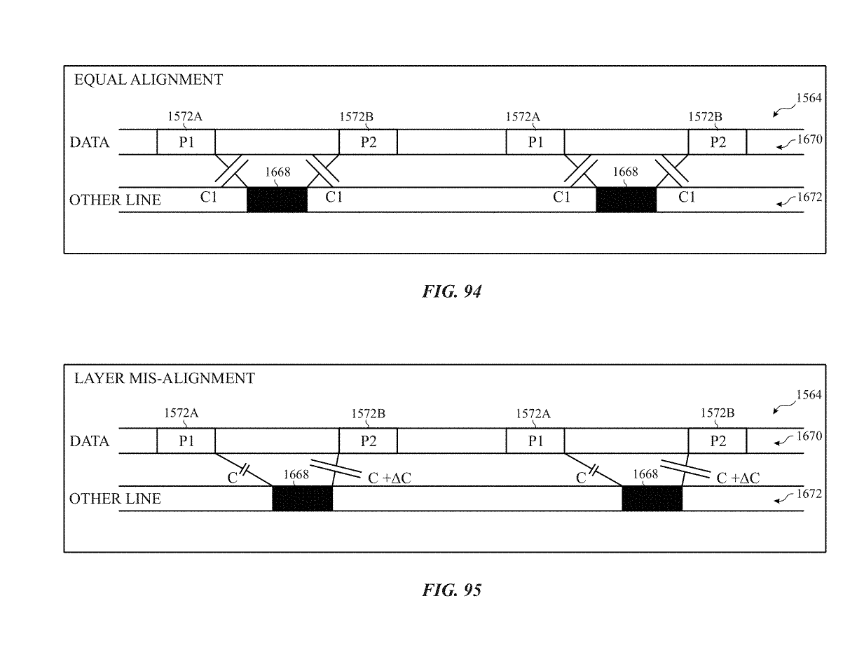

One reason different electrical characteristics could occur on the sense lines 1580 of different columns of pixels 1566 is illustrated by FIGS. 94 and 95. As shown in FIG. 94, when the sense lines 1580 are represented by the data lines 1572, a first data line 1572A and a second data line 1572B (which may be associated with different colors of pixels or different pixel arrangements) may share the same capacitance Ci with another conductive line 1668 in the active area 1564 of the electronic display 18 because the other line 1668 is aligned equally between the data lines 1572A and 1572B. The other line 1668 may be any other conductive line, such as a power supply line like a high or low voltage rail for electroluminance of the pixels 1566 (e.g., VDDEL or VSSEL). Here, the data lines 1572A and 1572B appear in one layer 1670, while the conductive line 1668 appears in a different layer 1672. Being in two separate layers 1670 and 1672, the data lines 1572A and 1572B may be fabricated at a different step in the manufacturing process from the conductive line 1668. Thus, it is possible for the layers to be misaligned when the electronic display 18 is fabricated.

Such layer misalignment is shown in FIG. 95. In the example of FIG. 95, the conductive line 1668 is shown to be farther from the first data line 1572A and closer to the second data line 1572B. This produces an unequal capacitance between the first data line 1572A and the conductive line 1668 in comparison to the second data line 1572B and the conductive line 1668. These are shown as a capacitance C on the data line 1572A and a capacitance C+ΔC on the data line 1572B.

These different capacitances on the data lines 1572A compared to 1572B suggest that differential sensing may be enhanced by differentially sensing a data line 1572A with another data line 1572A, and sensing a data line 1572B with another data line 1572B. When there are an even number of electrically similar data lines 1572A and an even number of electrically similar data lines 1572B, differential sensing can take place in the manner described above with reference to FIG. 92. An odd number of electrically similar data lines 1572A or an odd numbers of electrically similar data lines 1572B, however, may introduce challenges. Indeed, when each electrically similar data line 1572A is differentially sensed with one other electrically similar data line 1572A, that would leave one remaining data line 1572A that is not differentially sensed with another electrically similar data line 1572A. The same would be true for the electrically similar data lines 1572B.

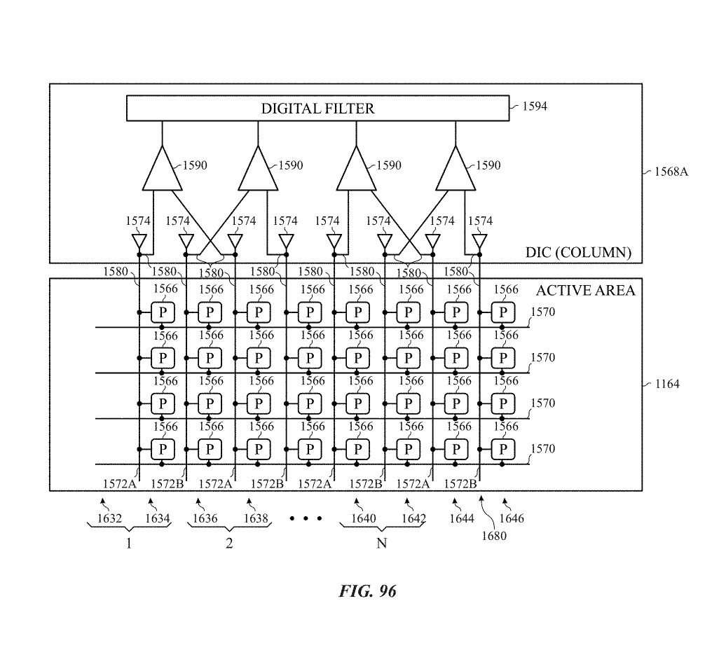

A few approaches to differential sensing that can accommodate an odd number of electrically similar data lines 1572A or 1572B are described with reference to the subsequent drawings. Namely, as shown in FIG. 96, there may be an odd number of groups of columns 1632 and 1634 that are coupled respectively to data lines 1572A and 1572B. In this example, there are N groups of columns 1632 and 1634, where N is an odd number. As a result, there may be one remaining group of columns 1632 and 1634 on the active area 1564 that are not able to be sensed differentially with another respective column 1632 or 1634 on the active area 1564. Accordingly, the approach of FIG. 96 adds dummy columns 1680 that includes additional dummy circuitry that will not be used to actively display image data (e.g., may be disposed outside of a portion of the active area 1564 that will be visible). The dummy columns 1680 include a dummy data line 1572A that can be differentially sensed with the last data line 1572A of the Nth column, and a dummy data line 1572B that can be differentially sensed with the data line 1572B of the Nth column. In this way, differential sensing may be used, even for an active area 1564 that includes an odd number of electrically similar columns for display.

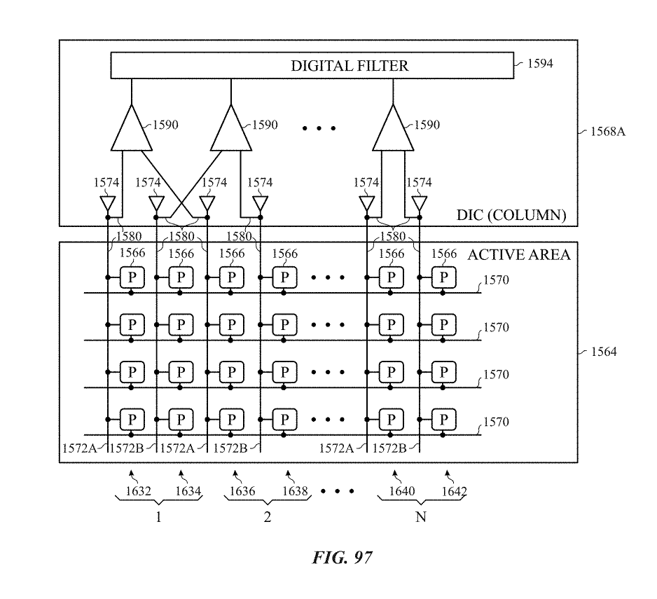

Another example is shown in FIG. 97, which does not include any dummy data lines 1572A or 1572B, but rather differentially senses the final columns 1632 and 1634 of the Nth column together. Although the data lines 1572A and 1572B of the Nth group of columns are not entirely electrically similar, this may at least permit differential sensing to occur when the number of electrically similar columns of the active area 1564 is an odd number.

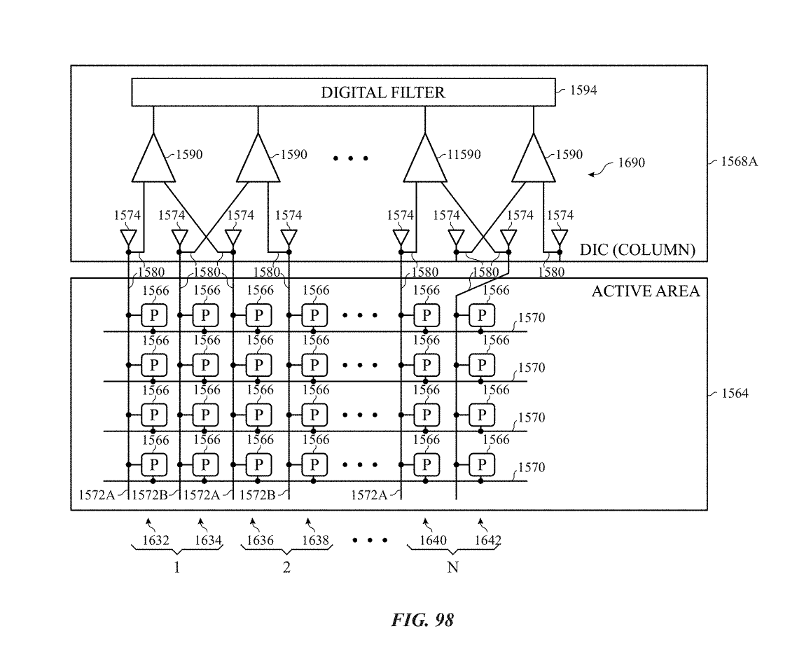

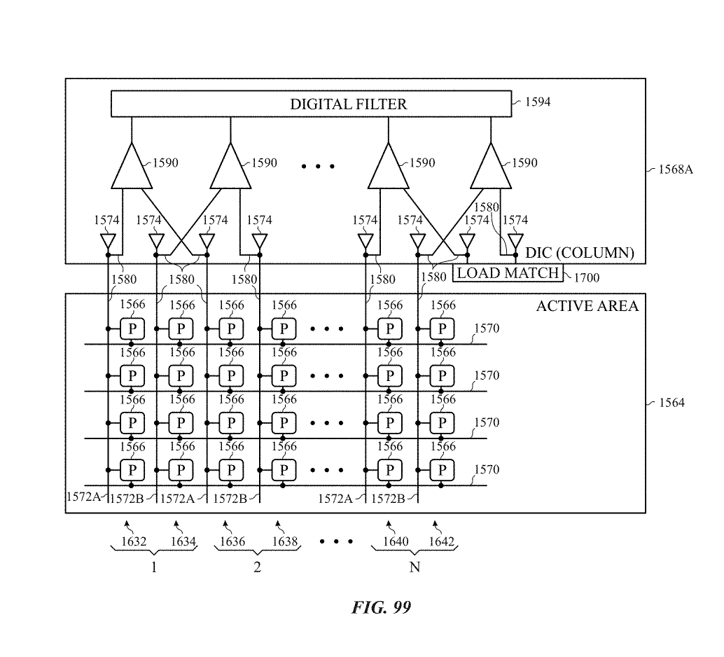

A variation of the circuitry of FIG. 97 may involve maintaining a common differential sensing structure, but may use a different form of sensing routing, as shown in FIG. 98. Here, electrical variations in the driver integrated circuit 1568 in the form of differential sensing used for groups of columns 1, 2, and so forth may be involve the same additional circuitry 1690 for Nth group of columns. Additionally or alternatively, load matching may be applied to enable differential sensing for an odd number N groups of columns, as shown in FIG. 99. Indeed, in FIG. 99, the driver integrated circuit 1568 may include differential sensing circuitry, such as the sense amplifiers 1590, coupled to load matching circuitry 1700. The load matching circuitry 1700 may apply a load to have roughly the same electrical characteristics as the column 1572A when the column 1572A of the Nth group of columns is differentially sensed, and to apply a capacitance of roughly the same capacitance as the data line 1572B when the data line 1572B of the Nth group of columns is differentially sensed.

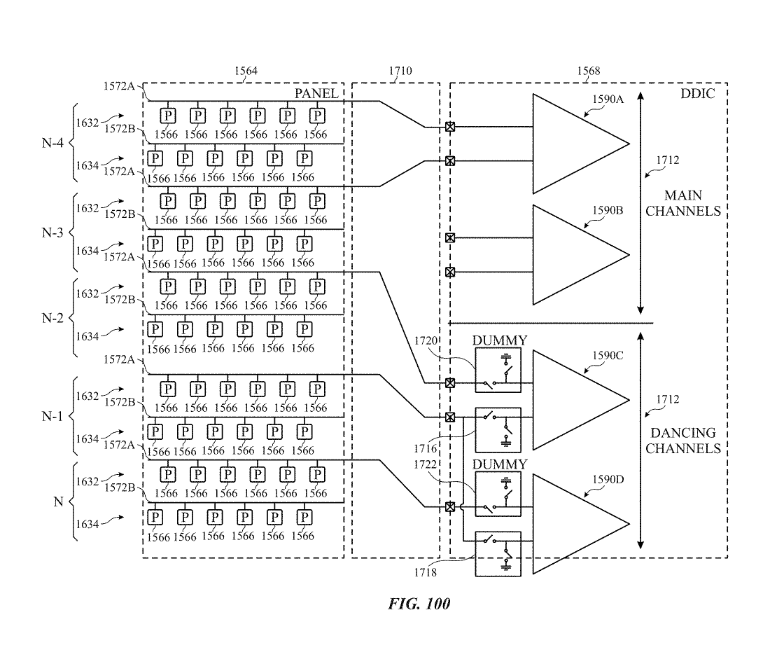

Another manner of differentially sensing an odd number of electrically similar columns is shown in FIG. 100. In FIG. 100, the active area 1564 is connected to the display driver integrated circuit 1568 through routing circuitry 1710. The routing circuitry 1710 may be a chip-on-flex (COF) interconnection, or any other suitable routing circuitry to connect the driver integrated circuit 1568 to the active area 1564 of the electronic display 18. The sensing circuity of the driver integrated circuit 1568 may be connected to a first number of fixed channels 1712 and a second number of dancing channels 1714.

When the active area 1564 of the electronic display 18 includes an even number of electrically similar columns, such as an even number of data lines 1572A and even number of data lines 1572B, the routing circuitry 1710 may route all of the columns to the main fixed channels 1712. When the active area 1564 of the electronic display 18 includes an odd number N of the data lines 1572A or 1572B, the routing circuitry 1710 may route at least three of each of the data lines 1572A and at least three of the 1572B to the dancing channels 1714. In this example, the electronic display 18 includes an active area 1564 with in N odd groups of columns, each of which includes two data lines 1572A and 1572B that are more electrically similarly to other respective data lines 1572A and 1572B than to each other (i.e., a data line 1572A may be more electrically similar to another data line 1572A, and a data line 1572B may be more electrically similar to another data line 1572B). For ease of explanation, only sense amplifiers 1590A, 1590B, 1590C, and 1590D that are used to sense the data lines 1572A are shown. However, it should be understood that similar circuitry may be used to differentially sense the other electrically similar data lines 1572B. Here, the last three groups of columns N, N-1, and N-2 are routed to the dancing channels 1714.

The dancing channels 1714 allow differential sensing of the odd number of electrically similar using switches 1716 and 1718. The switches 1716 and 1718 may be used to selectively route the data line 1572A from the N−1 group of columns to the sense amplifier 1590C for comparison with (1) the data line 1572A from the N−2 group of columns or (2) the sense amplifier 1590D for comparison with the data line 1572A from the N group of columns. Dummy switches 1720 and 1722 may be provided for load-matching purposes to offset the loading effects of the switches 1716 and 1718.

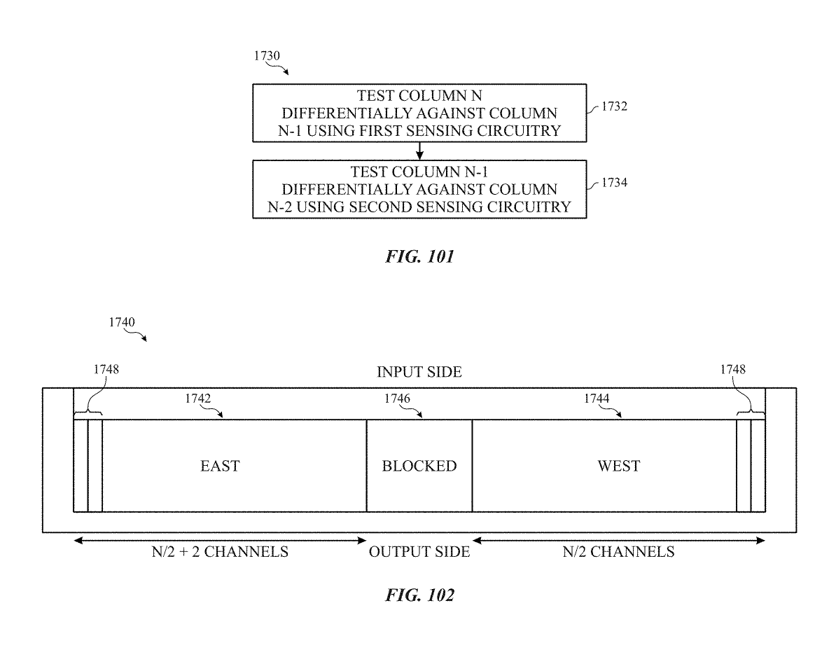

Thus, the dancing channels 1714 shown in FIG. 100 may allow each of the odd number N of electrically similar channels 1572A to be differentially sensed with another electrically similar channel 1572A, as described by a flowchart 1730 shown in FIG. 101. Namely, at one point in time, the data lines 1572A from column N may be differentially sensed against the data line 1572A from column N−1 using first sensing circuitry (e.g., sense amplifier 1590D) (block 1732). The data line 1572A from column N−1 may be differentially tested against the data line 1572A of column N−2 using second sensing circuitry (e.g., sense amplifier 1590C) (block 1734).

The dancing channels shown in FIG. 100 may be located on a display driver channel configuration 1740 as shown in FIG. 102. In FIG. 102, active east channels 1742 are equal in number to N/2+2 total channels, while active west channels 1744 encompass N/2 channels. A space of unused channels 1746 may be included when fewer total channels are used than all of the channels that may be available on the driver integrated circuit. Channels 1748 represent the dancing channels 1714. Here, the dancing channels 1748 may appear as part of both the east channels 1742 and the west channels 1744 to maintain loading similarity.

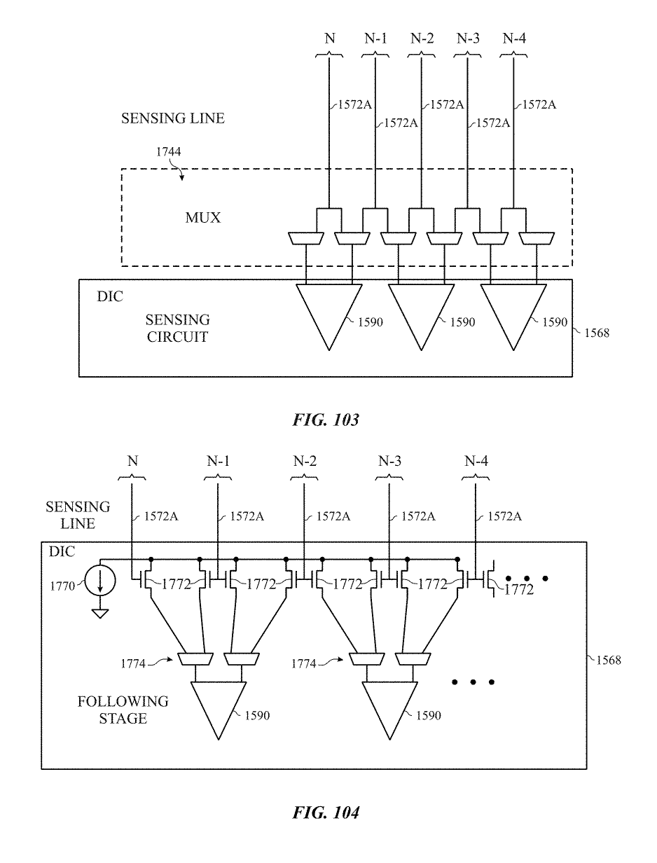

FIG. 103 represents an example of dancing channels that may occur over a wider portion of the active area 1564 of the electronic display 18. Indeed, the dancing channels may have access to data lines 1572 from the entire active area 1564. Furthermore, while the example shown in FIG. 103 relates to voltage sensing, it should be appreciated that, in other examples, current sensing may be used instead. The circuitry of FIG. 103 includes the sensing circuitry of the driver integrated circuit 1568, which includes a number of differential sense amplifiers 1590 that are coupled to selection circuitry 1760. The selection circuitry 1760 may be part of the driver integrated circuit 1568, or may be located on the active area 1564, or may be located on routing circuitry between the driver integrated circuit 1568 and the active area 1564, or may be distributed across these locations. The selection circuitry 1760 enables electrically similar data lines 1572A to be sensed in combination with neighboring electrically similar data lines 1572A at different points in time. For example, at one time, data lines 1572A from columns N and N−1 may be differentially sensed, data lines 1572A from columns N−2 and N−3 may be sensed. At another time, data lines from columns N−1 and N−2 may be differentially sensed, and the data lines 1572A from columns N−3 and N−4 may be differentially sensed, and so forth.

An example of dancing channels that use current sensing is shown in FIG. 104. In the example of FIG. 104, electrically similar data lines 1572A from 5 columns N, N−1, N−2, N−3, and N−4 are shown. It should be appreciated that any suitable number of data lines 1572A may be used and this pattern may repeat any suitable number of times as desired. A current source 1770 is applied to sense transistors 1772 that sense the signal on the electrically similar data lines 1572A. A variable amount of the current signal from the current source 1770 passes through the sense transistors 1772 onto selection circuitry 1774. The selection circuitry 1774 may be used to select which of the electrically similar data lines 1572A are differentially sensed. Indeed, in the circuitry of FIG. 104, the selection circuitry 1774 may allow:
a. the data line 1572A from the column N to be differentially sensed with either of the data lines 1572A from columns N−1 or N−2;
b. the data line 1572A from the column N−1 to be differentially sensed with either of the data lines 1572A from columns N or N−2; and
c. the data line 1572A from the column N−2 to be differentially sensed with either of the data lines 1572A from columns N or N−1 or from columns N−3 or N−4.

The pattern shown in FIG. 104 may continue across channels from the entire display active area 1564.

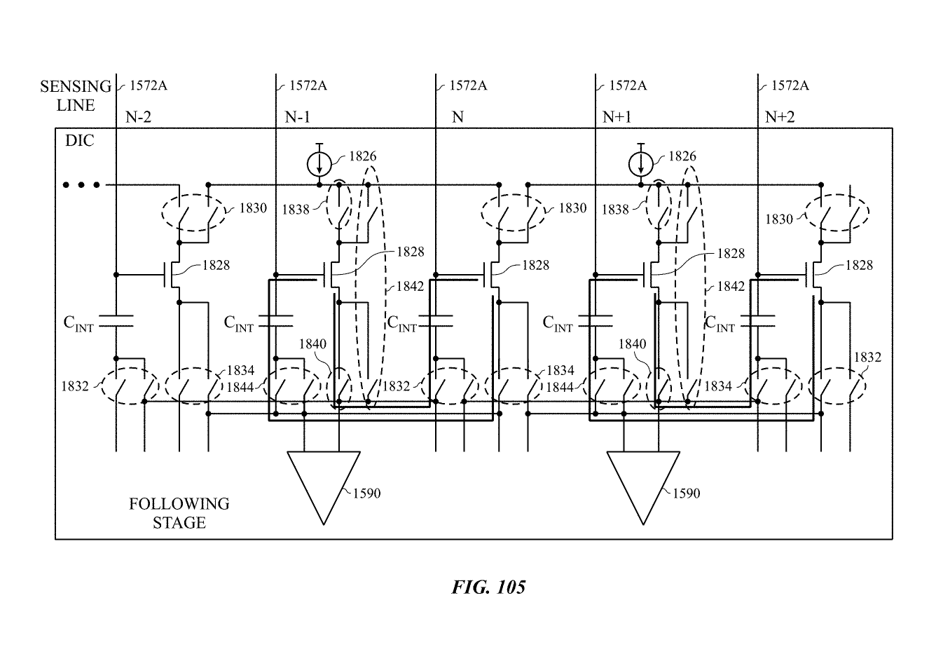

Dancing channels shown in FIG. 105 are implemented with slightly different circuitry. In this example, each data line 1572A from a number of columns N−2, N−1, N are coupled into sensing circuitry that uses current sensing based on one current source 1826, and data lines 1572A from columns N, N+1, N+2, are coupled into another current source 1826. Sense transistors 1828 may differentially sense the signals of two of the data lines 1572A as routed by the selection circuitry of FIG. 105, which will be described further below, based on the current source 1826 and an integration capacitance C_{INT}. For instance, switches 1830, 1832, and 1834 allow the data line 1572A of column N to be differentially sensed with the data line 1572A of column N−1 or the data line 1572A of column N+1, as well as to pass further signals down to following stages of differential sensing with other columns beyond those shown in FIG. 105. Switches 1838, 1840, 1842, and 1844 may operate as either dummy switches or to pass signals down to the following stages.

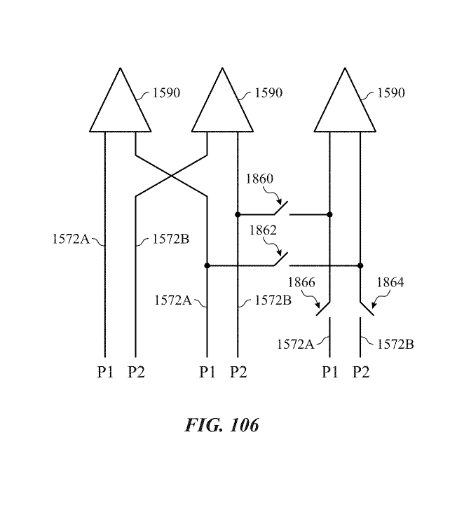

FIG. 106 represents an example of dancing channels as applied shown in FIG. 105 are implemented to the last, odd group of electrically similar columns. In FIG. 106, P1 represents a first type of pixels that may be present on the data line 1572A (e.g., red pixels and blue pixels), and P2 represents pixels that may be found on the data line 1572B (e.g., green pixels). A final sense amplifier 1590 may selectively differentially sense different electrically similar data lines 1572 using switches 1860, 1862, 1864, and 1866. The last electrically similar data line 1572A may be differentially sensed with the second-to-last data line 1572A by opening the switches 1860 and 1864 and closing the switches 1862 and 1866. The last electrically similar data line 1572B may be differentially sensed with the second-to-last data line 1572B by closing the switches 1860 and 1864 and opening the switches 1862 and 1866.

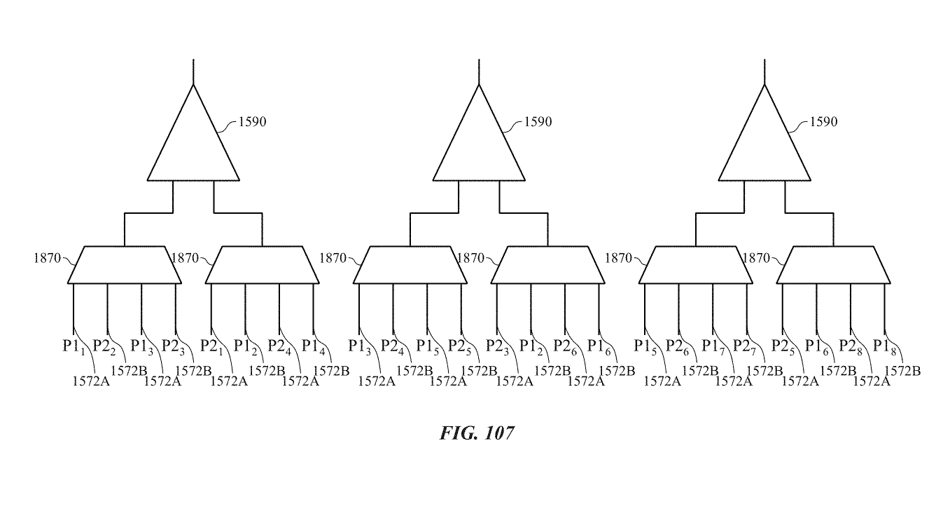

An example of dancing channels shown in FIG. 107 may enable an even greater number of differential sensing patterns. Here, differential sense amplifiers 1590 are coupled to selection circuitry 1870, each of which has four inputs. In the example of FIG. 107, the four inputs include data lines 1572 from with both electrically similar and electrically dissimilar characteristics. For example, in the example of FIG. 107, a first selection circuitry 1870 may selectively allow a signal to be sensed from a first column of a pixel of a first type (P1₁) (e.g., alternating rows of red pixels and blue pixels), a second column of a pixel of a second type (P2₂) (e.g., rows of second green pixels), a third column of a pixel of the first type (P1₃) (e.g., alternating rows of red pixels and blue pixels), and a third column of a pixel of a second type (P2₃) (e.g., rows of first green pixels), and a second selection circuitry 1870 may selectively allow a signal to be sensed from a first column of a pixel of the second type (P2₁) (e.g., rows of first green pixels), a second column of a pixel of the first type (P1₂) (e.g., alternating rows of blue and red pixels), a fourth column of a pixel of the second type (P2₄) (e.g., rows of the second green pixels), and a fourth column of a pixel of the first type (P1₄) (e.g., alternating rows of blue and red pixels), which may be done for a red-green-blue-green (RGBG) pixel arrangement on the active area 1564 of the electronic display 18. Similar arrangements are coupled to other sense amplifiers 1590. In effect, this may allow a given column of pixels to be sensed with a wide variety of other columns of pixels as desired. It should be appreciated that the arrangement shown in FIG. 107 is provided by way of example, and that many other arrangements may be used. Indeed, in another example, each selection circuitry 1870 may include three inputs, and fewer columns of pixels may be differentially sensed in relation to each other, or may include more than four inputs, and more columns of pixels may be differentially sensed in relation to each other.

### 2. Pre-Conditioning Treatment Before Sensing

Visual artifacts, such as images that remain on the display subsequent to powering off the display, changing the image, ceasing to drive the image to the display, or the like, can be reduced and/or eliminated through the use of active panel conditioning during times when one or more portions of the display is off (e.g., powered down or otherwise has no image being driven thereto). The active panel conditioning can be chosen, for example, based on the image most recently driven to the display (e.g., the image remaining on the display) and/or characteristics of the unique to the display so as to effectively increase hysteresis of driver TFTs of the display.

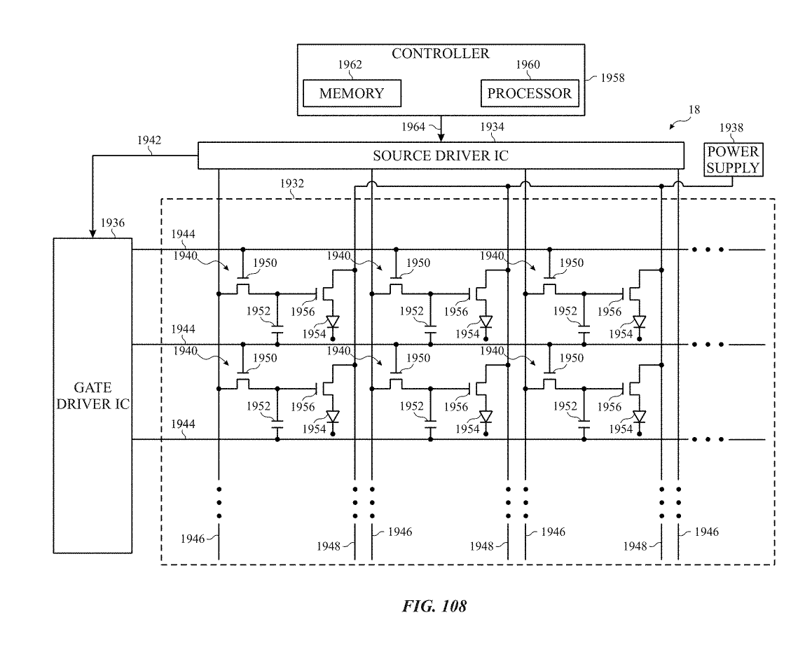

To help illustrate, one embodiment of a display 18 is described in FIG. 108. As depicted, the display 18 includes a display panel 1932, a source driver 1934, a gate driver 1936, and a power supply 1938. Additionally, the display panel 1932 may include multiple display pixels 1940 arranged as an array or matrix defining multiple rows and columns. For example, the depicted embodiment includes a six display pixels 1940. It should be appreciated that although only six display pixels 1940 are depicted, in an actual implementation the display panel 1932 may include hundreds or even thousands of display pixels 1940.

As described above, display 18 may display image frames by controlling luminance of its display pixels 1940 based at least in part on received image data. To facilitate displaying an image frame, a timing controller may determine and transmit timing data 1942 to the gate driver 1936 based at least in part on the image data. For example, in the depicted embodiment, the timing controller may be included in the source driver 1934. Accordingly, in such embodiments, the source driver 1934 may receive image data that indicates desired luminance of one or more display pixels 1940 for displaying the image frame, analyze the image data to determine the timing data 1942 based at least in part on what display pixels 1940 the image data corresponds to, and transmit the timing data 1942 to the gate driver 1936. Based at least in part on the timing data 1942, the gate driver 1936 may then transmit gate activation signals to activate a row of display pixels 1940 via a gate line 1944.

When activated, luminance of a display pixel 1940 may be adjusted by image data received via data lines 1946. In some embodiments, the source driver 1934 may generate the image data by receiving the image data and voltage of the image data. The source driver 1934 may then supply the image data to the activated display pixels 1940. Thus, as depicted, each display pixel 1940 may be located at an intersection of a gate line 1944 (e.g., scan line) and a data line 1946 (e.g., source line). Based on received image data, the display pixel 1940 may adjust its luminance using electrical power supplied from the power supply 1938 via power supply lines 1948.

As depicted, each display pixel 1940 includes a circuit switching thin-film transistor (TFT) 1950, a storage capacitor 1952, an LED 1954, and a driver TFT 1956 (whereby each of the storage capacitor 1952 and the LED 1954 may be coupled to a common voltage, Vcom). However, variations of display pixel 1940 may be utilized in place of display pixel 1940 of FIG. 108. To facilitate adjusting luminance, the driver TFT 1956 and the circuit switching TFT 1950 may each serve as a switching device that is controllably turned on and off by voltage applied to its respective gate. In the depicted embodiment, the gate of the circuit switching TFT 1950 is electrically coupled to a gate line 1944. Accordingly, when a gate activation signal received from its gate line 1944 is above its threshold voltage, the circuit switching TFT 1950 may turn on, thereby activating the display pixel 1940 and charging the storage capacitor 1952 with image data received at its data line 1946.

Additionally, in the depicted embodiment, the gate of the driver TFT 1956 is electrically coupled to the storage capacitor 1952. As such, voltage of the storage capacitor 1952 may control operation of the driver TFT 1956. More specifically, in some embodiments, the driver TFT 1956 may be operated in an active region to control magnitude of supply current flowing from the power supply line 1948 through the LED 1954. In other words, as gate voltage (e.g., storage capacitor 1952 voltage) increases above its threshold voltage, the driver TFT 1956 may increase the amount of its channel available to conduct electrical power, thereby increasing supply current flowing to the LED 1954. On the other hand, as the gate voltage decreases while still being above its threshold voltage, the driver TFT 1956 may decrease amount of its channel available to conduct electrical power, thereby decreasing supply current flowing to the LED 1954. In this manner, the display 18 may control luminance of the display pixel 1940. The display 18 may similarly control luminance of other display pixels 1940 to display an image frame.

As described above, image data may include a voltage indicating desired luminance of one or more display pixels 1940. Accordingly, operation of the one or more display pixels 1940 to control luminance should be based at least in part on the image data. In the display 18, a driver TFT 1956 may facilitate controlling luminance of a display pixel 1940 by controlling magnitude of supply current flowing into its LED 1954 (e.g., its OLED). Additionally, the magnitude of supply current flowing into the LED 1954 may be controlled based at least in part on voltage supplied by a data line 1946, which is used to charge the storage capacitor 1952.

FIG. 108 also includes a controller 1958, which may be part of the display 18 or externally coupled to the display 18. The source driver 1934 may receive image data from an image source, such the controller 1958, the processor 12, a graphics processing unit, a display pipeline, or the like. Additionally, the controller 1958 may generally control operation of the source driver 1934 and/or other portions of the electronic display 18. To facilitate control operation of the source driver 1934 and/or other portions of the electronic display 18, the controller 1958 may include a controller processor 1960 and controller memory 1962. More specifically, the controller processor 1960 may execute instructions and/or process data stored in the controller memory 1962 to control operation in the electronic display 18. Accordingly, in some embodiments, the controller processor 1960 may be included in the processor 12 and/or in separate processing circuitry and the memory 1962 may be included in memory 14, storage device 16, and/or in a separate tangible non-transitory computer-readable medium. Furthermore, in some embodiments, the controller 1958 may be included in the source driver 1934 (e.g., as a timing controller) or may be disposed as separate discrete circuitry internal to a common enclosure with the display 18 (or in a separate enclosure from the display 18). Additionally, the controller 1958 may be a digital signal processor (DSP), an application-specific integrated circuit (ASIC), or an additional processing unit.

Furthermore, the controller processor 1960 may interact with one or more tangible, non-transitory, machine-readable media (e.g., memory 1962) that stores instructions executable by the controller to perform the method and actions described herein. By way of example, such machine-readable media can include RAM, ROM, EPROM, EEPROM, or any other medium which can be used to carry or store desired program code in the form of machine-executable instructions or data structures and which can be accessed by the controller processor 1960 or by any processor, controller, ASIC, or other processing device of the controller 1958.

The controller 1958 may receive information related to the operation of the display 18 and may generate an output 1964 that may be utilized to control operation of the display pixels 1940. The output 1964 may be utilized to generate, for example, control signals in the source driver 1934 for control of the display pixels 1940. Additionally, in some embodiments, the output 1964 may be an active panel conditioning signal utilized to reduce hysteresis in driver TFTs 1956 of the LEDs 1954. Likewise, the memory 1962 may be utilized to store the most recent image data transmitted to the display 18 such that, for example, the controller processor 1960 may operate to actively select characteristics of the output 1964 (e.g., amplitude, frequency, duty cycle values) for the output 1964 (e.g., a common mode waveform) based on the most recent image displayed on the LED 1954. Additionally or alternatively, the output 1964 may be selected for example, by the controller processor 1960, based on stored characteristics of the LED 1954 that may be unique to each device 10.

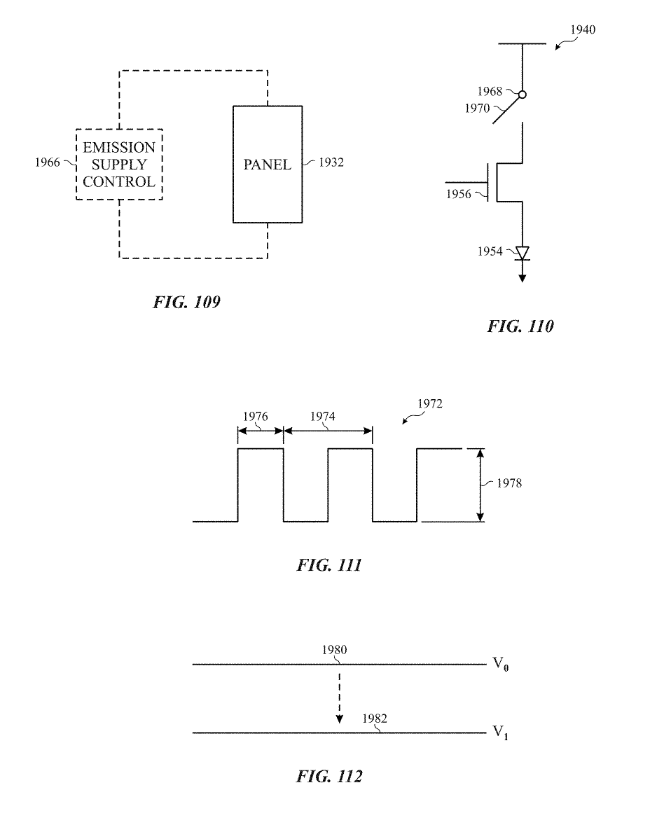

Active panel conditioning may be undertaken when the display 18 is turned off. In some embodiments, a gate source voltage (Vgs) value may be transmitted to and applied to the driver TFTs 1956, for example, as an active panel conditioning signal, which may be part of output 1964 or may be output 1964. In some embodiments, the active panel conditioning signal (e.g., the Vgs signal) may be a fixed value (e.g., a fixed bias voltage level or value) while in other embodiments, the active panel conditioning signal may be a waveform, which will be discussed in greater detail with respect to FIGS. 111 and 112 below. Fixed voltage schemes (e.g., using a fixed value as the active panel conditioning signal) may have power advantages for the device 10 since, for example, one or more of the portions of the device, such as the processor 12, may shut down and/or may be placed into a sleep mode to save power while, for example the controller 1958 and/or the source driver 1934 and the gate driver 1936 can continue operation. In other embodiments, the controller 1958 (in conjunction with or separate from processor 12) may shut down and/or may be placed into a sleep mode to save power while, for example the source driver 1934 and the gate driver 1936 continue operation. Regardless of the active panel conditioning signal transmitted to the display 18, during the time that the active panel conditioning occurs (e.g., while an active panel conditioning signal is being transmitted to the display 18), it is desirable that emission of light from the display 18 is prevented. FIGS. 109 and 110 illustrate examples of techniques for prevention of emission of light during a time in which active panel conditioning occurs.

FIG. 109 illustrates an example whereby emission by the display panel 1932 is prevented, e.g., during active panel conditioning. In some embodiments, this may include, for example, adjustment of the electrical power supplied from the power supply 1938 via power supply lines 1948. This adjustment may be controlled, for example, by an emission supply control circuit 1966 (e.g., a power controller) that dynamically controls the output of power supply 1938. In other embodiments, the controller 1958 (e.g., via the controller processor 1960) or the processor 12 may control the output of power supply 1938. The emission control circuit 1966 or the controller 1958 may cause the power supply 1938 to cease transmission of voltage along supply lines 1948 during time in which the display panel 1932 is off and/or during time in which an active panel conditioning signal is being transmitted to the display panel 1932 (although, for example, gate clock generation and transmission may be continued). Through restriction of voltage transmitted along voltage supply lines 1948, emission of light by the display 18 can be eliminated. An alternative technique to prevent emission of light from the display panel 1932 is illustrated in FIG. 110.

FIG. 110 illustrates inclusion of a switch 1968 that may operate to control emission from a pixel 1940 of the display panel. As illustrated, the switch 1968 may be opened, for example, via a control signal 1970. This control signal 1970 may be generated and transmitted from, for example, the controller 1958 (e.g., via the controller processor 1960). For example, the control signal 1970 may be part of output 1964 when the display 18 is turned off. In some embodiments, the control signal 1970 may be distributed in parallel to each of the pixels 1940 of the display panel 1932 or to a portion of the pixels 1940 of the display panel 1932. Through opening of the switch 1968, voltage may be prevented from being transmitted to the LED 1954, thus preventing emission of light from the LED 1954. Accordingly, by application of the control signal 1970 to any switch 1968 for a respective pixel 1940 of the display panel 1932, emission of light from the LED 1954 of that pixel 1940 may be controlled.

As previously noted, elimination of the emission of light from the display 18 may coincide with application of an active panel control signal. FIG. 111 illustrates a first example of an active panel conditioning control signal 1972 that may be transmitted to one or more of the pixels of the display 18. As illustrated, active panel conditioning control signal 1972 may be a waveform. In some embodiments, this waveform may be dynamically adjustable, for example, by the controller 1958 (e.g., via the controller processor 1960). For example, the frequency 1974 of the active panel conditioning control signal 1972, the duty cycle 1976 of pulses of the active panel conditioning control signal 1972, and/or the amplitude 1978 of the active panel conditioning control signal 1972 may each be adjusted or selected to be at a determined value.

Additionally, alteration or selection of the characteristics of the active panel conditioning control signal 1972 (e.g., adjustment of one or more of the frequency 1974, the duty cycle 1976, and/or the amplitude 1978) may be chosen based on device 10 characteristics (e.g., characteristics of the display panel 1932) such that the active panel conditioning control signal 1972 may be optimized for a particular device 10. Additionally and/or alternatively, the most recent image displayed on the display 18 may be stored in memory (e.g., memory 1962) and the processor 1960, for example, may perform alteration or selection of the characteristics of the active panel conditioning control signal 1972 (e.g., adjustment of one or more of the frequency 1974, the duty cycle 1976, and/or the amplitude 1978) based on the saved image data such that the active panel conditioning control signal 1972 may be optimized for a particular image. However, in some embodiments, a waveform as the active panel conditioning control signal 1972 may not be the only type of signal that may be used as part of the active panel conditioning of a display 18.

As illustrated in FIG. 112, an active panel conditioning control signal 1980 that may be transmitted to one or more of the pixels of the display 18 may have a fixed bias (e.g., voltage level) of V₀. Likewise, an active panel conditioning control signal 1982 that may be transmitted to one or more of the pixels of the display 18 may have a fixed bias (e.g., voltage level) of V₁. In some embodiments, V₀ may correspond to a “white” image while V₁ may correspond to a “black” image, although, any value between V₀ and V₁ may be chosen. For example, if V₀ corresponds greyscale value of 255 and V₀ corresponds to a greyscale value of 0, any greyscale value therebetween (inclusive of 0 and 255) may be chosen as a fixed bias level for the active panel conditioning control signal generated and supplied to the driver TFTs of the display 18.

Alteration or selection of a fixed bias level for an active panel conditioning control signal may be chosen based on device 10 characteristics (e.g., characteristics of the display panel 1932) such that the active panel conditioning control signal may be optimized for a particular device 10. Additionally and/or alternatively, the most recent image displayed on the display 18 may be stored in memory (e.g., memory 1962) and the processor 1960, for example, may perform alteration or selection of a fixed bias level for an active panel conditioning control signal based on the saved image data such that the active panel conditioning control signal may be optimized for a particular image.

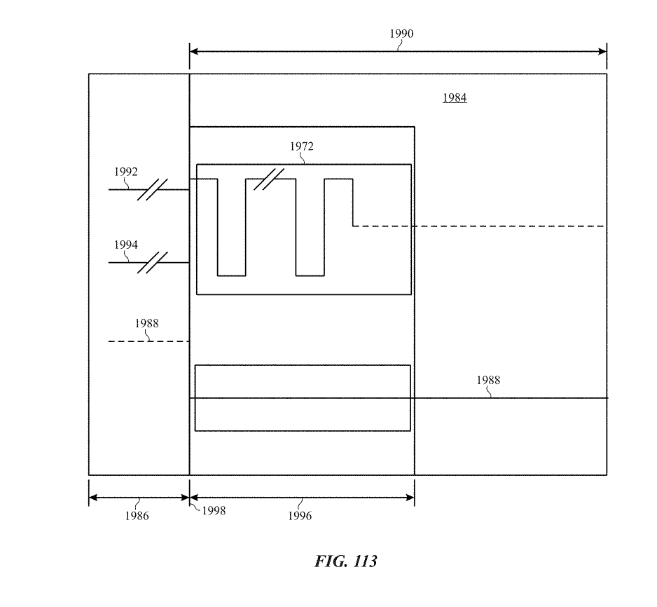

FIG. 113 illustrates a timing diagram 1984 illustrating active panel conditioning with the active panel conditioning control signal 1972. However, it should be noted that active panel conditioning control signal 1980 or 1982 can be substituted for the active panel conditioning control signal 1972 in FIG. 113. During a first period of time 1986 the display 18 is on and an emission signal 1988 is illustrated as being logically “1” or “high” to indicate that the display 18 is emitting light. During a second period of time 1990, the display 18 is off and the emission signal 1988 is illustrated as being logically “0” or “low” to indicate that the display 18 no longer emitting light (for example, as discussed in conjunction with FIGS. 109 and 110). Likewise, during the first period of time 1986, a first pixel 1940 has a gate source voltage (Vgs) value 1992, while a second pixel 1940 has a Vgs value 1994 that each correspond to the operation of the respective pixel 1940 during the image generation and display of that image during the first period of time 1986. While only two Vgs values 1992 and 1994 are illustrated, it is understood that each active pixel 1940 of the display 18 has a respective Vgs value corresponding to an image being generated during the first period of time 1986.

During the second period of time 1990, the active panel conditioning control signal 1972 may be transmitted to each of the pixels 1940 of the display 18 (or to a portion of the pixels 1940 of the display 18) for a third period of time 1996, which may be a subset of time of the second period of time 1990 that begins at time 1998 between the first period of time 1986 and the second period of time 1990 (e.g., where time 1998 corresponds to a time at which the display 18 is turned off or otherwise deactivated). Through application of the active panel conditioning control signal 1972 to the respective pixels 1940, the hysteresis of the driving TFTs 1956 associated with the respective pixels 1940 may be reduced so that at the completion of the second period of time 1990, the Vgs values 1992 and 1994 will be reduced from their levels illustrated in the first period of time 1986 so that the image being displayed during the first period of time 1986 will not be visible or will be visually lessened in intensity (e.g., to reduce or eliminate any ghost image, image retention, etc. of the display 18).

Effects from the aforementioned active panel conditioning are illustrated in the timing diagram 2000 of FIG. 114. During time 1986, the display 18 is on and the display 18 is emitting light. During time 1990, the display 18 is off and the display 18 no longer emitting light (for example, as discussed in conjunction with FIGS. 109 and 110). Time 1998 corresponds to a time at which the display 18 is turned off or otherwise deactivated and time 2002 corresponds to a time at which the display 18 is turned on or otherwise activated to emit light (e.g., generate an image). Likewise, a first pixel 1940 has a Vgs value 1992, while a second pixel 1940 has a Vgs value 1994 that each correspond to the operation of the respective pixel 1940 during the image generation and display of that image during the periods of time 1986. Moreover, while only two Vgs values 1992 and 1994 are illustrated, it is understood that each active pixel 1940 of the display 18 has a respective Vgs value corresponding to an image being generated during a respective period of time 1986.

Additionally, during the periods of time 1990, an active panel conditioning control signal (e.g., active panel conditioning control signal 1972 or active panel conditioning control signal 1980) may be transmitted to each of the pixels 1940 of the display 18 (or to a portion of the pixels 1940 of the display 18) for the periods of time 1996, which may be a subset of times 1990 that begin at times 1998. As illustrated, through application of the active panel conditioning control signal to the respective pixels 1940, the hysteresis of the driving TFTs 1956 associated with the respective pixels 1940 may be reduced so that at the completion of times 1990, the Vgs values 1992 and 1994 are reduced from their levels illustrated in the respective periods of time 1986 so that images corresponding to the Vgs values 1992 and 1994 of a prior period of time 1986 are not carried over into a subsequent period of time 1986 (e.g., reducing or eliminating any ghost image, image retention, etc. of the display 18 from previous content during subsequent display time periods 1986).

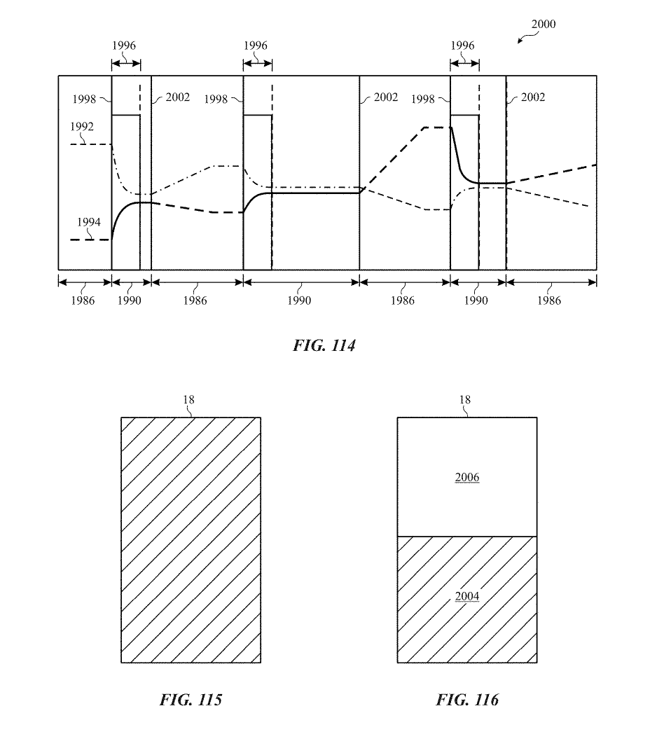

As illustrated in FIG. 115, active panel conditioning of a display 18 may be applied to an entire display 18 for a period of time 1996 (e.g., an active panel conditioning signal may be applied to each driving TFT 1956 of a display 18). However, as illustrated in FIG. 116, active panel conditioning of a display 18 may be applied, instead, to a portion 2004 of a display 18 while a second portion 2006 of the display 18 does not have active panel conditioning applied thereto. For example, in some embodiments, at time 1998, only the portion 2004 of the display 104 may be turned off and, accordingly, only portion 2004 may have an active panel conditioning signal applied to each driving TFT 1956 of the portion 2004 of the display 18 during a period of time 1996. In other embodiments, it may be desirable to refrain from active panel conditioning of portion 2006 of a display 18 even when the entire display is turned off at time 1998, for example, if portion 2006 is likely to have the same or a similar image generated therein when the display 18 is subsequently activated at time 2002.

As illustrated in the timing diagram 2007 of FIG. 117, active panel conditioning may occur in conjunction with additional sensing operations of display 18. For example, during time 1986, the display 18 is on and the display 18 is emitting light. During time 1990, the display 18 is off and the display 18 no longer emitting light (for example, as discussed in conjunction with FIGS. 109 and 110). Time 1998 corresponds to a time at which the display 18 is turned off or otherwise deactivated and additionally illustrated is a Vgs value 1992 of a first pixel 1940 and a Vgs value 1994 of a second pixel 1940 that each correspond to the operation of the respective pixel during the image generation and display of that image during a period of time 1986. Moreover, while only two Vgs values 1992 and 1994 are illustrated, it is understood that each active pixel 1940 of the display 18 may have a respective Vgs value corresponding to an image being generated during the period of time 1986.

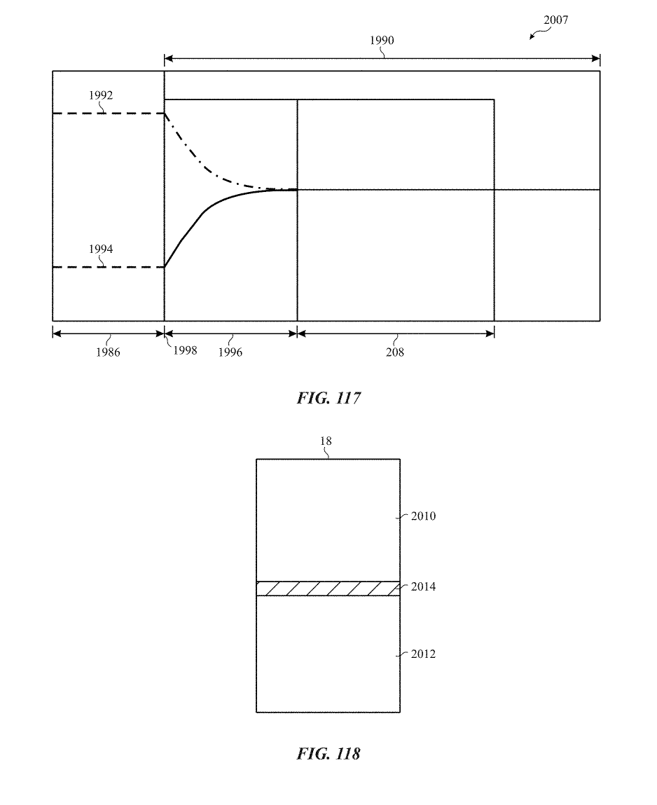

Additionally, during the period of time 1990, an active panel conditioning control signal (e.g., active panel conditioning control signal 1972 or active panel conditioning control signal 1980) may be transmitted to each of the pixels 1940 of the display 18 for the period of time 1996, which may be a subset of time 1990 that begins at time 1998. Alternatively, as will be discussed in conjunction with FIG. 118, an active panel conditioning control signal (e.g., active panel conditioning control signal 1972 or active panel conditioning control signal 1980) may be transmitted to one or more portions of the pixels 1940 of the display 18 for the period of time 1996. As illustrated, subsequent to the period of time 1996, a period of time 2008 is illustrated as a second subset of the period of time 1990. Period of time 2008 may correspond to a sensing period of time during which, for example, aging of pixels 1940 of the display 18 (or another operational characteristic of the display 18), an attribute affecting the display 18 (e.g., ambient light, ambient temperatures, etc.), and/or an input to the display 18 (e.g., capacitive sensing of a touch by a user, etc.) may be sensed. During the period of time 2008, the active panel conditioning control signal may be halted (e.g., transmission of the active panel conditioning control signal may cease as the sensing in time period 2008 begins).

As illustrated in FIG. 118, an active panel conditioning control signal (e.g., active panel conditioning control signal 1972 or active panel conditioning control signal 1980) may be transmitted to one or more portions 2010 and 2012 of the display 18 while another portion 2014 of the display 18 does not receive an active panel conditioning control signal. In some embodiments, the portion 2014 of the display 18 corresponds to a region in which the aforementioned sensing operation occurs. Accordingly, in some embodiments, active panel conditioning may occur in one or more portions 2010 and 2012 of the display 18 and not in another portion 2014 of the display 18 (e.g., allowing for the portion 2014 of the display 18 to operate in a sensing mode in parallel with the active panel conditioning of portions 2010 and 2012). This may increase the flexibility of the active panel conditioning operation, as it may be performed in a serial manner with a sensing operation (e.g., as illustrated in FIG. 117) or in parallel with a sensing operation (e.g., in conjunction with FIG. 118).

### 3. Common-Mode Noise Compensation

Display panel uniformity can be improved by estimating or measuring a parameter (e.g., current) through pixel, such as an organic light emitting diode (LED). Based on the measured parameter, a corresponding correction value may be applied to compensate for any offsets from an intended value. Per-pixel sensing schemes can employ the use of filters and other processing steps to help reduce or eliminate the unwanted effects of pixel leakage, noise, and other error sources. Although the application generally relates to sensing individual pixels, some embodiments may group pixels for sensing and observation such that at least one channel senses more than a single pixel. However, some external noise and error sources, such as capacitively coupled fluctuations in local supply voltage that result in common-mode error, may not be fully removable through the filtering process, resulting in erroneous correction values that compromise the effectiveness of the non-uniformity compensation. Moreover, this common-mode error is amplified by the inherent mismatches of parasitic capacitance values between different sensing channels within a display as a result of imperfect device process variations.

To address this common-mode error, when a given pixel current is being sensed through a channel (i.e., the sensing channel), a nearby pixel is also sensed through its own channel (i.e., the observation channel) while keeping the pixel emission off for the observation channel. Sensed parameter (e.g., current) value from the observation channel is scaled according to the relative mismatches of the sensing and observation channels as determined through an initial calibration process. Then, the scaled parameter is subtracted from the sensed current value from the sensing channel to determine a compensated sensing value.

The proximity of the nearby pixel, and hence the observation channel, is dependent on the accuracy level to be used in the system and correspondingly determines the spatial correlation to be used to achieve this accuracy level.

The differential input mismatch of the observation channel may be adjustable to ensure that the component of the sensed value attributed to noise and error is higher in the observation channel than it is in the sensing channel. Sensing from both the sensing channel and observation channel may occur at the same time to establish high time correlation. Moreover, the observation channel and/or the sensing channel may utilize single-ended and/or differential sensing channels.

FIG. 119 illustrates a block diagram view of a single-channel current sensing scheme 2100. As illustrated, a target pixel current is provided via a current source 2102. The current provided by the current source 2102 then is supplied to a current sensing system 2104 via a sensing channel 2106. The sensing channel 2106 may include a single-ended or a differential channel. The current sensing system 2104 then outputs an output 2108 that is used to compensate display panel operation. In other words, in the single-channel current sensing scheme 2100, a single channel 2106 is used to detect or estimate pixel current directly from a target pixel. Furthermore, the single-channel current sensing scheme 2100 may include amplifiers, filters, analog-to-digital converters, digital-to-analog converters, and/or other circuitry used for processing in the single-channel current sensing scheme 2100 that have been omitted from FIG. 119 for clarity.

The single-channel current sensing scheme 2100 detects at least some issues for the target pixel. But, common-mode noise sources, such as the noise source 2110, may be picked up by the current sensing system 2104 and converted into differential input by any inherent mismatches in the sensing channel 2106. This differential input may result in an error in the sensed current and a resultant error in the pixel current compensation of the output 2108.

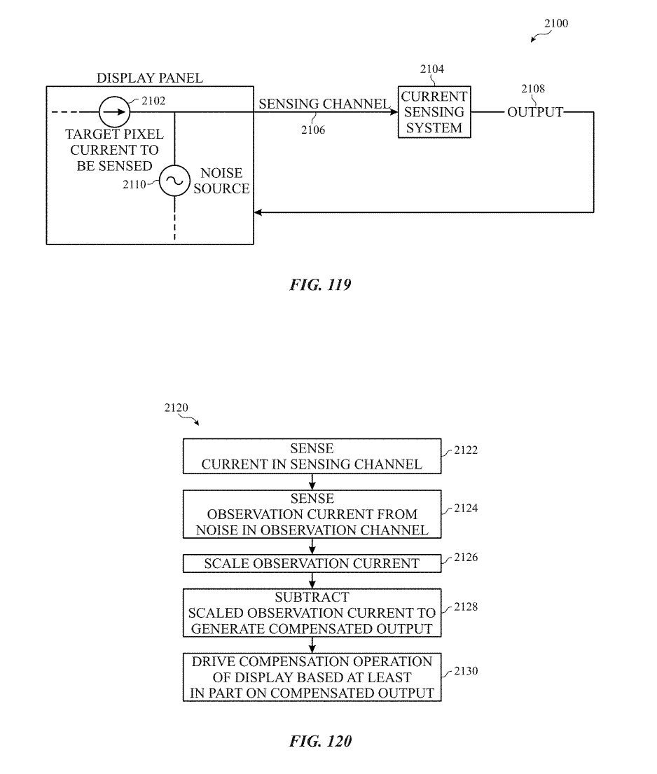

Instead of using a single channel to sense current, two channels may be used. FIG. 120 illustrates a flow diagram of a process 2120 for sensing a current using two channels. In a sensing channel of a display, a current is sensed through the sensing channel from a target current is driven from a current source (block 2122). An observation channel of the display is used to detect observation current attributable to noise, such as common-mode noise across the observation and sensing channels (block 2124). In an observation channel, no current is proactively driven through the channel other than noise generated in the system. For example, the observation channel may be decoupled from a current source used to send signals to a corresponding pixel to cause the pixel to display data. The current sensed on the observation channel is scaled based on a scaling factor determined during calibration (block 2126). In some embodiments, the calibration may be repeated prior to each sensing operation to ensure accuracy of the calculations using the scaling factor. The scaled current is then subtracted from the current found in the sensed channel to determine a compensated output (block 2128). The compensated output is used to compensate operation of the display (block 2130).

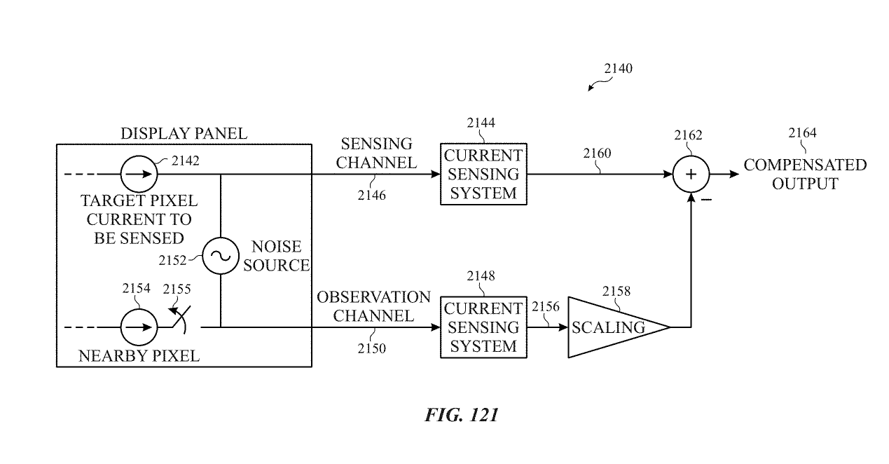

FIG. 121 illustrates a block diagram view of a dual-channel current sensing scheme 2140. As illustrated, a target pixel current is provided via a current source 2142. The current provided by the current source 2142 then is supplied to a current sensing system 2144 via a sensing channel 2146. For a pixel near the target pixel, a sensing system 2148 is used to detect current through an observation channel 2150 that receives current from a noise source 2152 (e.g., capacitive coupling). In other words, the observation channel is used to observe noise (e.g., common-mode noise) in the observation channel 2150 during driving of the sensing channel 2146 to determine a magnitude of the noise (e.g., common-mode noise).

To ensure that only noise is passed through the observation channel 2150, the observation channel 2150 may be decoupled from a corresponding current source 2154 via a switch 2155. A sensed observation current 2156 is scaled at scaling circuitry 2158 and subtracted from a sensed current 2160 at summing circuitry 2162 to generate a compensated output 2164 indicative of current through the sensing channel 2146 substantially attributable to the current provided by the current source 2142. The scaling factor may be determined in a calibration of the display panel to determine an output of each channel in response to an aggressor image/injected signal to determine channel properties to determine a common-mode error between channels.

Furthermore, the dual-channel current sensing scheme 2140 may include amplifiers, filters, analog-to-digital converters, digital-to-analog converters, and/or other circuitry used for processing in the dual-channel current sensing scheme 2140 that have been omitted from FIG. 121 for clarity.

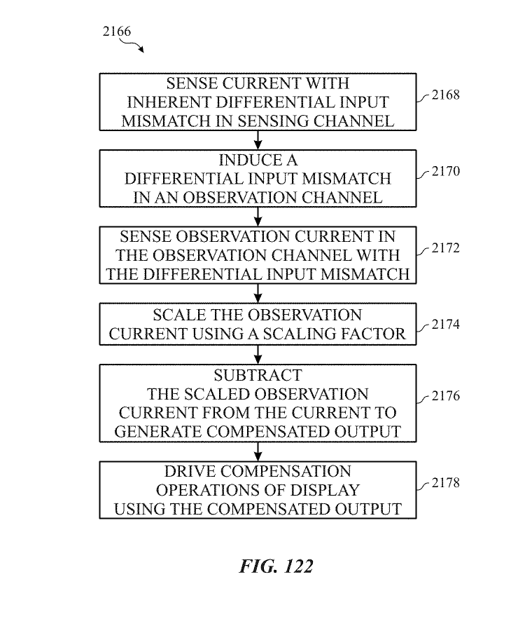

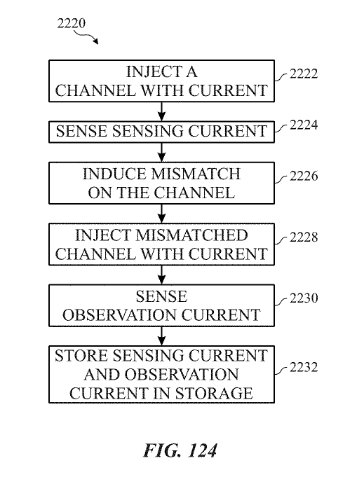

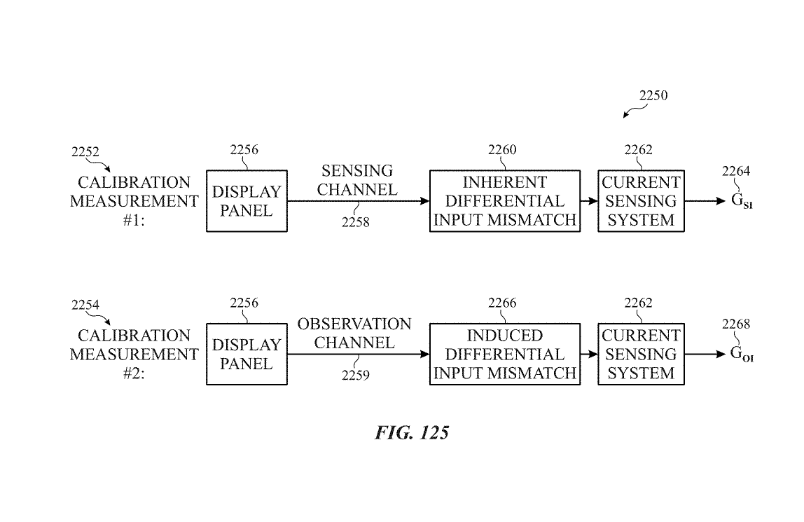

Each channel may include differential inputs. In embodiments with differential input channels, a sensing channel may utilize an inherent differential input mismatch while the observation channel may utilize an intentionally induced differential input mismatch to sense a time-correlated common-mode error. FIG. 122 illustrates a flow diagram of a process 2166 for sensing a current using two channels each having differential inputs. In a sensing channel, a target current is driven from a current source using and sensed with an inherent differential input mismatch (block 2168). An induced differential mismatch is induced in an observation channel (block 2170). The observation channel with the induced differential mismatch is used to sense an observation current derived from noise, such as common-mode noise across the observation and sensing channels (block 2172). In the observation channel, no current is proactively driven through the channel other than noise generated in the system. For example, the observation channel may be decoupled from a current source used to send signals to a corresponding pixel to cause the pixel to display data. The observation current sensed on the observation channel is scaled using scaling factor (block 2174). As discussed below in relation to FIGS. 124 and 125, the scaling factor may be determined from a calibration of the display panel. The scaled current sense is subtracted from the sensed channel to determine a compensated output (block 2176). The compensated output is used to drive compensation operations of the display (block 2178).

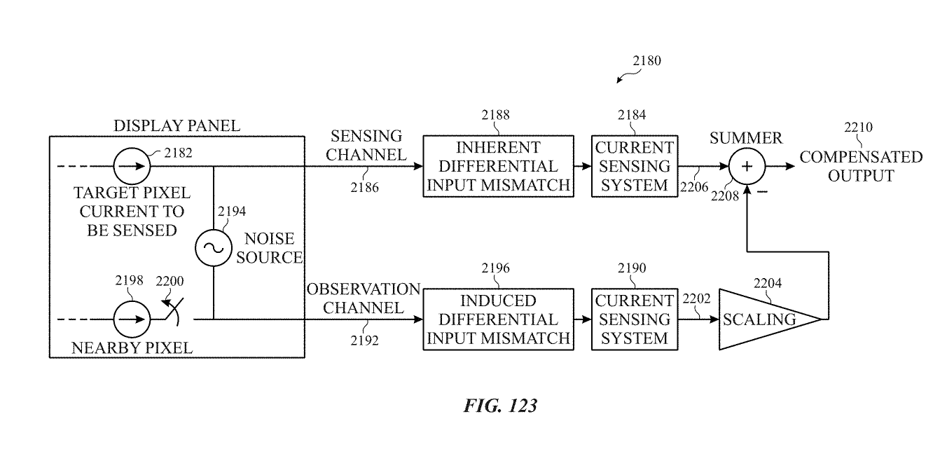

FIG. 123 illustrates a block diagram view of a dual-channel current sensing scheme 2180 with differential input channels. As illustrated, a target pixel current is provided via a current source 2182. The current provided by the current source 2182 then is supplied to a current sensing system 2184 via a sensing channel 2186. The sensing channel 2186 includes differential inputs with some inherent differential input mismatch 2188 inherent in the sensing channel 2186.

For another pixel (e.g., a pixel near to the target pixel), a sensing system 2190 is used to detect current through an observation channel 2192 that receives current from a noise source 2194 (e.g., capacitive coupling). The observation channel 2192 includes an induced differential input mismatch 2196 that is induced to sense a time-correlated common-mode error with the sensing channel 2186. In other words, the observation channel 2192 is used to observe noise (e.g., common-mode noise) in the observation channel 2192 during driving of the sensing channel 2186 to determine a magnitude of the noise (e.g., common-mode noise).

To ensure that only noise is passed through the observation channel 2192, the observation channel 2192 may be decoupled from a corresponding current source 2198 using a switch 2200. The current source 2198 is used to supply data to a pixel corresponding to the observation channel 2192. A sensed observation current 2202 is scaled at scaling circuitry 2204 and subtracted from a sensed current 2206 at summing circuitry 2208 to generate a compensated output 2210 indicative of current through the sensing channel 2186 substantially attributable to the current provided by the current source 2182.

Furthermore, the dual-channel current sensing scheme 2180 may include amplifiers, filters, analog-to-digital converters, digital-to-analog converters, and/or other circuitry used for processing in the dual-channel current sensing scheme 2180 that have been omitted from FIG. 123 for clarity.

The scaling factor may be determined in a calibration of the display panel to determine an output of each channel in response to an aggressor image/injected signal to determine channel properties to determine a common-mode error between channels. FIG. 124 illustrates a flow diagram of a process 2220 for calibrating the noise compensation circuitry. For a plurality of channels in a display, inject a channel with a current with an inherent differential input mismatch (block 2222). The current may be set using an aggressor image and/or injected signal setting a value for the pixel corresponding to the channel. A first output is sensed for the channel based on the current through the channel with the inherent differential input mismatch (block 2224).

The channel is also tested with an induced differential mismatch by inducing a differential mismatch in the channel (block 2226). While in the induced mismatch state, the current (e.g., using the same aggressor image/injected signal) is passed into the channel (block 2228). A second output is sensed for the channel based on the current through the channel with the induced mismatch (block 2230).

Once these outputs are obtained for each channel to be calibrated, the outputs are stored in a lookup table used to establish the scaling factors (block 2232). For instance, the first output of the sensed channel (Gₛᵢ) is stored for each channel in an inherent differential sensing mode, and the second output of the sensed channel (Gₒᵢ) is stored for each channel in an induced differential observing mode. The storage of these values may be stored in a lookup table, such as that shown below in Table 1.

TABLE 1
Lookup table for calibration outputs

Channel

| | 1 | 2 | 3 | 4 | . . . | n |
|---|---|---|---|---|---|---|
| Inherent | Gₛ₁ | Gₛ₂ | Gₛ₃ | Gₛ₄ | . . . | Gₛₙ |
| Mismatch | | | | | | |
| Induced | Gₒ₁ | Gₒ₂ | Gₒ₃ | Gₒ₄ | . . . | Gₒₙ |
| Mismatch | | | | | | |

These stored outputs may be used to determine a scaling factor using a relationship between outputs of a sensing channel and an observational channel. For example, the scaling factor that is used to scale observation channel sensed currents may be determined using the following Equation 1:

$${SF}_{ij} = \frac{G \text{?}}{{G}_{si}} , \\ \text{?} \text{indicates text missing or illegible when filed} \qquad ( Equation 1 )$$

where channel i is the sensing channel, channel j is the observational channel, SFᵢⱼ is the scaling factor used to scale an output of the observational channel j when sensing via channel i, Gₒⱼ is the output of channel j during induced differential mode calibration, and Gₛᵢ is the output of channel i during inherent differential mode calibration. As previously discussed, the scaling factor is used to scale the observational channel output before subtracting from the sensing channel output to ensure that the resulting compensated output is substantially attributable to the sensing channel's effects on the current through channel without inappropriately applying common-mode noise to the compensation.

In some embodiments, calibration measurements may be conducted multiple times to average the results to improve a signal-to-noise ratio of the outputs.

FIG. 125 is a block diagram view of calibration scheme 2250. As illustrated, the calibration scheme 2250 includes calibrating values for each channel in a sensing channel mode 2252 and an observation channel mode 2254.

The sensing channel mode 2252 generates a current that is sent through a channel of the display panel 2256 corresponding to one or more pixels that is sensed through a sensing channel 2258 having an inherent (e.g., non-induced) amount of differential input mismatch 2260. The current through the channel 258 having the inherent differential input mismatch 2260 is sensed at a current sensing system 2262 producing an output (Gₛᵢ) 2264 that is stored in memory (e.g., lookup table illustrated in Table 1) for the inherent mismatch value used in scaling factor calculations.

During another calibration step before or after sensing channel mode 2252 analysis, an observational channel mode 2254 is employed. In the observational channel mode 2254, the same current is generated (e.g., using the same image or injected signal). However, the observation channel 2259 is now equipped with an induced differential input mismatch 2266. The amount of mismatch may be an amount of mismatch used in the observational channel operation during dual-channel sensing previously discussed or may differ to tune the scaling factor. The current in the channel 2259 with the induced differential input mismatch 2266 is sensed using the current sensing system 2262 and an output (Gₒᵢ) 2268 is stored in memory (e.g., lookup table illustrated in Table 1) for the induced mismatch in scaling factor calculations.

### Adjusting the Display Based on Operation Variations

### A. Content-Dependent Temperature Prediction

A temperature prediction based on the change in content on the electronic display may also be used to prevent visual artifacts from appearing on the electronic display 18. For instance, as shown by a flowchart 910 of FIG. 50, a change in the brightness of content in the image data 752 to be displayed on the electronic display may be determined when one frame changes to another frame (block 912). An estimated change in temperature over time caused by the change in brightness of the content may be estimated (block 914). Based on the estimated change in temperature over time, the electronic display 18 may be refreshed earlier than otherwise. Namely, when the change in temperature over time would be expected to cause a visual artifact to appear due to the change in temperature on the electronic display 18, the electronic display 18 may be refreshed (block 916). It should be appreciated that this technique, while described in relation to change in content, may additionally or alternatively take into account the changes in other heat sources, such as the heat-producing components discussed above.

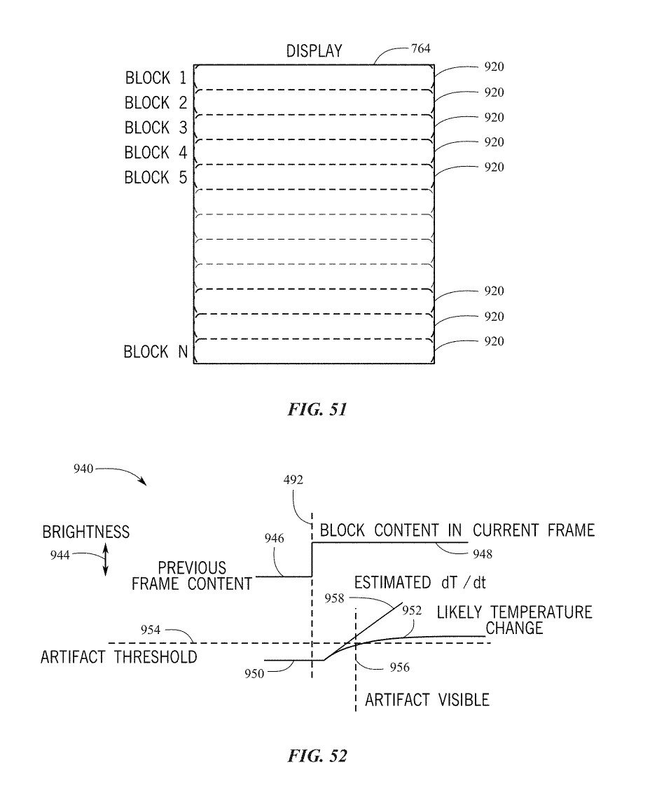

Identifying a change in content may involve identifying a change in content within in a particular block 920 of content on the display of active area 764, as shown in FIG. 51. The blocks 920 shown in FIG. 51 are meant to provide only one example of blocks of content that may be analyzed. The blocks 920 may be as small as a single pixel or as large as the entire display panel 764. However, by segmenting the pixel 766 into multiple blocks 920 that each encompasses a subset of the total number of pixels 766 of the active area 764, efficiencies may be gained. Indeed, this may reduce the amount of computing power involved in computing brightness change that would be used in calculating this for every single pixel 766, while providing a more discrete portion of the total pixels of the active area 764 than the entire active area.

The size of the blocks 920 may be fixed at a particular size and location or may be adaptive. For example, the size of the blocks that are analyzed for changes in content may vary depending on a particular frame rate. Namely, since a slower frame rate could produce a greater amount of local heating, blocks 920 may be smaller for slower frame rates and larger for faster frame rates. In another example, the blocks may be larger for slower frame rates to computing power. Moreover, the blocks 920 may be the same size throughout the electronic display 18 or may have different sizes. For example, blocks 920 from areas of the electronic display 18 that may be more susceptible to thermal variations may be smaller, while blocks 920 from areas of the electronic display 18 that may be less susceptible to thermal variations may be larger.

As shown by a timing diagram 940, the content of a particular block 920 may vary upon a frame refresh 942, at which point content changes from that provided in a previous frame 946 to that provided in a current frame 948. When the current frame 948 begins to be displayed, a particular block 920 may have a change in the brightness from the previous frame 946 to the current frame 948. In the example of FIG. 52, the previous frame content 946 is less bright than the current frame 948. This means that the current frame 948 causes the pixel 766 to emit more light, and therefore, when the pixel 766 is part of a self-emissive display such as an OLED display, this causes the pixel 766 to emit a greater amount of heat as well. This increase in heat will cause the temperature on the active area 764 of the display to increase. While the example of FIG. 52 shows an increase in brightness 944, leading to an increase of heat output and an increase in temperature on the active area 764, in other cases, the previous frame content 946 may have brighter than the current frame 948. When the content changes from brighter to less bright, this may cause the amount of heat to be emitted to be lower, and therefore to cause the temperature in that part of the active area 764 to decrease instead.

Thus, as the content between the previous frame 946 and the current frame 948 has changed, the temperature also changes. If the temperature changes too quickly, even though the image data 752 may have been compensated for a correct temperature at the point of starting to display the current frame 948, the temperature may cause the appearance of the current frame 948 to have a visual artifact. Indeed, the temperature may change fast enough that the amount of compensation for the current frame 948 may be inadequate. This situation is most likely to occur when the refresh rate of the electronic display 18 is slower, such as during a period of reduced refresh rate to save power.

A baseline temperature 950 thus may be determined and predicted temperature changes accumulated based on the baseline temperature 950. The baseline temperature 950 may correspond to a temperature understood to be present at the time when the previous frame 946 finishes being displayed and the current frame 948 begins. In some cases, the baseline temperature 950 may be determined from an average of additional previous frames in addition to the most recent previous frame 946. Other functions than average may also be used (e.g., a weighted average of previous frames that weights the most recent frames more highly) to estimate the baseline temperature 950. From the baseline 950, a curve 952 is shown a likely temperature change as the content increases in brightness 944 between the previous frame 946 and the current frame 948. There may be an artifact threshold 954 representing a threshold amount of temperature change, beyond which point a visual artifact may become visible at a time 956. To avoid having a visual artifact appear due to temperature change, at the time 956, a change in temperature over time (dT/dt) 958 may be identified. A new, early frame may be provided when the estimated rate of change in temperature (dT/dt) 958 crosses the artifact threshold 954.

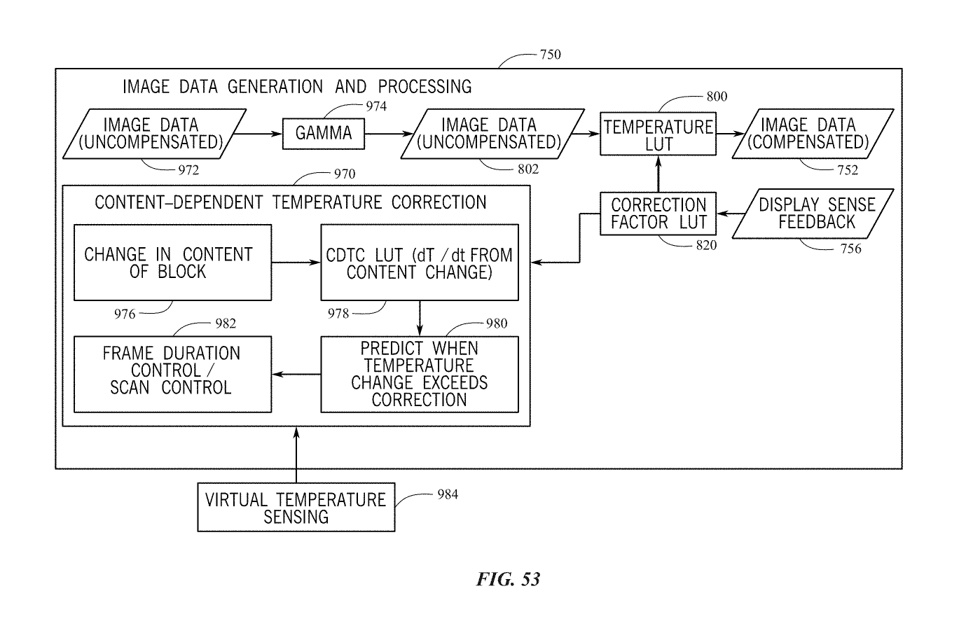

One example of a system for operating the electronic display 18 to avoid visual artifacts due to temperature changes based on content appears in a block diagram of FIG. 53. The block diagram of FIG. 53 may include a content-dependent temperature correction loop 970 that may operate based at least partly on changes in content in the image data that is to be displayed on the electronic display 18. In the example shown in FIG. 53, uncompensated image data 972 in a linear domain is used, but the uncompensated image data 802 or the compensated image data 752, both of which may be in the gamma domain for display on the electronic display 18, may be used instead. To generate the uncompensated image data 802 from the uncompensated image data 972 in the linear domain, a gamma transformation 974 may be performed.

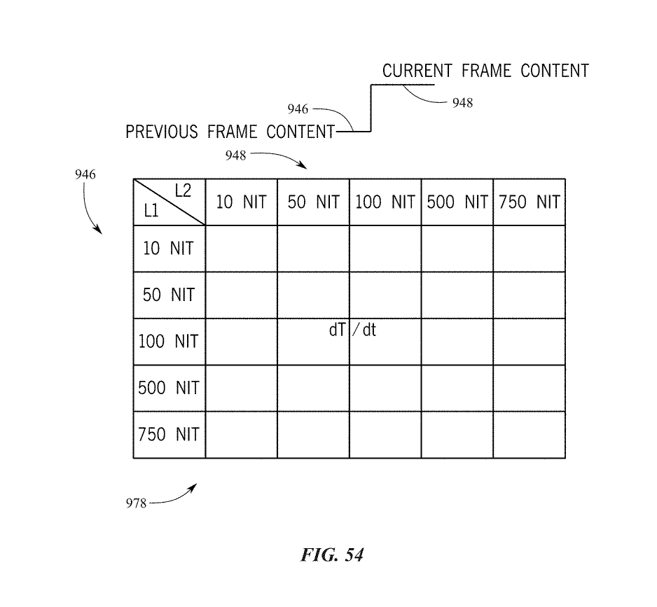

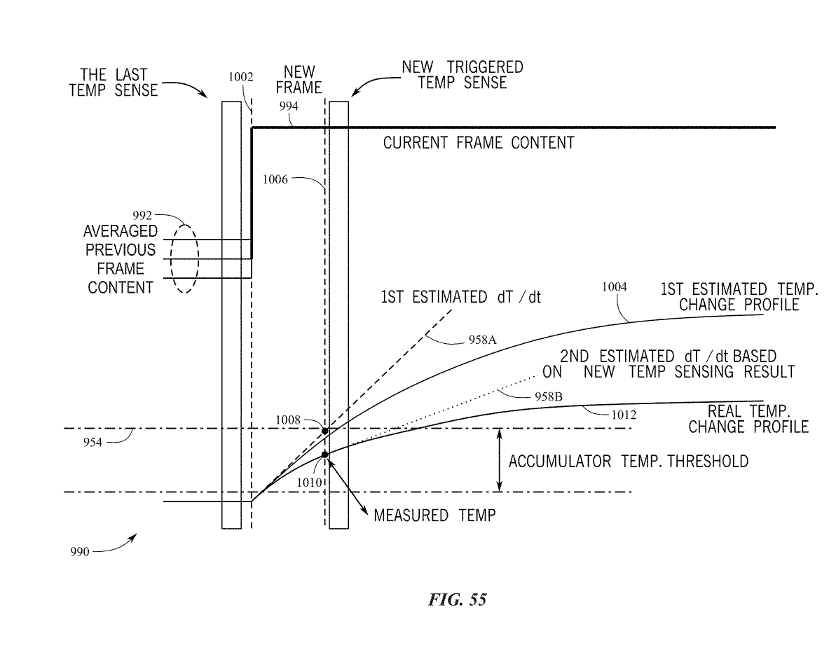

The content-dependent temperature correction loop 970 may include circuitry or logic to determine changes in the content of various blocks 920 of content in the image data 972 (block 976). A content-dependent temperature correction lookup table (CDCT LUT) 978 may obtain a rate of temperature change estimated based on a previous content of a previous frame or an average of previous frames and the current frame of image data 972. An example of the content-dependent temperature correction lookup table (CDCT LUT) 978 will be discussed further below with reference to FIG. 54. The estimated rate of temperature change (dT/dt) due to the change in content may be provided to circuitry or logic that keeps a running total of temperature change over time for each block of content. This running total may be used to predict when the change in temperature will result in a total amount of temperature change that exceeds the ability of the current temperature lookup table (LUT) 800 to compensate the uncompensated image data 802 (block 980). Frame duration control and sense scan control circuitry or logic 982 may cause the electronic display 18 to receive a new frame, performing display sense feedback 756 on at least on a subset of the active area 764 that includes the block exceeding the artifact threshold. The display sense feedback 756 therefore may be provided to the correction factor LUT 820 to update the temperature lookup table (LUT) 800 at least for the block that is predicted to have changed enough in temperature to otherwise cause an artifact if it had not otherwise been refreshed. Thus, when the uncompensated image data 802 of the frame is compensated using the temperature lookup table (LUT) 800, the uncompensated image data 752 may take into account the current temperature on the display as measured by the display sense feedback 756.

When a new frame is caused to be sent to the electronic display 18 and the display sense feedback 756 for the block that triggered the new frame is obtained, the correction factor associated with that block may be provided to the content-dependent temperature correction loop 970. This may act as a new baseline temperature for predicting a new accumulation of temperature changes in block 980. In addition, virtual temperature sensing 984 (e.g., as provided by other components of the electronic device 10, such as an operating system running on processor core complex 12, or actual temperature sensors disposed throughout the electronic device 10) may also be used by the content-dependent temperature correction loop 970 to predict a temperature change accumulation at block 980 to trigger provision of new image frames and new display sense feedback 756 from the frame duration control/frame control circuitry or logic block 982.

FIG. 54 is a block diagram representing the content-dependent temperature control lookup table (CDCT LUT) 978. The content-dependent temperature correction LUT 978 may be a two-dimensional table with indices representing the brightness of previous frame 946 and the brightness of a current frame 948. The particular amount of temperature change dT/dt may be obtained experimentally and/or through modeling of the electronic display 18. In some embodiments, there may be multiple content-dependent temperature control lookup tables (CDCT LUTs) 978, each corresponding to a different mode of operation and/or block location. For example, there may be a content-dependent temperature control lookup table (CDCT LUT) 978 for indoor lighting circumstances and there may be another content-dependent temperature control lookup table (CDCT LUT) 978 for outdoor lighting circumstances when the sun is likely to also heat the electronic display 18. Additionally or alternatively, there may be a content-dependent temperature control lookup table (CDCT LUT) 978 for certain blocks of pixels and another content-dependent temperature control lookup table (CDCT LUT) 978 for other blocks of pixels.

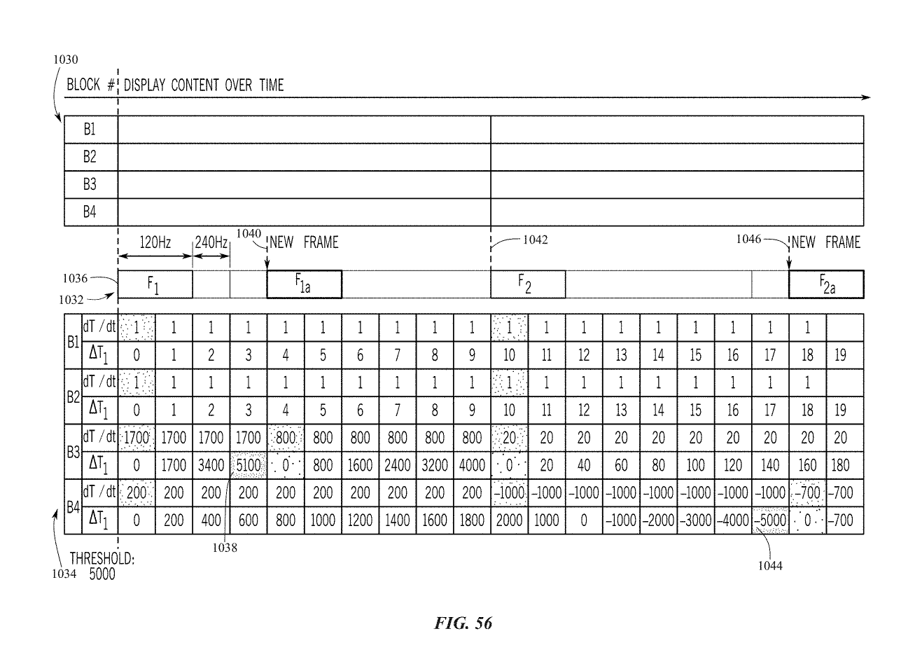

Another example of performing the content-dependent temperature correction for a particular block of content is described by a timing diagram 990 of FIG. 55. As shown in the timing diagram 990, an average brightness of a block of content from a previous frame 992 may be compared to a new brightness of the block of content from a current frame 994. Upon receipt of a refresh 1002 where the content changes, an initial estimated rate of temperature change 958A may be determined and compared to the artifact threshold 954. Note that the true likely temperature change over time 1004 may be represented a function over time in which the estimated rate of temperature change (dT/dt) 958A is asymptotic, approaching some maximum temperature change, for ease of computation, a new frame 1006 may be triggered when the first estimated rate of temperature change 958A is detected to cross the artifact threshold 954 at a point 1008. This may cause new display panel sensing 756 at least at a location corresponding to a block of content that is described in the timing diagram 990 of FIG. 55. The new display panel sensing 756 (e.g., as shown in FIG. 53) may be used to establish a new baseline temperature 1010 for the block of content at the point where the new frame 1006 is written to the electronic display 18. It should be understood that the new frame 1006 may include the same content as the current frame 994, except that the block of content that is described in the timing diagram 990 of FIG. 55 may have been updated to be compensated for the newly determined baseline temperature 1010. In other embodiments, the block of content that is described in the timing diagram 990 of FIG. 55 may not have been updated, but rather a new estimated rate of temperature change (dT/dt) 958B may be determined and monitored to determine when this would cross the artifact threshold 954. As noted above, the new estimated rate of temperature change (dT/dt) 958B may be used for ease of calculation instead of a true likely temperature change 1012, which would likely cross the artifact threshold 954 at a later time.

FIG. 56 provides another example of content-dependent temperature prediction by accumulating the rate of temperature change over discrete points in time. FIG. 56 may represent an example of the block 980 of FIG. 53. Namely, FIG. 56 shows accumulation values over time for various blocks B1, B2, B3, and B4 of content appearing on the electronic display 18. The content is shown generally by in visual form at numeral 1030, timing of writing new frames is shown at numeral 1032, and calculated temperature accumulation is shown at numeral 1034. In the example of FIG. 56, the change in temperature in relation to time is shown to be in units of temperature in which 5000 units of temperature accumulation produces a visual artifact, and time is measured per 240 Hz accumulation cycle, but any suitable accumulation calculation rate may be used, which may be larger or smaller than 240 Hz. Moreover, while the 5000 units of temperature accumulation is used as a magnitude threshold that can be either positive or negative in this example, this threshold may vary for different situations. For example, the threshold may vary depending on whether the change is positive or negative, and may depend on the starting temperature of a block of content.

Display block content is shown to begin upon writing a new frame 1036. In the example of FIG. 56, the change in content of blocks B1 and B2 is relatively minor, prompting a change in estimated temperature change to be relatively small (here, a value of 1 unit, where a visual artifact threshold may be considered to be 5000 units). Content block B4 is considered to have an estimated rate of temperature change of 200 units per unit of time. Block B3 has been determined to have an estimated rate of change in temperature (dT/dt) of 1700 units per accumulation cycle. Thus, after three accumulation cycles, the total accumulated temperature change 1038 for block B3 exceeds the threshold of 5000 units of temperature. This triggers a new frame 1040. A new temperature baseline for the content block B3 is established as zero and a new estimated rate of change in temperature (dT/dt) is estimated based on the average content of the previous frames for the content block B3. In this case, the estimated rate of change in temperature (dT/dt) for the content block B3 is determined to be 800 units of temperature per accumulation cycle.

Upon receiving a subsequent frame 1042, the content of block B4 changes to become much darker. Here, the content of block B4 has an estimated rate in change of temperature per accumulation cycle of −1000 units, resulting in an accumulation of −5000 at point 1044, thereby crossing the threshold value of a magnitude of 5000 units of temperature change. This triggers a new frame 1046. A new temperature baseline for the content block B4 is established as zero and a new estimated rate of change in temperature (dT/dt) is estimated based on the average content of the previous frames for the content block B4. In this case, the estimated rate of change in temperature (dT/dt) for the content block B4 is now determined to be −700 units of temperature per accumulation cycle. In this way, even for relatively slow refresh rates, rapid changes in temperature may be predicted and visual artifacts based on temperature variation may be avoided.

### B. Dual-Loop Display Sensing for Compensation

Pixels may vary when a driving current/voltage is applied under variable conditions, such as different temperatures or different online times of different pixels in the display. External compensation using one or more processors may be used to compensate for these variations. During a scan, these variations of the display are scanned using test data, and the results are provided to image processing circuitry external to the display. Based on the sensed variations of the pixels, the image processing circuitry adjusts the image data before it is provided to the display. When the image data reaches the display, it has been compensated in advance for the expected display variations based on the scans.

However, the compensation loops used to compensate for variations may not be capable of fully compensating for more than a single factor (e.g., temperature, aging). Dual-loop compensation may be used to apply compensation for multiple variation types. However, loops directed to different classifications of variation may utilize filtering or may not run simultaneously. Instead, the dual-loop compensation scheme may utilize a fast loop and a slow loop.

The fast loop is updated rapidly to cover variations with high temporal variations. The fast loop may also be populated with low-spatial variance scans to handle low-spatial variations, such as a generally broad area of aging of pixels (e.g., low-spatial aging variations) and temperature variations. The fast loop will also the low-spatial aging variations even though the low-spatial aging variations may have a relatively low frequency of variation.

The slow loop may handle aging variations that are not handled by the fast loop. Specifically, the slow loop may be updated much slower than the fast loop and with a higher spatial frequency (e.g., finer granularity) than the fast loop. Thus, the slow loop will handle aging that has a low-temporal frequency and a high spatial aging variations.

Since the variations that are picked up the fast loop and the slow loop, their compensations may be applied independently without complicated processing between the calculated compensations. These compensations may be added together before application to image data and/or may be applied to image data compensation settings independently.

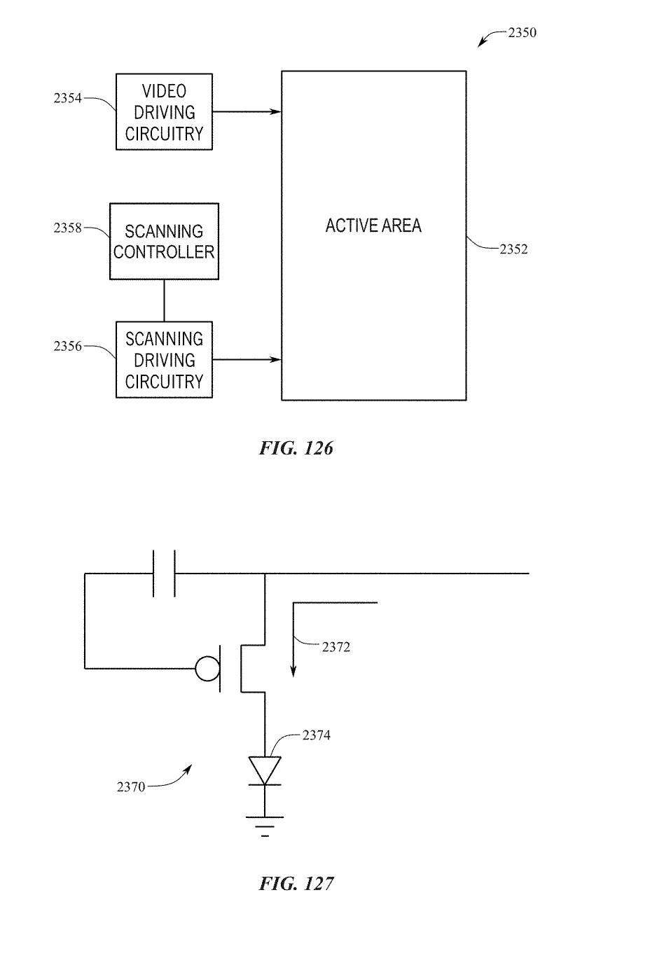

With the foregoing in mind, FIG. 126 illustrates a display system 2350 that may be included in the display 18 be used to display and scan an active area 2352 of the display 18. The display system 2350 includes video driving circuitry 2354 that drives circuitry in the active area 2352 to display images. The display system 2350 also includes scanning (or sensing) driving circuitry 2356 that drives circuitry in the active area 2352. In some embodiments, at least some of the components of the video driving circuitry 2354 may be common to the scanning driving circuitry 2356. Furthermore, some circuitry of the active area may be used both for displaying images and scanning. For example, pixel circuitry 2370 of FIG. 127 may be driven, alternatingly, by the video driving circuitry 2354 and the scanning driving circuitry 2356. When a pixel current 2372 is submitted to an organic light emitting diode (OLED) 2374 from the video driving circuitry 2354 and the scanning driving circuitry 2356, the OLED 2374 turns on. However, emission of the OLED 2374 during a scanning phase may be relatively low, such that the scan is not visible while the OLED 2374 is being sensed. In some embodiments, the display 18 may include LEDs or other emissive elements rather than the OLED 2374. To control scans during the scanning mode, a scanning controller 2358 of FIG. 126 may control scanning mode parameters used to drive the scanning mode via the scanning driving circuitry 2356. The scanning controller 2358 may be embodied using software, hardware, or a combination thereof. For example, the scanning controller 2358 may at least be partially embodied as the processors 12 using instructions stored in memory 14 or in communication with the processors 12.

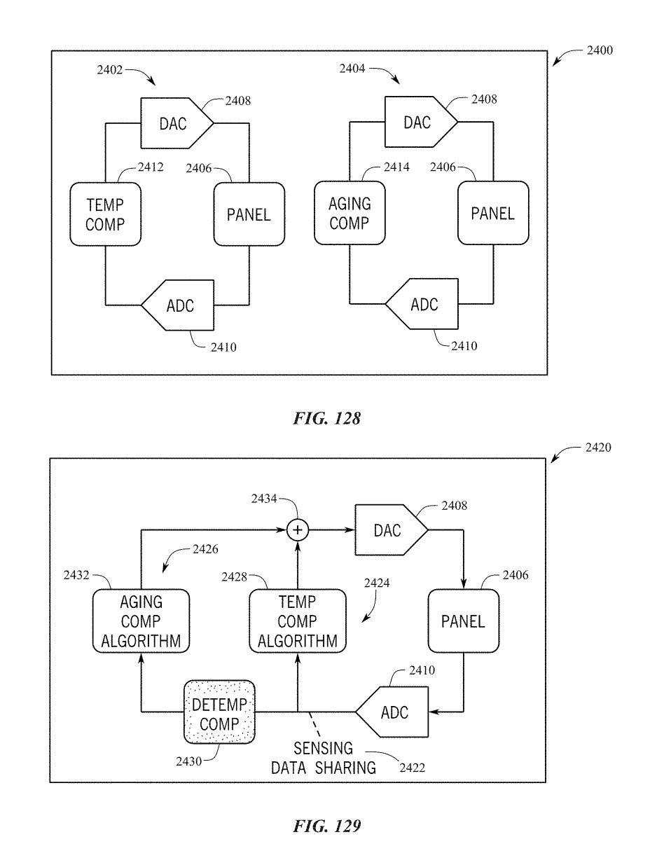

The processors 12 are in communication with the scanning controller 2358 and/or the scanning driving circuitry 2356. The processors 12 compensate image data for results from scanning using the scanning driving circuitry 2356 using dual-loops of processing. For example, FIG. 128 illustrates a flow diagram for a dual-loop scheme 2400 that includes a first loop 2402 and a second loop 2404. The first loop may be a temperature compensation loop that runs during a first period during which the display 18 undergoes temperature changes, such as while the electronic device 10 is in use. The second loop 2404 may be an aging compensation loop that runs during a second period when the first loop 2402 is not running. For example, the second loop 2404 could run when the electronic device is in a standby state, such as a power off state and/or charging state.

In the first loop 2402, a panel 2406 receives test data from a digital-to-analog-converter (DAC) 2408 that sends test data to a panel 2406 for sensing characteristics of pixels in the panel 2406. Sensed data returning from the panel 2406 are submitted to an analog-to-digital converter (ADC) 2410. The digital sensed data is sent to processors 12 and compensated using temperature compensation logic 2412 running on the processors 12. Specifically, any temperature fluctuations causing a change in brightness of resulting pixels. The temperature compensation logic 2412 compensates for variations that would occur from the temperature variations by applying inverted versions of the temperature changes to image data to reduce or eliminate fluctuations from transmitted image data.

In the second loop 2404, the panel 2406 receives test data from the digital-to-analog-converter (DAC) 2408 that sends test data to the panel 2406 for sensing characteristics of pixels in the panel 2406. Sensed data returning from the panel 2406 are submitted to the analog-to-digital converter (ADC) 2410. The digital sensed data is sent to processors 12 and compensated using aging compensation logic 2414 running on the processors 12. Specifically, since the electronic device 10 may be on standby, results of the sensed data may include only aging data without temperature variation effects. The aging compensation logic 2414 compensates for variations that would occur from the aging of circuitry of the panel 2406 variations by applying inverted versions of the temperature changes to image data to reduce or eliminate fluctuations from transmitted image data.

As illustrated, there is no interaction between the first loop 2402 and the second loop 2404. By allowing the first loop 2402 and the second loop 2404 to operate independently, implementation may be more simple and compensation may be generally less complex. However, aging data may be collected at a relatively low collection speed and corresponds to a relatively high visibility risk.

FIG. 129 is schematic diagram of a dual-loop scheme 2420 that includes sharing sensed data 2422 between an temperature compensation loop 2424 and an aging compensation loop 2426 that operate at the same time. The temperature compensation loop 2424 receives the sensed data and processes the sensed data 2422 using the sensed data to reduce potential variations based on the sensing data 2422. The sensed data 2422 is also submitted to the aging loop 2426 in total, but the sensed data 2422 first has temperature aspects filtered out. For example, the sensed data 2422 may use de-temperature compensation logic 2430 to filter out temperature aspects. One method of performing such filtration includes averaged temperature effect out of the sensed data 2422. The adjustments using the temperature compensation logic 2428 and the aging compensation logic 2432 are combined together using an accumulator 2434 for driving images and for further testing using the DAC 2408. An advantage of the scheme 2420 is that all aging information goes into the aging loop 2426. However, all temperature variation is sensed by the aging loop 2426 unless the temperature data is filtered out. To filter out the temperature data, the de-temperature compensation logic 2430 uses a relatively long time to statistically average the temperature effect out.

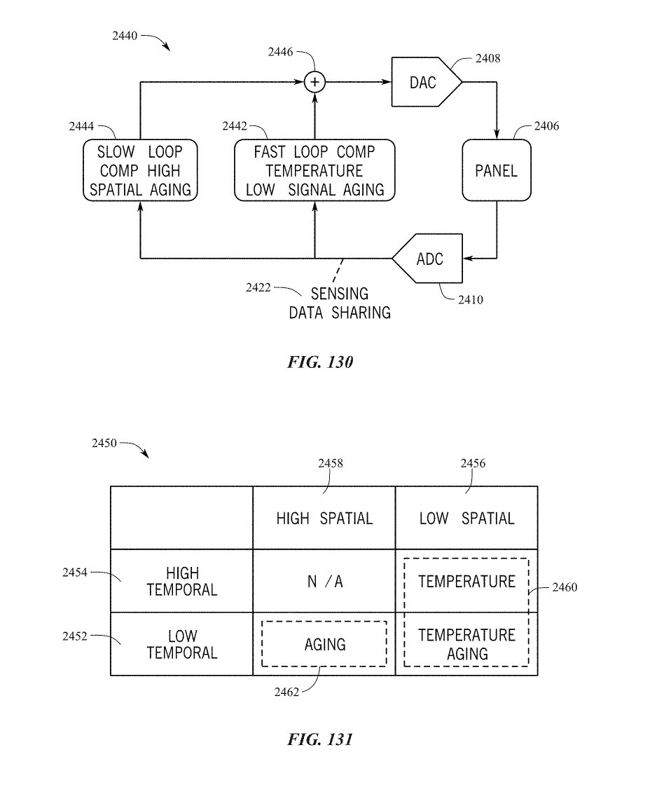

FIG. 130 illustrates an embodiment of a dual-loop scheme 2440 that includes fast loop compensation 2442 and slow loop compensation 2444 that run simultaneously rather than differentiating between temperature and aging or running different temperature and aging loops at different times. For example, the “fast” loop may run to handle variations corresponding to low spatial frequency variations that are run more frequently. The fast loop handles everything that falls within its bandwidth. The “slow” loop may run to handle remaining variations. An accumulator 2446 combines the results of the fast and slow loop compensation 2442 and 2444. FIG. 131 illustrates how temperature variations and aging variations are handled using the fast loop compensation 2442 and the slow loop compensation 2444. Specifically, a graph 2450 is illustrated with a division of variations in sensing data in spatial and temporal distributions. As illustrated, aging variations generally take a relatively high amount of time thus include only low temporal variations 2452 while temperature may include low temporal variations 2452 and high temporal variations 2454 due to slow temperature changes (e.g., gradual heating) or fast temperature changes (e.g., internal heating by electronic circuitry).

Temperature also varies little from pixel-to-pixel but rather only fluctuates with a relatively low spatial frequency 2456 of variance. However, aging may vary from pixel-to-pixel in a high spatial frequency 2458 of variance since adjacent pixels may have differing levels of usage. Aging may also vary in a low spatial frequency 2456 due to groups of pixels (e.g., whole display, a notification area of a user interface, etc.) that are used substantially together. Neither aging nor temperature has a high temporal frequency 2454 variation and high spatial frequency 2458. To cover aging and compensation, if a fast loop 2460 has a low spatial frequency or coarse scanning pattern in sensing scans and/or compensation, the slow loop 2462 may apply a high spatial frequency or more fine tuned pattern at less frequent intervals. This dual-loop scheme 2440 results in aging and temperature variations being compensated for properly. Furthermore, the dual-loop scheme 2440 may be deployed without filtering to remove temperature data from aging data or vice versa since the slow loop 2462 only handles high spatial frequency, low temporal variation aging that is not handled by the fast loop 2460.

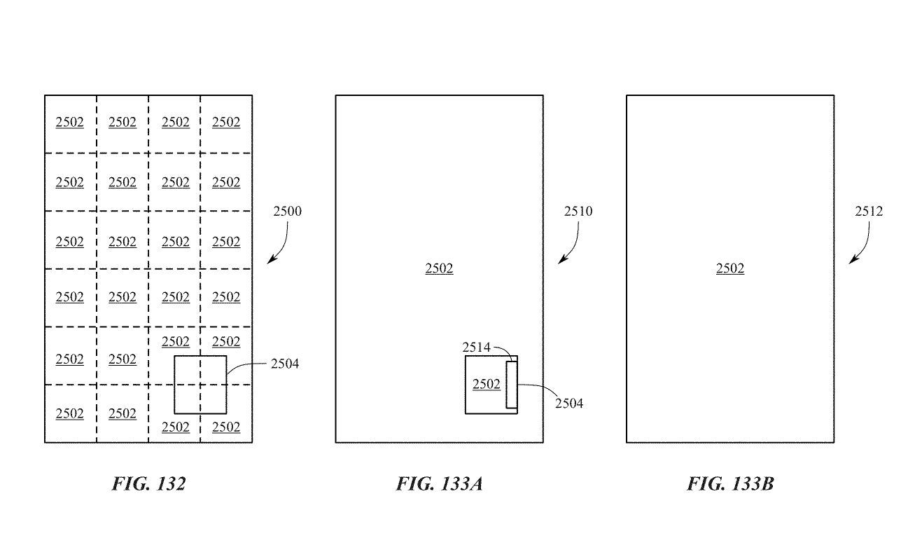

Furthermore, using only a single loop with low spatial variation would not properly address all issues arising from aging and temperature variations. FIG. 132 illustrates an example of a screen 2500 logically divided into multiple regions 2502. The values for all sensing data in each region 2502 may be spatially averaged and/or sampled with each pixel being treated the same within the same region 2502. Although the regions are shown consistent in size and location, in some embodiments, the region sizes and/or locations may vary during operation of the display. Regardless, when a portion of the screen 2500 includes an area 2504 that ages differently. For example, the area 2504 may include pixels that undergo more heavy use than surrounding pixels, such as portions of a notification area, a more heavily used portion of the screen in a video game, icons, and/or other continuously displayed images. When the display 18 attempts to display an image, such as a gray screen 2510 of FIG. 133A or a gray screen 2512 of FIG. 133B. One or more artifacts 2514 may be displayed if only a single compensation loop having a coarse-grained low-spatial frequency pattern as shown in FIG. 133A. However, if a low temporal fine-grained analysis is used to compensate for variations, the artifacts are not present in the screen 2512 of FIG. 133B. The artifacts 2514 may appear around an edge of the area 2504 because the averaging due to low spatial variance will correct inside and outside the area 2504, but the boundary between the pixels inside and outside the area 2504 are not properly addressed causing the artifacts 2514 to appear at the boundaries of the area 2504. Such variations are addressed using the slow loop compensation with fine tuned granularity that will address the aging differences by for high spatial frequency. For example, the slow loop may be compensated from pixel-to-pixel or in small groups relative to group sizing used for the fast loop.

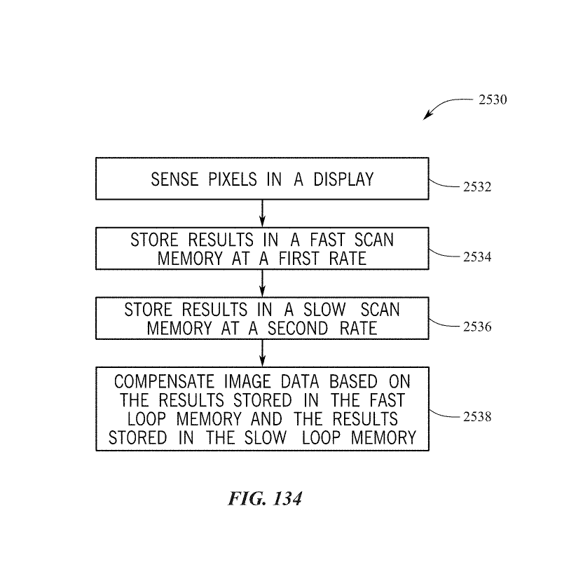

FIG. 134 illustrates a process 2530 that may be employed by the processors 12 to compensate for fluctuations due to temperature and aging using a fast loop and a slow loop. The processors 12 cause pixels of a display to be sensed (block 2532). For example, the processors 12 may use the scanning driving circuitry 2356. The processors 12 store results from the scan in a first scan memory at a first rate (block 2534). The first rate may be relatively low with a frequency of more than once per second, once every couple seconds, once every couple minutes, once every ten minutes, or other periods of high temporal frequency. In other words, the first scan memory stores scan data using a high temporal rate. The data in the first scan memory may include a coarse scan with low spatial frequency that is obtained by sampling only a portion of a region rather than each pixel and/or by spatially averaging sensing data of multiple pixels. In some embodiments, the spatial averaging may be performed by sensing multiple pixels at once thereby averaging out sensing data. Additionally or alternatively, the spatial averaging may be performed by mathematically averaging sensed data using the processors 12 or other circuitry and/or logic.

The processors 12 also store results from the scans in a second scan memory at a second rate (block 2536). The second rate may be low relative to the first rate with a frequency of scan (or at least storage of scans) being stored only once every several minutes, once an hour, once per several hours, or other periods of low temporal rates.

Using the sensing results stored in the first scan memory and the second scan memory, the processors 12 compensate image data (block 2538). Compensation for the variations detected using each loop may be compensated for in series with the fast loop or the slow loop compensation performed first with the other performed after. For example, the fast loop may be compensated for with the slow loop being compensated after or vice versa. This sequential compensation is feasible for the dual-loop scheme since each loop addresses non-overlapping areas of concern. Additionally or alternatively, a summed compensation may be applied. For example, if the slow loop indicates that a pixel's driving level (e.g., current or voltage) should be increased by a certain amount due to aging while the fast loop indicates that the pixel's driving level should be decreased by a certain amount. The compensations may be compounded together by subtracting the values from each other.

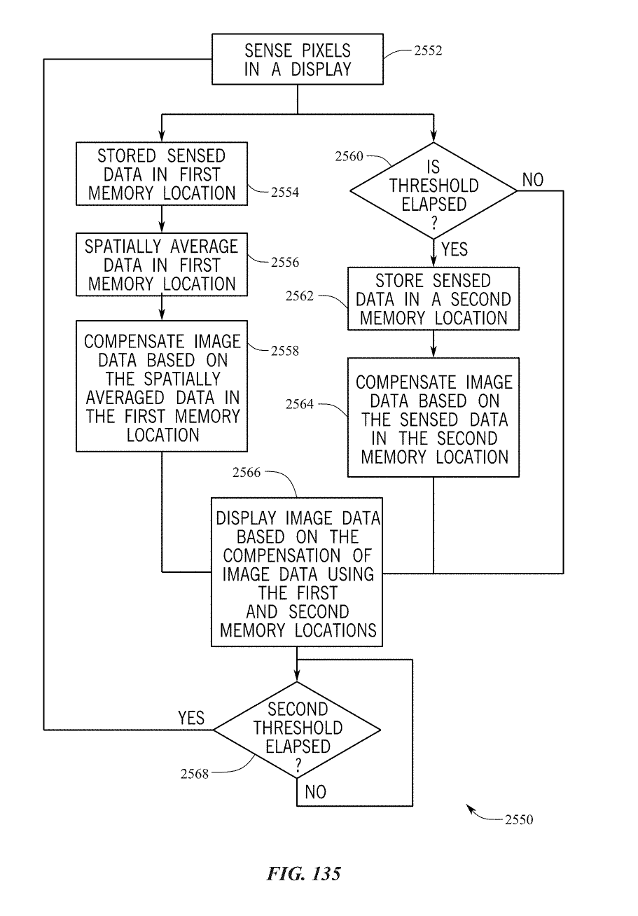

FIG. 135 illustrates a detailed process 2550 that may be used by the processors 12 to compensate for temperature and aging variations using dual-loop analysis. The processors 12 cause the scanning driving circuitry 2356 to sense values returned from one or more pixels based on input data (block 2552). For example, the input data may cause low level emission of the one or more pixels and receive return data from the one or more pixels indicating a temperature and/or aging of the one or more pixels. In some embodiments, some scans may include a scan of every pixel in the display 18 while other scans may include only some of the pixels of the display 18 as a sample.

Analysis of the sensed data is performed using two loops. In a “fast” loop, the sensed data is stored in a first memory location (block 2554). Before or after storage, the sensed data in the first memory location is spatially averaged to create a coarse scan (block 2556). As previously discussed, this coarse scan (sampled at a high temporal rate) results in the fast loop capturing variations related to low spatial aging and temperature of high and low temporal frequency variations. These variations are compensated for (block 2558) by inverting expected image fluctuations in the image data where the expected fluctuations are based on the spatially averaged data in the first memory location.

In the second loop or the “slow” loop, the processors 12 determine whether a first threshold has elapsed since the last scan of the slow loop (block 2560). For example, this threshold may be several minutes to several hours of time. If the threshold has not elapsed, no new data is sampled into the slow loop and a previous compensation using the slow loop is maintained. However, if the duration has elapsed, the processors 12 store the sensed data in a second memory location (block 2562). In some embodiments, the first threshold may be forgone if no data is stored in the second memory location after start up of the electronic device 10. As previously noted, the data in the second memory may have a fine grain resolution (e.g., high spatial frequency) that captures variations due to high spatial frequency aging of pixels or small groups of pixels. These variations are compensated for (block 2564) based on the sensed data stored in the second memory location. The compensations from the first and second loop may be mathematically combined using an accumulator and/or each may be applied directly to the image data independently.

Once compensations using the fast and slow loops have been applied to image data, the compensated image data is displayed based on the compensations using the first and second memory locations (block 2566).

The rescan process is repeated once a second threshold elapses (block 2568). The second threshold may be used to control how often the fast loop obtains data. Therefore, the second threshold may be less than a second, a second, more than a second, a few minutes, or any value less than the first threshold. If the second threshold has not elapsed, current compensations are maintained, but if the second threshold has elapsed, a new scan is begun and at least fed to the fast loop. Since a single set of scan results may be used for both the fast loop and the slow loop, the loops may share scan data (prior to spatial averaging in the fast loop). Thus, the second threshold determines when to begin a new scan and the first threshold determines whether the new scan is submitted to the slow loop or only the fast loop. Additionally or alternatively, the first threshold may independently begin a new scan for the slow loop when the first threshold has elapsed.

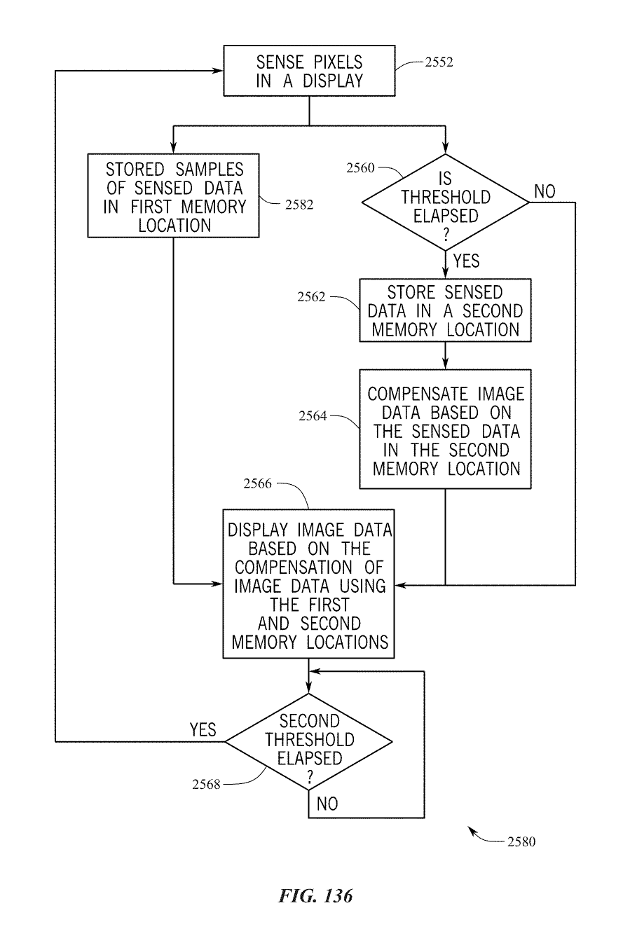

As previously noted, the fast loop may use a sample of data rather than spatially averaged values. FIG. 136 illustrates a process 2580 that may be used by the processors 12 to compensate for temperature and aging variations using dual-loop analysis. The process 2580 is similar to the process 2550. However, the process 2580 utilizes sampling rather than spatial averaging in the fast loop. Specifically, the processors 12 store samples of sensed data in the first memory location (block 2582). For example, if a full scan is produced, only a portion of the sensed data may be stored in the first memory location. Alternatively, a partial scan may be completed scanning only the pixels that are to be used for the low spatial variation fast scan. Regardless, the sampled pixel may vary in each scan to average individual pixel characteristics.

Furthermore, as previously noted, the processors 12 cause sensing of pixels (block 2552). However, unlike sensing in the process 2580, some scans of the display 18 may include sensing only a portion of the pixels of the display rather than all of the pixels of the display 18. For example, when a threshold period has elapsed for the second threshold, a scan may be initiated, but a scan type may depend upon whether a threshold period has elapsed for the first threshold. If the second first threshold has elapsed, the scan may be complete for every pixel to generate a fine scan with a high spatial frequency pattern, but if the second threshold has elapsed, the scan may include only the pixels that are to be included in the first memory rather than sampling a full scan.

### C. Post-Processing Algorithms

### 1. Grid-Based Interpolation For Temperature

Process, system, and/or environmental induced panel non-uniformities may be corrected by providing an area based dynamic display uniformity correction. This area based display uniformity correction can be applied at particular locations of the display or across the entirety of the display. In some embodiments, a lookup table of correction values may be a reduced resolution correction map to allow for reduced power consumption and increased response times. Additional techniques are disclosed to allow for dynamic and/or local adjustments of the resolution of the lookup table (e.g., a correction map), which also may be globally or locally updated based on real time measurements of the display, one or more system sensors, and/or virtual measurements of the display (e.g., estimates of temperatures affecting a display generated from measurements of power consumption, currents, voltages, or the like).

Additionally, per-pixel compensation may use large storage memory and computing power. Accordingly, reduced size representative values may be stored in a look-up table whereby the representative values subsequently may subsequently be decompressed, scaled, interpolated, or otherwise converted for application to input data of a pixel. Furthermore, the update rate for display image data and/or the lookup table may be variable or set at a preset rate. Dynamic reference voltages may also be applied to pixels of the display in conjunction with the corrective measures described above.

Additional compensation techniques related to adaptive correction of the display are also described. Pixel response (e.g., luminance and/or color) can vary due to component processing, temperature, usage, aging, and the like. In one embodiment, to compensate for non-uniform pixel response, a property of the pixel (e.g., a current or a voltage) may be measured and compared to a target value to generate correction value using estimated pixel response as a correction curve. However, mismatch between correction curve and actual pixel response due to panel variation, temperature, aging, and the like can cause correction error across the panel and can cause display artifacts, such as luminance disparities, color differences, flicker, and the like, to be present on the display.

Accordingly, pixel response to input values may be measured and checked for differences against a target response. Corrected input values may be transmitted to the pixel in response to any differences determined in the pixel response. The pixel response may be checked again and a second correction (e.g., an offset) may be additionally applied to insure that any residual errors are accounted for. The aforementioned correction values may supplement values transmitted to the pixel so that a target response of the pixel to an input is generated. This process may be done at an initial time (e.g., when the display is manufactured, when the device is powered on, etc.) and then repeated at one or more times to account for time-varying factors. In this manner, to accommodate for mismatches, a correction curve can be continuously monitored (or at predetermined intervals) in real time and adaptively adjusted on the fly to minimize correction error.

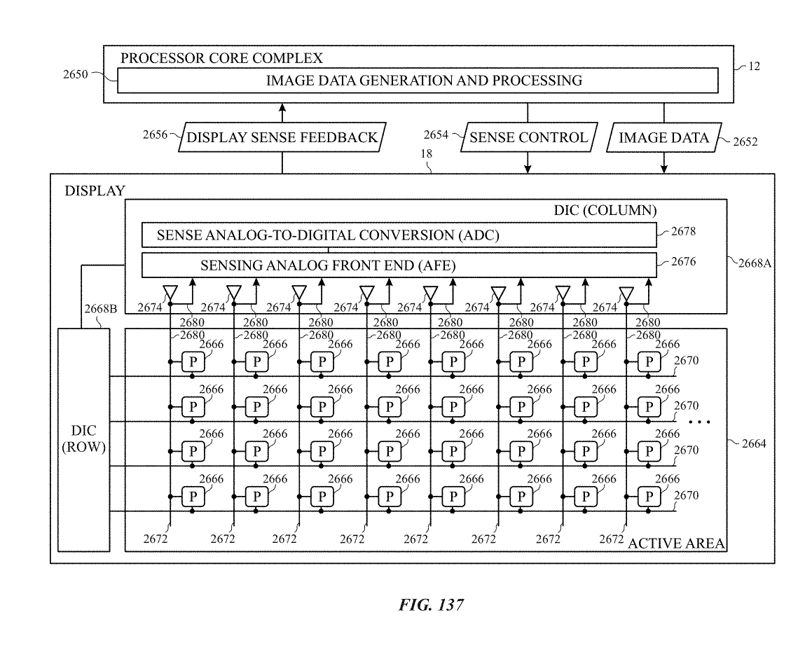

As shown in FIG. 137, in the various embodiments of the electronic device 10, the processor core complex 12 may perform image data generation and processing 2650 to generate image data 2652 for display by the electronic display 18. The image data generation and processing 2650 of the processor core complex 12 is meant to represent the various circuitry and processing that may be employed by the core processor 12 to generate the image data 2652 and control the electronic display 18. Since this may include compensating the image data 2652 based on manufacturing and/or operational variations of the electronic display 18, the processor core complex 12 may provide sense control signals 2654 to cause the electronic display 18 to perform display panel sensing to generate display sense feedback 2656. The display sense feedback 2656 represents digital information relating to the operational variations of the electronic display 18. The display sense feedback 2656 may take any suitable form, and may be converted by the image data generation and processing 2650 into a compensation value that, when applied to the image data 2652, appropriately compensates the image data 2652 for the conditions of the electronic display 18. This results in greater fidelity of the image data 2652, reducing or eliminating visual artifacts that would otherwise occur due to the operational variations of the electronic display 18.

The electronic display 18 includes an active area 2664 with an array of pixels 2666. The pixels 2666 are schematically shown distributed substantially equally apart and of the same size, but in an actual implementation, pixels of different colors may have different spatial relationships to one another and may have different sizes. In one example, the pixels 2666 may take a red-green-blue (RGB) format with red, green, and blue pixels, and in another example, the pixels 2666 may take a red-green-blue-green (RGBG) format in a diamond pattern. The pixels 2666 are controlled by a driver integrated circuit 2668, which may be a single module or may be made up of separate modules, such as a column driver integrated circuit 2668A and a row driver integrated circuit 2668B. The driver integrated circuit 2668 (e.g., 2668B) may send signals across gate lines 2670 to cause a row of pixels 2666 to become activated and programmable, at which point the driver integrated circuit 2668 (e.g., 2668A) may transmit image data signals across data lines 2672 to program the pixels 2666 to display a particular gray level (e.g., individual pixel brightness). By supplying different pixels 2666 of different colors with image data to display different gray levels, full-color images may be programmed into the pixels 2666. The image data may be driven to an active row of pixel 2666 via source drivers 2674, which are also sometimes referred to as column drivers.

As mentioned above, the pixels 2666 may be arranged in any suitable layout with the pixels 2666 having various colors and/or shapes. For example, the pixels 2666 may appear in alternating red, green, and blue in some embodiments, but also may take other arrangements. The other arrangements may include, for example, a red-green-blue-white (RGBW) layout or a diamond pattern layout in which one column of pixels alternates between red and blue and an adjacent column of pixels are green. Regardless of the particular arrangement and layout of the pixels 2666, each pixel 2666 may be sensitive to changes on the active area 2664 of the electronic display 18, such as variations and temperature of the active area 2664, as well as the overall age of the pixel 2666. Indeed, when each pixel 2666 is a light emitting diode (LED), it may gradually emit less light over time. This effect is referred to as aging, and takes place over a slower time period than the effect of temperature on the pixel 2666 of the electronic display 18.

Display panel sensing may be used to obtain the display sense feedback 2656, which may enable the processor core complex 12 to generate compensated image data 2652 to negate the effects of temperature, aging, and other variations of the active area 2664. The driver integrated circuit 2668 (e.g., 2668A) may include a sensing analog front end (AFE) 2676 to perform analog sensing of the response of pixels 2666 to test data. The analog signal may be digitized by sensing analog-to-digital conversion circuitry (ADC) 2678.

For example, to perform display panel sensing, the electronic display 18 may program one of the pixels 2666 with test data. The sensing analog front end 2676 then senses a sense line 2680 of connected to the pixel 2666 that is being tested. Here, the data lines 2672 are shown to act as extensions of the sense lines 2680 of the electronic display 18. In other embodiments, however, the display active area 2664 may include other dedicated sense lines 2680 or other lines of the display 18 may be used as sense lines 2680 instead of the data lines 2672. Other pixels 2666 that have not been programmed with test data may be sensed at the same time a pixel that has been programmed with test data. Indeed, by sensing a reference signal on a sense line 2680 when a pixel on that sense line 2680 has not been programmed with test data, a common-mode noise reference value may be obtained. This reference signal can be removed from the signal from the test pixel that has been programmed with test data to reduce or eliminate common mode noise.

The analog signal may be digitized by the sensing analog-to-digital conversion circuitry 2678. The sensing analog front end 2676 and the sensing analog-to-digital conversion circuitry 2678 may operate, in effect, as a single unit. The driver integrated circuit 2668 (e.g., 2668A) may also perform additional digital operations to generate the display feedback 2656, such as digital filtering, adding, or subtracting, to generate the display feedback 2656, or such processing may be performed by the processor core complex 12.

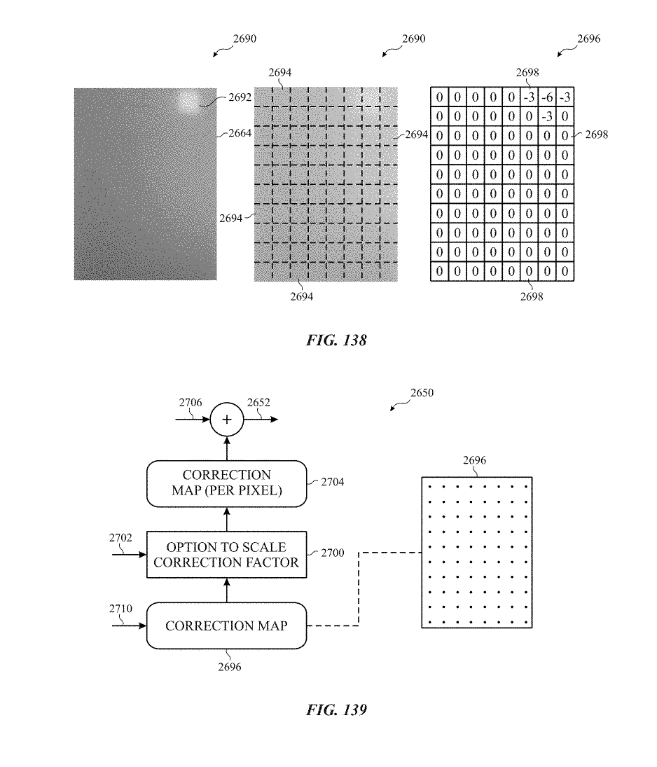

In some embodiments, a variety of sources can produce heat that could cause a visual artifact to appear on the electronic display 18 if the image data 2652 is not compensated for the thermal variations on the electronic display 18. For example, as shown in a thermal diagram 2690 of FIG. 138, the active area 2664 of the electronic display 18 may be influenced by a number of different nearby heat sources. For example, the thermal map 2690 illustrates the effect of at least one heat source that creates high local distribution of heat 2692 on the active area 2664. The heat source(s) that generate the distribution of heat 2692 may be any heat-producing electronic component, such as the processor core complex 12, camera circuitry, or the like, that generate heat in a predictable pattern on the electronic display 18.

As further illustrated in FIG. 138, the thermal diagram 2690 may be divided into regions 2692 of the display 18 that each include a set of pixels 2666. In this manner, groups of pixels 2666 may be represented by the regions 2692 such that attributes for a region 2692 (e.g., temperatures affecting the region 2692) may be attributed to a group of pixels 2666 of that region 2692. As will be discussed in greater detail below, grouping sensed attributes or influences of pixels 2666 into regions 2692 may allow for reduced memory requirements and processing when correcting for non-uniformity of the display 18. FIG. 138 additionally, shows an example of a correction map 2696 that may include correction values 2698 that correspond to the regions 2692. For example, the correction values 2698 may represent offsets or other values applied to image data being transmitted to the pixels 2666 in a region 2694 to correct, for example, for temperature differences at the display 18 or other characteristics affecting the uniformity of the display 18.

As shown in FIG. 139, the effects of the variation and non-uniformity in the display 18 may be corrected using the image data generation and processing system 2650 of the processor core complex 12. For example, the correction map 2696 (which may correspond to a look up table having a set of correction values 2698 that correspond to the regions 2692) may be present in storage (e.g., memory) in the image data generation and processing system 2650. This correction map 2696 may, in some embodiments, correspond to the entire active area 2664 of the display 18 or a sub-segment of the active area 2664. As previously discussed, to reduce the size of the memory to store the correction map 2696 (or the data therein), the correction map 2696 may include correction values 2698 that correspond to the regions 2692. Additionally, in some embodiments, the correction map 2696 may be a reduced resolution correction map that enables low power and fast response operations. For example, the image data generation and processing system 2650 may reduce the resolution of the correction values 2698 prior to their storage in memory so that less memory may be required, responses may be accelerated, and the like. Additionally, adjustment of the resolution of the correction map 2696 may be dynamic and/or resolution of the correction map 2696 may be locally adjusted (e.g., adjusted at particular locations corresponding to one or more regions 2692).

The correction map 2696 (or a portion thereof, for example, data corresponding to a particular region 2692), may be read from the memory of the image data generation and processing system 2650. The correction map 2696 (e.g., one or more correction values) may then (optionally) be scaled (represented by step 2700), whereby the scaling corresponds to (e.g., offsets or is the inverse of) a resolution reduction that was applied to the correction map 2696. In some embodiments, whether this scaling is performed (and the level of scaling) may be based on one or more input signals 2702 received as display settings and/or system information.

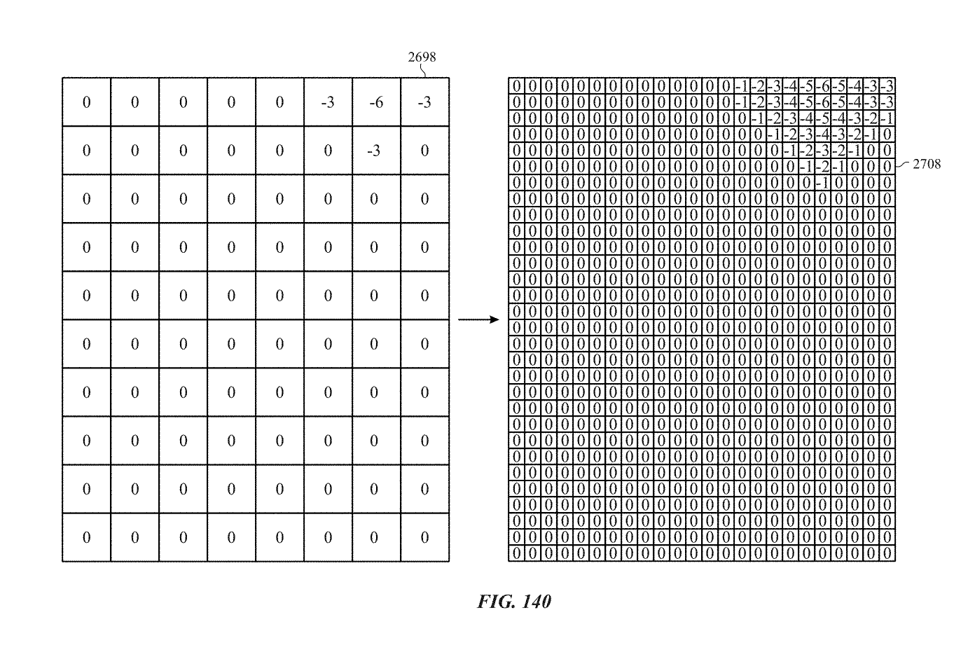

In step 2704, conversion of the correction map 2696 may be undertaken via interpolation (e.g., Gaussian, linear, cubic, or the like), extrapolation (e.g., linear, polynomial, or the like), or other conversion techniques being applied to the data of the correction map 2696. This may allow for accounting of, for example, boundary conditions of the correction map 2696 and may yield compensation driving data that may be applied to raw display content 2706 (e.g., image data) so as to generate compensated image data 2652 that is transmitted to the pixels 2666. A visual example of this process of step 2704 is illustrated in FIG. 140, which illustrates an example of converting the data values of correction map 2696 into compensation driving data organized into a per pixel correction map 2708 from the correction map 2696.

Returning to FIG. 139, in some embodiments, the correction map 2696 may be updated, for example, based on the input values 2710 generated from the display sense feedback 2656. This updating of the correction map 2696 may be performed globally (e.g., affecting the entirety of the correction map 2696) and/or locally (e.g., affecting less than the entirety of the correction map 2696). The update may be based on real time measurements of the active area 2664 of the electronic display 18, transmitted as display sense feedback 2656. Additionally and/or alternatively, a variable update rate of correction can be chosen, e.g., by the image data generation and processing system 2650, based on conditions affecting the display 18 (e.g., display 18 usage, power level of the device, environmental conditions, or the like).

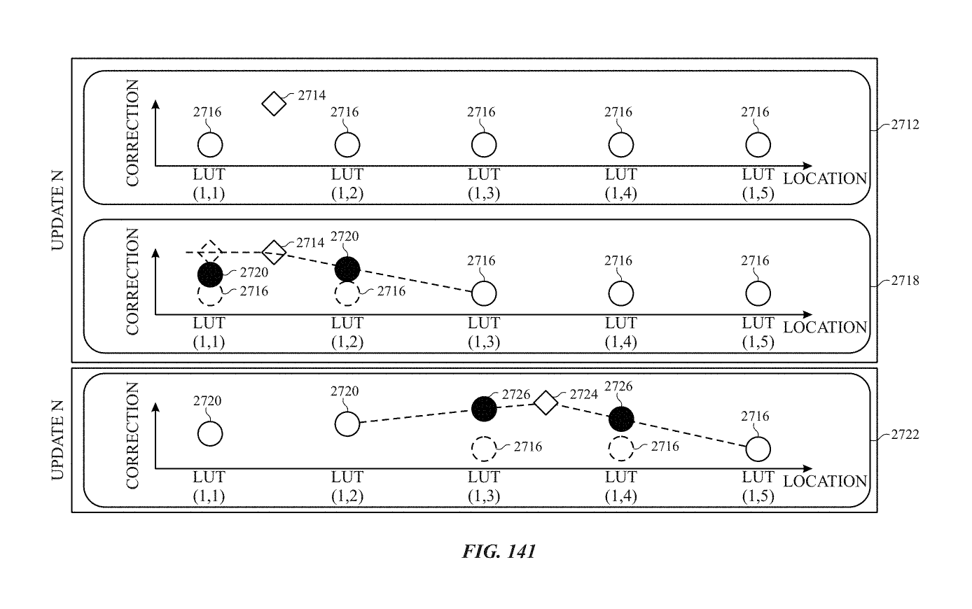

FIG. 141 illustrates a graphical example of updating of the correction map 2696. As shown in graph 2712, a new data value 2714 may be generated based on the display sense feedback 2656 during an update at time n (corresponding to, for example, a first frame refresh). Also illustrated in graph 2712 is the current look up table values 2716 corresponding to particular row (e.g., row one) and column (e.g., columns one-five) pixel 2666 locations. As part of the update of the correction map 2696, as illustrated in graph 2718, the new data value 2714 may be applied to current look up table values 2716 associated with (e.g., proximate to) the new data value 2714. This results in shifting of the look up table values 2716 corresponding to pixels 2666 affected by the condition represented by the new data value 2714 to generate corrected look up table values 2720 (illustrated along with the former look up table values 2716 that were adjusted).

As illustrated in graph 2722, which represents an update at time n+1 (corresponding to, for example, a second frame refresh). An additional new data value data value 2724 may be generated based on the display sense feedback 2656 during an update at time n+1. As part of the update of the correction map 2696, as illustrated in graph 2718, the new data value 2724 may be applied to current look up table values 2716 associated with (e.g., proximate to) the new data value 2724. This results in shifting of the look up table values 2716 corresponding to pixels 2666 affected by the condition represented by the new data value 2724 to generate corrected look up table values 2726 (illustrated along with the former look up table values 2716 that were adjusted). The illustrated update process in FIG. 141 may represent a spatial interpolation example. However, it is understood that additional and/or alternative updating techniques may be applied to update the correction map 2696.

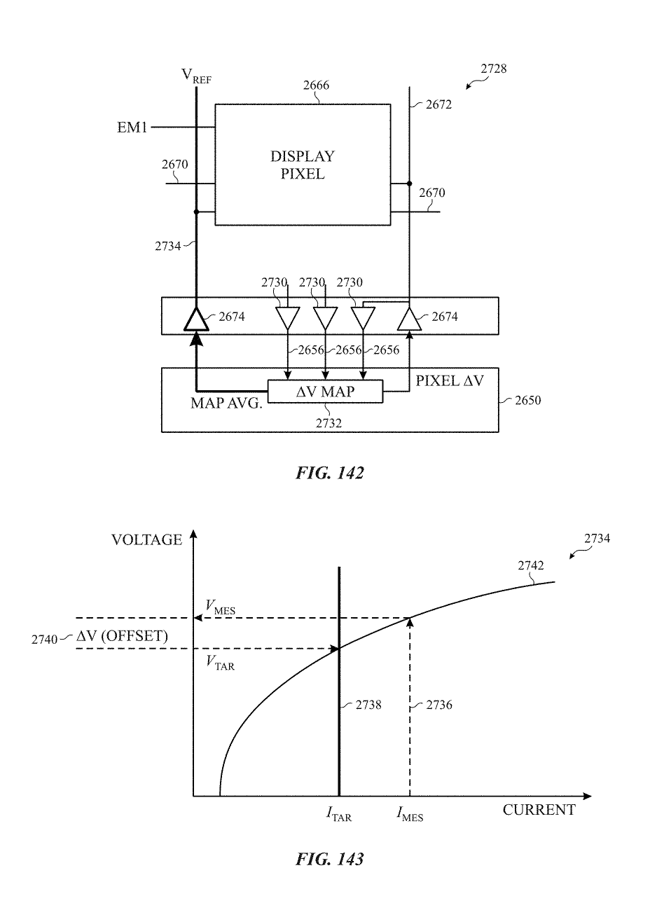

In some embodiments, dynamic correction voltages may be provided to the pixels 2666 singularly and/or globally. FIG. 142 illustrates an example of dynamic updating of voltage levels supplied to the pixels 2666 and/or the active area 2664. As illustrated in diagram 2728, the image data generation and processing system 2650 may receive display sense feedback 2656 from, for example, one or more sensors 2730. Also illustrated is a voltage change map 2732 that may include updated voltage values generated by sensed conditions received from the one or more sensors 2730. In some embodiments, the voltage change map 2732 may be the correction map 2696 discussed above.

Some pixels 2666 may use one terminal for image dependent voltage driving and a different terminal for global reference voltage driving. Accordingly, as illustrated in FIG. 142, common mode information (e.g., a correction map average of the overall voltage change map 2732) can be used to update global driving voltage along reference voltage line 2734. In this manner, for example, pixels of an active area 2664 may adjusted together instead of individually (although individual adjustment would still be available via, for example, data lines 2672).

Other techniques for corrections of non-uniformity of a display are additionally contemplated. For example, as illustrated in graph 2734 of FIG. 143, to compensate for non-uniform pixel response, a property of the pixel 2666 (e.g., a current or a voltage) may be measured 2736 and compared to a target value 2738 to generate correction value 2740 (e.g., an offset voltage) using an estimated pixel 2666 response to generate a correction curve 2742. This correction curve 2742 may be used (e.g., in conjunction with a lookup table), for example to apply the correction value 2740 to raw display content 2706 (e.g., image data) so as to generate compensated image data 2652 that is transmitted to the respective pixel 2666 (e.g., the correction curve 2742 may be used to choose offset voltages to be applied to the raw display content 2706 based on a target current to be achieved). This process may be performed prior to or subsequent to the corrections discussed in conjunction with FIG. 139 (e.g., the corrected data generated based upon application of a particular value selected in conjunction with the correction curve 2742 may be transmitted as the raw display content 2706 of FIG. 139 or the compensated image data 2652 of FIG. 139 may be corrected in conjunction with the correction curve 2742 and subsequently transmitted to the pixel 2666). However, mismatch between the correction curve 2742 and actual pixel 2666 response due to panel variation, temperature, aging, and the like can cause correction error across the active area 2664 of pixels 2666 and can cause display artifacts, such as luminance disparities, color differences, flicker, and the like, to be present on the display 18.

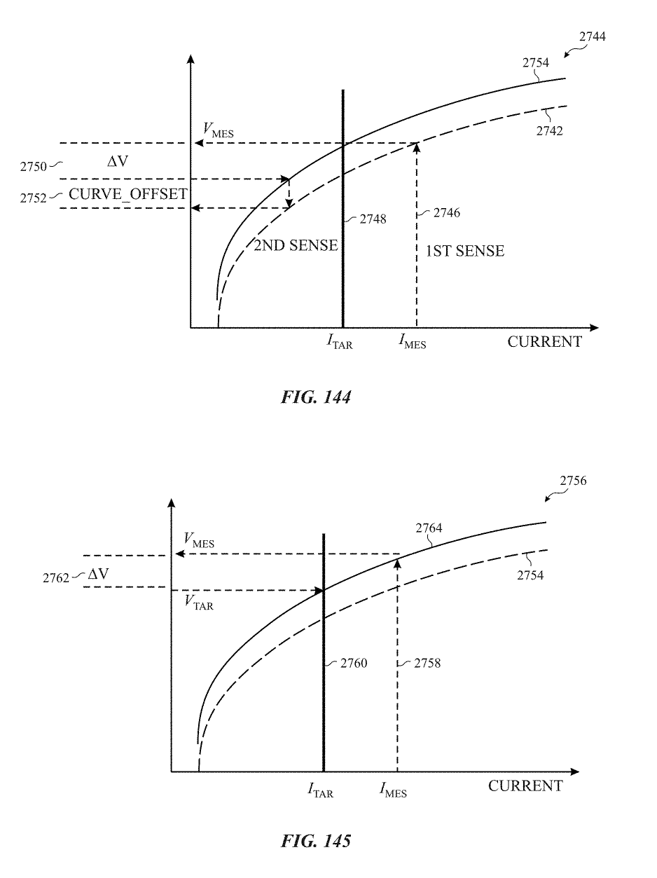

FIG. 144 illustrates a graph 2744 that represents one technique to correct the correction curve 2742 (e.g., to correct time-invariant curve mismatch, such as process variation). As illustrated in FIG. 144, a property of the pixel 2666 (e.g., a current or a voltage) may be measured 2746 and compared to a target value 2748 to generate correction value 2750 (e.g., an offset voltage) using a given correction curve 2742 associated with the pixel 2666. This correction value 2750 may be applied to in a manner similar to that described above with respect to correction value 2740.

Additionally, the property of the pixel 2666 (e.g., a current a voltage) may be measured 2752 at a second time, yielding a second measurement 2746 that allows for residual correction (e.g., curve offset 2752) to be additionally applied with the correction value 2750 to generate a panel curve 2754 that may be utilized (e.g., in conjunction with a lookup table) to apply the combined value of the correction value 2750 and the curve offset 2752 to, for example, raw display content 2706 (e.g., image data) so as to generate compensated image data 2652 that is transmitted to the pixels 2666 (e.g., the panel curve 2754 may be used to choose offset voltages to be applied to the raw display content 2706 based on a target current to be achieved). This process may be performed prior to or subsequent to the corrections discussed in conjunction with FIG. 139 (e.g., the corrected data generated based upon application of a particular value selected in conjunction with the panel curve 2754 may be transmitted as the raw display content 2706 of FIG. 139 or the compensated image data 2652 of FIG. 139 may be corrected in conjunction with the panel curve 2754 and subsequently transmitted to the pixel 2666). This process may be performed as an initial configuration of the device 10 (e.g., at the factory and/or during initial device 10 or display 18 testing) or may be dynamically performed (e.g., at predetermined intervals or in response to a condition, such as startup of the device).

FIG. 145 illustrates a graph 2756 that represents a technique to correct the panel curve 2754 (e.g., to correct time-variant curve mismatch caused by temperature, age, usage, or the like). As illustrated in FIG. 145, the panel curve 2754 may be originally calculated (e.g., when the device 10 and/or display is first manufactured or tested) and stored. Likewise, the panel curve 2754 may be calculated as described above with respect to FIG. 144 iteratively, for example, upon a power cycle of the device 10. Once the panel curve 2754 is determined and the correction value 2750 and the curve offset 2752 are being applied to provide image data 2652 (e.g., the panel curve 2754 may be used to choose offset voltages to be applied to the raw display content 2706 based on a target current to be achieved), an additional correction technique may be undertaken.

As illustrated in FIG. 145, a property of the pixel 2666 (e.g., a current a voltage) may be measured 2758 and compared to a target value 2760 to generate correction value 2762 (e.g., an offset voltage) that allows for further correction of the panel curve 2754 correction values (e.g., the correction value 2750 and the curve offset 2752). This results in generation of an adapted panel curve 2764 that may be utilized (e.g., in conjunction with a lookup table) to apply the combined value of the correction value 2750, the curve offset 2752, and the correction value 2762 to, for example, raw display content 2706 (e.g., image data) so as to generate compensated image data 2652 that is transmitted to the pixels 2666 (e.g., the adapted panel curve 2764 may be used to choose offset voltages to be applied to the raw display content 2706 based on a target current to be achieved). This process may be performed prior to or subsequent to the corrections discussed in conjunction with FIG. 139 (e.g., the corrected data generated based upon application of a particular value selected in conjunction with the adapted panel curve 2764 may be transmitted as the raw display content 2706 of FIG. 139 or the compensated image data 2652 of FIG. 139 may be corrected in conjunction with adapted panel curve 2764 and subsequently transmitted to the pixel 2666).

The aforementioned described process may be performed on the fly (e.g., the panel curve 2754 and/or the adapted panel curve 2764 can be continuously monitored in real time and/or in near real time and adaptively adjusted on the fly to minimize correction error). Likewise, this process may be performed at regular intervals (e.g., in connection to the refresh rate of the display 18) to allows for enhancement correction accuracy for pixel 2666 response estimation. In other embodiments, for example, in order to enhance curve adaptation further such as slope, the above adaptation procedure can be performed in multiple different current levels. Furthermore, as each pixel 2666 may have its own I-V (current-voltage) curve, the above noted process may be done for each pixel 2666 of the display.

### 2. Spatial and Temporal Filtering

Many electronic devices may use display panels to provide user interfaces. Many user display panels may be pixel-based panels, such as light-emitting diode (LED) panels, organic light emitting diodes (OLED) panels and/or plasma panels. In these panels, each pixel may be driven individually by a display driver. For example, a display driver may receive an image to be displayed, determine what intensity each pixel of the display should display, and drive that pixel individually. Minor distinctions between circuitry of the pixels due to fabrication variations, aging effects and/or degradation may lead to differences between a target intensity and the actual intensity. These differences may lead to non-uniformities in the panel. To prevent or reduce the effects of such non-uniformities, displays may be provided with a sensing and processing circuitry that measures the actual intensity being provided by a pixel, compares the measured intensity to a target intensity, and provides a correction map to the display driver.

The sensing circuitry may be susceptible to errors. These errors may lead to generation of incorrect correction maps, which in its turn may lead to overcorrection in the display. The accumulated errors due to overcorrections as well as due to delays associated to this correction process may lead to visible artifacts such as luminance jumps, screen flickering, and non-uniform flickering. Embodiments described herein are related to methods and system that reduce visible artifacts and lead to a more comfortable interface for users of electronic devices. In some embodiments, sensing errors from sensor hysteresis are addressed. In some embodiments, sensing error from thermal noise are addressed. Embodiments may include spatial filters, such as 2D filters, feedforward sensing, and partial corrections to reduce the presence of visible artifacts due to sensing errors.

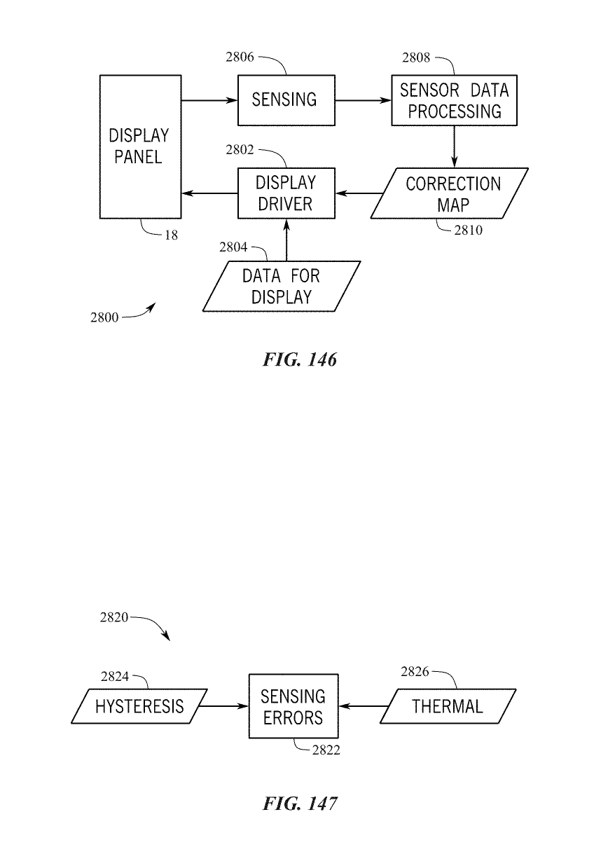

FIG. 146 is a diagram 2800 that illustrates a system that may be used to obtain uniformity across the multiple pixels of the display 18 (or a display panel of the display 18). For the purposes of portions of this disclosure, the display 18 and the display panel of the display 18 may be referred to interchangeably. A display driver 2802 may receive from any other system of the electronic device data 2804 to produce an image to be displayed in display panel 18. Display panel 18 may also be coupled with sensing circuitry 2806 that may measure the intensity of the pixels being displayed. Sensing circuitry 2806 may operate by measuring a voltage or a current across pixel circuitry, which may be associated with the luminance level produced by the pixel. In some embodiments, sensing circuitry 2806 may measure the light output of the pixel. Measurements from sensing circuitry 2806 may be direct or indirect.

Sensing data may be provided to a sensor data processing circuitry 2808 from the sensing circuitry 2806. Sensor data processing circuitry 108 may compare the target intensities with the measured intensities to provide a correction map 2810. As detailed below, in some embodiments, the sensor data processing circuitry 2808 may include image filtering schemes. In some embodiments, the sensor data processing circuitry 2808 may include feedforward sensing schemes that may be associated with the provision of partial correction maps 2810. These schemes may substantially decrease visual artifacts generated by undesired errors introduced in the sensing circuitry 2806 and provide an improved user experience.

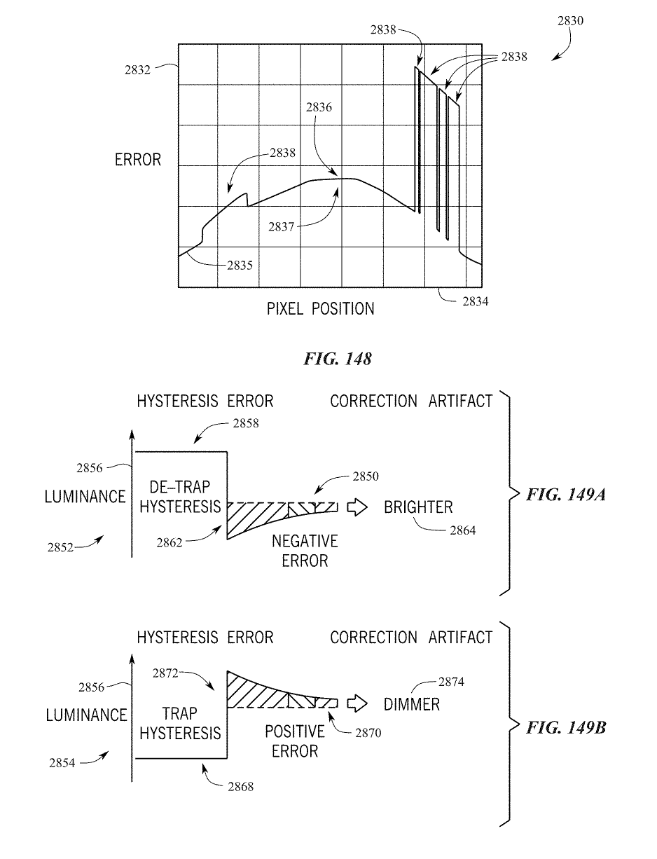

FIG. 147 provides a diagram 2820 that illustrate two possible sources of sensor errors 2822 that may affect sensing circuitry 2806. Hysteresis errors 2824 may relate to sensor errors that are caused by carryover effects from previous content, while thermal errors 2826 may relate to sensor errors that are caused by temperature variations in the device. FIG. 148 provides a chart 2830 that illustrates an example of errors 2822 that may enter sensing circuitry 2806. Chart 2830 provides the error 2832 as a function of pixel position 2834 along a profile of a display 18. Curve 2835 presents a convex shape 2836 with a maximum around the center of the screen 2837. This convex shape 2836 may be due to thermal noise 2826. Curve 2835 also presents sharper artifacts 2838. These sharp artifacts 2838 may be caused by hysteresis errors 2824. Note that thermal error 2826 may be caused by variations in temperature. Since the temperature in neighboring pixels is correlated, thermal errors may have a smooth error profile. By contrast, hysteresis errors 2832 may occur at the individual pixel level, and there may be very little correlation between hysteresis errors 2832 in neighboring pixels. As a result, the error profile may be associated with the discontinuous sharp artifacts 2838 seen in curve 2835.

FIGS. 149A and 149B illustrate two types of hysteresis errors 2832 that may occur. Diagram 2852 in FIG. 149A illustrates a de-trap hysteresis, while diagram 2854 in FIG. 149B illustrates a trap hysteresis. A de-trap hysteresis (diagram 2852) occurs when the luminance 2856 of a pixel goes from a high value 2858 to a low target value 2850. As a carry-over from the high value 2858, the sensor may underestimate the actual luminance 2856, resulting in an overcorrection that provides a negative error 2862. This results in a brighter visual artifact 2864. A trap hysteresis (diagram 2854) may occur when the luminance 2856 of a pixel goes from a low value 2868 to a higher target value 2870. As a carry-over from the low value 2868, the sensor may overestimate the actual luminance 2856, resulting in an overcorrection that provides a positive error 2872. This results in a dimmer visual artifact 2874. Note that neighboring pixels may suffer from different levels or types of hysteresis, and therefore sensing errors from neighboring pixels may be uncorrelated. This may lead to correction artifacts that present high spatial frequency (e.g., sharp artifacts in curve).

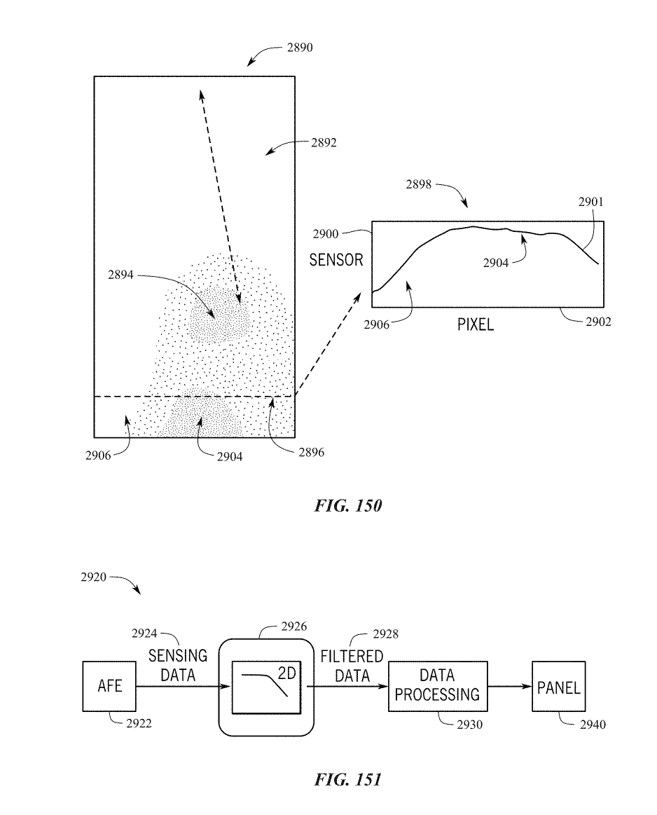

FIG. 150 illustrates the effect of thermal noise on the measurement from the sensor. Heat map 2890 illustrates thermal characteristics of a display having colder areas 2892 and warmer areas 2894. Chart 2898 illustrates sensor measurements of a horizontal profile 2896 across the display. Sensor measurement 2900 is given as a function of the pixel coordinate 2902 within the profile 2896, as indicated by curve 2901. Note that in warmer regions of profile 2896 (e.g., region 2904) the corresponding sensor measurement is higher than in colder regions (e.g., region 2906). Note, further, that the thermal characteristics do not vary sharply between neighboring pixels, resulting in a curve with low spatial frequency (e.g., smooth curve).

As discussed above, sensing errors from hysteresis effects appear as high frequency artifacts while sensing errors from thermal effects appear as low frequency artifacts. Suppression of the high frequency component of the error may be obtained by having the sensing data run through a low pass filter, which may decrease the amount of visible artifacts, as discussed below. FIG. 151 illustrates a system 2920 that may be used to suppress high frequency components of the error from the sensing circuitry of a display. Sensors 2922 may provide sensing data 2924 to a low pass filter 2926. The low pass filter may be a two-dimensional spatial filter 2926. In some implementations the two-dimensional spatial filter may be a Gaussian filter, a triangle filter, a box filter, or any other two-dimensional spatial filter. The filtered data 2928 may then be used data processing circuitry 2930 to determine correction factors or a correction map that may be forwarded to panel 2940. In some implementations, data processing circuitry 2930 may employ look-up tables (LUT), functions executed on-the-fly, or some other logic to determine a correction factor from the filtered data 2928.

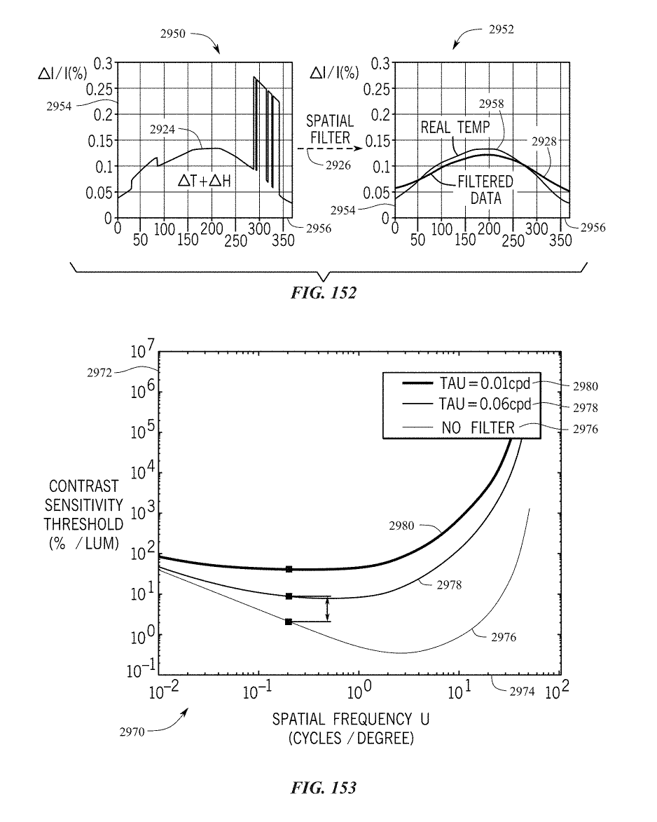

The charts in FIG. 152 illustrate an example of an application of a spatial filter 2926 to sensing data from a display. Chart 2950 illustrates the sensing signal prior to filtering and chart 2952 illustrates sensing after the filtering process. Both charts 2950 and 2952 show the sensing variation 2954 as a function of pixel position 2956. Note that the sensing data 2924 includes high frequency artifacts as well as low frequency artifacts. After spatial filtering 2926, the filtered data 2928 may have much less high frequency content. Note that the temperature profile 2958 may correlate with filtered data 2928. In some implementations, as discussed above, the filter may be used to mitigate preferentially errors from hysteresis, as opposed to errors from thermal variations.

Filtering of high frequency sensing errors may lead to a reduced impact on the visual experience for a user of an electronic device. The chart 2970 in FIG. 153 illustrates the effect by providing an effective contrast sensitivity threshold 2972 as a function of the spatial frequency 2974 of visual artifacts. The effective contrast sensitivity threshold 2972 denotes the variation in luminance that an artifact may be perceived by a user. The chart provides the effective contrast sensitivity threshold 2972 for a system with no filter (curve 2976), a system with a filter having cut-off frequency (e.g., corner frequency) of 0.06 cpd (cycle per degree) (curve 2978) and a filter having a cut-off frequency of 0.01 cpd (curve 2980). The spatial filter increases the contrast sensitivity threshold, at the risk of opposing high spatial thermal frequency error which is high pass in nature. A bound for the frequency of thermal error suppression is set by the same cut off frequency of the low pass filter. This may correspond to a system that has higher tolerance to sensor errors. Note further that the effect is more pronounced in regions with higher spatial frequency.

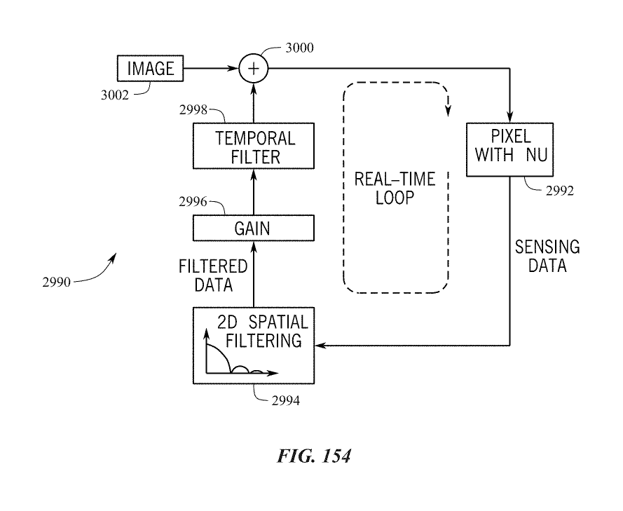

The schematic diagram 2990 of FIG. 154 illustrates a real-time closed loop system that may be used to correct the pixel using a two-dimensional spatial filtering scheme, as discussed above. In this system, a display pixel 2992 may be measured to produce sensing data that may be provided to the two-dimensional low-pass filter 2994. Low pass filter 2994 may provide filtered data to a gain element 2996. The gain element 2996 may also convert the signal from luminance units (e.g., metric provided by the display sensor) to voltages (e.g., voltage signal employed by the display driver to calculate target intensity). A temporal filter 2998 may also be used to prevent very fast time updates, and potential stabilities. The output signal from the temporal filter may be combined by circuitry 3000 with an image signal 3002 to generate the set of target luminance provided to the pixel with the proper compensation based on the sensed data. This combined image may be provided by the display pixel 2992.

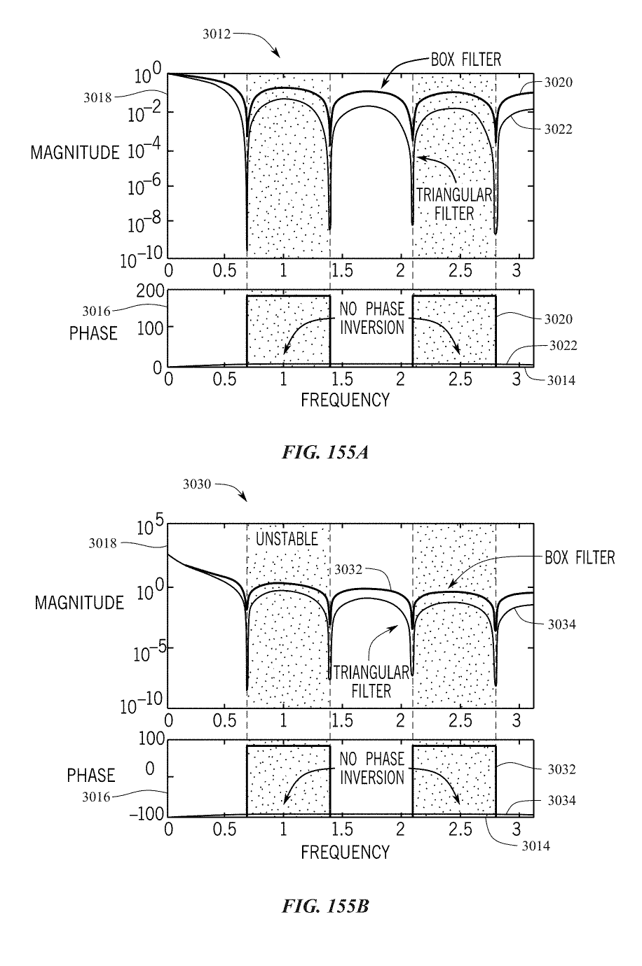

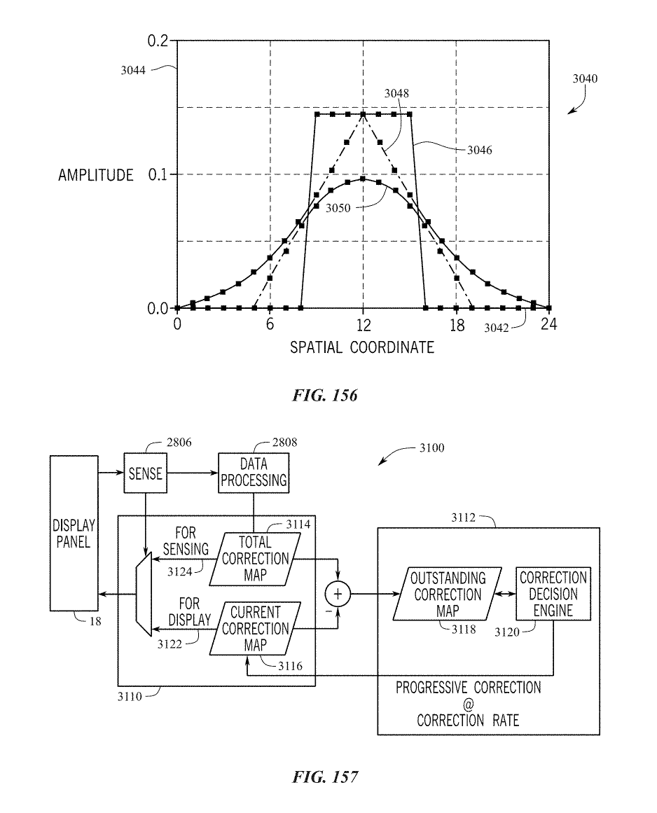

FIG. 155A provides a Bode chart 3012 (phase 3016 and magnitude 3018 as function of frequency 3014) of the open loop response for two spatial filters that may be used in the two-dimensional spatial filtering schemes illustrated above. Response for a box filter 3020 (e.g., a square filter) and a triangular filter 3022 are provided in chart 3012. Note that the box filter 3020 may have regions showing phase inversion in certain regions. FIG. 155B provides a Bode chart 3030 of the closed loop response for system 2990 for a box filter 3032 or a triangular filter 3034. The presence of phase inversion in the open loop response of the filter may be associated to closed-loop instability behavior for the pixel, which may correspond to flickering artifacts from over correction. Note that a triangle filter may be obtained by concatenating (e.g., convoluting) two box filters. Accordingly, a filter with stable closed loop response may be obtained by concatenating an even number of box filters, since this prevents the presence of phase inversion in the open loop response. FIG. 156 provides a chart 3040 illustrating spatial filters that may be used in the schemes described above. Chart 3040 illustrates amplitude 3044 as a function of a spatial coordinate 3042. The chart illustrates a box filter 3046, a triangle filter 3048, and a Gaussian filter 3050.

As discussed above, some artifacts may be generated by an overcorrection of the display luminance due to faulty sensing data. In some situations, this overcorrection may be minimized by employing a partial correction scheme. In such situations, a partial correction map is calculated from the total correction map that is based on the differences between target luminance and sensed luminance. This partial correction map is used by the display driver. A system that employs partial corrections may present a more gradual change in the luminance, and artifacts from sensing errors as the ones discussed above may be unperceived by the user of the display. In some implementations, this scheme may use partial corrections to generate images in the display, but it may instead use the total correction map for adjusting the sensed data. This strategy may be known as a feedforward sensing scheme. Feedforward sensing schemes may be useful as they allow faster convergence of the correction map to the total correction map.

With the foregoing in mind, FIG. 157 illustrates a system 3100 having a feedforward sensing circuitry 3110 along with a partial correction generation circuitry 3112. A sensing circuitry 2806 may measure luminance in a display panel 18. The sensing data may be provided for data processing circuitry 2808 that may obtain a total correction map 3114 based on the difference between the target luminance and the sensing data. A current correction map 3116, which may have an accumulation of the correction maps that were progressively added, may be compared with the total correction map 3114 to obtain an outstanding correction map 3118. A correction decision engine 3120 may then be used to update the current correction map 3116 based on the outstanding correction map 3118 and other configurable properties of the partial correction generation system 3100. The current correction map 3116 may be used to correct the pixel luminance in the display (arrow 3122). As discussed below, the total correction map 3114 may be used to adjust the sensors (arrow 3124) in a feedforward manner. The feedforward strategy prevents the sensing circuitry from introducing errors in the sensing data due to the use of a non-converged current correction map. As a result, the feedforward strategy may accelerate the convergence between the current correction map 3116 to the total correction map 3114. The updates to the current correction map 3116 may take place at a tunable correction rate, based on a desired user experience. Faster correction rates may lead to quicker convergence between the total correction map and the current correction map, which lead to more accurate images. Slower correction rates may lead to slower visual artifacts, which leads to smoother user experience.

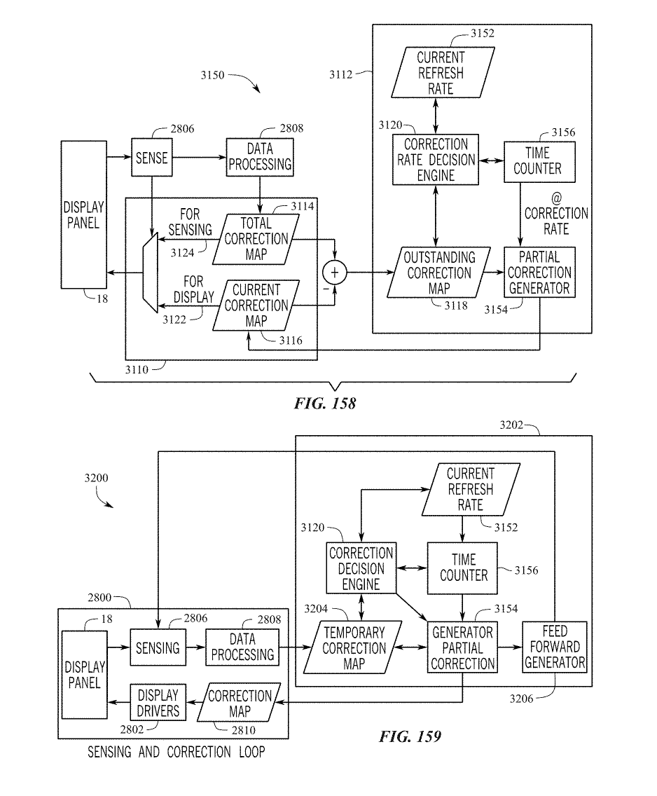

FIG. 158 illustrates another system 3150 for correction of display panel 18 luminance based on sensed data. In this system, the correction rate may be changed by employing a dynamic refresh rate. Such a system may adapt the progressive correction scheme based on the frequency of the content being displayed by display 18. Sensing circuitry 2806 may measure pixel luminance from display 18 and provide the measured luminance to data processing circuitry 2808. Data processing circuitry 2808 may produce a total correction map 3114 based on these measured values and the expected values. As in system 3100, an outstanding correction map 3118 may be produced from the total correction map 3114, and a current correction map that is being used. In system 3150, the progressive correction circuitry 3112 may also dynamically change the correction rate for the display, using a correction rate decision engine 3120. The current refresh rate 3152 may be chosen to balance smoothness (e.g., slower updates) and accuracy or speed (e.g., faster updates). Based on the current refresh rate 3152 and the outstanding correction map 3118, partial correction generator 3154 may update the current correction map 3116 using a time counter 3156 to identify when an update should take place. As in system 3100, the current correction map 3116 may be used to update the display circuitry (arrow 3122) while the total correction map 3114 may be used to update the sensing circuitry (arrow 3124).

In certain situations, the partial correction and feedforward sensing scheme may be added to a sensing and correction system, such as system 2800 in FIG. 146. System 3200 in FIG. 159 illustrate progressive correction circuitry 3202 that may be coupled to system 2800 to provide partial correction generation and feedforward sensing. As described above with respect to FIG. 146, sensing circuitry 2806 may provide to data processing circuitry 2808 measurements of luminance for pixels in display 18. Display driver 2802 may use a correction map 2810 to display pixels with corrected luminance in display panel 18. Progressive correction circuitry 3202 may be coupled to system 2800 such that it receives a temporary correction map 3204 and provides the correction map 2810. The temporary correction map 3204 is received by the data processing circuitry 2808. A correction decision engine 3120 may adjust the current refresh rate 3152 based on a desired user experience. The correction decision engine 3120 may also control a partial correction generator to produce a correction map 2810 to be returned to system 2800 based on the temporary correction map 3204 and the current refresh rate 3152. These decisions may be based on correction speed and step sizes for the partial correction scheme implemented, and may be based on the content being displayed in display 18. The time counter 3156 may keep track of the correction rate and to trigger updates to the correction map 2810. In system 3200, the feedforward sensing scheme may be implemented by using a feedforward generator circuitry 506 that may be calculated by the partial correction generator 3154. The feedforward generator 3206 may calculate offsets that may be sent to sensing circuitry 2806, reducing the time for convergence between the correction map 2810 and the total correction map.

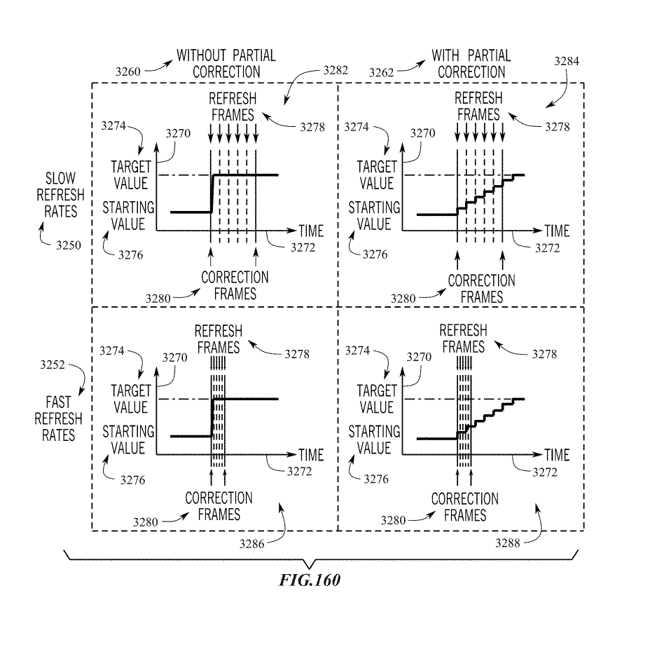

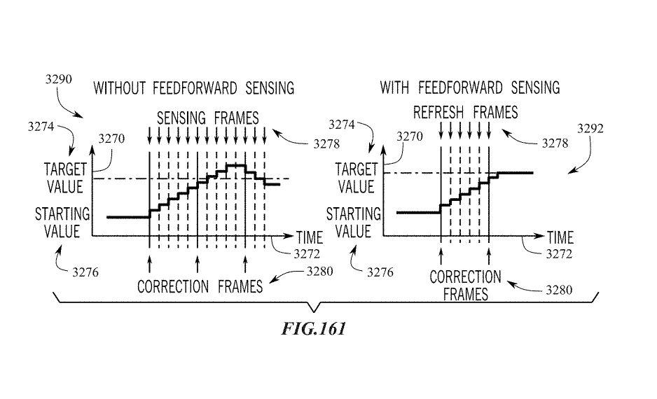

The charts in FIG. 160 illustrate the performance of systems such as the ones of FIGS. 158-160 when the content is updated at a slow refresh rate (row 3250) or at a fast refresh rate (row 3252). The performance of a system without partial correction (column 3260) is compared with that of a system with partial correction (column 3262). In all charts, luminance 3270 is plotted over time 3272. Pixels are driven from a target value 3274 from a starting value 3276. In all charts, refresh frames (arrows 3278) and correction frames (arrows 3280) are annotated as reference. Note that at slow refresh rates (row 3250), the system without partial correction (chart 3282) shows a very sharp correction when it receives a correction frame while the system with partial correction (chart 3284) shows a smoother transition towards the target value. The slow variation may correspond to a more pleasant interface experience for the user. Similarly, at a fast refresh rate (row 3252), the system without partial correction (chart 3286) shows a much sharper correction when compared to the system with partial correction (chart 3288). Note that at fast refresh rates, a new correction frame may be received before the luminance reaches the target value. In such situations, a reduction in the correction rate may be used. Note that the use of partial corrections (column 3262) generally leads to a gradual, non-noticeable correction to a user.

FIG. 161 illustrates the effect of feedforward sensing strategies to accelerate convergence of the luminance to a target value. Chart 3290 shows luminance 3270 as function of time 3272 in a system without forward sensing. Note that in chart 3290 the luminance value overshoots the target value before reaching the target value 3274. Since the full correction map is applied in partial steps (e.g., partial correction maps) in a partial correction system, the sensing circuit will sense a partially corrected image and will operate as if an additional amount of correction needs to be applied. As a result, the following correction frame may overcorrect the luminance, since it was calculated without adequate information. This overcorrection leads to the overshoot performance and may delay convergence to the target value 3274. By contrast, in chart 3292, the luminance value progressively converges from starting value 3276 to target value 3274 without overshooting. As discussed above, with feedforward schemes, the sensing circuitry operates using the full correction map, and as a result, the sensing data will reflect the actual panel values immediately before the new correction frame is calculated. The feedforward sensing scheme, therefore, may lead to a faster convergence, as illustrated.

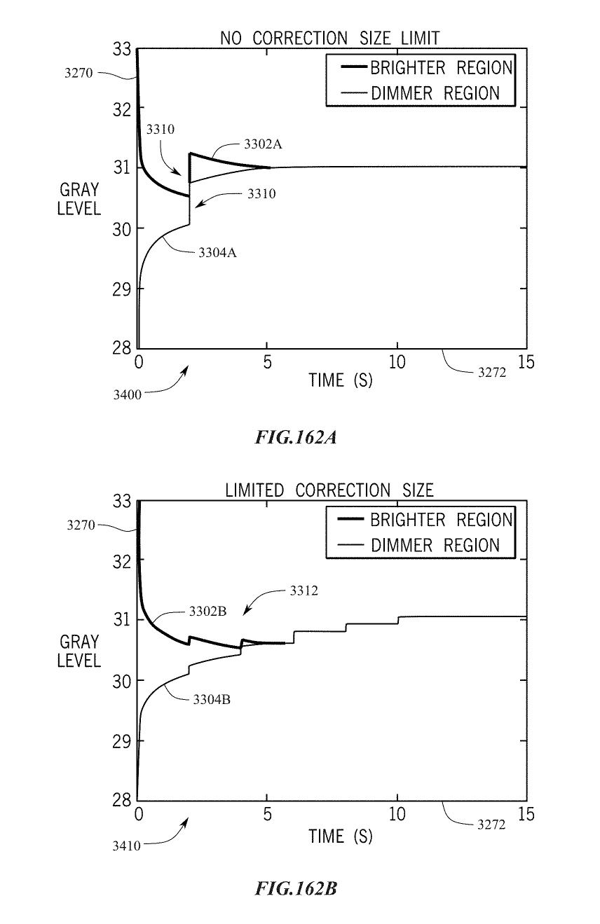

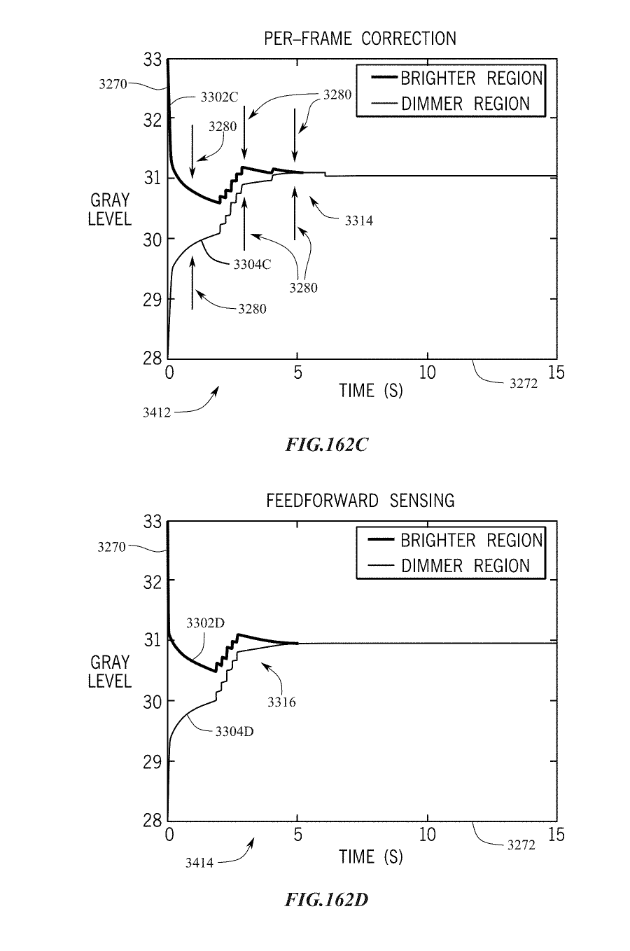

The charts illustrated in FIGS. 162A, 162B, 162C, and 162D provide the performance of pixel luminance 3270 in transitions from a brighter region (curves 3302) and from a dimmer regions (curves 3304) to a target gray level as a function of time 3272. These charts illustrate the effect of partial corrections, per-frame partial corrections, and feedforward sensing schemes that may be used to obtain reduced visibility from corrections. In chart 3400 of FIG. 162A, the performance of a system without partial correction systems is illustrated. Note that, while both curves 3302A and 3304A converge to the desired grey level quickly, both curves present visible luminance jumps (edges 3310) that may interfere with the user experience. The incorporation of partial corrections, illustrated in chart 3410 of FIG. 162B mitigate the presence of visible artifacts by providing a more gradual transition (region 3312). In such system, the convergence may, however, take longer than without the partial correction mechanism.

The use of per-frame partial corrections is illustrated in chart 3412 of FIG. 162C. In such system, the correction system still incorporates partial corrections, but the partial corrections are calculated on a per-correction frame basis. The sensing takes place for the particular pixel whose luminance at the instants annotated by arrows 3280. Corrections frames are located halfway between the sensing frames annotated by arrows 3280. Note that transition into the target luminance remains gradual (region 3314), but the convergence time decreased, when compared to the ones observed in chart 3410. Chart 3414 in FIG. 162D illustrates the effect of feedforward sensing in the performance of a system with partial correction. In this situation, the convergence may be reached as fast as in the situation without convergence illustrated in chart 3400, but with a smoother transition (region 3316) which mitigates the presence of visual artifacts.

### 3. Power-On-Burst

Image artifacts due to thermal variations on an electronic display (e.g., an organic light emitting diode, or OLED) display panel can be corrected using external compensation (e.g., using processors) by adjusting image data based on a correction profile using a sensed thermal profile of the electronic display. The thermal profile is actual distribution of heat inside the electronic display, and the correction profile is the sensed heating and a resulting image data correction for each heat level. For instance, higher thermal levels may cause pixels to display brighter in response to image data. Once these levels are sensed, the processor may create a correction profile based on the sensed data that inverts expected changes based on the thermal profile and applies them to image data so that the correction and the thermal variation cancel each other out causing the image data to appear as it was stored.

After power cycling, a residual (or pre-existing) thermal profile from previous usage can cause significant artifacts until an external compensation loop corrects the artifact using processors external to the display. The processors may use the external compensation loop to generate the correction profile In addition, any thermal variation built during off-display, such as LTE usage, light, and ambient temperature, can also cause artifacts. In this warm boot-up condition, sensing of variation due to temperature and correction of image data may be performed quickly to minimize initial artifacts. Every power cycle, sensing and correction of the whole screen can be performed during power-on sequence. This may take place even before panel starts to display images or even establishes communication with processors used to externally compensate for the thermal profile. Sensing and correction of the entire screen may involve programming driving circuitry to conduct sensing after a boot up before establishing communication with the processors that may cause sensing during scanning phases of normal operation. Furthermore, since the scanning may be performed before establishment of communication with the processors for external compensation, sensing results may be stored in a local buffer (e.g., group of line buffers) until communication with the processors 12 is established.

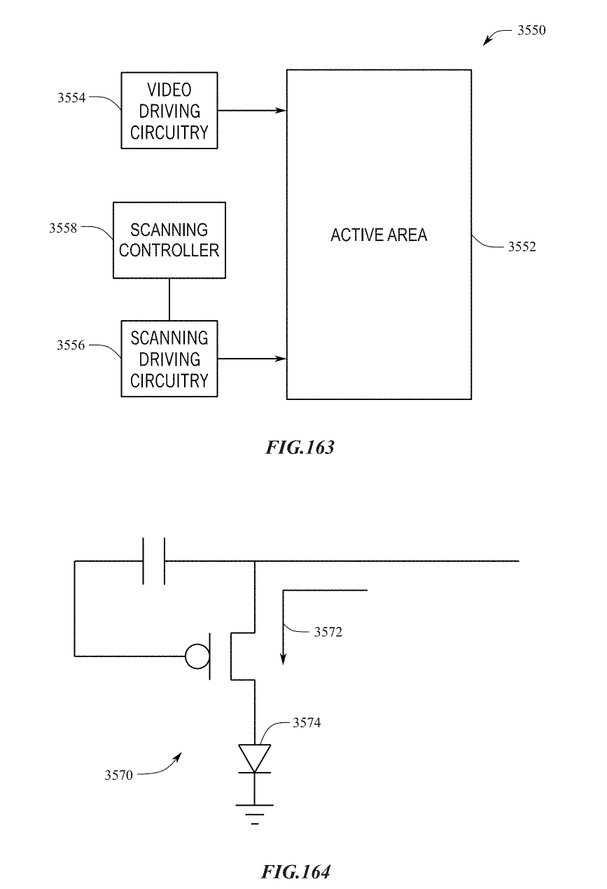

FIG. 163 illustrates a display system 3550 that may be included in the display 18 be used to display and scan an active area 3552 of the display 18. The display system 3550 includes video driving circuitry 3554 that drives circuitry in the active area 3552 to display images. The display system 3550 also includes scanning (or sensing) driving circuitry 3556 that drives circuitry in the active area 3552. In some embodiments, at least some of the components of the video driving circuitry 3554 may be common to the scanning driving circuitry 3556. Furthermore, some circuitry of the active area may be used both for displaying images and scanning. For example, pixel circuitry 3570 of FIG. 164 may be driven, alternatingly, by the video driving circuitry 3554 and the scanning driving circuitry 3556. When a pixel current 3572 is submitted to an organic light emitting diode (OLED) 3574 from the video driving circuitry 3554 and the scanning driving circuitry 3556, the OLED 3574 turns on. However, emission of the OLED 3574 during a scanning phase may be relatively low, such that the scan is not visible while the OLED 3574 is being sensed. In some embodiments, the display 18 may include LEDs or other emissive elements rather than the OLED 3574. To control of scans during the scanning mode, a scanning controller 3558 of FIG. 163 may control scanning mode parameters used to drive the scanning mode via the scanning driving circuitry 3556. The scanning controller 3558 may be embodied using software, hardware, or a combination thereof. For example, the scanning controller 3558 may at least be partially embodied as the processors 12 using instructions stored in memory 14 or in communication with the processors 12.

External or internal heat sources may heat at least a portion of the active area 3552. Operation of the electronic device 10 with the active area heated unevenly may result in display artifacts if these heat variations are not compensated for. For example, heat may change a threshold voltage of the an access transistor of a respective pixel, causing power applied to the pixel to appear differently than an appearance the same power would cause in adjacent pixels undergoing a different amount of heat. During operation of the electronic device 10, compensation using the processors 12 may account for such artifacts due to ongoing sensing. However, during startup of the device 10, this external compensation may generally begin after communication is established between the display 18 (e.g., scanning driving circuitry 3556 and/or scanning controller 3558. During this startup time, if a preexisting thermal profile preexists the power cycle, the correction speed (e.g., τ=0.3 s) may be too slow to prevent a waving artifact issue.

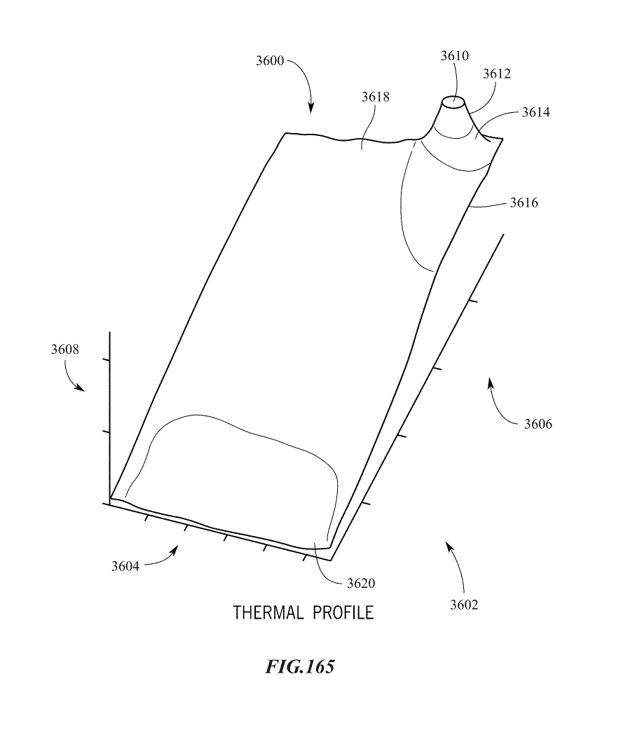

FIG. 165 illustrates an embodiment of a possible thermal profile 3600 illustrated on a graph 3602 showing where actual heat exists in the electronic device 10. As illustrated, the graph 3602 includes an x-axis 3604 that corresponds to an x-axis of the active area 3552. The graph 3602 also includes a y-axis 3606 that corresponds to a y-axis of the active area 3552. Furthermore, the graph 3602 includes a z-axis 3608 that corresponds to temperature at a corresponding location on the x-y plane formed by the x-axis 3604 and the y-axis 3606. The thermal profile 3600 includes multiple regions 3610, 3612, 3614, 3616, 3618, and 3620 (collectively referred to as “regions 3610-3620”). The temperature level of each of the regions 3610-3620 may be at least partially due to heat sources internal to the electronic device 10, such as wireless (e.g., LTE or WiFi) chips, processing circuitry, camera circuitry, batteries, and/or other heat sources within the electronic device 10. The temperature level of each of the regions may also be at least partially due to heat sources external to the electronic device 10.

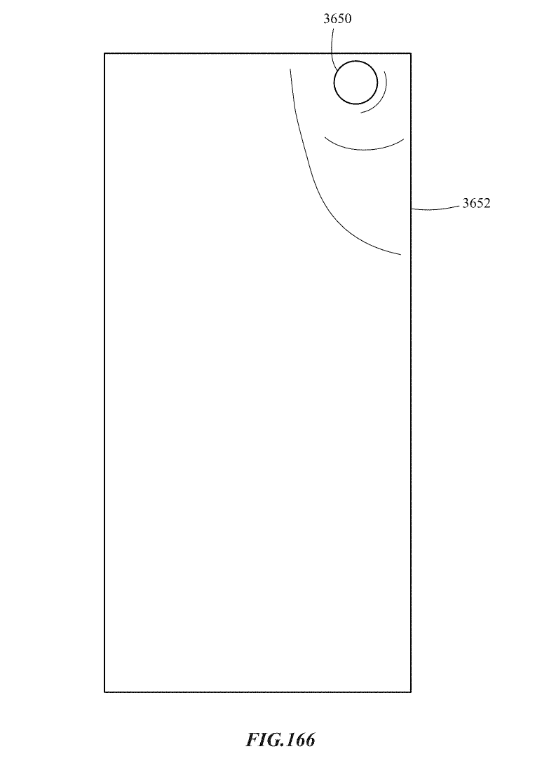

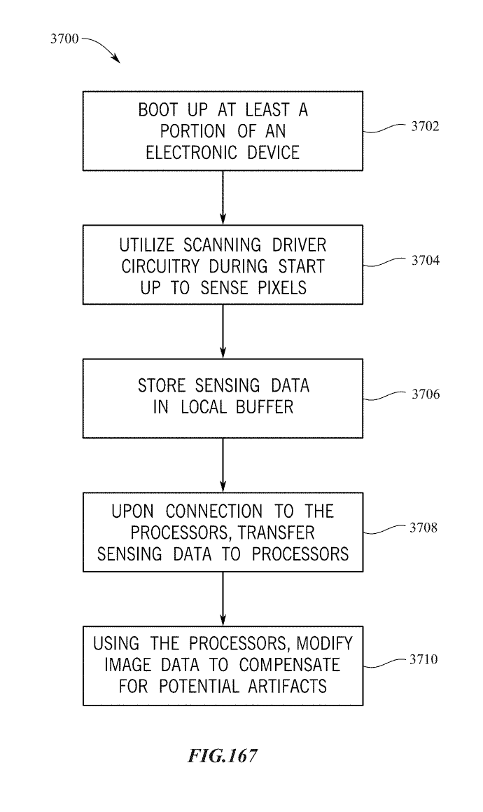

Due to internal or external heat sources, heat in the regions 3610-3620 may vary throughout the active area 3552 due to light (e.g., sunlight), ambient air temperatures, and/or other outside heat sources. As illustrated, the region 3610 corresponds to a relatively high temperature. This temperature may correspond to a processing chip (e.g., camera chip, video processing chip) or other circuitry located underneath the active area 3552. When the electronic device 10 boots up while having the thermal profile 3600, the relatively high temperature of the region 3610 may result in an artifact, such as the artifact 3650 illustrated in FIG. 166. Specifically, the artifact 3650 may be a brighter area of a screen 3652 displayed by the display 18. The screen 3652 is intended to display a consistent grayscale level throughout the screen 3652. However, due to the temperature fluctuation throughout the screen 3652 during boot up of the device, the screen 3652 contains image artifacts due to temperature dependence of the active area 3552. Specifically, the elevated temperature may result in an area corresponding to the region 3610 that is brighter than remaining portions of the screen 3652.

Furthermore, the thermal profile 3600 may be built prior to or during the power cycle. For example, heat may remain through the power cycle due to operation of the electronic device 10 during a previous ON state for the electronic device 10. Additionally or alternatively, the power cycle may correspond to only some portions of the electronic device 10 (e.g., the display 18) while other portions (e.g., network interface 26, I/O interface 24, and/or power source 28) remain active and possibly generating heat. The thermal profile 3600 may be stored in memory 14 upon shutdown of the previous ON state. However, this thermal profile 3600 is likely to change over time, and external compensation using the processors 12 is unlikely to be correct since the processors 12 may correct video data using a thermal profile 3600 that is no longer current. Thus, such embodiments may result in artifacts corresponding to an incorrect thermal profile. Instead, the thermal profile 3600 may be reset and to be correctly mapped during a sense phase of the display 18. However, since the sensing phase is generally sent to the processors 12 after communication is established with the processors 12 by the display 18. In other words, the processors 12 traditionally send image data to the display 18 at substantially the same time that the first image data is sent to the display 18 after start up or image data is sent after the first image data is sent to the display 18.

As illustrated in FIG. 167, the electronic device 10 may utilize a process 3700 for accounting for potential artifacts due to boot up thermal profiles. The process 3700 includes booting up at least a portion of the electronic device 10 (block 3702). Booting up may include booting up the whole electronic device 10 or may include booting up only a portion (e.g., the display 18). During boot up, the scanning driving circuitry 3556 may start sensing pixels of the active area 3552 (block 3704). The scanning driving circuitry 3556 and/or the scanning controller 3558 may be programed to cause sensing of at least some of the pixels of the active area 3552 before initiating communication with the processors 12 and/or prior to receiving any image data from the processors 12.

Furthermore, sensing of the pixels of the active area 3552 may include sensing only a portion of the pixels. For example, pixels in key locations, such as those near known heat sources, may be scanned. Additionally or alternatively, a sampling representative of the active area 3552 may be made. It is noted that an amount of pixels scanned may be a function of available buffer space since the sensing data is stored in a local buffer (block 3706). The local buffer may be located in or near the scanning driving circuitry 3556 and/or the scanning controller 3558. The local buffer is used for boot up scanning since communication with the processors 12 has not been established in the boot up process before the sensing of pixels begin. As previously noted, the buffer size may be related to how many pixels are sensed during the sensing scan. For example, if only strategic locations are stored, the local buffer may include twenty line buffers, over a thousand line buffers may be used if all pixels are sensed during the boot up scan.

Once communication is established between the display 18 and the processors 12, the sensing data is transferred to the processors 12 (block 3708). The processors 12 then modify image data to compensate for the potential artifacts (block 3710). For example, the image data may be modified to reduce luminance levels of pixels corresponding to locations indicating a relatively high temperature.

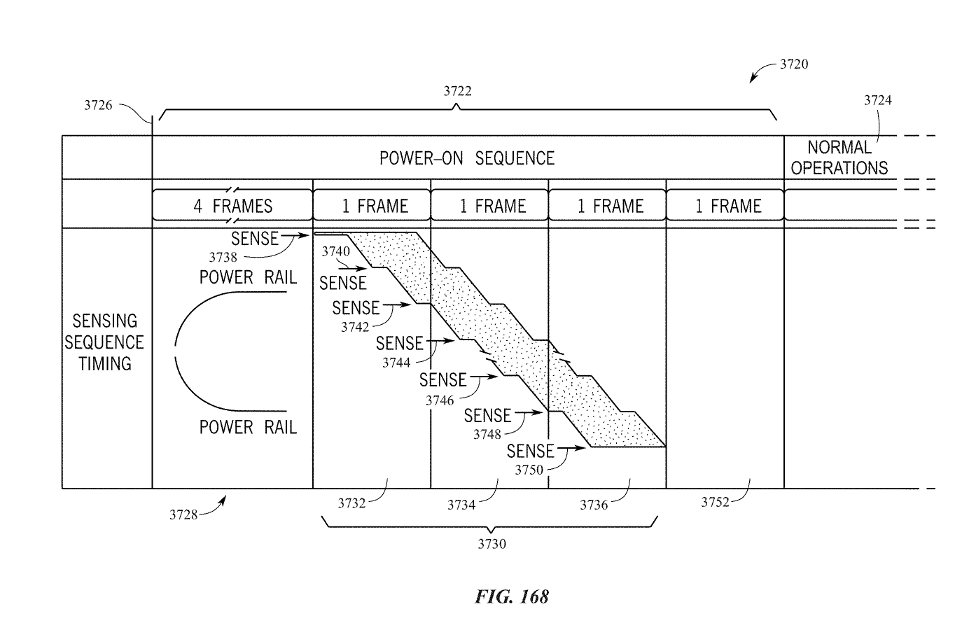

FIG. 168 illustrates a timing diagram 3720 that may be used to sense pixels during a power-on sequence. As illustrated, the timing diagram 3720 includes a power on sequence 3722 that occurs before a normal operation mode 3724 after a boot up event 3726. As previously discussed, the boot up event may be a boot up of the entire electronic device 10 or may only be a portion of the electronic device 10 (e.g., display 18). The power on sequence 3722 includes a power rail settling period 3728 that includes a period of time adequate to allow power rails of the display 18 to sufficiently settle. In the illustrated embodiment, the power rail settling period 3728 includes a duration equivalent to four frames (e.g., 33.2 ms). However, the power rail settling period 3728 may be set to any duration sufficient to adequately settle the power rails. After the power rails have settled, the scanning driving circuitry 3556 and/or the scanning controller 3558 begin boot-up sensing 3730. In the illustrated embodiment, the boot-up sensing 3730 lasts through frames 3732, 3734, and 3736. However, this duration may be programmable to any period and may at least partially depend on how many pixels are scanned during the boot-up sensing 3730. For example, the illustrated embodiment includes sensing lines 3738, 3740, 3742, 3744, 3746, 3748, and 3750. If additional lines/pixels are to be scanned, additional frames may be programmed into the boot-up sensing 3730. During a clock transition period 3752 after the boot-up sensing 3730, communication between the display 18 (e.g., the sensing driving circuitry 3556 and/or the sensing controller 3558) may be established and normal operation 3724 uses a clock signal that is also used by the processors 12.

### 4. Predictive Temperature Compensation

Display panel quality and/or uniformity can be negatively effected by temperature. For example, as the temperature changes a voltage (V_{HILO}) across the high and low terminals of a light-emissive solid-state device may cause unintended variation of light emission from the light-emissive solid-state device. The light-emissive solid-state device may include an organic light emitting diode (OLED), a light emitting diode (LED), or the like. Herein, the following refers to an OLED, but some embodiments may include any other light-emissive solid-state devices.

Specifically, as the temperature changes in a pixel around the OLED, a corresponding driving transistor (e.g., thin-film transistor TFT) fluctuates a voltage/current provided to the OLED. Using a temperature index and a relationship between system temperature and a temperature of the OLED, a V_{HILO} may be predicted and compensated for even when direct measurement of the OLED temperature is impossible or impractical.

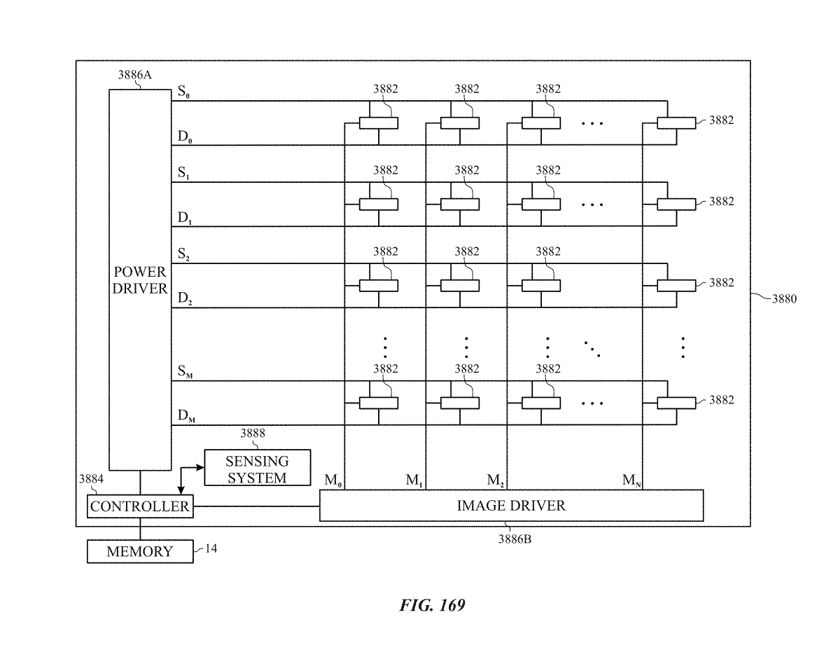

Generally, the brightness depicted by each respective pixel in the display 18 is generally controlled by varying an electric field associated with each respective pixel in the display 18. Keeping this in mind, FIG. 169 illustrates one embodiment of a circuit diagram of the display 18 that may generate the electrical field that energizes each respective pixel and causes each respective pixel to emit light at an intensity corresponding to an applied voltage. As shown, display 18 may include a self-emissive pixel array 3880 having an array of self-emissive pixels 3882.

The self-emissive pixel array 3880 is shown having a controller 3884, a power driver 3886A, an image driver 3886B, and the array of self-emissive pixels 3882. The self-emissive pixels 3882 are driven by the power driver 3886A and image driver 3886B. Each power driver 3886A and image driver 3886B may drive one or more self-emissive pixels 3882. In some embodiments, the power driver 3886A and the image driver 3886B may include multiple channels for independently driving multiple self-emissive pixels 3882. The self-emissive pixels may include any suitable light-emitting elements, such as organic light emitting diodes (OLEDs), micro-light-emitting-diodes (μ-LEDs), and the like.

The power driver 3886A may be connected to the self-emissive pixels 3882 by way of scan lines S₀, S₁, . . . Sₘ₋₁, and Sₘ and driving lines D₀, D₁, . . . Dₘ₋₁, and Dₘ. The self-emissive pixels 3882 receive on/off instructions through the scan lines S₀, S₁, . . . Sₘ₋₁, and Sₘ and generate driving currents corresponding to data voltages transmitted from the driving lines D₀, D₁, . . . Dₘ₋₁, and Dₘ. The driving currents are applied to each self-emissive pixel 3882 to emit light according to instructions from the image driver 3886B through driving lines M₀, M₁, . . . Mₙ₋₁, and Mₙ. Both the power driver 3886A and the image driver 3886B transmit voltage signals through respective driving lines to operate each self-emissive pixel 3882 at a state determined by the controller 3884 to emit light. Each driver may supply voltage signals at a duty cycle and/or amplitude sufficient to operate each self-emissive pixel 3882.

The controller 3884 may control the color of the self-emissive pixels 3882 using image data generated by the processor core complex 12 and stored into the memory 14 or provided directly from the processor core complex 12 to the controller 3884. A sensing system 3888 may provide a signal to the controller 3884 to adjust the data signals transmitted to the self-emissive pixels 3882 such that the self-emissive pixels 3882 may depict substantially uniform color and luminance provided the same current input in accordance with the techniques that will be described in detail below.

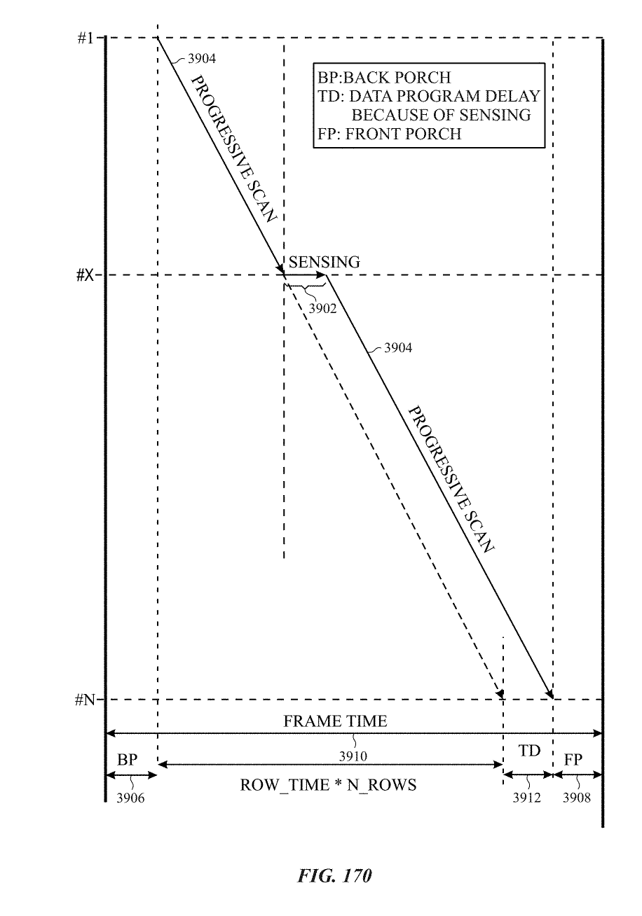

With the foregoing in mind, FIG. 170 illustrates an embodiment in which the sensing system 3888 may incorporate a sensing period during a progressive data scan of the display 18. In some embodiments, the controller 3884 may send data (e.g., gray level voltages or currents) to each self-emissive pixel 3882 via the power driver 3886A on a row-by-row basis. That is, the controller 3884 may initially cause the power driver 3886A to send data signals to the pixels 3882 of the first row of pixels on the display 18, then the second row of pixels on the display 18, and so forth. When incorporating a sensing period, the sensing system 3888 may cause the controller 3884 to pause the transmission of data via the power driver 3886A for a period of time (e.g., 100 microseconds) during the progressive data scan at a particular row of the display (e.g., for row X). The period of time in which the power driver 3886A stops transmitting data corresponds to a sensing period 3902.

As shown in FIG. 170, the progressive scan 3904 is performed between a back porch 3906 and a front porch 3908 of a frame 3910 of data. The progressive scan 3904 is interrupted by the sensing period 3902 while the power driver 3886A is transmitting data to row X of the display 18. The sensing period 3902 corresponds to a period of time in which a data signal may be transmitted to a respective pixel 3882, and the sensing system 3888 may determine certain sensitivity properties associated to the respective pixel 3882 based on the pixel's reaction to the data signal. The sensitivity properties may include, for example, power, luminance, and color values of the respective pixel when driven by the provided data signal. After the sensing period 3902 expires, the sensing system 3888 may cause the power driver 3886A to resume the progressive scan 3904. As such, the progressive scan 3904 may be delayed by a data program delay 3912 due to the sensing period 3902.

In order to incorporate the sensing period 3902 into the progressive scans of the display 18, pixel driving circuitry may transmit data signals to pixels of each row of the display 18 and may pause its transmission of data signals during any portion of the progressive scan to determine the sensitivity properties of any pixel on any row of the display 18. Moreover, as sizes of displays decrease and smaller bezel or border regions are available around the display, integrated gate driver circuits may be developed using a similar thin film transistor process as used to produce the transistors of the pixels 3882. In some embodiments, the sensing periods may be between progressive scans of the display.

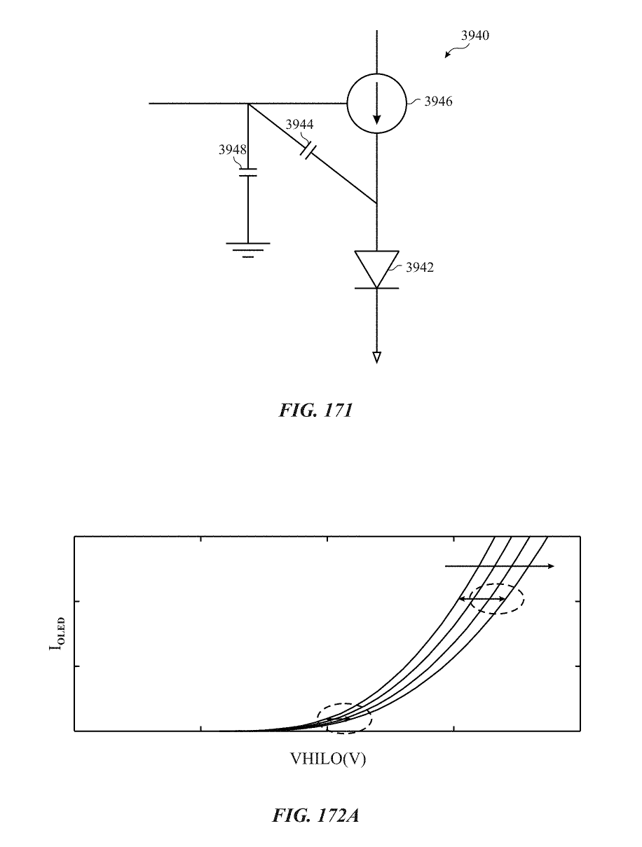

FIG. 171 is a block diagram for a simplified pixel 3940 that controls emission of an OLED 3942. As illustrated, the OLED 3942 is an active matrix OLED (AMOLED) that uses a storage capacitor 3944 that enables data to be written to the storage capacitor 3944 to multiple pixel rows and/or columns sequentially. The storage capacitor 3944 maintains a line pixel state in the pixel 3940. The pixel 3940 also includes a current source 3946 that may be representative of one or more TFTs that provide a current to the OLED 3942.

The output of the current source 3946 depends upon the voltage stored in the storage capacitor 3944. For example, the storage capacitor 3944 may equal a gate-source voltage V_{GS} of a TFT of the current source 3946. However, the voltage in the storage capacitor 3944 may change due to parasitic capacitances represented by the capacitor 3948. The amount of parasitic capacitance may change with temperature that causes operation of the current source 3946 to vary thereby causing changes in emission of the OLED 3942 based at least in part on temperature fluctuations. Temperature may also cause other fluctuations in the pixel current through the OLED 3942, such as fluctuations of operation of the TFTs making up the current source and/or operation of the OLED 3942 itself.

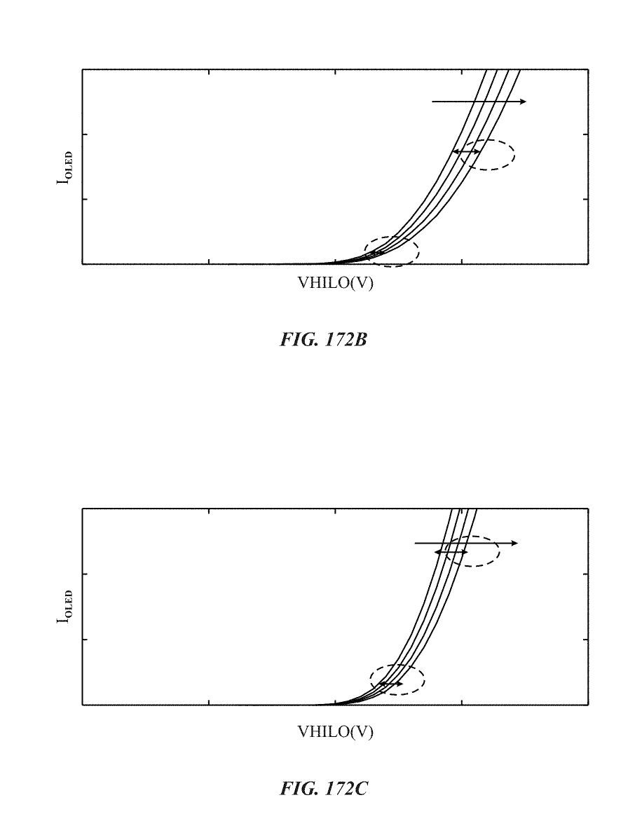

FIGS. 172A-172C illustrates graph of V_{HILO} versus the current I_{OLED} through the OLED 3942 over various temperatures (e.g., 45° C. to 30° C.). However, the change may vary based on a color of the OLED. For example, FIG. 172A may represent a change in ratio of V_{HILO} to I_{OLED} for a red color OLED, FIG. 172B may represent a change in ratio of V_{HILO} to I_{OLED} for a green color OLED, and FIG. 172C may represent a change in ratio of V_{HILO} to I_{OLED} for a blue color OLED.

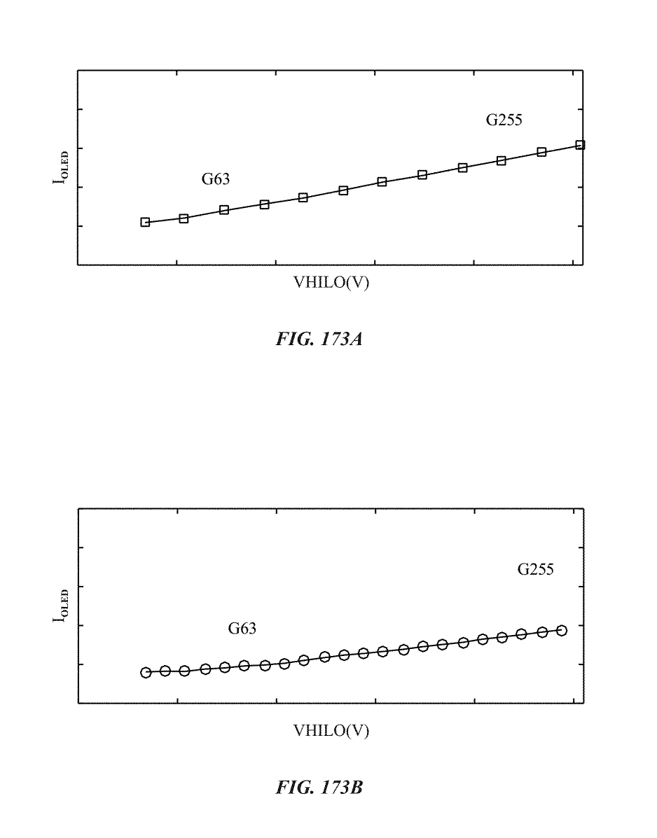

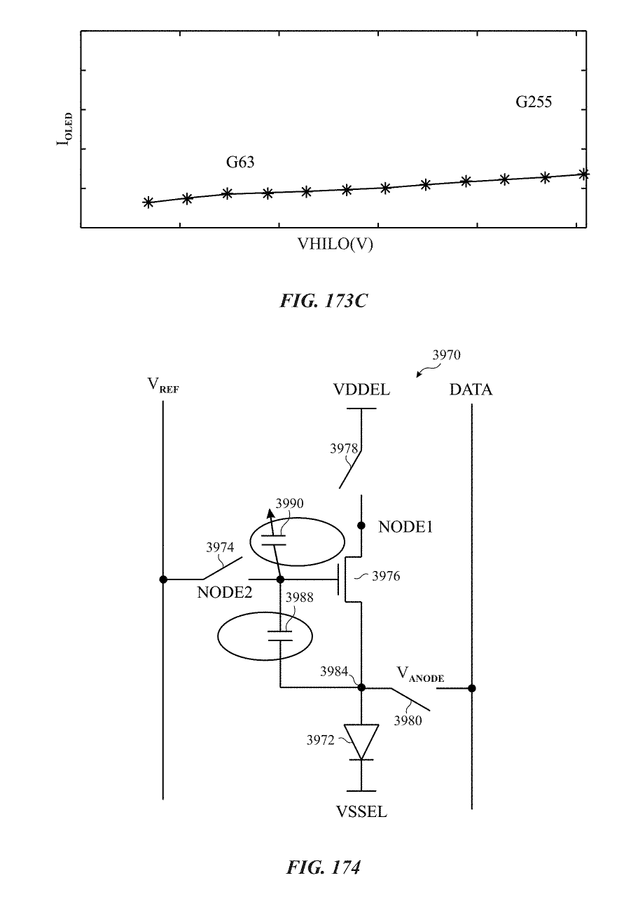

Furthermore, grayscale levels may also affect a change in an amount of shift in V_{HILO} and its corresponding I_{OLED}. FIGS. 173A-173C illustrate such relationships. As with the relationship between V_{HILO} and I_{OLED}, the relationship between gray level and V_{HILO} shift may be color-dependent. For example, FIG. 173A may represent a relationship between a gray level and a V_{HILO} shift for a red OLED, FIG. 173B may represent a relationship between a gray level and a V_{HILO} shift for a green OLED, and FIG. 173C may represent a relationship between a gray level and a V_{HILO} shift for a blue OLED.

FIG. 174 illustrates a more detailed depiction of an embodiment of a pixel control circuitry. The pixel driving circuitry 3970 may include a number of semiconductor devices that may coordinate the transmission of data signals to an OLED 3972 of a respective pixel 3882. In some embodiments, the pixel driving circuitry 3970 may receive input signals (e.g., an emission signal and/or one or more scan signals).

With this in mind, the pixel driving circuitry 3970 may include switches 3974, 3978, and 3980 along with transistor 3976. These switches may include any type of suitable circuitry, such as transistors. Transistors (e.g., transistor 3976) may include N-type and/or P-type transistors. That is, depending of the type of transistors used within the pixel driving circuitry 3970, the waveforms or signals provided to each transistor should be coordinated in a manner to cause the pixel control circuitry.

As shown in FIG. 174, the transistor 3976 and the switches 3974, 3978, and 3980 may be driven by scan and emission signals. Based on these input signals, the pixel driving circuitry 3970 may implement a number of pixel driving schemes for a respective pixel.

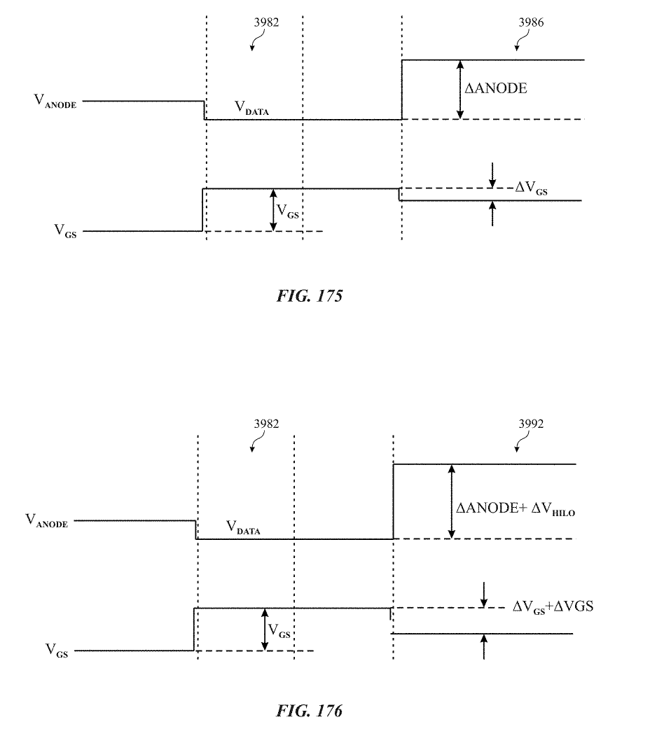

As illustrated in FIG. 175, the scan and/or emission signals may cause the pixel control circuitry 3970 to be placed in a data write mode 3982. During the data write mode 3982, a voltage V_{ANODE} at a node 3984 in FIG. 174 between the transistor 3976 and the switch 3980 is driven to a voltage V_{DATA} of the data. Returning to FIG. 175, in a subsequent emission period 3986 (e.g., caused by the emission signal), the V_{ANODE} becomes a sum of a VSSEL supply voltage (e.g., −3V˜-2.5V), the V_{HILO}. The gate-source voltage V_{GS} of the transistor 3976 (across storage capacitor 3988) also changes by ΔV_{GS} during the emission period 3986. This ΔV_{Gs} is determined by V_{HILO} sensitivity and the V_{ANODE}. The V_{HILO} sensitivity is a ratio of a parasitic capacitance at the gate of transistor 3976 (represented by gate capacitor 3990 in FIG. 174) to a sum of capacitances of the storage capacitor 3988 and the parasitic capacitance 3990.

$$Δ {V}_{GS} = {V}_{HILO} sensitivity \times Δ {V}_{ANODE} = \frac{{C}_{GATE}}{{C}_{ST} + {C}_{GATE}} \times Δ {V}_{ANODE} , \qquad ( Equation 1 )$$

where C_{GATE} is the capacitance of parasitic capacitance at the gate and C_{ST} is the capacitance of the storage capacitor 3988.

Although the pixel sensitivity ratio may be reduced by increasing capacitance of the storage capacitor, size in the pixel control circuitry 3970 may be limited due to display size, compactness of pixels (i.e., pixels-per-inch), part costs, and/or other constraints. In other words, the V_{HILO} sensitivity cannot be reasonably eliminated. Thus, in realistic situations, as previously discussed, V_{HILO} may shift due to temperature and/or other causes. FIG. 176 illustrates an embodiment of emission levels in response to a V_{HILO} shift. The data write period 3982 remains unchanged. However, in emission period 3992 the V_{ANODE} is the sum of VSSEL and V_{HILO} including any shift that has occurred on the V_{HILO} as voltage of ΔV_{HILO} due to temperature and/or other changes. Since the ΔV_{HILO} shifts the V_{ANODE}, the ΔV_{HILO} also shifts the V_{GS}. Thus, the ΔV_{HILO} creates a V_{GS} error ΔV_{gs} that is attributable to the V_{HILO} sensitivity and the ΔV_{HILO} that has been added to the V_{ANODE}.

$$Δ {V}_{gs} = \frac{{C}_{GATE}}{( {C}_{ST} + {C}_{GATE} )} \times Δ {V}_{HALO} \qquad ( Equation 2 )$$

In other words, this ΔV_{gs} error is created by parasitic capacitance on the gate of the transistor 3976 in a source-follower-type pixel. In other embodiments, the error may be shifted around to other locations due to other parasitic capacitances.

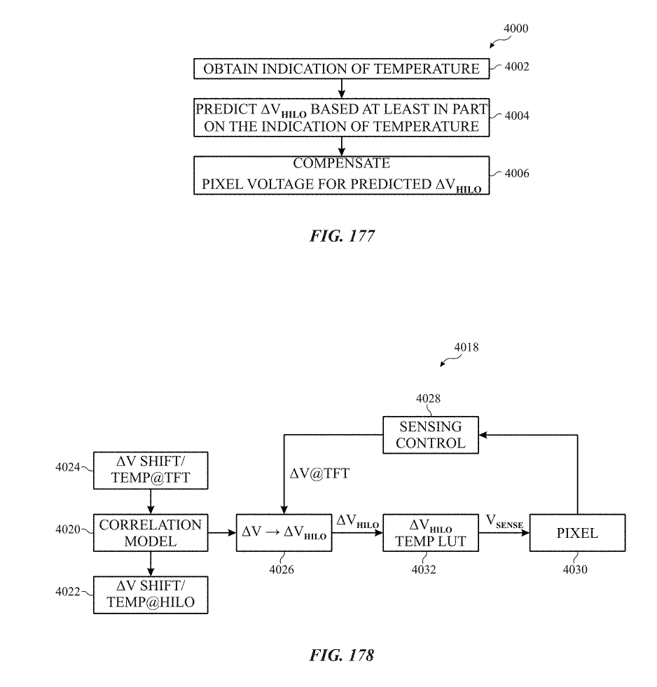

To address these problems a predictive V_{HILO} model may be used to mitigate a temperature effect on V_{HILO}. FIG. 177 illustrates an embodiment of a process 4000 for mitigating temperature effect on V_{HILO} variation. The processor core complex 12 obtains an indication of temperature (block 4002). The indication of temperature may be a direct measurement of a temperature from a temperature sensor. Additionally or alternatively, the indication of the temperature may include adjustments to a measured temperature as an interpolated or calculated temperature. Furthermore, the temperature may be an overall system temperature and/or may include a grid temperature that logically divides the electronic device into regions or grids that have a common temperature indication.

The processor core complex 12 then predicts a change in V_{HILO} based at least in part on the indication of the temperature (block 4004). If the indication of temperature corresponds to an overall system temperature, the indication of temperature may be interpolated from a system temperature to a temperature for a pixel or group of pixels based on a location of the pixel or group of pixels relative to heat sources in the electronic device 10, operating states (e.g., camera running, high processor usage, etc.) of the electronic device, an outside temperature (e.g., received via the network interface(s) 26), and/or other temperature factors.

Using either the received indication directly or an interpolation based on the received indication, the prediction may be performed using a lookup table that has been populated using empirical data reflecting how ΔV_{HILO} is related to temperature for the pixel in an array of pixels in a display panel, a grid of the panel, an entire panel, and/or a batch of panels. This empirical data may be derived at manufacture of the panels. In some embodiments, the empirical data may be captured multiple times and averaged together to reduce noise in the correlation between ΔV_{HILO} and temperature. In some embodiments, instead of a lookup table with empirically derived data, the empirical data may be used to derive a transfer function that is formed from a curve fit of one or more empirical data gathering passes.

As previously note, in addition to temperature, ΔV_{HILO} may depend on grayscale levels and/or emission color of the OLED 3972. Thus, the prediction of the ΔV_{HILO} may also be empirically gathered for color effects and/or grayscale levels. In other words, the predicted ΔV_{HILO} may be based at least in part on the temperature, the (upcoming) grayscale level of the OLED 3972, the color of the OLED 3972, or any combination thereof.

The processor core complex 12 compensates a pixel voltage inside the pixel control circuitry 3970 to compensate based at least in part on the predicted ΔV_{HILO} (block 4006). Compensation includes offsetting the voltage based on the predicted ΔV_{HILO} by submitting a voltage having an opposite polarity but similar amplitude on the pixel voltage (e.g., V_{ANODE}). The compensation may also include compensating for other temperature-dependent (e.g., transistor properties) or temperature-independent factors. Furthermore, since some grayscale levels are more likely to be visible due to human detection factors or properties of the grayscale level and ΔV_{HILO}, in some embodiments, the compensation voltage may be applied for some grayscale level content but not applied for other grayscale level content.

FIG. 178 illustrates an embodiment of a compensation system 4018 that utilizes a correlation model 4020 that correlates various voltage shifts to a temperature. As previously discussed, this correlation model 4020 may receive data corresponding to a first stored relationship 4022 between temperature and ΔV shift at the OLED 3972. Additionally or alternatively, the correlation model 4020 may receive data corresponding to a second stored relationship 4024 between temperature and ΔV shift at a TFT (e.g., transistor 3976). The second stored relationship 4024 may also include a temperature index indicating a temperature at the TFT based on direct measurements and/or calculations from a system measurement.

The correlation model 4020 is used by the processor core complex 12 to convert to predict V_{HILO} (block 4026) based on the temperature index and a current ΔV as determined from a sensing control 4028 used to determine how to drive voltages for operating a pixel 4030. The sensing control 4028 is used to control voltages used during an emission state based on results of a sensing phase. Additionally or alternatively, a transfer function may be used from the temperature index/ΔV. This prediction may be made using a first lookup table that converts ΔV and a temperature index to a predicted ΔV_{HILO}. The predicted ΔV_{HILO} is then used to determine a V_{SENSE} level that is used in a sensing state to offset the ΔV_{HILO} using the processor to access a second lookup table (block 4032). Additionally or alternatively, a transfer function may be used from ΔV_{HILO} to determine the V_{SENSE} compensating for the ΔV_{HILO}.

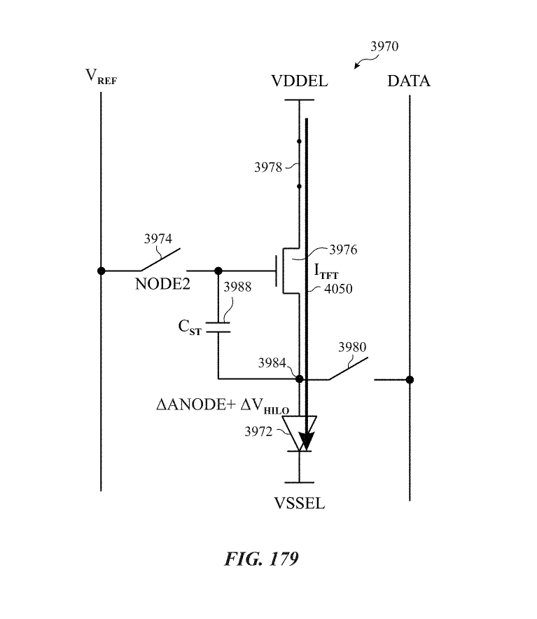

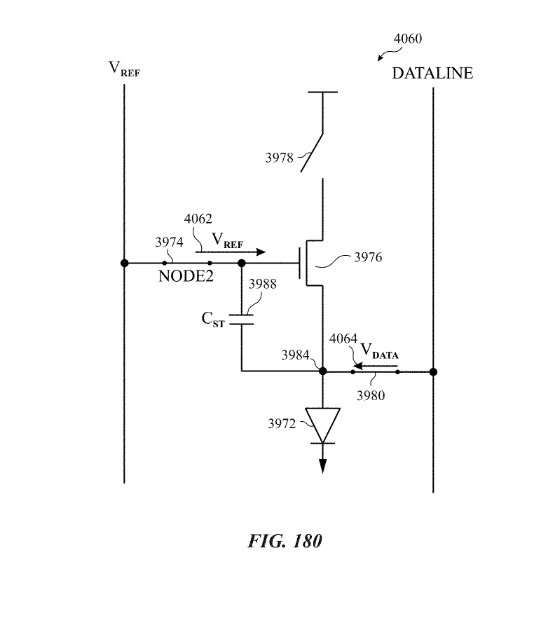

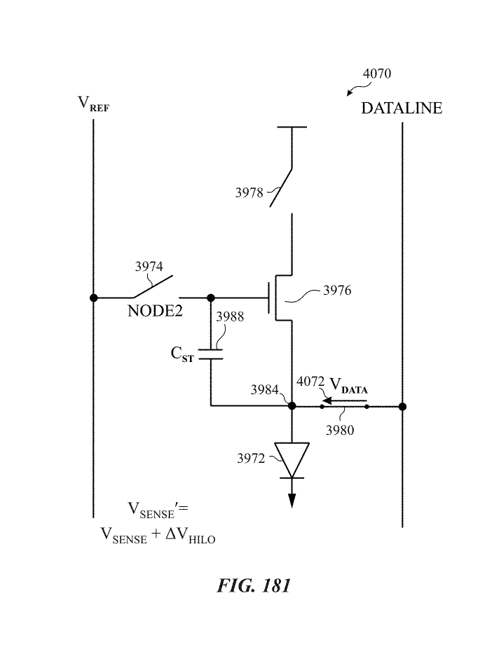

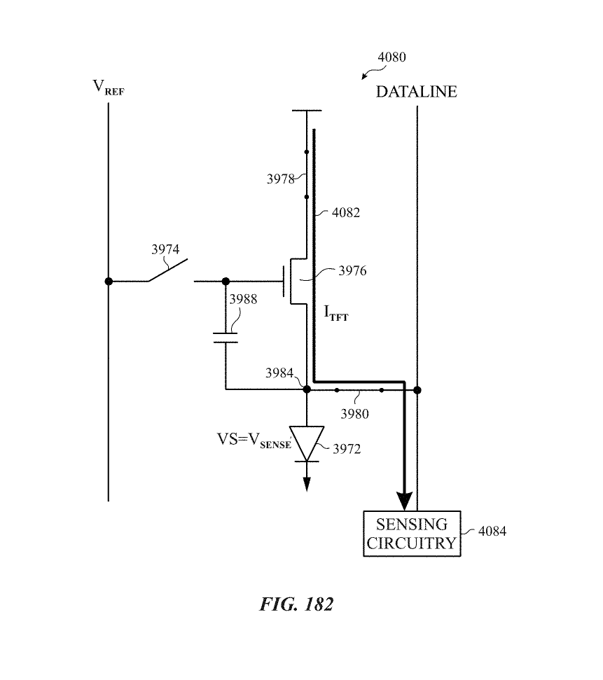

FIG. 179 illustrates an embodiment of an emission mode for the pixel control circuitry 3970 in an emission state. In the emission state, an I_{TFT} current 4050 is passed through the OLED 3972 to cause emission. To achieve a desired level, the V_{ANODE} may be set to compensate for the ΔV_{HILO}. To achieve this level, voltage at the ANODE may be set during the sensing phase of the display 18. FIGS. 180-182 illustrates compensating the V_{ANODE} for ΔV_{HILO} due to temperature and/or other factors. FIG. 180 illustrates a loading step 4060 the C_{ST} 3988 using V_{REF} 4062 and V_{DATA} 4064 via the closed switches 3974 and 3980. FIG. 181 illustrates an injection mode 4070 that injects a V_{SENSE}′ 4072 that includes a V_{SENSE} and a compensation for ΔV_{HILO}. The V_{SENSE} may be a static voltage level that is sufficiently high to determine whether a return current is as expected to determine health (e.g., age) and/or expected functionality of the corresponding pixel. FIG. 182 illustrates a sense phase 4080 using the return current I_{TFT} 4082 through the transistor 3976 and closed switches 3978 and 3980 to sensing circuitry 4084.

The specific embodiments described above have been shown by way of example, and it should be understood that these embodiments may be susceptible to various modifications and alternative forms. It should be further understood that the claims are not intended to be limited to the particular forms disclosed, but rather to cover all modifications, equivalents, and alternatives falling within the spirit and scope of this disclosure.

The techniques presented and claimed herein are referenced and applied to material objects and concrete examples of a practical nature that demonstrably improve the present technical field and, as such, are not abstract, intangible or purely theoretical. Further, if any claims appended to the end of this specification contain one or more elements designated as “means for [perform]ing [a function] . . . ” or “step for [perform]ing [a function] . . . ”, it is intended that such elements are to be interpreted under 35 U.S.C. 112(f). However, for any claims containing elements designated in any other manner, it is intended that such elements are not to be interpreted under 35 U.S.C. 112(f).

What is claimed is:

1. A mobile electronic device comprising:
a display comprising a pixel;
processing circuitry separate from but communicatively coupled to the display, wherein the processing circuitry is configured to prepare image data to send to the pixel and adjust the image data to compensate for operational variations of the display based on feedback received from the display that describes a present operational behavior of the pixel; and
one or more additional electronic components that affect the present operational behavior of the pixel depending on present operational behavior of the one or more additional electronic components.

2. The mobile electronic device of claim 1, wherein the processing circuitry is configured to adjust the image data to compensate for the operational variations of the display by:
generating a compensation value that, when applied to the image data, compensates for the operational variations of the display; and
apply the compensation value to the image data.

3. The mobile electronic device of claim 1, wherein the operational variations comprise aging of the display, degradation of the display, temperature across the display, or any combination thereof.

4. The mobile electronic device of claim 1, wherein display is configured to sense the operational variations when displaying test image data or user image data.

5. The mobile electronic device of claim 1, wherein the display is configured to:
program the pixel with test data; and
sense the operational variations by sensing voltage, current, or a combination thereof, of a response of the pixel to being programmed with the test data.

6. The mobile electronic device of claim 1, wherein the display is configured to reduce noise on a sense line of the display by performing differential sensing, difference-differential sensing, correlated double sampling, programmable capacitor matching, or any combination thereof.

7. The mobile electronic device of claim 1, wherein the processing circuitry is configured to cause the display to turn off and cause the display to modify a gate source voltage of a drive transistor coupled to a light emitting diode of the display while the display is turned off.

8. A method comprising:
sensing, via current sensing, operational variations of an electronic display; and
adjusting, via processing circuitry apart from the electronic display, image data that is sent to the electronic display based at least in part on the operational variations.

9. The method of claim 8, wherein sensing, via the current sensing, the operational variations comprises:
sensing a first parameter of a first pixel of the electronic display; and
sensing a second parameter of a second pixel of the electronic display while the first pixel operates in a non-light emitting mode.

10. The method of claim 9, wherein adjusting, via the processing circuitry, the image data that is sent to the electronic display is based at least in part on sensing the first parameter and sensing the second parameter.

11. The method of claim 8, comprising generating, via the processing circuitry, a correction value based at least in part on a correction curve associated with the pixel.

12. The method of claim 11, wherein adjusting, via the processing circuitry, the image data that is sent to the electronic display is based at least in part on applying the correction value to the image data sent to the electronic display.

13. The method of claim 11, comprising updating, via the processing circuitry, the correction curve based at least in part on the correction value.

14. The method of claim 8, comprising:
filtering, via the processing circuitry, the operational variations to produce correction factors, a correction map, or both; and
sending the correction factors, the correction map, or both, to the electronic display.

15. An electronic device comprising:
a display comprising:
a display panel, wherein the display panel comprises a pixel; and
display driver circuitry comprising integrated display sensing circuitry configured to sense a present operational variation of the pixel; and
processing circuitry communicatively coupled to the display, wherein the processing circuitry is configured to:
receive an indication of the present operational variation of the pixel from the display;
adjust image data based at least in part on the present operational variation of the pixel; and
send the image data to the display.

16. The electronic device of claim 15, wherein the display comprises an analog-to-digital converter configured to digitize the indication of the present operational variation of the pixel before it is sent to the processing circuitry.

17. The electronic device of claim 15, wherein the integrated display sensing circuitry comprises a sensing analog front end configured to perform analog sensing of a response of the pixel to test image data or user image data.

18. The electronic device of claim 15, wherein the processing circuitry is configured to adjust the image data using a dual loop compensation scheme.

19. The electronic device of claim 18, wherein the dual loop compensation scheme comprises a coarse scan loop updated at a first rate and a fine scan loop updated at a second rate, wherein the first rate is faster than the second rate.

20. The electronic device of claim 15, comprising filtering circuitry communicatively coupled to the processing circuitry, wherein the filtering circuitry is configured to filter the operational variations.
